(19) United States
(12) Patent Application Publication
(10) Pub. No.: US 2025/0055363 A1
(43) Pub. Date: Feb. 13, 2025

(54) INFRARED PLASMA LIGHT RECYCLING THERMOPHOTOVOLTAIC HYDROGEN ELECTRICAL POWER GENERATOR

(71) Applicant: BRILLIANT LIGHT POWER, INC., NEWTOWN, PA (US)

(72) Inventor: RANDELL L. MILLS, NEWTOWN, PA (US)

(73) Assignee: BRILLIANT LIGHT POWER, INC., NEWTOWN, PA (US)

(21) Appl. No.: 18/917,666

(22) Filed: Oct. 16, 2024

Related U.S. Application Data
(63) Continuation of application No. PCT/IB2023/053932, filed on Apr. 18, 2023.
(60) Provisional application No. 63/332,111, filed on Apr. 18, 2022.
(60) Provisional application No. 63/339,949, filed on May 9, 2022.
(60) Provisional application No. 63/343,971, filed on May 19, 2022.
(60) Provisional application No. 63/355,562, filed on Jun. 24, 2022.
(60) Provisional application No. 63/368,602, filed on Jul. 15, 2022.
(60) Provisional application No. 63/370,106, filed on Aug. 1, 2022.
(60) Provisional application No. 63/371,754, filed on Aug. 17, 2022.
(60) Provisional application No. 63/375,530, filed on Sep. 13, 2022.
(60) Provisional application No. 63/429,914, filed on Dec. 2, 2022.
(60) Provisional application No. 63/477,760, filed on Dec. 29, 2022.
(60) Provisional application No. 63/481,384, filed on Jan. 24, 2023.
(60) Provisional application No. 63/449,948, filed on Mar. 3, 2023.
(60) Provisional application No. 63/457,108, filed on Apr. 4, 2023.

(51) Int. Cl. H02K 44/08; G21B 3/00; H05H 1/24

(52) U.S. Cl. CPC H02K 44/08; H05H 1/4697; G21B 3/004

(57) ABSTRACT

A power generator is described that provides at least one of electrical and thermal power comprising (i) at least one reaction cell for reactions involving atomic hydrogen products identifiable by unique analytical and spectroscopic signatures, (ii) a molten metal injection system comprising at least one pump such as an electromagnetic pump that provides a molten metal stream to the reaction cell and at least one reservoir that receives the molten metal stream, and (iii) an ignition system comprising an electrical power source that provides low-voltage, high-current electrical energy to the at least one steam of molten metal to ignite a plasma to initiate rapid kinetics of the reaction and an energy gain. In some embodiments, the power generator may comprise: (v) a source of H₂ and O₂ supplied to the plasma, (vi) a molten metal recovery system, and (vii) a power converter capable of (a) converting the high-power light output from a blackbody radiator of the cell into electricity using concentrator thermophotovoltaic cells with plasma light recycling or (b) converting the energetic plasma into electricity using a magnetohydrodynamic converter.

### CROSS REFERENCE TO RELATED APPLICATIONS

The present application claims priority to and the benefit of U.S. App. No. 63/332,111 filed Apr. 18, 2022, U.S. App. No. 63/339,949 filed May 9, 2022, U.S. App. No. 63/343,971 filed May 19, 2022, U.S. App. No. 63/355,562 filed Jun. 24, 2022, U.S. App. No. 63/368,602 filed Jul. 15, 2022, U.S. App. No. 63/370,106 filed Aug. 1, 2022, U.S. App. No. 63/371,754 filed Aug. 17, 2022, U.S. App. No. 63/375,530 filed Sep. 13, 2022, U.S. App. No. 63/429,914 filed Dec. 2, 2022, U.S. App. No. 63/477,760 filed Dec. 29, 2022, U.S. App. No. 63/481,384 filed Jan. 24, 2023, U.S. App. No. 63/449,948 filed Mar. 3, 2023, and U.S. App. No. 63/457,108 filed Apr. 4, 2023, each of which is hereby incorporated by reference in its entirety.

### FIELD OF DISCLOSURE

The present disclosure relates to the field of power generation and, in particular, to systems, devices, and methods for the generation of power. More specifically, embodiments of the present disclosure are directed to power generation devices and systems, as well as related methods, which produce optical power, plasma, and thermal power and produces electrical power via a magnetohydrodynamic power converter, an optical to electric power converter, plasma to electric power converter, photon to electric power converter, or a thermal to electric power converter. In addition, embodiments of the present disclosure describe systems, devices, and methods that use the ignition of a water or water-based fuel source to generate optical power, mechanical power, electrical power, and/or thermal power using photovoltaic power converters. These and other related embodiments are described in detail in the present disclosure.

### BACKGROUND

Power generation can take many forms, harnessing the power from plasma. Successful commercialization of plasma may depend on power generation systems capable of efficiently forming plasma and then capturing the power of the plasma produced.

Plasma may be formed during ignition of certain fuels. These fuels can include water or water-based fuel source. During ignition, a plasma cloud of electron-stripped atoms is formed, and high optical power may be released. The high optical power of the plasma can be harnessed by an electric converter of the present disclosure. The ions and excited state atoms can recombine and undergo electronic relaxation to emit optical power. The optical power can be converted to electricity with photovoltaics.

### SUMMARY

The present disclosure is directed to power systems that generates at least one of electrical energy and thermal energy comprising:
at least one vessel capable of a maintaining a pressure below atmospheric;
reactants capable of undergoing a reaction that produces enough energy to form a plasma in the vessel comprising:
   a) a mixture of hydrogen gas and oxygen gas, and/or water vapor, and/or
      a mixture of hydrogen gas and water vapor;
   b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction; a power converter or output system to convert a portion of the energy produced from the reaction (e.g., light and/or thermal output from the plasma) to electrical power and/or thermal power.

Power systems (herein referred to as “SunCells”) of the present disclosure may comprise:
a) at least one vessel capable of a maintaining a pressure below atmospheric comprising a reaction chamber;
b) two electrodes configured to allow a molten metal flow therebetween to complete a circuit;
c) a power source connected to said two electrodes to apply a current therebetween when said circuit is closed;
d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);
wherein when current is applied across the circuit, the effluence of the plasma generation cell undergoes a reaction to producing a second plasma and reaction products; and
e) a power adapter configured to convert and/or transfer energy from the second plasma into mechanical, thermal, and/or electrical energy. In some embodiments, the gas in the plasma generation cell is a mixture of hydrogen (H₂) and oxygen (O₂). For example, the relative molar ratio of oxygen to hydrogen is from 0.01%-50% (e.g. from 0.1%-20%, from 0.1-15%, etc.). In certain implementations, the molten metal is Gallium. In some embodiments, the reaction products have at least one spectroscopic signature as described herein. In various aspects, the second plasma is formed in a reaction cell, and the walls of said reaction cell comprise a liner having increased resistance to alloy formation with the molten metal and the liner and the walls of the reaction cell have a high permability to the reaction products (e.g. stainless-steel such as 347 SS such as 4130 alloy SS or Cr—Mo SS, nickel, Ti, niobium, vanadium, iron, W, Re, Ta, Mo, niobium, and Nb(94.33 wt %)—Mo(4.86 wt %)—Zr(0.81 wt %)). The liner may be made of a crystalline material (e.g., SiC, BN, quartz) and/or a refractory metal such as at least one of Nb, Ta, Mo, or W. In certain embodiments, the second plasma is formed in a reaction cell, wherein the walls reaction cell chamber comprise a first and a second section,
   the first section composed of stainless steel such as 347 SS such as 4130 alloy SS or Cr—Mo SS, nickel, Ti, niobium, vanadium, iron, W, Re, Ta, Mo, niobium, and Nb(94.33 wt %)—Mo(4.86 wt %)—Zr(0.81 wt %);
   the second section comprising a refractory metal different than the metal in the first section;
   wherein the union between the different metals is formed by a lamination material (e.g., a ceramic such as BN).

A power system of the present disclosure may include:
a.) a vessel capable of a maintaining a pressure below atmospheric comprising a reaction chamber;
b) a plurality of electrode pairs, each pair comprising electrodes configured to allow a molten metal flow therebetween to complete a circuit.
c) a power source connected to said two electrodes to apply a current therebetween when said circuit is closed;
d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);
   wherein when current is applied across the circuit, the effluence of the plasma generation cell undergoes a reaction to producing a second plasma and reaction products; and
e) a power adapter configured to convert and/or transfer energy from the second plasma into mechanical, thermal, and/or electrical energy;
   wherein at least one of the reaction products (e.g., intermediates, final products) has at least one spectroscopic signature as described herein.

The power generation system may comprise:
a) at least one vessel comprising a baseplate capable of a maintaining a pressure below atmospheric comprising a reaction chamber;
b) two electrodes each in fluid communication with molten metal contained in a corresponding reservoir, wherein the molten metal is configured to flow between the electrodes to complete a circuit;
c) a power source connected to said two electrodes comprising a cathode and anode to apply an ignition current therebetween when said circuit is closed;
d) optionally, a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir);
wherein when current is applied across the circuit, the effluence of the plasma generation cell undergoes a reaction to produce a second plasma and reaction products wherein energy from second plasma produces radiation;
e) a transparent window cavity to transmit radiation produced from the second plasma, wherein the transparent window cavity is in contact with the baseplate of the vessel;
f) a wet seal between the transparent window cavity and the baseplate comprising a wet seal molten metal, and
g) a power adapter configured to receive the radiation transmitted through the transparent window cavity and convert and/or transfer energy from the second plasma into mechanical, thermal, and/or electrical energy. In some embodiments the vessel is a stainless-steel dome. The baseplate may be positioned on top of the vessel. In various implementations, a window having a cavity (e.g., quartz window cavity) may be positioned on the baseplate of the vessel and the reaction chamber may considered the space defined by the cavity and the baseplate (e.g., the reactants are ignited in the window cavity). In various implementations, the vessel is the reaction chamber. In some embodiments, the window and cavity are part of the vessel. In some embodiments, the vessel comprises a spherical, hemispherical, or parabolic dome section to which the reservoirs are connected and further comprises a drip edge at the connection to each outer reservoir.

The molten metal may be supplied to the electrodes to close the circuit by two molten metal injector systems that each form a molten metal stream in contact with one of the electrodes, wherein the molten metal streams intersect to close the circuit. The molten metal injector system may comprise:
a) a reservoir that contains some of the molten metal, a molten metal pump system (e.g., one or more electromagnetic pumps) configured to deliver the molten metal in the reservoir and through an injector tube to provide a molten metal stream, and the reservoir for receiving a returning molten metal stream following injection;
b) an inlet riser tube to control the molten metal level in the reservoir;
c) an electrical break in the wall of the reservoir to electrically isolate each of the corresponding electrodes from the electrode of opposite polarity, and
d) an alignment mechanism to change the orientation of the electrode injector such that the corresponded two streams of the two electrodes intersect to complete the circuit. In various implementations, each of the injector tubes may be covered by an electrically insulating sleeve that is resistant to wetting by the molten metal. The sleeve may comprise at least one of quartz, boron nitride, carbon, and a plurality of carbon sections separated by electrically insulating sections of boron nitride or quartz and may comprise at least two portions, an upper portion and a lower portion. The electromagnetic pump may comprise an EM bus bar assembly coated internally with a coating (e.g., TiN) that at least one of resists oxidation and alloy formation. In various implementations, the electromagnetic pump may comprise a tungsten EM bus bar assembly and tungsten pump tubes laser welded with Kovar shins at the joints and further coated on externally with tungsten disilicide or precious metal.

In some embodiments, each reservoir further comprises an inner and outer reservoir separated by a gap wherein the outer reservoir connects to the vessel and houses the inner reservoir under vacuum, and the inner reservoir opens to the inside of the vessel and the window cavity and receives the return flow of the molten metal. The inner reservoir may further comprise a funnel (e.g., a quartz funnel) at its opening to the vessel to present the returning molten metal from flowing into the gap. In some embodiments, the funnel further comprises a graphite or BN washer between the drip edge and the funnel to seal the top of the funnel to the bottom of the drip edge. The inner and outer reservoirs may further comprise a thermal conductor and an electrical insulator which conduct heat positioned in the gap between the inner and outer reservoirs and permit heat conduction while maintaining the electrical isolation of the two electrodes. The thermal conductor and electrical insulator may be coupled together and provide maintain the electrical isolation while also providing the heat conduction. For example, the thermal conductor and an electrical insulator may comprise a cylinder of copper to provide the thermal conductivity and a cylinder of boron nitride to provide the electrical isolation and heat conduction; wherein the cylinders are concentric and fill the gap between the inner and outer reservoirs, comprise expand slots, and have a height less than or equal to the height of the inner reservoir. The system may further comprise a heater to heat the outer wall of the outer reservoir whereby the thermal conductor conducts the heat from the heater to the inner reservoir to melt the molten metal. In some embodiments, the heater comprises at least one hydrogen torch.

The power generation systems of the present disclosure may comprise a magnetohydrodynamic wet seal for maintaining a vacuum on one side of a photovoltaic (PV) window comprising a cavity transparent to optical power; wherein the wet seal joins the PV window chamber and a baseplate (e.g., a baseplate of the vessel having penetrations for the tops of one or more reservoirs) and comprises a channel containing molten metal into which the PV window chamber is inserted;
wherein the molten metal is electrically connected to a power supply to create current in the molten metal in the channel to induce magnetorestriction of the molten metal in the housing to maintain the seal;
wherein light is generated on one side of the PV window, transmitted through the window, and collected in at least one photovoltaic cell to generate electrical power. In some embodiments, the molten metal is exposed to magnetic field such that the Lorentz force of the current and magnetic field on the molten metal in the channel is directed against external forces on the molten metal to maintain the wet seal. In some embodiments, the wet seal is formed from a plurality of metal layers, wherein a liquid metal layer is disposed between two solid metal layers.

In some embodiments, the vessel is connected to the window cavity and the wet seal further comprises:
a) a window flange at the base of the window cavity;
b) a baseplate flange on the baseplate;
c) a top flange on top of the window cavity flange having a mechanical connection to the baseplate flange to provide pressure on the window flange against the baseplate flange;
d) a gasket (e.g., carbon) on a least one window cavity flange surface in contact with the top flange and the baseplate flange;
e) at least one of an inner circumferential housing or retention wall to the inside of the window cavity and an outer circumferential housing or retention wall to the outside of the window cavity flange, and
f) wet seal molten metal retained by the housing and retention wall and the gasket to maintain a lower pressure inside of the window cavity relative to outside to maintain a pressure differential. The wet seal may comprise a graphite gasketed flange seal for the transparent window cavity comprising a top and bottom seal flange bolted together with top and bottom graphite gaskets between each flange surface of the window cavity and the corresponding seal flange further comprises an angle ring or channel ring around the perimeter of the graphite-gasketed flange seal welded to at least one of baseplate and the bottom flange of the seal to form a cavity around the graphite gasketed flange seal wherein the cavity is filled with wet seal molten metal to form the wet seal.

The wet seal gasket (e.g., graphite or carbon gasket) may be compressed by atmospheric pressure due to the pressure differential such that at least one of the flange mechanical tension is reduced and the force to maintain gasket compression is provided by atmospheric pressure alone. In some embodiments, the wet seal comprises a barrier gasket which at least one of supports the weight of the window cavity and prevents flow of molten metal due to a downward force corresponding to the pressure differential between atmosphere and the pressure of the gas within the window cavity. The wet seal may comprise at least one of:
a) the base of the window cavity having a precision flat surface mated to a matching precision flat surface of the baseplate;
b) a window flange at the base of the window cavity having a precision flat surface mated to a matching precision flat surface of the baseplate;
c) a gasket (e.g., carbon) between the base of the window cavity and the baseplate flange;
d) a gasket (e.g., carbon) between at least a portion of the surface of the window cavity flange in contact with baseplate;
e) an outer circumferential housing or retention wall to the outside of the window cavity or window cavity flange;
f) an inner circumferential housing or retention wall to inside of the window cavity;
g) wet seal molten metal retained by the housing and retention wall and the gasket to maintain a lower pressure inside of the window cavity relative to outside to maintain a pressure differential, and
h) wet seal molten metal retained by the housing and retention wall and the precision mated contact between the window cavity or the window cavity flange to the baseplate to maintain a lower pressure inside of the window cavity relative to outside to maintain a pressure differential.

The wet seal molten metal (or a portion thereof) may be solidified along at least one of the outer perimeter of the outer housing or retention wall and under the base of the PV window cavity or its flange. In some embodiments, at least one of
a) the height of the outer circumferential housing or the retention wall;
b) the width of the window cavity flange not covered by the gasket;
c) the width of the window cavity flange precision mated to the baseplate, and
d) the height of the window cavity flange are sufficient to permit formation of the wet seal (e.g., in the range of 1 mm to 100 mm). In various implementations, the wet seal comprises precision and matching flatness to the window cavity flange and baseplate, and wherein at least one of
a) the gap between the window cavity flange and the baseplate is less than a height above which the wet seal molten metal can penetrate;
b) the gap between the window cavity flange and the baseplate with or without the wet seal gasket is less than a height above which the wet seal molten metal flows outwards;
c) any gap between the flange and baseplate is less than (or from 0.1 microns to) 1 mm (e.g., less than 100 microns, less than 10 microns);
d) a circumferential portion of the gap between the precision mated window cavity flange and the baseplate is a height that prevents
   1) the wet seal molten metal penetration wherein the gap height maintains a barrier to inward wet seal molten metal flow to maintain a positive pressure differential between the inside and outside of the window cavity, and/or
   2) the wet seal molten metal outward flow to retain the wet seal molten metal in the region of the gap, and
e) at least a circumferential portion of the gap between the window cavity flange and the baseplate due to thickness of the gasket is a height that prevents outward wet seal molten metal flow to retain the wet seal molten metal in the region of the gap.

The wet seal molten metal is typically a molten metal capable of filling the channel in a flowable state (e.g., by heating) and able to maintain the pressure differential. The wet seal molten metal may comprise tin or gallium. In some embodiments, the wet seal molten metal is impregnated in a solid matrix.

The wet seal and window cavity may further comprise a gasket interface comprising surfaces on each joined component that may permit relative moment between the gasket and the window cavity without destructive damage to the gasket. The gasket interface may comprise or be positioned at the base of the window cavity or a flange comprises edges each having a radius of curvature or chamfers to form smooth edges. In various implementations, the wet seal comprises at least one of inner and outer housings and retention rings wherein at least one of
a) the inner housing or inner retention ring comprises a refractory metal from the group of W, Ta, Mo, or Nb, or a ceramic such as quartz or alumina,
b) at least one of the walls of the inner and outer housings and retention rings is coated with BN, and
c) at least one housing and retention ring is at least partially sunk into the baseplate.

In some implementations, the system (e.g., baseplate and/or vessel) may further comprise reflective liners of all the surfaces that are incident the plasma radiation and reflect the incident light through the window cavity to the power adapter wherein the liners further comprise penetrations for the injectors that are further covered by reflective penetration liners. The reflectors may comprise quartz plates conforming to the surfaces that they line having the backside coated with a reflective coating. Exemplary reflective coatings include comprises at least one from the group of Aremco Quartz Coat 850 https://news.thomasnet.com/fullstory/reflective-coating-handles-temperature-to-1-600-f-454985, CP4040-S2-HT, and LC4040-SG, Aremco Pyro-Duct™ 597-A (Adhesive) Pyro-Duct™ 597-C(Coating)Silver-Filled, Electrically & Thermally Conductive, One-Part Systems to 1700° F. (927° C.) (https://www.aremco.com/conductive-compounds/), Aremco 634-BN—SiC, the reflective quartz material OM 100 (Heraeus, https://www.heraeus.com/media/media/hca/doc_hca/products_and_solutions_8/solids/OM10 0_EN.pdf), a metal, silver, aluminum, a precious metal, gold, rhodium, iridium, ruthenium, palladium, and platinum, and combinations thereof. In various embodiments, the reflective coating may be coated with a protective coat (e.g., BN) to avoid alloy formation with the molten metal. In various implementations, the system (e.g., one of the baseplate, vessel, and inner reservoir) may further comprise an electromagnetic pump baseplate wherein the surfaces in contact with the molten metal are coated with a coating (e.g., boron nitride) that prevents alloy formation with the molten metal.

In specific embodiments, the molten metal to close the circuit is tin. In various implementations, the tin does not wet the PV window. In some embodiments, the effluence of the plasma generation cell does not oxidize tin. In some embodiments, the transparent window cavity (e.g., PV window) comprises at least one of quartz, sapphire, aluminum oxynitride, and MgF₂.

In some embodiments, the power adapter is a thermophotovoltaic adapter. The power adapter may comprise photovoltaic cells and the photons produced from the second plasma having an energy less than the bandgap of the photovoltaic cells are reflected back to the reaction chamber, are absorbed by the second plasma, and the absorbed energy is at least partially emitted as radiation above the bandgap, wherein the radiation above the bandgap is incident on the photovoltaic cells.

The power systems of the present disclosure may be augmented to increase the light recycling and incidence of the light produced by the second plasma on the power adapter. For example, the vessel may have a wet floor and/or a wet wall, and a baseplate or wall of the vessel has a layer of molten metal deposited thereon to reflect the second plasma light through the window cavity to the power adapter. In various implementations, the baseplate or wall has a membrane disposed thereover to provide a desired molten metal film coverage. The baseplate or wall may have a bead-liner disposed thereon and a bead retention support comprising a tray to support the beads of the bead-liner. In some embodiments, the tray has a plurality of depths of varying height (e.g., with independently selected bead diameters to match with the depth).

In some embodiments, the vessel further comprises the window cavity that transmits light from the second plasma and/or the blackbody radiation in the vessel to the power adapter; the window cavity comprises a window cavity flange; and the window flange is attached to the baseplate through a baseplate flange attached to (or part of) the vessel; wherein the seal between the window cavity flange and the baseplate flange is partially formed by the wet seal formed from the molten metal is dispersed between the window cavity flange and the baseplate flange and along the outer edge the window cavity flange. In some embodiments, the window cavity flange comprises the window cavity wall at its base. In various implementations, a mated baseplate or baseplate flange and window cavity flange form a housing along the perimeter of the window cavity flange, wherein the perimeter may be filled with the molten metal and the molten metal is solidified along the outer perimeter of the housing.

A wet seal system for maintaining a vacuum on one side of a photovoltaic (PV) window is provided, wherein the wet seal may comprise a cavity transparent to optical power; wherein the wet seal joins a PV window chamber and a baseplate (e.g., a baseplate of the vessel having penetrations for the tops of one or more reservoirs) and comprises a channel containing molten metal into which the PV window chamber is inserted;
wherein the molten metal rotates such that the centrifugal force pushes radially on the molten metal to maintain the seal against external forces.

A wet seal (e.g., magnetohydrodynamic wet seal) for maintaining a vacuum on one side of a photovoltaic (PV) window may comprise a cavity transparent to optical power;
wherein the seal comprises an electrically insulated channel dimensioned for the photovoltaic window chamber to be inserted therein and extending around the PV window chamber when the PV window chamber is inserted in the channel;
wherein the channel is filled with molten metal;
wherein the electrically insulated channel has at least one positive lead electrode and at least one negative lead electrode at different points of the channel;
at least one current is applied through the molten metal in the channel, and the molten metal is exposed to at least one magnetic field applied by at least one magnet to create at least one Lorentz force along a section of the channel wherein the electrodes and magnets are configured and oriented such that the Lorentz forces of the corresponding currents and magnetic fields are in the vector directions to oppose the atmospheric pressure force on the molten metal in the channel to produce a vacuum seal, the Lorentz forces of the currents and magnetic fields are sufficient to maintain a pressure difference (e.g., vacuum seal). In some embodiments, the wet seal comprises two or more electrically insulated channels; wherein each channel has at least one positive lead electrode and negative lead electrode;
wherein when the PV window chamber comprising at least one edge is inserted into at least one channel, each channel is independently filled with molten metal such that the two or more channels together extend around the PV window, and
the current or currents in each channel is independently biased and together interact with independent Lorentz fields to maintain a pressure difference (e.g., vacuum seal). In various implementations, the PV window may form a PV window cavity having a flange at its base, and the PV window flange is seated on a window cavity baseplate; wherein the magnetohydrodynamic wet seal between the PV window cavity flange and the window cavity baseplate further comprising comprises:
a) a molten metal (e.g., tin or gallium) reservoir circumferential to the PV window cavity flange that supplies molten metal (e.g., tin or gallium) to a gap between the bottom of the PV window flange and a portion of the baseplate;
b) a continuous separator in a gap between an outer wall of the molten metal (e.g., tin or gallium) reservoir wall and a vertical edge of the PV window flange and the gap between the bottom of the PV window flange and the baseplate;
c) a source of magnetic field such as a permanent magnet, wherein the magnetic field produced from the source of the magnetic field is perpendicular to the gap between the PV window flange and the baseplate;
d) a current supply and electrodes on opposite sides of the continuous separator connected to the molten metal (e.g., gallium) to supply current to the corresponding tin or gallium wet seal circuit, wherein the current, in the presence of the crossed magnetic field, produces a radial MHD force in the gap between the PV window flange and the baseplate, and
e) an MHD-atmospheric pressure force balance processor operably connected to sensors of the wet seal position such as at least one optical sensor and one conductivity sensor, an MHD current sensor and controller, an evacuation rate sensor such as a pressure gauge and controller such as at least one of a vacuum value such as a needle valve and its controller and a vacuum pump and its controller wherein the MHD-atmospheric pressure force balance processor may receive sensor input and reiteratively adjust the MHD current and vacuum rate to achieve and maintain a stable wet seal as and when the PV window cavity is evacuated. In various implementations, an MHD-atmospheric pressure force balance processor may sets the current supply controller to provide a current corresponding to an increased MHD force relative to the maximum atmospheric force, whereby as a vacuum inside the PV window cavity, the outer atmospheric pressure causes more molten metal (e.g., tin or gallium) to flow into the gap between PV window flange and the baseplate to cause an increase in the width of the wet seal and an increase in MHD current flow with a concomitant increase in the opposing MHD force until a steady state wet seal is established.

Methods of using the systems of the present disclosure are also provided. For example, a method of maintaining a pressure difference (e.g., vacuum) between two sides of a first solid material may comprise:
a) mating the first solid material and the second solid material with the molten metal disposed therebetween; wherein when mated, the molten metal has a magnetic field applied thereto;
b) applying a current through the molten metal;
c) reducing the pressure on the molten metal;
wherein the force created by the current and the magnetic field opposes the force created by the reduction of pressure to maintain the pressure difference.

A method of maintaining a pressure difference (e.g., vacuum) between two sides of molten metal seal between a first solid material and a second solid material may comprise: a magnetic field of the opposite polarity for each ½ of the perimeter with opposite currents such that the Lorentz force is in the same direction relative to the channel (e.g., ½ of the channel may be magnetized with the magnetic field in the +z-direction, and ½ of the channel may be magnetized with the magnetic field in the −z-direction).

A method of maintaining a pressure difference (e.g., vacuum) between two sides of molten metal seal between atmosphere and a closed cavity may comprise: a channel loop comprising molten metal to carry current, a plurality of current leads to supply a plurality of current segments between at least a pair of the plurality of leads that are either clockwise or counter clockwise along a perimeter of the channel loop, and further comprising a plurality of sources of magnetic field perpendicular to the direction of each segment of the plurality of current segments, each field having a polarity such that the corresponding Lorentz force of the current segment and the field is in a direction relative to the channel that opposes the force created by the reduction of pressure to maintain the pressure difference.

The power system may comprise a gas mixer for mixing the hydrogen and oxygen gases and/or water molecules and a hydrogen and oxygen recombiner and/or a hydrogen dissociator. In some embodiments, the hydrogen and oxygen recombiner comprises a plasma cell. The plasma cell may comprise a center positive electrode and a grounded tubular body counter electrode wherein a voltage (e.g.,a voltage in the range of 50 V to 1000 V) is applied across the electrodes to induce the formation of a plasma from a hydrogen (H₂) and oxygen (O₂) gas mixture. In some embodiments, the hydrogen and oxygen recombiner comprises a recombiner catalytic metal supported by an inert support material. In certain implementations, the gas mixture supplied to the plasma generation cell to produce the first plasma comprises a non-stoichiometric H₂/O₂ mixture (e.g., an H₂/O₂ mixture having less than 1/3 mole % O₂ or from 0.01% to 30%, or from 0.1% to 20%, or less than 10%, or less than 5%, or less than 3% O₂ by mole percentage of the mixture) that is flowed through the plasma cell (e.g., a glow discharge cell) to create a reaction mixture capable of undergoing the reaction with sufficient exothermicity to produce the second plasma. A non-stoichiometric H₂/O₂ mixture may pass through the glow discharge to produce an effluence of atomic hydrogen and nascent H₂O (e.g., a mixture having water at a concentration and with an internal energy sufficient to prevent formation of hydrogen bonds);
the glow discharge effluence is directed into a reaction chamber where the ignition current is supplied between two electrodes (e.g., with a molten metal passed therebetween), and upon interaction of the effluence with the biased molten metal (e.g., gallium or tin), the reaction between the nascent water and the atomic hydrogen is induced, for example, upon the formation of arc current.

The power system may comprise at least one of the reaction chamber (e.g. where the nascent water and atomic hydrogen undergo the plasma forming reaction) and/or reservoir comprising at least one refractory material liner that is resistant to forming an alloy with the molten metal. The inner wall of the reaction chamber may comprise a ceramic coating, a carbon liner lined with a W, Nb, or Mo liner, lined with W plates. In some embodiments, the reservoir comprises a carbon liner and the carbon is covered by the molten metal contained therein. In various implementations, the reaction chamber wall comprises a material that is highly permeable to the reaction product gas. In various embodiments, the reaction chamber wall comprises at least one of stainless steel (e.g., Mo—Cr stainless steel), niobium, molybdenum, or tungsten.

The power system may comprise a a condenser to condense molten metal vapor and metal oxide particles and vapor and returns them to the reaction cell chamber. In some embodiments, the power system may further comprise a vacuum line wherein the condenser comprises a section of the vacuum line from the reaction cell chamber to the vacuum pump that is vertical relative to the reaction cell chamber and comprises an inert, high-surface area filler material that condenses the molten metal vapor and metal oxide particles and vapor and returns them to the reaction cell chamber while permitting the vacuum pump to maintain a vacuum pressure in the reaction cell chamber.

The power system may comprise a blackbody radiator and a window to output light from the blackbody radiator. Such embodiments may be used to generate light (e.g., used for lighting).

In some embodiments, the power system may further comprise a gas mixer for mixing the hydrogen and oxygen gases and a hydrogen and oxygen recombiner and/or a hydrogen dissociator. For example, the power system may comprise a hydrogen and oxygen recombiner wherein the hydrogen and oxygen recombiner comprises a recombiner catalytic metal supported by an inert support material.

The power system may be operated with parameters that maximize reactions, and specifically, reactions capable of outputting enough energy to sustain plasma generation and net energy output. For example, in some embodiments, the pressure of the vessel during operation is in the range of 0.1 Torr to 50 Torr. In certain implementations, the hydrogen mass flow rate exceeds that of the oxygen mass flow rate by a factor in the range of 1.5 to 1000. In some embodiments, the pressure may be over 50 Torr and may further comprise a gas recirculation system.

In some embodiments, an inert gas (e.g., argon) is injected into the vessel. The inert gas may be used to prolong the lifetime of certain in situ formed reactants (such as nascent water).

The power system may comprise a water micro-injector configured to inject water into the vessel such that the plasma produced from the energy output from the reaction comprises water vapor. In some embodiments, the micro-injector injects water into the vessel. In some embodiments, the H₂ molar percentage is in the range of 1.5 to 1000 times the molar percent of the water vapor (e.g., the water vapor injected by the micro-injector).

The power system may further comprise a heater to melt a metal (e.g., tin or gallium or silver or copper or combinations thereof) to form the molten metal. The power system may further comprise a molten metal recovery system configured to recover molten metal after the reaction comprising a molten metal overflow channel which collects overflow from the non-injector molten metal reservoir.

The molten metal injection system may further comprise electrodes in the molten metal reservoir and the non-injection molten metal reservoir; and the ignition system may comprise a source of electrical power or ignition current to supply opposite voltages to the injector and non-injector reservoir electrodes; wherein the source of electrical power supplies current and power flow through the stream of molten metal to cause the reaction of the reactants to form a plasma inside of the vessel.

The source of electrical power typically delivers a current (e.g., high-current) electrical energy sufficient to cause the reactants to react to form plasma. In certain embodiments, the source of electrical power comprises at least one supercapacitor. In various implementations, the current from the molten metal ignition system power is in the range of 10 A to 50,000 A.

Typically, the molten metal pump system is configured to pump molten metal from a molten metal reservoir to a non-injection reservoir, wherein a stream of molten metal is created therebetween. In some embodiments, the molten metal pump system is one or more electromagnetic pumps and each electromagnetic pump comprises one of a
a) DC or AC conduction type comprising a DC or AC current source supplied to the molten metal through electrodes and a source of constant or in-phase alternating vector-crossed magnetic field, or
b) induction type comprising a source of alternating magnetic field through a shorted loop of molten metal that induces an alternating current in the metal and a source of in-phase alternating vector-crossed magnetic field.
   In some embodiments, the circuit of the molten metal ignition system is closed by the molten metal stream to cause ignition to further cause ignition (e.g., with an ignition frequency less than 10,000 Hz). The injector reservoir may comprise an electrode in contact with the molten metal therein, and the non-injector reservoir comprises an electrode that makes contact with the molten metal provided by the injector system.

In various implementations, the non-injector reservoir is aligned above (e.g., vertically with) the injector and the injector is configured to produce the molten stream orientated towards the non-injector reservoir such that molten metal from the molten metal stream may collect in the reservoir and the molten metal stream makes electrical contact with the non-injector reservoir electrode; and wherein the molten metal pools on the non-injector reservoir electrode. In certain embodiments, the ignition current to the non-injector reservoir may comprise:
a) a hermitically sealed, high-temperature capable feedthrough that penetrates the vessel;
b) an electrode bus bar, and
c) an electrode.

The ignition current density may be related to the vessel geometry for at least the reason that the vessel geometry is related to the ultimate plasma shape. In various implementations, the vessel may comprise an hourglass geometry (e.g., a geometry wherein a middle portion of the internal surface area of the vessel has a smaller cross section than the cross section within 20% or 10% or 5% of each distal end along the major axis) and oriented in a vertical orientation (e.g., the major axis approximately parallel with the force of gravity) in cross section wherein the injector reservoir is below the waist and configured such that the level of molten metal in the reservoir is about proximal to the waist of the hourglass to increase the ignition current density. In some embodiments, the vessel is symmetric about the major longitudinal axis. In some embodiments, the vessel may an hourglass geometry and comprise a refractory metal liner. In some embodiments, the injector reservoir of the vessel having an hourglass geometry may comprise the positive electrode for the ignition current.

The molten metal may comprise at least one of silver, gallium, silver-copper alloy, copper, or combinations thereof. In some embodiments, the molten metal has a melting point below 700° C. For example, the molten metal may comprise at least one of bismuth, lead, tin, indium, cadmium, gallium, antimony, or alloys such as Rose's metal, Cerrosafe, Wood's metal, Field's metal, Cerrolow 136, Cerrolow 117, Bi—Pb—Sn—Cd—In—Tl, and Galinstan. In certain aspects, at least one of component of the power generation system that contacts that molten metal (e.g., reservoirs, electrodes) comprises, is clad with, or is coated with one or more alloy resistant material that resists formation of an alloy with the molten metal. Exemplary alloy resistant materials are W, Ta, Mo, Nb, Nb(94.33 wt %)—Mo(4.86 wt %)—Zr(0.81 wt %), Os, Ru, Hf, Re, 347 SS, Cr—Mo SS, silicide coated, carbon, and a ceramic such as BN, quartz, Si3N4, Shapal, AlN, Sialon, Al₂O₃, ZrO₂, or HfO₂. In some embodiments, at least a portion of the vessel is composed of a ceramic and/or a metal. The ceramic may comprise at least one of a metal oxide, quartz, alumina, zirconia, magnesia, hafnia, silicon carbide, zirconium carbide, zirconium diboride, silicon nitride, and a glass ceramic. In some embodiments, the metal of the vessel comprises at least one of a stainless steel and a refractory metal.

The molten metal may react with water to form atomic hydrogen in situ. In various implementations, the molten metal is gallium and the power system further comprises a gallium regeneration system to regenerate gallium from gallium oxide (e.g., gallium oxide produced in the reaction). The gallium regeneration system may comprise a source of at least one of hydrogen gas and atomic hydrogen to reduce gallium oxide to gallium metal. In some embodiments, hydrogen gas is delivered to the gallium regeneration system from sources external to the power generation system. In some embodiments, hydrogen gas and/or atomic hydrogen are generated in situ. The gallium regeneration system may comprise an ignition system that delivers electrical power to gallium (or gallium/gallium oxide combinations) produced in the reaction. In several implementations, such electrical power may electrolyze gallium oxide on the surface of gallium to gallium metal. In some embodiments, the gallium regeneration system may comprise an electrolyte (e.g., an electrolyte comprising an alkali or alkaline earth halide). In some embodiments, the gallium regeneration system may comprise a basic pH aqueous electrolysis system, a means to transport gallium oxide into the system, and a means to return the gallium to the vessel (e.g., to the molten metal reservoir). In some embodiments, the gallium regeneration system comprises a skimmer and a bucket elevator to remove gallium oxide from the surface of gallium. In various implementations, the power system may comprise an exhaust line to the vacuum pump to maintain an exhaust gas stream and further comprising an electrostatic precipitation system in the exhaust line to collect gallium oxide particles in the exhaust gas stream.

In some embodiments, the power generation system generates a water/hydrogen mixture to be directed towards the molten metal cell through a plasma generation cell. In these embodiments, the plasma generation cell such as a glow discharge cell induce the formation of a first plasma from a gas (e.g., a gas comprising a mixture oxygen and hydrogen); wherein effluence of the plasma generation cell is directed towards the any part of the molten metal circuit (e.g., the molten metal, the anode, the cathode, an electrode submerged in a molten metal reservoir). Upon interaction of the biased molten metal with this effluence, a second plasma (more energetic than that created by the plasma generation cell) may be formed. In these embodiments, the plasma generation cell may be fed hydrogen (H₂) and oxygen mixtures (O₂) having a molar excess of hydrogen such that the effluence comprises atomic hydrogen (H) and water (H₂O). The water in the effluence may be in the form of nascent water, water sufficiently energized and at a concentration such that it is not hydrogen bonded to other components in the effluence. This effluence may proceed in a second more energetic reaction involving the H and HOH that forms a plasma that intensifies upon interaction with the molten metal and a supplied external current through at least one of the molten metal and the plasma that may produce additional atomic hydrogen (from the H₂ in the effluence) to further propagate the second energetic reaction.

In some embodiments, the power system may further comprise at least one heat exchanger (e.g., a heat exchanger coupled to a wall of the vessel wall, a heat exchanger which may transfer heat to or from the molten metal or to or from the molten metal reservoir). In some embodiments, the heat exchanger comprises one of a (i) plate, (ii) block in shell, (iii) SiC annular groove, (iv) SiC polyblock, and (v) shell and tube heat exchanger. In certain implementations, the shell and tube heat exchanger comprises conduits, manifolds, distributors, a heat exchanger inlet line, a heat exchanger outlet line, a shell, an external coolant inlet, an external coolant outlet, baffles, at least one pump to recirculate the hot molten metal from the reservoir through the heat exchanger and return the cool molten metal to the reservoir, and one or more a water pumps and water coolant or one or more air blowers and air coolant to flow cold coolant through the external coolant inlet and shell wherein the coolant is heated by heat transfer from the conduits and exists the external coolant outlet. In some embodiments, the shell and tube heat exchanger comprise conduits, manifolds, distributors, a heat exchanger inlet line, and a heat exchanger outlet line comprising carbon that line and expand independently of conduits, manifolds, distributors, a heat exchanger inlet line, a heat exchanger outlet line, a shell, an external coolant inlet, an external coolant outlet, and baffles comprising stainless steel. The external coolant of the heat exchanger comprises air, and air from a microturbine compressor or a microturbine recuperator forces cool air through the external coolant inlet and shell wherein the coolant is heated by heat transfer from the conduits and exists the external coolant outlet, and the hot coolant output from the external coolant outlet flows into a microturbine to convert thermal power to electricity.

In some embodiments, the power system comprises at least one power converter or output system of the reaction power output comprises at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a supercritical CO₂ cycle converter, a Brayton cycle converter, an external-combustor type Brayton cycle engine or converter, a Rankine cycle engine or converter, an organic Rankine cycle converter, an internal-combustion type engine, and a heat engine, a heater, and a boiler. The vessel may comprise a light transparent photovoltaic (PV) window to transmit light from the inside of the vessel to a photovoltaic converter and at least one of a vessel geometry.

The power converter or output system may comprise a magnetohydrodynamic (MHD) converter comprising a nozzle connected to the vessel, a magnetohydrodynamic channel, electrodes, magnets, a metal collection system, a metal recirculation system, a heat exchanger, and optionally a gas recirculation system. In some embodiments, the molten metal may comprise silver. In embodiments with a magnetohydrodynamic converter, the magnetohydrodynamic converter may be delivered oxygen gas to form silver particles nanoparticles (e.g., of size in the molecular regime such as less than about 10 nm or less than about 1 nm) upon interaction with the silver in the molten metal stream, wherein the silver nanoparticles are accelerated through the magnetohydrodynamic nozzle to impart a kinetic energy inventory of the power produced from the reaction. The reactant supply system may supply and control delivery of the oxygen gas to the converter. In various implementations, at least a portion of the kinetic energy inventory of the silver nanoparticles is converted to electrical energy in a magnetohydrodynamic channel. Such version of electrical energy may result in coalescence of the nanoparticles. The nanoparticles may coalesce as molten metal which at least partially absorbs the oxygen in a condensation section of the magnetohydrodynamic converter (also referred to herein as an MHD condensation section) and the molten metal comprising absorbed oxygen is returned to the injector reservoir by a metal recirculation system. In some embodiments, the oxygen may be released from the metal by the plasma in the vessel. In some embodiments, the plasma is maintained in the magnetohydrodynamic channel and metal collection system to enhance the absorption of the oxygen by the molten metal.

The molten metal pump system may comprise a first stage electromagnetic pump and a second stage electromagnetic pump, wherein the first stage comprises a pump for a metal recirculation system, and the second stage that comprises the pump of the metal injector system.

The reaction induced by the reactants produces enough energy in order to initiate the formation of a plasma in the vessel. The reactions may produce a hydrogen product characterized as one or more of:
a) a molecular hydrogen product H₂ (e.g., H₂(1/p) (p is an integer greater than 1 and less than or equal to 137) comprising an unpaired electron) which produces an electron paramagnetic resonance (EPR) spectroscopy signal;
b) a molecular hydrogen product H₂ (e.g., H₂(1/4)) having an EPR spectrum comprising a principal peak with a g-factor of 2.0046386 that is optionally split into a series of pairs of peaks with members separated by spin-orbital coupling energies that are a function of the corresponding electron spin-orbital coupling quantum numbers wherein
   (i) the unpaired electron magnetic moment induces a diamagnetic moment in the paired electron of the H₂(1/4) molecular orbital based on the diamagnetic susceptibility of H₂(1/4);
   (ii) the corresponding magnetic moments of the intrinsic paired-unpaired current interactions and those due to relative rotational motion about the internuclear axis give rise to the spin-orbital coupling energies;
   (iii) each spin-orbital splitting peak is further sub-split into a series of equally spaced peaks that matched integer fluxon energies that are a function of the electron fluxon quantum number corresponding to the number of angular momentum components involved in the transition, and
   (iv) additionally, the spin-orbital splitting increases with spin-orbital coupling quantum number on the downfield side of the series of pairs of peaks due to magnetic energies that increased with accumulated magnetic flux linkage by the molecular orbital.
c) for an EPR frequency of 9.820295 GHz,
   (i) the downfield peak positions B_{SIOcombined}^{downfield} due to the combined shifts due to the magnetic energy and the spin-orbital coupling energy of H₂(1/4) are

$${B}_{S / Ocombined}^{downfield} = ( 0.35001 m 3.99427 \times {10}^{4} ( 0.5 ) \frac{{( 2 m 3.99427 \times {10}^{4} )}^{2}}{0.175} ) T ;$$

(ii) the upfield peak positions B_{SIO}^{upfield} with quantized spin-orbital splitting energies E_{SIO} and electron spin-orbital coupling quantum numbers m=0.5,1,2,3,5 . . . are

$${B}_{S / O}^{upfield} = 0.35001 ( 1 + m [ \frac{7.426 \times {10}^{27} J}{h 9.820295 GHz} ] ) T = ( 0.35001 + m 3.99427 \times {10}^{4} ) T ,$$

and/or
(iii) the separations B of the integer series of peaks at each spin-orbital peak position are

$${B}^{downfield} = ( 0.35001 m 3.99427 \times {10}^{4} ( 0.5 ) \frac{{( 2 m 3.99427 \times {10}^{4} )}^{2}}{0.175} ) [ \frac{m 5.783 \times {10}^{28} J}{h 9.820295 GHz} ] \times {10}^{4} G$$

$$and {B}^{upfield} = ( 0.35001 + m 3.99427 \times {10}^{4} ) [ \frac{m 5.783 \times {10}^{28} J}{h 9.820295 GHz} ] \times {10}^{4} G for electron fluxon quantum numbers m = 1 , 2 , 3 ;$$

d) a hydride ion H⁻ (e.g., H⁻(1/p)) comprising a paired and unpaired electron in a common atomic orbital that demonstrates flux linkage in quantized units of h/2e observed on H⁻(1/2) by high-resolution visible spectroscopy in the 400-410 nm range;
e) flux linkage in quantized units of h/2e observed when the rotational energy levels of H₂(1/4) were excited by laser irradiation during Raman spectroscopy and by collisions of high energy electrons from an electron beam with H₂(1/4);
f) molecular hydrino (e.g., H₂(1/p)) having Raman spectral transitions of the spin-orbital coupling between the spin magnetic moment of the unpaired electron and the orbital magnetic moment due to molecular rotation wherein
   (i) the energies of the rotational transitions are shifted by these spin-orbital coupling energies as a function of the corresponding electron spin-orbital coupling quantum numbers;
   (ii) molecular rotational peaks shifted by spin-orbital energies are further shifted by fluxon linkage energies with each energy corresponding to its electron fluxon quantum number dependent on the number of angular momentum components involved in the rotational transition, and/or
   (iii) the observed sub-splitting or shifting of Raman spectral peaks is due to flux linkage in units of the magnetic flux quantum h/2e during the spin-orbital coupling between spin and molecular rotational magnetic moments while the rotational transition occurs;
g) H₂(1/4) having exemplary Raman spectral transitions comprising
   (i) either the pure H₂ (1/4) J=0 to J′=3 rotational transition with spin-orbital coupling and fluxon coupling:

$${E}_{Raman} = {E}_{J = 0 \to {J}^{′}} + {E}_{S / O , rot} + {E}_{, rot} = 11701 {cm}^{1} + m 528 {cm}^{1} + m 31 {cm}^{1} ,$$

(ii) the concerted transitions comprising the J=0 to J′=2,3 rotational transitions with the J=0 to J=1 spin rotational transition:

$${E}_{Raman} = {E}_{J = 0 \to {J}^{′}} + {E}_{SIO , rot} + {E}_{, rot} = 7801 {cm}^{1} ( 13 , 652 {cm}^{1} ) + m 528 {cm}^{1} + {m}_{3 / 2} 46 {cm}^{1} ,$$

or
(iii) the double transition for final rotational quantum numbers J′ₚ=2 and J=′_{c}=1:

$${E}_{Raman} = {E}_{J = 0 \to {J}_{p}^{′} = 2} + {E}_{J = 0 \to {J}_{c}^{′} = 1} + {E}_{SIO , rot} + {E}_{, rot} = 9751 {cm}^{1} + m 528 {cm}^{1} + m 31 {cm}^{1} + {m}_{3 / 2} 46 {cm}^{1}$$

wherein the corresponding spin-orbital coupling and fluxon coupling were also observed with the pure, concerted, and double transitions;
h) H₂(1/4) UV Raman peaks (e.g., as recorded on the complex GaOOH:H₂(1/4):H₂O and Ni foils exposed to the reaction plasma observed in the 12,250-15,000 cm⁻¹ region wherein the exemplary lines match the concerted pure rotational transition J=3 and J=1 spin transition with spin-orbital coupling and fluxon linkage splittings:

$${E}_{Raman} = {E}_{J = 0 \to 3} + {E}_{J = 0 \to 1} + {E}_{SIO , rot} + {E}_{, rot} = 13 , 652 {cm}^{1} + m 528 {cm}^{1} + m 31 {cm}^{1} ) ;$$

i) the rotational energies of the HD(1/4) Raman spectrum shifted by a factor of ¾ relative to that of H₂(1/4);
j) the exemplary rotational energies of the HD(1/4) Raman spectrum match those of
   (i) either the pure HD(1/4) J=0 to J′=3,4 rotational transition with spin-orbital coupling and fluxon coupling:

$${E}_{Raman} = {E}_{J = 0 \to {J}^{′}} + {E}_{SIO , rot} + {E}_{, rot} = 8776 {cm}^{1} ( 14 , 627 {cm}^{1} ) + m 528 {cm}^{1} + m 31 {cm}^{1} ,$$

(ii) the concerted transitions comprising the J=0 to J′=3 rotational transitions with the J=0 to J=1 spin rotational transition:

$${E}_{Raman} = {E}_{J = 0 \to {J}^{′}} + {E}_{SIO , rot} + {E}_{, rot} = 10 , 239 {cm}^{1} , \text{} + m 528 {cm}^{1} + {m}_{3 / 2} 46 {cm}^{1}$$

(iii) the double transition for final rotational quantum numbers J′ₚ=3; J′_{c}=1:

$${E}_{Raman} = {E}_{J = 0 \to {J}_{p}^{′} = 2} + {E}_{J = 0 \to {J}_{c}^{′} = 1} + {E}_{SIO , rot} + {E}_{, rot} = 11 , 701 {cm}^{1} + m 528 {cm}^{1} + m 31 {cm}^{1} + {m}_{3 / 2} 46 {cm}^{1}$$

wherein spin-orbital coupling and fluxon coupling are also observed with both the pure and concerted transition;
k) H₂(1/4)-noble gas mixtures irradiated with high energy electrons of an electron beam show equal, 0.25 eV spaced line emission in the ultraviolet (150-180 nm) region with a cutoff at 8.25 eV that match the H₂(1/4)=1 to =0 vibrational transition with a series of rotational transitions corresponding to the H₂(1/4) P-branch wherein
   (i) the spectral fit is a good match to 4²0.515 eV 4²(J+1)0.01509; J=0,1,2,3 . . .
wherein 0.515 eV and 0.01509 eV are the vibrational and rotational energies of ordinary molecular hydrogen, respectively,
   (ii) small satellite lines are observed that match the rotational spin-orbital splitting energies that are also observed by Raman spectroscopy, and (iii) the rotational spin-orbital splitting energy separations match m528 cm¹ m=1,1.5 wherein 1.5 involves the m=0.5 and m=1 splittings;
1) the spectral emission of the H₂(1/4) P-branch rotational transitions with the =1 to =0 vibrational transition are observed by electron beam excitation of H₂(1/4) trapped in a KCl crystalline matrix wherein
   (i) the rotational peaks match that of a free rotor;
   (ii) the vibrational energy is shifted by the increase in the effective mass due to interaction of the vibration of H₂(1/4) with the KCl matrix;
   (iii) the spectral fit is a good match to 5.8 eV 4² (J+1)0.01509; J=0,1,2,3 . . . comprising peaks spaced at 0.25 eV, and
   (iv) relative magnitude of the H₂(1/4) vibrational energy shift match the relative effect on the ro-vibrational spectrum caused by ordinary H₂ being trapped in KCl;
m) the Raman spectrum with a HeCd energy laser shows a series of 1000 cm⁻¹ (0.1234 eV) equal-energy spaced in the 8000 cm⁻¹ to 18,000 cm⁻¹ region wherein conversion of the Raman spectrum into the fluorescence or photoluminescence spectrum reveals a match as the ½-energy, virtual ro-vibrational spectrum of H₂(1/4) corresponding to the e-beam excitation emission spectrum of H₂(1/4) in a KCl matrix given by 5.8 eV 4² (J+1)0.01509; J=0,1,2,3 . . . and comprising the matrix shifted=1 to =0 vibrational transition with 0.25 eV energy-spaced rotational transition peaks;
n) infrared rotational transitions of H₂(1/4) are observed in an energy region higher than 4400 cm⁻¹ wherein the intensity increases with the application of a magnetic field in addition to an intrinsic magnetic field, and rotational transitions coupling with spin-orbital transitions are also observed;
o) the allowed double ionization of H₂(1/4) by the Compton effect corresponding to the total energy of 496 eV is observed by X-ray photoelectron spectroscopy (XPS);
p) H₂(1/4) is observed by gas chromatography that shows a faster migration rate than that of any known gas considering that hydrogen and helium have the fastest prior known migration rates and corresponding shortest retention times;
q) extreme ultraviolet (EUV) spectroscopy records extreme ultraviolet continuum radiation with a 10.1 nm cutoff (e.g., as corresponding to the hydrino reaction transition H to H(1/4) catalyzed by nascent HOH catalyst);
r) proton magic-angle spinning nuclear magnetic resonance spectroscopy (¹H MAS NMR) records an upfield matrix-water peak in the −4 ppm to −5 ppm region;
s) bulk magnetism such as paramagnetism, superparamagnetism and even ferromagnetism when the magnetic moments of a plurality of hydrogen product molecules interact cooperatively wherein superparamagnetism (e.g., as observed using a vibrating sample magnetometer to measure the magnetic susceptibility of compounds comprising reaction products);
t) time of flight secondary ion mass spectroscopy (ToF-SIMS) and electrospray time of flight secondary ion mass spectroscopy (ESI-ToF) recorded on K₂CO₃ and KOH exposed to a molecular gas source from the reaction products showing complexing of reaction products (e.g., H₂(1/4) gas) to the inorganic compounds comprising oxyanions by the unique observation of M+2 multimer units (e.g., K⁺[H₂:K₂CO₃]ₙ and K⁺[H₂:KOH]ₙ wherein n is an integer) and an intense H peak due to the stability of hydride ion, and
u) reaction products consisting of molecular hydrogen nuclei behaving like organic molecules as evidenced by a chromatographic peak on an organic molecular matrix column that fragments into inorganic ions. In various implementations, the reaction produces energetic signatures characterized as one or more of:
   (i) extraordinary Doppler line broadening of the H Balmer a line of over 100 eV in plasmas comprising H atoms and nascent HOH or H based catalyst such as argon-H₂, H₂, and H₂O vapor plasmas,
   (ii) H excited state line inversion,
   (iii) anomalous H plasma afterglow duration,
   (iv) shockwave propagation velocity and the corresponding pressure equivalent to about 10 times more moles of gunpowder with only about 1% of the power coupling to the shockwave,
   (v) optical power of up to 20 MW from a 10 μl hydrated silver shot, and
   (vi) calorimetry of the SunCell power system validated at a power level of 340,000 W.

These reactions may produce a hydrogen product characterized as one or more of:
a) a hydrogen product with a Raman peak at one or more range of 1900 to 2200 cm⁻¹, 5500 to 6400 cm⁻¹, and 7500 to 8500 cm⁻¹, or an integer multiple of a range of 1900 to 2200 cm⁻¹;
b) a hydrogen product with a plurality of Raman peaks spaced at an integer multiple of 0.23 to 0.25 eV;
c) a hydrogen product with an infrared peak at a range of an integer multiple of 1900 to 2000 cm⁻¹;
d) a hydrogen product with a plurality of infrared peaks spaced at an integer multiple of 0.23 to 0.25 eV;
e) a hydrogen product with at a plurality of UV fluorescence emission spectral peaks in the range of 200 to 300 nm having a spacing at an integer multiple of 0.23 to 0.3 eV;
f) a hydrogen product with a plurality of electron-beam emission spectral peaks in the range of 200 to 300 nm having a spacing at an integer multiple of 0.2 to 0.3 eV;
g) a hydrogen product with a plurality of Raman spectral peaks in the range of 5000 to 20,000 cm⁻¹ having a spacing at an integer multiple of 1000±200 cm⁻¹;
h) a hydrogen product with a X-ray photoelectron spectroscopy peak at an energy in the range of 490 to 525 eV;
i) a hydrogen product that causes an upfield MAS NMR matrix shift;
j) a hydrogen product that has an upfield MAS NMR or liquid NMR shift of greater than −5 ppm relative to TMS;
m) a hydrogen product comprising at least one of a metal hydride and a metal oxide further comprising hydrogen wherein the metal comprises at least one of Zn, Fe, Mo, Cr, Cu, and W;
o) a hydrogen product comprising an inorganic compound MₓX_{y} and H₂ wherein M is a cation and X in an anion having at least one of electrospray ionization time of flight secondary ion mass spectroscopy (ESI-ToF) and time of flight secondary ion mass spectroscopy (ToF-SIMS) peaks of M(MₓX_{y}H₂)n wherein n is an integer;
p) a hydrogen product comprising at least one of K₂CO₃H₂ and KOHH₂ having at least one of electrospray ionization time of flight secondary ion mass spectroscopy (ESI-ToF) and time of flight secondary ion mass spectroscopy (ToF-SIMS) peaks of K(K₂H₂CO₃)ₙ⁺ and K(KOHH₂)ₙ⁺, respectively;
q) a magnetic hydrogen product comprising at least one of a metal hydride and a metal oxide further comprising hydrogen wherein the metal comprises at least one of Zn, Fe, Mo, Cr, Cu, W, and a diamagnetic metal;
r) a hydrogen product comprising at least one of a metal hydride and a metal oxide further comprising hydrogen wherein the metal comprises at least one of Zn, Fe, Mo, Cr, Cu, W, and a diamagnetic metal that demonstrates magnetism by magnetic susceptometry;
s) a hydrogen product comprising a metal that is not active in electron paramagnetic resonance (EPR) spectroscopy wherein the EPR spectrum comprises at least one of a g factor of about 2.0046±20%, a splitting of the EPR spectrum into a series of peaks with a separation of about 1 to 10 G wherein each main peak is sub-split into a series of peaks with spacing of about 0.1 to 1 G;
t) a hydrogen product comprising a metal that is not active in electron paramagnetic resonance (EPR) spectroscopy wherein the EPR spectrum comprises at least an electron spin-orbital coupling splitting energy of about m₁ X 7.43X10⁻²⁷ J±20%, and fluxon splitting of about m₂ X 5.78X10⁻²⁸ J±20%, and a dimer magnetic moment interaction splitting energy of about 1.58 X10⁻²³ J±20%;
v) a hydrogen product comprising a gas having a negative gas chromatography peak with hydrogen or helium carrier;
w) a hydrogen product having a quadrupole moment/e of

$$\frac{1.70127 {a}_{0}^{2}}{{p}^{2}} \pm 10 \%$$

wherein p is an integer;
x) a protonic hydrogen product comprising a molecular dimer having an end over end rotational energy for the integer J to J+1 transition in the range of (J+1)44.30 cm⁻¹±20 cm⁻¹ wherein the corresponding rotational energy of the molecular dimer comprising deuterium is ½ that of the dimer comprising protons;
y) a hydrogen product comprising molecular dimers having at least one parameter from the group of (i) a separation distance of hydrogen molecules of 1.028 Å±10%, (ii) a vibrational energy between hydrogen molecules of 23 cm^{-1±10}%, and (iii) a van der Waals energy between hydrogen molecules of 0.0011 eV±10%;
z) a hydrogen product comprising a solid having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.019 eV±10%;
aa) a hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.0011 eV±10% per molecular hydrogen;
bb) a solid hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.019 eV±10% per molecular hydrogen.
cc) a hydrogen product comprising a hydrogen hydride ion that is magnetic and links flux in units of the magnetic in its bound-free binding energy region, and
dd) a hydrogen product wherein the high pressure liquid chromatography (HPLC) shows chromatographic peaks having retention times longer than that of the carrier void volume time using an organic column with a solvent comprising water wherein the detection of the peaks by mass spectroscopy such as ESI-ToF shows fragments of at least one inorganic compound.

In various implementations, the hydrogen product may be characterized similarly as products formed from various hydrino reactors such as those formed by wire detonation in an atmosphere comprising water vapor. Such products may:
a) comprise at least one of a metal hydride and a metal oxide further comprising hydrogen wherein the metal comprises at least one of Zn, Fe, Mo, Cr, Cu, and W and the hydrogen comprises H;
b) comprise an inorganic compound MₓX_{y} and H₂ wherein M is a metal cation and X is an anion and at least one of the electrospray ionization time of flight secondary ion mass spectrum (ESI-ToF) and the time of flight secondary ion mass spectrum (ToF-SIMS) comprises peaks of M(MₓX_{y}H(1/4)₂)n wherein n is an integer;
c) be magnetic and comprise at least one of a metal hydride and a metal oxide further comprising hydrogen wherein the metal comprises at least one of Zn, Fe, Mo, Cr, Cu, W, and a diamagnetic metal, and the hydrogen is H(1/4), and
d) comprise at least one of a metal hydride and a metal oxide further comprising hydrogen wherein the metal comprises at least one of Zn, Fe, Mo, Cr, Cu, W, and a diamagnetic metal and H is H(1/4) wherein the product demonstrates magnetism by magnetic susceptometry.

In some embodiments, the hydrogen product formed by the reaction comprises the hydrogen product complexed with at least one of (i) an element other than hydrogen, (ii) an ordinary hydrogen species comprising at least one of H⁺, ordinary H₂, ordinary H⁻, and ordinary H₃⁺, an organic molecular species, and (iv) an inorganic species. In some embodiments, the hydrogen product comprises an oxyanion compound. In various implementations, the hydrogen product (or a recovered hydrogen product from embodiments comprising a getter) may comprise at least one compound having the formula selected from the group of:
a) MH, MH₂, or M₂H₂, wherein M is an alkali cation and H or H₂ is the hydrogen product;
b) MHₙ wherein n is 1 or 2, M is an alkaline earth cation and H is the hydrogen product;
c) MHX wherein M is an alkali cation, X is one of a neutral atom such as halogen atom, a molecule, or a singly negatively charged anion such as halogen anion, and H is the hydrogen product;
d) MHX wherein M is an alkaline earth cation, X is a singly negatively charged anion, and H is H is the hydrogen product;
e) MHX wherein M is an alkaline earth cation, X is a double negatively charged anion, and H is the hydrogen product;
f) M₂HX wherein M is an alkali cation, X is a singly negatively charged anion, and H is the hydrogen product;
g) MHₙ wherein n is an integer, M is an alkaline cation and the hydrogen content Hₙ of the compound comprises at least one of the hydrogen products;
h) M₂Hₙ wherein n is an integer, M is an alkaline earth cation and the hydrogen content Hₙ of the compound comprises at least of the hydrogen products;
i) M₂XHₙ wherein n is an integer, M is an alkaline earth cation, X is a singly negatively charged anion, and the hydrogen content Hₙ of the compound comprises at least one of the hydrogen products;
j) M₂X2Hₙ wherein n is 1 or 2, M is an alkaline earth cation, X is a singly negatively charged anion, and the hydrogen content Hₙ of the compound comprises at least one of the hydrogen products;
k) M₂X3H wherein M is an alkaline earth cation, X is a singly negatively charged anion, and H is the hydrogen product;
l) M₂XHₙ wherein n is 1 or 2, M is an alkaline earth cation, X is a double negatively charged anion, and the hydrogen content Hₙ of the compound comprises at least one of the hydrogen products;
m) M₂XX′H wherein M is an alkaline earth cation, X is a singly negatively charged anion, X′ is a double negatively charged anion, and H is the hydrogen product;
n) MM′Hₙ wherein n is an integer from 1 to 3, M is an alkaline earth cation, M′ is an alkali metal cation and the hydrogen content Hₙ of the compound comprises at least one of the hydrogen products;
o) MM′XHₙ wherein n is 1 or 2, M is an alkaline earth cation, M′ is an alkali metal cation, X is a singly negatively charged anion and the hydrogen content Hₙ of the compound comprises at least one of the hydrogen products;
p) MM′XH wherein M is an alkaline earth cation, M′ is an alkali metal cation, X is a double negatively charged anion and H is the hydrogen products;
q) MM′XX′H wherein M is an alkaline earth cation, M′ is an alkali metal cation, X and X′ are singly negatively charged anion and H is the hydrogen product;
r) MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one of the hydrogen products;
s) MHₙ wherein n is an integer, M is a cation such as a transition element, an inner transition element, or a rare earth element, and the hydrogen content Hₙ of the compound comprises at least one of the hydrogen products;
t) MXHₙ wherein n is an integer, M is an cation such as an alkali cation, alkaline earth cation, X is another cation such as a transition element, inner transition element, or a rare earth element cation, and the hydrogen content Hₙ of the compound comprises at least one of the hydrogen products;
u) (MHₘMCO₃)ₙ wherein M is an alkali cation or other +1 cation, m and n are each an integer, and the hydrogen content Hₘ of the compound comprises at least one of the hydrogen products;
v) (MHₘMNO₃)ₙ⁺ nX wherein M is an alkali cation or other +1 cation, m and n are each an integer, X is a singly negatively charged anion, and the hydrogen content Hₘ of the compound comprises at least one of the hydrogen products;
w) (MHMNO₃)ₙ wherein M is an alkali cation or other +1 cation, n is an integer and the hydrogen content H of the compound comprises at least one of the hydrogen products;
x) (MHMOH)ₙ wherein M is an alkali cation or other +1 cation, n is an integer, and the hydrogen content H of the compound comprises at least one of the hydrogen products;
y) (MHₙM′X)ₙ wherein m and n are each an integer, M and M′ are each an alkali or alkaline earth cation, X is a singly or double negatively charged anion, and the hydrogen content Hₘ of the compound comprises at least one of the hydrogen products; and
z) (MHₘM′X′)ₙ⁺ nX wherein m and n are each an integer, M and M′ are each an alkali or alkaline earth cation, X and X′ are a singly or double negatively charged anion, and the hydrogen content Hₘ of the compound comprises at least one of the hydrogen products.

The anion of the hydrogen product formed by the reaction may be one or more singly negatively charged anions including a halide ion, a hydroxide ion, a hydrogen carbonate ion, a nitrate ion, a double negatively charged anions, a carbonate ion, an oxide, and a sulfate ion. In some embodiments, the hydrogen product is embedded in a crystalline lattice (e.g., with the use of a getter such as K₂CO₃ located, for example, in the vessel or in an exhaust line). For example, the hydrogen product may be embedded in a salt lattice. In various implementations, the salt lattice may comprise an alkali salt, an alkali halide, an alkali hydroxide, alkaline earth salt, an alkaline earth halide, an alkaline earth hydroxide, or combinations thereof.

Electrode systems are also provided comprising:
a) a first electrode and a second electrode;
b) a stream of molten metal (e.g., molten silver, molten gallium) in electrical contact with said first and second electrodes;
c) a circulation system comprising a pump to draw said molten metal from a reservoir and convey it through a conduit (e.g., a tube) to produce said stream of molten metal exiting said conduit;
d) a source of electrical power configured to provide an electrical potential difference between said first and second electrodes;
   wherein said stream of molten metal is in simultaneous contact with said first and second electrodes to create an electrical current between said electrodes. In some embodiments, the electrical power is sufficient to create a current in excess of 100 A.

Electrical circuits are also provided which may comprise:
a) a heating means for producing molten metal;
b) a pumping means for conveying said molten metal from a reservoir through a conduit to produce a stream of said molten metal exiting said conduit;
c) a first electrode and a second electrode in electrical communication with a power supply means for creating an electrical potential difference across said first and second electrode;
   wherein said stream of molten metal is in simultaneous contact with said first and second electrodes to create an electrical circuit between said first and second electrodes. For example, in an electrical circuit comprising a first and second electrode, the improvement may comprise passing a stream of molten metal across said electrodes to permit a current to flow there between.

Additionally, systems for producing a plasma (which may be used in the power generation systems described herein) are provided. These systems may comprise:
a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with said molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
   wherein said plasma is produced when current is supplied through said metal stream. In some embodiments, the system may further comprise:
   a pumping system configured to transfer metal collected after the production of said plasma to said metal reservoir. In some embodiments, the system may comprise:
a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal. In certain implementations, the system may comprise:
   a) a pumping system configured to transfer metal collected after the production of said plasma to said metal reservoir; and
   b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
      wherein metal regenerated in said metal regeneration system is transferred to said pumping system. In certain implementations, the metal is gallium, silver, or combinations thereof. In some embodiments, the electrolyte is an alkali hydroxide (e.g., sodium hydroxide, potassium hydroxide).

Systems for producing a plasma of the present disclosure may comprise:
a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
wherein said plasma is produced when current is supplied through said metal stream. In some embodiments, the system may further comprise:
a) a pumping system configured to transfer metal collected after the production of said plasma to said metal reservoir; and
b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
wherein metal regenerated in said metal regeneration system is transferred to said pumping system.

The system for generating a plasma may comprise:
a) two electrodes configured to allow a molten metal flow therebetween to complete a circuit;
b) a power source connected to said two electrodes to apply a current therebetween when said circuit is closed;
c) a recombiner cell (e.g., glow discharge cell) to induce the formation of nascent water and atomic hydrogen from a gas; wherein effluence of the recombiner is directed towards the circuit (e.g., the molten metal, the anode, the cathode, an electrode submerged in a molten metal reservoir);
wherein when current is applied across the circuit, the effluence of the recombiner cell undergoes a reaction to produce a plasma. In some embodiments, the system is used to generate heat from the plasma. In various implementations, the system is used to generate light from the plasma.

The systems of the present disclosure may comprise (or be part of) a mesh network comprising a plurality of power-system-transmitter-receiver nodes that transmit and received electromagnetic signals in at least one frequency band, the frequency of the band may be high frequency due to the ability to position nodes locally with short separation distance wherein the frequency may be in at least one range of about 0.1 GHz to 500 GHz, 1 GHz to 250 GHz, 1 GHz to 100 GHz, 1 GHz to 50 GHz, and 1 GHz to 25 GHz.

The unique spectroscopic signatures measured in the reaction products produces hydrogen products with unique characteristics. These hydrogen reaction products may be used in various devices, each part of the present disclosure.

Methods are also provided. The method may, for example, generate power or produce light, or produce a plasma using one or more systems of the present disclosure. In some embodiments, the method comprises:
a) electrically biasing a molten metal;
b) directing the effluence of a plasma generation cell (e.g., a glow discharge cell) to interact with the biased molten metal and induce the formation of a plasma. In certain implementations, the effluence of the plasma generation cell is generated from a hydrogen (H₂) and oxygen (O₂) gas mixture passing through the plasma generation cell during operation.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIGS. 66C-D are schematic drawings of an inverted Y geometry SunCell® power generator comprising dual reservoirs and DC EM pump injectors as liquid electrodes having reservoirs that join to form the reaction cell chamber that is connected to a PV window in accordance with an embodiment of the present disclosure.

FIG. 66E is a schematic drawing of a photovoltaic converter and an inverted Y geometry SunCell® power generator comprising dual reservoirs and DC EM pump injectors as liquid electrodes having reservoirs that join to form the reaction cell chamber that is connected to a PV window in accordance with an embodiment of the present disclosure.

FIGS. 66F-66G are schematic drawings of a thermophotovoltaic SunCell® power generator comprising dual EM pump injectors as liquid electrodes showing a tilted electromagnetic pump assembly with an inlet riser, inner and outer PV windows, and one reservoir or two comprising an electrical break and a bellows in accordance with an embodiment of the present disclosure.

FIGS. 66H-66L are schematic drawings of a thermophotovoltaic SunCell® power generator comprising dual EM pump injectors as liquid electrodes with each showing a tilted electromagnetic pump assembly having an inlet riser, an inner PV window, an outer PV window, at least one reservoir comprising an electrical break, and at least one reservoir comprising a bellows in accordance with an embodiment of the present disclosure.

FIGS. 66M-66N are schematic drawings of a SunCell® power generator comprising dual reservoirs and DC EM pump injectors as liquid electrodes having reservoirs that join to form the reaction cell chamber in accordance with an embodiment of the present disclosure.

FIGS. 66O-66T are schematic drawings of a SunCell® power generator comprising dual reservoirs and DC EM pump injectors as liquid electrodes having reservoirs that join to form the reaction cell chamber and a PV window chamber sealed to the reservoirs by a wet seal in accordance with an embodiment of the present disclosure.

FIG. 66U is a schematic drawing of a SunCell® EM pump tube, EM pump bus bar assembly, reflective baseplate, and bead retention housing in accordance with an embodiment of the present disclosure.

FIGS. 66V-66X are schematic drawings of a SunCell® power generator comprising dual inner and outer reservoirs and DC EM pump injectors as liquid electrodes having reservoirs that join to form a chamber joined to a baseplate and a PV window chamber that is sealed to baseplate by a wet seal in accordance with an embodiment of the present disclosure.

FIGS. 66Y-66ZA are schematic drawings of a SunCell® power generator comprising dual inner and outer reservoirs and DC EM pump injectors as liquid electrodes having reservoirs that intersect and join a hemispherical dome connected to a baseplate and a PV window chamber that is sealed to baseplate by a wet seal in accordance with an embodiment of the present disclosure.

FIG. 2I132 is a schematic drawing of a SunCell® power generator showing details of an optical distribution and the photovoltaic converter system in accordance with an embodiment of the present disclosure.

FIG. 2I133 is a schematic drawing of a triangular element of the geodesic dense receiver array of the photovoltaic converter or heat exchanger in accordance with an embodiment of the present disclosure.

FIGS. 2I143-2I144 are schematic drawings of a thermophotovoltaic SunCell® power generator comprising dual EM pump injectors as liquid electrodes showing a tilted electromagnetic pump assembly with an inlet riser and a PV converter of increased radius to decrease the blackbody light intensity in accordance with an embodiment of the present disclosure.

### DETAILED DESCRIPTION

Disclosed herein are power generation systems and methods of power generation which convert the energy output from reactions involving atomic hydrogen into electrical and/or thermal energy. These reactions may involve catalyst systems which release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

A theory which may explain the exothermic reactions produced by the power generation systems of the present disclosure involves a nonradiative transfer of energy from atomic hydrogen to certain catalysts (e.g., nascent water). Classical physics gives closed-form solutions of the hydrogen atom, the hydride ion, the hydrogen molecular ion, and the hydrogen molecule and predicts corresponding species having fractional principal quantum numbers. Atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=1/2, 1/3, 1/4, . . . , 1/p (p≤137 is an integer) replaces the well-known parameter n=integer in the Rydberg equation for hydrogen excited states. Each hydrino state also comprises an electron, a proton, and a photon, but the field contribution from the photon increases the binding energy rather than decreasing it corresponding to energy desorption rather than absorption. Since the potential energy of atomic hydrogen is 27.2 eV, m H atoms serve as a catalyst of m·27.2 eV for another (m+1)th H atom [R. Mills, The Grand Unified Theory of Classical Physics; September 2016 Edition, posted at https://brilliantlightpower.com/book-download-and-streaming/(“Mills GUTCP” or “Mills GUT”)]. For example, a H atom can act as a catalyst for another H by accepting 27.2 eV from it via through-space energy transfer such as by magnetic or induced electric dipole-dipole coupling to form an intermediate that decays with the emission of continuum bands with short wavelength cutoffs and energies of

$${m}^{2} \cdot 13.6 eV ( \frac{91.2}{{m}^{2}} nm ) .$$

In addition to atomic H, a molecule that accepts m×27.2 eV from atomic H with a decrease in the magnitude of the potential energy of the molecule by the same energy may also serve as a catalyst. The potential energy of H₂O is 81.6 eV. Then, by the same mechanism, the nascent H₂O molecule (not hydrogen bonded in solid, liquid, or gaseous state) formed by a thermodynamically favorable reduction of a metal oxide is predicted to serve as a catalyst to form H(1/4) with an energy release of 204 eV, comprising an 81.6 eV transfer to HOH and a release of continuum radiation with a cutoff at 10.1 nm (122.4 eV).

In the H-atom catalyst reaction involving a transition to the

$$H [ \frac{{a}_{H}}{p = m + 1} ]$$

state, m H atoms serve as a catalyst of m·27.2 eV for another (m+1)th H atom. Then, the reaction between m+1 hydrogen atoms whereby m atoms resonantly and nonradiatively accept m·27.2 eV from the (m+1)th hydrogen atom such that mH serves as the catalyst is given by

$$m \cdot 27.2 eV + m H + H \to {m H}_{fast}^{+} + me + H * [ \frac{{a}_{H}}{m + 1} ] + m \cdot 27.2 eV \qquad ( 1 )$$

$$H * [ \frac{{a}_{H}}{m + 1} ] \to H [ \frac{{a}_{H}}{m + 1} ] + [ \begin{matrix}{( m + 1 )}^{2} & {1}^{2} ] \cdot 13.6 eV\end{matrix} m \cdot 27.2 eV \qquad ( 2 )$$

$${m H}_{fast}^{+} + me \to m H + m \cdot 27.2 eV \qquad ( 3 )$$

And, the overall reaction is

$$H \to H [ \frac{{a}_{H}}{p = m + 1} ] + [ \begin{matrix}{( m + 1 )}^{2} & {1}^{2} ] \cdot 13.6 eV\end{matrix} \qquad ( 4 )$$

The catalysis reaction (m=3) regarding the potential energy of nascent H₂O [R. Mills, The Grand Unified Theory of Classical Physics; September 2016 Edition, posted at https://brilliantlightpower.com/book-download-and-streaming/] is

$$81.6 eV + {H}_{2} O + H [ {a}_{H} ] \to 2 {H}_{fast}^{+} + O + e + H * [ \frac{{a}_{H}}{4} ] + 81.6 eV \qquad ( 5 )$$

$$H * [ \frac{{a}_{H}}{4} ] \to H [ \frac{{a}_{H}}{4} ] + 122.4 eV \qquad ( 6 )$$

$$2 {H}_{fast}^{+} + O + e \to {H}_{2} O + 81.6 eV \qquad ( 7 )$$

And, the overall reaction is

$$H [ {a}_{H} ] \to H [ \frac{{a}_{H}}{4} ] + 81.6 eV + 122.4 eV \qquad ( 8 )$$

After the energy transfer to the catalyst (Eqs. (1) and (5)), an intermediate

$$H * [ \frac{{a}_{H}}{m + 1} ]$$

is formed having the radius of the H atom and a central field of m+1 times the central field of a proton. The radius is predicted to decrease as the electron undergoes radial acceleration to a stable state having a radius of 1/(m+1) the radius of the uncatalyzed hydrogen atom, with the release of m²×13.6 eV of energy. The extreme-ultraviolet continuum radiation band due to the

$$H * [ \frac{{a}_{H}}{m + 1} ]$$

intermediate (e.g. Eq. (2) and Eq. (6)) is predicted to have a short wavelength cutoff and energy

$${E}_{( H \to H [ \frac{{a}_{H}}{p = m + 1} ] )}$$

given by

$${{E}_{( H \to H [ \frac{{a}_{H}}{p = m + 1} ] )} = {m}^{2} \cdot 13.6 eV ;}_{( H \to H [ \frac{{a}_{H}}{p = m + 1} ] )} = \frac{91.2}{{m}^{2}} nm$$

and extending to longer wavelengths than the corresponding cutoff. Here the extreme-ultraviolet continuum radiation band due to the decay of the H*[a_{H}/4] intermediate is predicted to have a short wavelength cutoff at E=m²·13.6=9·13.6=122.4 eV (10.1 nm) [where p=m+1=4 and m=3 in Eq. (9)] and extending to longer wavelengths. The continuum radiation band at 10.1 nm and going to longer wavelengths for the theoretically predicted transition of H to lower-energy, so called “hydrino” state H(1/4), was observed only arising from pulsed pinch gas discharges comprising some hydrogen. Another observation predicted by Eqs. (1) and (5) is the formation of fast, excited state H atoms from recombination of fast H⁺. The fast atoms give rise to broadened Balmer emission. Greater than 50 eV Balmer line broadening that reveals a population of extraordinarily high-kinetic-energy hydrogen atoms in certain mixed hydrogen plasmas is a well-established phenomenon wherein the cause is due to the energy released in the formation of hydrinos. Fast H was previously observed in continuum-emitting hydrogen pinch plasmas.

Additional catalyst and reactions to form hydrino are possible. Specific species (e.g. He⁺, Ar⁺, Sr⁺, K, Li, HCl, and NaH, OH, SH, SeH, nascent H₂O, nH (n=integer)) identifiable on the basis of their known electron energy levels are required to be present with atomic hydrogen to catalyze the process. The reaction involves a nonradiative energy transfer followed by q×13.6 eV continuum emission or q×13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$${E}_{n} = \frac{{e}^{2}}{{n}^{2} 8 {}_{o} {a}_{H}} = \frac{13.598 eV}{{n}^{2}} . \qquad ( 10 )$$

$$n = 1 , 2 , 3 , … \qquad ( 11 )$$

where a_{H} is the Bohr radius for the hydrogen atom (52.947 pm), e is the magnitude of the charge of the electron, and 0 is the vacuum permittivity, fractional quantum numbers:

$$n = 1 , \frac{1}{2} , \frac{1}{3} , \frac{1}{4} , … , \frac{1}{p} ; where p 137 is an interger \qquad ( 12 )$$

replace the well known parameter n=integer in the Rydberg equation for hydrogen excited states and represent lower-energy-state hydrogen atoms called “hydrinos.” The n=1 state of hydrogen and the

$$n = \frac{1}{interger}$$

states of hydrogen are nonradiative, but a transition between two nonradiative states, say n=1 to n=1/2, is possible via a nonradiative energy transfer. Hydrogen is a special case of the stable states given by Eqs. (10) and (12) wherein the corresponding radius of the hydrogen or hydrino atom is given by

$$r = \frac{{a}_{H}}{p} , \qquad ( 13 )$$

where p=1,2,3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

$$m \times 27.2 eV \qquad ( 14 )$$

where m is an integer. It is believed that the rate of catalysis is increased as the net enthalpy of reaction is more closely matched to m×27.2 eV. It has been found that catalysts having a net enthalpy of reaction within ±10%, preferably ±5%, of m×27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$m \cdot 27.2 eV + {Cat}^{q +} + H [ \frac{{a}_{H}}{p} ] \to {Cat}^{( q + r ) +} + re + H * [ \frac{{a}_{H}}{( m + p )} ] + m \cdot 27.2 eV \qquad ( 15 )$$

$$H * [ \frac{{a}_{H}}{( m + p )} ] \to H [ \frac{{a}_{H}}{( m + p )} ] + [ {( p + m )}^{2} {p}^{2} ] \cdot 13.6 eV m \cdot 27.2 eV \qquad ( 16 )$$

$${Cat}^{( q + r ) +} + re \to {Cat}^{q +} + m \cdot 27.2 eV and \qquad ( 17 )$$

the overall reaction is

$$H [ \frac{{a}_{H}}{p} ] \to H [ \frac{{a}_{H}}{( m + p )} ] + [ {( p + m )}^{2} {p}^{2} ] \cdot 13.6 eV \qquad ( 18 )$$

q, r, m, and p are integers.

$$H * [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of

$$\frac{1}{( m + p )}$$

that of H.

The catalyst product, H(1/p), may also react with an electron to form a hydrino hydride ion H (1/p), or two H (1/p) may react to form the corresponding molecular hydrino H₂(1/p). Specifically, the catalyst product, H(1/p), may also react with an electron to form a novel hydride ion H (1/p) with a binding energy E_{B}:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 19 )$$

where p=integer >1, S=1/2, h is Planck's constant bar, 0 is the permeability of vacuum, mₑ is the mass of the electron, e is the reduced electron mass given by

$$\text{?}$$

$$\text{?} \text{indicates text missing or illegible when filed}$$

where mₚ is the mass of the proton, a₀ is the Bohr radius, and the ionic radius is

$${r}_{1} = \frac{{a}_{0}}{p} ( 1 + \sqrt{s ( s + 1 )} ) .$$

From Eq. (19), the calculated ionization energy of the hydride ion is 0.75418 eV, and the experimental value is 6082.99±0.15 cm¹ (0.75418 eV). The binding energies of hydrino hydride ions may be measured by X-ray photoelectron spectroscopy (XPS).

Upfield-shifted NMR peaks are direct evidence of the existence of lower-energy state hydrogen with a reduced radius relative to ordinary hydride ion and having an increase in diamagnetic shielding of the proton. The shift is given by the sum of the contributions of the diamagnetism of the two electrons and the photon field of magnitude p (Mills GUTCP Eq. (7.87)):

$$\frac{{B}_{T}}{B} = \text{} \frac{{pe}^{2}}{{0}^{} 12 {m}_{e} {a}_{0} ( 1 + \sqrt{s ( s + 1 )} )} ( 1 + {p}^{2} ) = ( p 29.9 + {p}^{2} 1.59 \times {10}^{3} ) ppm \qquad ( 20 )$$

where the first term applies to H with p=1 and p=integer >1 for H (1/p) and is the fine structure constant. The predicted hydrino hydride peaks are extraordinarily upfield shifted relative to ordinary hydride ion. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 relative to a bare proton, may be −(p29.9+p²2.74) ppm (Eq. (20)) within a range of about at least one of ±5 ppm, ±10 ppm, ±20 ppm, ±30 ppm, ±40 ppm, ±50 ppm, +60 ppm, ±70 ppm, ±80 ppm, ±90 ppm, and ±100 ppm. The range of the absolute shift relative to a bare proton may be −(p29.9+p²1.59 X 10⁻³) ppm (Eq. (20)) within a range of about at least one of about 0.1% to 99%, 1% to 50%, and 1% to 10%. In another embodiment, the presence of a hydrino species such as a hydrino atom, hydride ion, or molecule in a solid matrix such as a matrix of a hydroxide such as NaOH or KOH causes the matrix protons to shift upfield. The matrix protons such as those of NaOH or KOH may exchange. In an embodiment, the shift may cause the matrix peak to be in the range of about −0.1 ppm to −5 ppm relative to TMS. The NMR determination may comprise magic angle spinning ¹H nuclear magnetic resonance spectroscopy (MAS ¹H NMR).

H(1/p) may react with a proton and two H(1/p) may react to form H₂ (1/p)⁺ and H₂ (1/p), respectively. The hydrogen molecular ion and molecular charge and current density functions, bond distances, and energies were solved from the Laplacian in ellipsoidal coordinates with the constraint of nonradiation.

$$( ) R - ( R - ) + ( ) R - ( R - ) + ( ) R - ( R - ) = 0 \qquad ( 21 )$$

The total energy E_{T} (Mills GUT Eqs. (11.192-11.194)) of the hydrogen molecular ion having a central field of +pe at each focus of the prolate spheroid molecular orbital is

$${E}_{T} = {p}^{2} 16.253 \qquad ( 22 )$$

The total energy E_{T} (Mills GUT Eqs. (11.239-11.242)) of the hydrogen molecule having a central field of +pe at each focus of the prolate spheroid molecular orbital is

$${E}_{T} = {p}^{2} 31.667 \qquad ( 23 )$$

The bond dissociation energy, E_{D}, (Mills GUT Eqs. (11.249-11.253)) of the hydrogen molecule H₂(1/p) is the difference between the total energy of the corresponding hydrogen atoms and E_{T}

$${E}_{D} = E ( 2 H ( 1 / p ) ) {E}_{T} \qquad ( 24 )$$

where

$$E ( 2 H ( 1 / p ) ) = {p}^{2} 27.2 e V \qquad ( 25 )$$

$${E}_{D} is given by Eqs . ( 23 - 25 ) :$$

$${E}_{D} = E ( 2 H ( / p ) - {E}_{T} = {p}^{2} 27.2 - {E}_{T} = {p}^{2} 4.478 e V \qquad ( 26 )$$

H₂(1/p) may be identified by X-ray photoelectron spectroscopy (XPS) wherein the ionization product in addition to the ionized electron may be at least one of the possibilities such as those comprising two protons and an electron, a hydrogen (H) atom, a hydrino atom, a molecular ion, hydrogen molecular ion, and H₂(1/p)⁺ wherein the energies may be shifted by the matrix.

The NMR of catalysis-product gas provides a definitive test of the theoretically predicted chemical shift of H₂(1/p). In general, the ¹H NMR resonance of H₂(1/p) is predicted to be upfield from that of H₂ due to the fractional radius in elliptic coordinates wherein the electrons are significantly closer to the nuclei. The predicted shift

$$\frac{{B}_{T}}{B} ,$$

for H₂(1/p) is given by the sum of the contributions of the diamagnetism of the two electrons and the photon field of magnitude p (Mills GUTCP Eqs. (11.415-11.416)):

$$\frac{{B}_{T}}{B} {=}_{0} ( 4 \sqrt{2} ln \frac{\sqrt{2} + 1}{\sqrt{2} 1} ) \frac{{pe}^{2}}{36 {a}_{0} {m}_{e}} ( 1 + {p}^{2} ) \qquad ( 27 )$$

$$\frac{{B}_{T}}{B} = ( p 28.01 + {p}^{2} 1.49 \times {10}^{3} ) ppm \qquad ( 28 )$$

where the first term applies to H₂ with p=1 and p integer >1 for H₂(1/p). The experimental absolute H₂ gas-phase resonance shift of −28.0 ppm is in excellent agreement with the predicted absolute gas-phase shift of −28.01 ppm (Eq. (28)). The predicted molecular hydrino peaks are extraordinarily upfield shifted relative to ordinary H₂. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 ppm relative to a bare proton, may be −(p28.01+p²2.56) ppm (Eq. (28)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p28.01+p²1.49 X 10⁻³) ppm (Eq. (28)) within a range of about at least one of about 0.1% to 99%, 1% to 50%, and 1% to 10%.

The vibrational energies, E_{vib}, for the =0 to =1 transition of hydrogen-type molecules H₂(1/p) are

$${E}_{vib} = {p}^{2} 0.515902 e V \qquad ( 29 )$$

where p is an integer.

The rotational energies, Eᵣₒₜ, for the J to J+1 transition of hydrogen-type molecules H₂(1/p) are

$${E}_{rot} = {E}_{J + 1} - {E}_{J} = \frac{{ℏ}^{2}}{I} [ J + 1 ] = {p}^{2} ( J + 1 ) 0.01509 e V \qquad ( 30 )$$

where p is an integer and I is the moment of inertia. Ro-vibrational emission of H₂(1/4) was observed on e-beam excited molecules in gases and trapped in solid matrix.

The p² dependence of the rotational energies results from an inverse p dependence of the internuclear distance and the corresponding impact on the moment of inertia I. The predicted internuclear distance 2c′ for H₂ (1/p) is

$$2 c = \frac{{a}_{o} \sqrt{2}}{p} \qquad ( 31 )$$

At least one of the rotational and vibration energies of H₂(1/p) may be measured by at least one of electron-beam excitation emission spectroscopy, Raman spectroscopy, and Fourier transform infrared (FTIR) spectroscopy. H₂(1/p) may be trapped in a matrix for measurement such as in at least one of MOH, MX, and M₂CO₃ (M=alkali; X=halide) matrix.

In an embodiment, the molecular hydrino product is observed as an inverse Raman effect (IRE) peak at about 1950 cm⁻¹. The peak is enhanced by using a conductive material comprising roughness features or particle size comparable to that of the Raman laser wavelength that supports a Surface Enhanced Raman Scattering (SERS) to show the IRE peak.

### I. Catalysts

In the present disclosure the terms such as hydrino reaction, H catalysis, H catalysis reaction, catalysis when referring to hydrogen, the reaction of hydrogen to form hydrinos, and hydrino formation reaction all refer to the reaction such as that of Eqs. (15-18) of a catalyst defined by Eq. (14) with atomic H to form states of hydrogen having energy levels given by Eqs. (10) and (12). The corresponding terms such as hydrino reactants, hydrino reaction mixture, catalyst mixture, reactants for hydrino formation, reactants that produce or form lower-energy state hydrogen or hydrinos are also used interchangeably when referring to the reaction mixture that performs the catalysis of H to H states or hydrino states having energy levels given by Eqs. (10) and (12).

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom, ion, or molecule, and may further comprise the concerted reaction of a bond cleavage with ionization of one or more electrons from one or more of the partners of the initial bond. An integer number of hydrogen atoms may also serve as the catalyst of an integer multiple of 27.2 eV enthalpy. In an embodiment, the catalyst is capable of accepting energy from atomic hydrogen in integer units of one of 27.2 about 27.2 eV±0.5 eV and eV±0.5 eV.

$$\frac{27.2}{2} e V \pm 0.5 e V .$$

Classical physical laws predict that atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=1/2, 1/3, 1/4, . . . , 1/p (p≤137 is an integer) replaces the well-known parameter n=integer in the Rydberg equation for hydrogen excited states. Each hydrino state also comprises an electron, a proton, and a photon, but the field contribution from the photon increases the binding rather than decreasing it corresponding to energy desorption rather than absorption. Since the potential energy of atomic hydrogen is 27.2 eV, M H atoms serve as a catalyst of m×27.2 eV for another (m+1)th H atom. For example, an H atom can act as a catalyst for another H by accepting 27.2 eV from it via through-space energy transfer such as by magnetic or induced electric dipole-dipole coupling. In addition to atomic H, a molecule that accepts m×27.2 eV from atomic H with a decrease in the magnitude of the potential energy of the molecule by the same energy may also serve as a catalyst. The potential energy of H₂O is 81.6 eV [Mills GUT]. Then, by the same mechanism, the nascent H₂O molecule (not hydrogen bonded in solid, liquid, or gaseous state) may serve as a catalyst. Based on the 10% energy change in the heat of vaporization in going from ice at 0° C. to water at 100° C., the average number of H bonds per water molecule in boiling water is 3.6 [Mills GUT]; thus, H₂O must be formed chemically as isolated molecules with suitable activation energy in order to serve as a catalyst to form hydrinos. The catalysis reaction (m=3) regarding the potential energy of nascent H₂O is

$$81.6 e V + {H}_{2} O + H [ {a}_{H} ] \to 2 {H}_{fast}^{+} + O + e + H * [ \frac{{a}_{H}}{4} ] + 81.6 e V \qquad ( 1 a )$$

$$H * [ \frac{{a}_{H}}{4} ] \to H [ \frac{{a}_{H}}{4} ] + 122.4 e V \qquad ( 2 a )$$

$$2 {H}_{fast}^{+} + O + e \to {H}_{2} O + 81.6 e V or OH + {H}_{fast} \qquad ( 3 a )$$

And, the overall reaction is

$$H [ {a}_{H} ] \to H [ \frac{{a}_{H}}{4} ] + 81.6 e V + 122.4 e V \qquad ( 4 a )$$

After the energy transfer to the catalyst, an intermediate

$$H * [ \frac{{a}_{H}}{m + 1} ]$$

is formed having the radius of the H atom and a central field of m+1 times the central field of a proton (e.g.

$$H * [ \frac{{a}_{H}}{4} ]$$

is the intermediate in Eq. (1) wherein m=3, and H⁺_{fast} and H_{fast} refer to these species with excessive kinetic energy). The radius is predicted to decrease as the electron undergoes radial acceleration to a stable state having a radius of 1/(m+1) the radius of the uncatalyzed hydrogen atom, with the release of m²×13.6 eV of energy. The extreme-ultraviolet continuum radiation band due to the

$$H * [ \frac{{a}_{H}}{m + 1} ]$$

intermediate (e.g. Eq. (2a)) is predicted to have a short wavelength cutoff and energy

$${E}_{( H \to H [ \frac{{a}_{H}}{p = m + 1} ] )}$$

given by

$${E}_{( H \to H [ \frac{{a}_{H}}{p = m + 1} ] )} = {m}^{2} \cdot 13.6 eV ; \qquad ( 5 a )$$

$${( H \to H [ \frac{{a}_{H}}{p = m + 1} ] )}_{} = \frac{91.2}{{m}^{2}} nm$$

and extending to longer wavelengths than the corresponding cutoff.

### II. Hydrinos

A hydrogen atom having a binding energy given by

$${E}_{B} = \frac{13.6 eV}{{( 1 / p )}^{2}}$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eqs. (10) and (12) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

According to the present disclosure, a hydrino hydride ion (H⁻) having a binding energy according to Eq. (19) that is greater than the binding of ordinary hydride ion (about 0.75 eV) for p=2 up to 23, and less for p=24 (H⁻) is provided. For p=2 to p=24 of Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{16.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$${E}_{T} = {p}^{2} 16.253$$

such as within a range of about 0.9 to 1.1 times E_{T}=p²16.253 where p is an integer, h is Planck's constant bar, mₑ is the mass of the electron, c is the speed of light in vacuum, and is the reduced nuclear mass, and (b) a dihydrino molecule having a total energy of about

$${E}_{T} = {p}^{2} 31.667$$

such as within a range of about 0.9 to 1.1 times E_{T}=p²310.667 where p is an integer and a₀ is the Bohr radius.

According to one embodiment of the present disclosure wherein the compound comprises a negatively charged increased binding energy hydrogen species, the compound further comprises one or more cations, such as a proton, ordinary H₂⁺, or ordinary H₃⁺.

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} \times 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 137.

A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

In an embodiment, at least one of very high power and energy may be achieved by the hydrogen undergoing transitions to hydrinos of high p values in Eq. (18) in a process herein referred to as disproportionation as given in Mills GUTCP Chp. 5 which is incorporated by reference. Hydrogen atoms H(1/p) p=1, 2,3, . . . 137 can undergo further transitions to lower-energy states given by Eqs. (10) and (12) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) given by Eq. (32) is represented by

$$H ( 1 / {p}^{′} ) + H ( 1 / p ) ⟶ H + H ( 1 / ( p + m ) ) + [ 2 pm + {m}^{2} - {p}^{′ 2} + 1 ] \cdot 13.6 eV \qquad ( 32 )$$

The EUV light from the hydrino process may dissociate the dihydrino molecules and the resulting hydrino atoms may serve as catalysts to transition to lower energy states. An exemplary reaction comprises the catalysis H to H(1/17) by H(1/4) wherein H(1/4) may be a reaction product of the catalysis of another H by HOH. Disproportionation reactions of hydrinos are predicted to given rise to features in the X-ray region. As shown by Eqs. (5-8) the reaction product of HOH catalyst is

$$H [ \frac{{a}_{H}}{4} ] .$$

Consider a likely transition reaction in hydrogen clouds containing H₂O gas wherein the first hydrogen-type atom

$$H [ \frac{{a}_{H}}{p} ]$$

is an H atom and the second acceptor hydrogen-type atom

$$H [ \frac{{a}_{H}}{{p}^{′}} ]$$

serving as a catalyst is

$$H [ \frac{{a}_{H}}{4} ] .$$

Since the potential energy of

$$H [ \frac{{a}_{H}}{4} ]$$

is 4²×27.2 eV=16×27.2 eV=435.2 eV, the transition reaction is represented by

$$16 \times 27.2 eV + H [ \frac{{a}_{H}}{4} ] + H [ \frac{{a}_{H}}{1} ] ⟶ {H}_{fast}^{+} + e + H * [ \frac{{a}_{H}}{17} ] + 16 \cdot 27.2 eV \qquad ( 33 )$$

$$H * [ \frac{{a}_{H}}{17} ] ⟶ H [ \frac{{a}_{H}}{17} ] + 3481.6 eV \qquad ( 34 )$$

$${H}_{fast}^{+} + e ⟶ H [ \frac{{a}_{H}}{1} ] + 231.2 eV \qquad ( 35 )$$

And, the overall reaction is

$$H [ \frac{{a}_{H}}{4} ] + H [ \frac{{a}_{H}}{1} ] ⟶ H [ \frac{{a}_{H}}{1} ] + H [ \frac{{a}_{H}}{17} ] + 3712.8 eV \qquad ( 36 )$$

The extreme-ultraviolet continuum radiation band due to the

$$H * [ \frac{{a}_{H}}{p + m} ]$$

intermediate (e.g. Eq. (16) and Eq. (34)) is predicted to have a short wavelength cutoff and energy

$${E}_{( H ⟶ H [ \frac{{a}_{H}}{p + m} ] )}$$

given by

$$\begin{matrix}\begin{matrix}{E}_{( H ⟶ H [ \frac{{a}_{H}}{p + m} ] )} = [ \begin{matrix}{( p + m )}^{2} & {p}^{2} ] \cdot 13.6 eV\end{matrix} & m \cdot 27.2 eV\end{matrix} \\ {( H ⟶ H [ \frac{{a}_{H}}{p + m} ] )}_{} = \frac{91.2}{\begin{matrix}[ \begin{matrix}{( p + m )}^{2} & {p}^{2} ] \cdot 13.6 eV\end{matrix} & m \cdot 27.2 eV\end{matrix}} nm\end{matrix} \qquad ( 37 )$$

and extending to longer wavelengths than the corresponding cutoff. Here the extreme-ultraviolet continuum radiation band due to the decay of the

$$H * [ \frac{{a}_{H}}{17} ]$$

intermediate is predicted to have a short wavelength cutoff at E=3481.6 eV; 0.35625 nm and extending to longer wavelengths. A broad X-ray peak with a 3.48 keV cutoff was observed in the Perseus Cluster by NASA's Chandra X-ray Observatory and by the XMM-Newton [E. Bulbul, M. Markevitch, A. Foster, R. K. Smith, M. Loewenstein, S. W. Randall, “Detection of an unidentified emission line in the stacked X-Ray spectrum of galaxy clusters,” The Astrophysical Journal, Volume 789, Number 1, (2014); A. Boyarsky, O. Ruchayskiy, D. Iakubovskyi, J. Franse, “An unidentified line in X-ray spectra of the Andromeda galaxy and Perseus galaxy cluster,” (2014),arXiv:1402.4119 [astro-ph.CO]] that has no match to any known atomic transition. The 3.48 keV feature assigned to dark matter of unknown identity by BulBul et al. matches the

$$H [ \frac{{a}_{H}}{4} ] + H [ \frac{{a}_{H}}{1} ] ⟶ H [ \frac{{a}_{H}}{17} ]$$

transition and further confirms hydrinos as the identity of dark matter.

The novel hydrogen compositions of matter can comprise:
(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and
(b) at least one other element. Typically, the hydrogen products described herein are increased binding energy hydrogen species.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising
(a) at least one neutral, positive, or negative hydrogen species having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and
(b) at least one other element.

The total energy of the hydrogen species is the sum of the energies to remove all of the electrons from the hydrogen species. The hydrogen species according to the present disclosure has a total energy greater than the total energy of the corresponding ordinary hydrogen species. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (19) for p=24 has a first binding energy that is less than the first binding energy of ordinary hydride ion, while the total energy of the hydride ion of Eq. (19) for p=24 is much greater than the total energy of the corresponding ordinary hydride ion.

Also provided herein are novel compounds and molecular ions comprising
(a) a plurality of neutral, positive, or negative hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and
(b) optionally one other element.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising
(a) a plurality of neutral, positive, or negative hydrogen species having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and
(b) optionally one other element.

In an embodiment, a compound is provided comprising at least one increased binding energy hydrogen species chosen from (a) hydride ion having a binding energy according to Eq. (19) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”). In the disclosure, increased binding energy hydrogen species and compounds is also referred to as lower-energy hydrogen species and compounds. Hydrinos comprise an increased binding energy hydrogen species or equivalently a lower-energy hydrogen species.

### III. Chemical Reactor

The present disclosure is also directed to other reactors for producing increased binding energy hydrogen species and compounds of the present disclosure, such as dihydrino molecules and hydrino hydride compounds. Further products of the catalysis are power and optionally plasma and light depending on the cell type. Such a reactor may be hereinafter referred to as a “hydrogen reactor” or “hydrogen cell.” The hydrogen reactor comprises a cell for making hydrinos. The cell for making hydrinos may take the form of a chemical reactor or gas fuel cell such as a gas discharge cell, a plasma torch cell, or microwave power cell, and an electrochemical cell. In an embodiment, the catalyst is HOH and the source of at least one of the HOH and H is ice. The ice may have a high surface area to increase at least one of the rates of the formation of HOH catalyst and H from ice and the hydrino reaction rate. The ice may be in the form of fine chips to increase the surface area. In an embodiment, the cell comprises an arc discharge cell and that comprises ice at least one electrode such that the discharge involves at least a portion of the ice.

In an embodiment, the arc discharge cell comprises a vessel, two electrodes, a high voltage power source such as one capable of a voltage in the range of about 100 V to 1 MV and a current in the range of about 1 A to 100 kA, and a source of water such as a reservoir and a means to form and supply H₂O droplets. The droplets may travel between the electrodes. In an embodiment, the droplets initiate the ignition of the arc plasma. In an embodiment, the water arc plasma comprises H and HOH that may react to form hydrinos. The ignition rate and the corresponding power rate may be controlled by controlling the size of the droplets and the rate at which they are supplied to the electrodes. The source of high voltage may comprise at least one high voltage capacitor that may be charged by a high voltage power source. In an embodiment, the arc discharge cell further comprises a means such as a power converter such as one of the present invention such as at least one of a PV converter and a heat engine to convert the power from the hydrino process such as light and heat to electricity.

Exemplary embodiments of the cell for making hydrinos may take the form of a liquid-fuel cell, a solid-fuel cell, a heterogeneous-fuel cell, a CIHT cell, and an SF-CIHT or SunCell® cell. Each of these cells comprises: (i) reactants including a source of atomic hydrogen; (ii) at least one catalyst chosen from a solid catalyst, a molten catalyst, a liquid catalyst, a gaseous catalyst, or mixtures thereof for making hydrinos; and (iii) a vessel for reacting hydrogen and the catalyst for making hydrinos. As used herein and as contemplated by the present disclosure, the term “hydrogen,” unless specified otherwise, includes not only proteum (¹H), but also deuterium (²H) and tritium (¹H). Exemplary chemical reaction mixtures and reactors may comprise SF-CIHT, CIHT, or thermal cell embodiments of the present disclosure. Additional exemplary embodiments are given in this Chemical Reactor section. Examples of reaction mixtures having H₂O as catalyst formed during the reaction of the mixture are given in the present disclosure. Other catalysts may serve to form increased binding energy hydrogen species and compounds. The reactions and conditions may be adjusted from these exemplary cases in the parameters such as the reactants, reactant wt %'s, H₂ pressure, and reaction temperature. Suitable reactants, conditions, and parameter ranges are those of the present disclosure. Hydrinos and molecular hydrino are shown to be products of the reactors of the present disclosure by predicted continuum radiation bands of an integer times 13.6 eV, otherwise unexplainable extraordinarily high H kinetic energies measured by Doppler line broadening of H lines, inversion of H lines, formation of plasma without a breakdown fields, and anomalously plasma afterglow duration as reported in Mills Prior Publications. The data such as that regarding the CIHT cell and solid fuels has been validated independently, off site by other researchers. The formation of hydrinos by cells of the present disclosure was also confirmed by electrical energies that were continuously output over long-duration, that were multiples of the electrical input that in most cases exceed the input by a factor of greater than 10 with no alternative source. The predicted molecular hydrino H₂(1/4) was identified as a product of CIHT cells and solid fuels by MAS H NMR that showed a predicted upfield shifted matrix peak of about −4.4 ppm, ToF-SIMS and ESI-ToFMS that showed H₂(1/4) complexed to a getter matrix as m/e=M+n2 peaks wherein M is the mass of a parent ion and n is an integer, electron-beam excitation emission spectroscopy and photoluminescence emission spectroscopy that showed the predicted rotational and vibration spectrum of H₂(1/4) having 16 or quantum number p=4 squared times the energies of H₂, Raman and FTIR spectroscopy that showed the rotational energy of H₂(1/4) of 1950 cm⁻¹, being 16 or quantum number p=4 squared times the rotational energy of H₂, XPS that showed the predicted total binding energy of H₂(1/4) of 500 eV, and a ToF-SIMS peak with an arrival time before the m/e=1 peak that corresponded to H with a kinetic energy of about 204 eV that matched the predicted energy release for H to H(1/4) with the energy transferred to a third body H as reported in Mills Prior Publications and in R. Mills X Yu, Y. Lu, G Chu, J. He, J. Lotoski, “Catalyst Induced Hydrino Transition (CIHT) Electrochemical Cell”, International Journal of Energy Research, (2013) and R. Mills, J. Lotoski, J. Kong, G Chu, J. He, J. Trevey, “High-Power-Density Catalyst Induced Hydrino Transition (CIHT) Electrochemical Cell” (2014) which are herein incorporated by reference in their entirety.

Using both a water flow calorimeter and a Setaram DSC 131 differential scanning calorimeter (DSC), the formation of hydrinos by cells of the present disclosure such as ones comprising a solid fuel to generate thermal power was confirmed by the observation of thermal energy from hydrino-forming solid fuels that exceed the maximum theoretical energy by a factor of 60 times. The MAS H NMR showed a predicted H₂(1/4) upfield matrix shift of about −4.4 ppm. A Raman peak starting at 1950 cm⁻¹ matched the free space rotational energy of H₂(1/4) (0.2414 eV). These results are reported in Mills Prior Publications and in R. Mills, J. Lotoski, W. Good, J. He, “Solid Fuels that Form HOH Catalyst”, (2014) which is herein incorporated by reference in its entirety.

### IV. SunCell and Power Converter

Power systems (also referred to herein as “SunCell”) that generate at least one of electrical energy and thermal energy may comprise:
a vessel capable of a maintaining a pressure below atmospheric;
reactants capable of undergoing a reaction that produces enough energy to form a plasma in the vessel comprising:
a) a mixture of hydrogen gas and oxygen gas, and/or
   water vapor, and/or
   a mixture of hydrogen gas and water vapor;
b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction; and
a power converter or output system to convert a portion of the energy produced from the reaction (e.g., light and/or thermal output from the plasma) to electrical power and/or thermal power. In some embodiments, the effluence comprises (or consists of) nascent water and atomic hydrogen. In some embodiments, the effluence comprises (or consists of) nascent water, and molecular hydrogen. In some embodiments, the effluence comprises (or consists of) nascent water, atomic hydrogen, and molecular hydrogen. In some embodiments, the effluence further comprises a noble gas.

In some embodiments, the power system may comprise an optical rectenna such as the one reported by A. Sharma, V. Singh, T. L. Bougher, B. A. Cola, “A carbon nanotube optical rectenna”, Nature Nanotechnology, Vol. 10, (2015), pp. 1027-1032, doi:10.1038/nnano.2015.220 which is incorporated by reference in its entirety, and specifically to its disclosure of thermal to electric power converters. In a further embodiment, the vessel is capable of a pressure of at least one of atmospheric, above atmospheric, and below atmospheric. In another embodiment, the at least one direct plasma to electricity converter can comprise at least one of the group of plasmadynamic power converter, \vec{E}×\vec{B} direct converter, magnetohydrodynamic power converter, magnetic mirror magnetohydrodynamic power converter, charge drift converter, Post or Venetian Blind power converter, gyrotron, photon bunching microwave power converter, and photoelectric converter. In a further embodiment, the at least one thermal to electricity converter can comprise at least one of the group of a heat engine, a steam engine, a steam turbine and generator, a gas turbine and generator, a Rankine-cycle engine, a Brayton-cycle engine, a Stirling engine, a thermionic power converter, and a thermoelectric power converter. Exemplary thermal to electric systems that may comprise closed coolant systems or open systems that reject heat to the ambient atmosphere are supercritical CO₂, organic Rankine, or external combustor gas turbine systems.

In addition to UV photovoltaic and thermal photovoltaic of the current disclosure, the SunCell® may comprise other electric conversion means known in the art such as thermionic, magnetohydrodynamic, turbine, microturbine, Rankine or Brayton cycle turbine, chemical, and electrochemical power conversion systems. The Rankine cycle turbine may comprise supercritical CO₂, an organic such as hydrofluorocarbon or fluorocarbon, or steam working fluid. In a Rankine or Brayton cycle turbine, the SunCell® may provide thermal power to at least one of the preheater, recuperator, boiler, and external combustor-type heat exchanger stage of a turbine system. In an embodiment, the Brayton cycle turbine comprises a SunCell® turbine heater integrated into the combustion section of the turbine. The SunCell® turbine heater may comprise ducts that receive airflow from at least one of the compressor and recuperator wherein the air is heated and the ducts direct the heated compressed flow to the inlet of the turbine to perform pressure-volume work. The SunCell® turbine heater may replace or supplement the combustion chamber of the gas turbine. The Rankine or Brayton cycle may be closed wherein the power converter further comprises at least one of a condenser and a cooler.

The converter may be one given in Mills Prior Publications and Mills Prior Applications. The hydrino reactants such as H sources and HOH sources and SunCell® systems may comprise those of the present disclosure or in prior US Patent Applications such as Hydrogen Catalyst Reactor, PCT/US08/61455, filed Apr. 24, 2008; Heterogeneous Hydrogen Catalyst Reactor, PCT/US09/052072, filed Jul. 29, 2009; Heterogeneous Hydrogen Catalyst Power System, PCT/US10/27828, filed Mar. 18, 2010; Electrochemical Hydrogen Catalyst Power System, PCT/US11/28889, filed Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed Jan. 10, 2014; Photovoltaic Power Generation Systems and Methods Regarding Same, PCT/US14/32584 filed Apr. 1, 2014; Electrical Power Generation Systems and Methods Regarding Same, PCT/US2015/033165 filed May 29, 2015; Ultraviolet Electrical Generation System Methods Regarding Same, PCT/US2015/065826 filed Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed Dec. 7, 2017; Thermophotovoltaic Electrical Power Generator, PCT/US2017/013972 filed Jan. 18, 2017; Extreme and Deep Ultraviolet Photovoltaic Cell, PCT/US2018/012635 filed Jan. 5, 2018; Magnetohydrodynamic Electric Power Generator, PCT/US18/17765 filed Feb. 12, 2018; Magnetohydrodynamic Electric Power Generator, PCT/US2018/034842 filed May 29, 2018; Magnetohydrodynamic Electric Power Generator, PCT/IB2018/059646 filed Dec. 5, 2018; Magnetohydrodynamic Electric Power Generator, PCT/IB2020/050360 filed Jan. 16, 1920; Magnetohydrodynamic Hydrogen Electrical Power Generator, PCT/US21/17148 filed Feb. 8, 2021; and Infrared Light Recycling Thermophotovoltaic Hydrogen Electrical Power Generator, PCT/IB2022/052016, filed Mar. 8, 2022 (“Mills Prior Applications”) herein incorporated by reference in their entirety.

In an embodiment, H₂O is ignited to form hydrinos with a high release of energy in the form of at least one of thermal, plasma, and electromagnetic (light) power. (“Ignition” in the present disclosure denotes the ignition from a set of reactants to produce a reaction such as a reaction ignited by the application of current to a set of reactants to produce a plasma which may be due to very high reaction rate of H to hydrinos that may be manifest as a burst, pulse or other form of high-power release). H₂O may comprise the fuel that may be ignited with the application a high current such as one in the range of about 10 A to 100,000 A. In an embodiment, the hydrino reaction rate is dependent on the application or development of a high current. In an embodiment of a SunCell®, the reactants to form hydrinos are subject to a low voltage, high current, high power pulse that causes a very rapid reaction rate and energy release. In an exemplary embodiment, a 60 Hz voltage is less than 15 V peak, the current ranges from 100 A/cm² and 50,000 A/cm² peak, and the power ranges from 1000 W/cm² and 750,000 W/cm². Other frequencies, voltages, currents, and powers in ranges of about 1/100 times to 100 times these parameters are suitable. In an embodiment, the hydrino reaction rate is dependent on the application or development of a high current. In an embodiment, the voltage is selected to cause a high AC, DC, or an AC-DC mixture of current that is in the range of at least one of 100 A to 1,000,000 A, 1 kA to 100,000 A, 10 kA to 50 kA. The DC or peak AC current density may be in the range of at least one of 100 A/cm² to 1,000,000 A/cm², 1000 A/cm² to 100,000 A/cm², and 2000 A/cm² to 50,000 A/cm². The DC or peak AC voltage may be in at least one range chosen from about 0.1 V to 1000 V, 0.1 V to 100 V, 0.1 V to 15 V, and 1 V to 15 V. The AC frequency may be in the range of about 0.1 Hz to 10 GHz, 1 Hz to 1 MHz, 10 Hz to 100 kHz, and 100 Hz to 10 kHz. The pulse time may be in at least one range chosen from about 10⁻⁶ s to 10 s, 10⁻⁵ to 1 s, 10⁻⁴ s to 0.1 s, and 10⁻³ s to 0.01 s.

### Ignition System

In an embodiment, the ignition system comprises a switch to at least one of initiate the current and interrupt the current once ignition is achieved. The flow of current may be initiated by the contact of the molten metal streams. The switching may be performed electronically by means such as at least one of an insulated gate bipolar transistor (IGBT), a silicon-controlled rectifier (SCR), and at least one metal oxide semiconductor field effect transistor (MOSFET). Alternatively, ignition may be switched mechanically. The current may be interrupted following ignition in order to optimize the output hydrino generated energy relative to the input ignition energy. The ignition system may comprise a switch to allow controllable amounts of energy to flow into the fuel to cause detonation and turn off the power during the phase wherein plasma is generated. In an embodiment, the source of electrical power to deliver a short burst of high-current electrical energy comprises at least one of the following:
a voltage selected to cause a high AC, DC, or an AC-DC mixture of current that is in the range of at least one of 100 A to 1,000,000 A, 1 kA to 100,000 A, 10 kA to 50 kA;
a DC or peak AC current density in the range of at least one of 1 A/cm² to 1,000,000 A/cm², 1000 A/cm² to 100,000 A/cm², and 2000 A/cm² to 50,000 A/cm²;
wherein the voltage is determined by the conductivity of the solid fuel wherein the voltage is given by the desired current times the resistance of the solid fuel sample;
the DC or peak AC voltage is in the range of at least one of 0.1 V to 500 kV, 0.1 V to 100 kV, and 1 V to 50 kV, and
the AC frequency is in range of at least one of 0.1 Hz to 10 GHz, 1 Hz to 1 MHz, 10 Hz to 100 kHz, and 100 Hz to 10 kHz.

The system further comprises a startup power/energy source such as a battery such as a lithium ion battery. Alternatively, external power such as grid power may be provided for startup through a connection from an external power source to the generator. The connection may comprise the power output bus bar. The startup power energy source may at least one of supply power to the heater to maintain the molten metal conductive matrix, power the injection system, and power the ignition system.

In an embodiment, the SunCell® comprises a heater such as a combustion heater such as one to perform hydrogen oxygen combustion to melt the molten metal such as the molten metal of the wet seal and that contained in the reservoirs and EM pump tubes. The heater may comprise a plurality of burner nozzles. An exemplary heater comprises at least one of a plurality of burner nozzles (i) under and directed at the baseplate 5b31c to heat it and the wet seal, (ii) around the reservoirs at the location of the molten metal to heat the corresponding section of the reservoirs and internal molten metal, and (iii) directed at the EM pump tubes 5k6 to heat them and the internal molten metal. The burner or nozzles may comprise a material capable of high temperature operation such as stainless steel such as 310.

The section may be heated well above the melting point to cause heating of other components of the SunCell by conduction and by transport with EM pumping of the molten metal. The melting and heating may be performed during operational startup. The hydrogen to supply the heater may be contained in a tank that may also supply the hydrogen reactant for the hydrino reaction. The hydrogen may be generated from the electrolysis of water wherein the electrolysis power may be provided by the SunCell. In addition to the tank, a combustion heater gas system may further comprise an optional oxygen tank, water electrolyzer, flow meters, pressure gauges, sensors, pressure and flow controllers, values, and a computer. After startup, the burner nozzles may serve as coolant injection jets to cool the corresponding SunCell® component such as the reservoir. Exemplary coolants are air and water.

In an embodiment, the burner heater nozzles may heat the inner reservoir directly or indirectly to melt the molten metal during startup. The nozzles may be positioned on the outside and be directed towards the outside of the outer reservoirs to heat the inner reservoirs by conduction. The gap between the inner and outer reservoir may comprise a thermal conductive medium. In another embodiment, the heater such as one comprising an electrical cartridge heater or at least one burner nozzle may be position in a housing or well the runs inside of the inner reservoir.

The SunCell® may comprise a high-pressure water electrolyzer such as one comprising a proton exchange membrane (PEM) electrolyzer having water under high pressure to provide high-pressure hydrogen. Each of the H₂ and O₂ chambers may comprise a recombiner to eliminate contaminant O₂ and H₂, respectively. The PEM may serve as at least one of the separator and salt bridge of the anode and cathode compartments to allow for hydrogen to be produced at the cathode and oxygen at the anode as separate gases. The cathode may comprise a dichalcogenide hydrogen evolution catalyst such as one comprising at least one of niobium and tantalum that may further comprise sulfur. The cathode may comprise one known in the art such as Pt or Ni. The hydrogen may be produced at high pressure and may be supplied to the reaction cell chamber 5b31 directly or by permeation through a hydrogen permeable membrane. The SunCell® may comprise an oxygen gas line from the anode compartment to the point of delivery of the oxygen gas to a storage vessel or a vent. In an embodiment, the SunCell® comprises sensors, a processor, and an electrolysis current controller.

In another embodiment, hydrogen fuel may be obtained from electrolysis of water, reforming natural gas, at least one of the syngas reaction and the water-gas shift reaction by reaction of steam with carbon to form H₂ and CO and CO₂, and other methods of hydrogen production known by those skilled in the art.

In another embodiment, the hydrogen may be produced by thermolysis using supplied water and the heat generated by the SunCell®. The thermolysis cycle may comprise one of the disclosure or one known in the art such as one that is based on a metal and its oxide such as at least one of SnO/Sn and ZnO/Zn. In an embodiment wherein the inductively coupled heater, EM pump, and ignition systems only consume power during startup, the hydrogen may be produced by thermolysis such that the parasitic electrical power requirement is very low. The SunCell® may comprise batteries such as lithium ion batteries to provide power to run systems such as the gas sensors and control systems such as those for the reaction plasma gases.

### Molten Metal Stream Generation

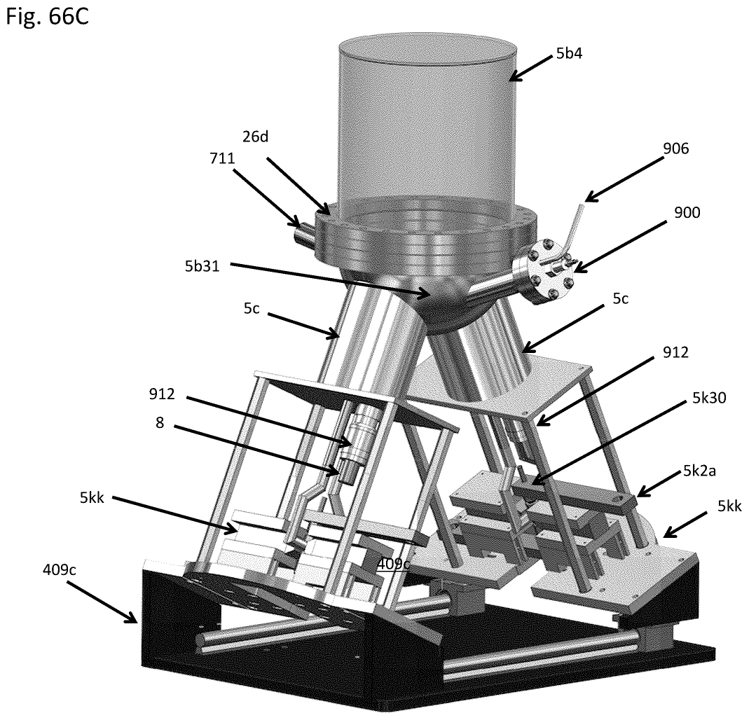

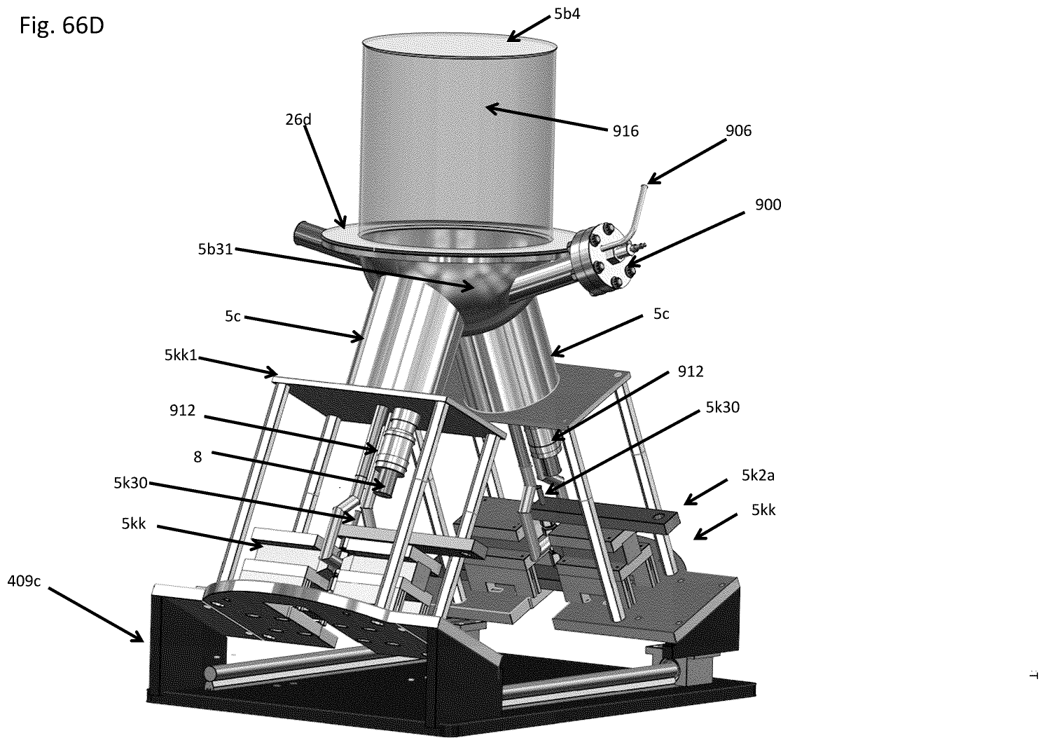

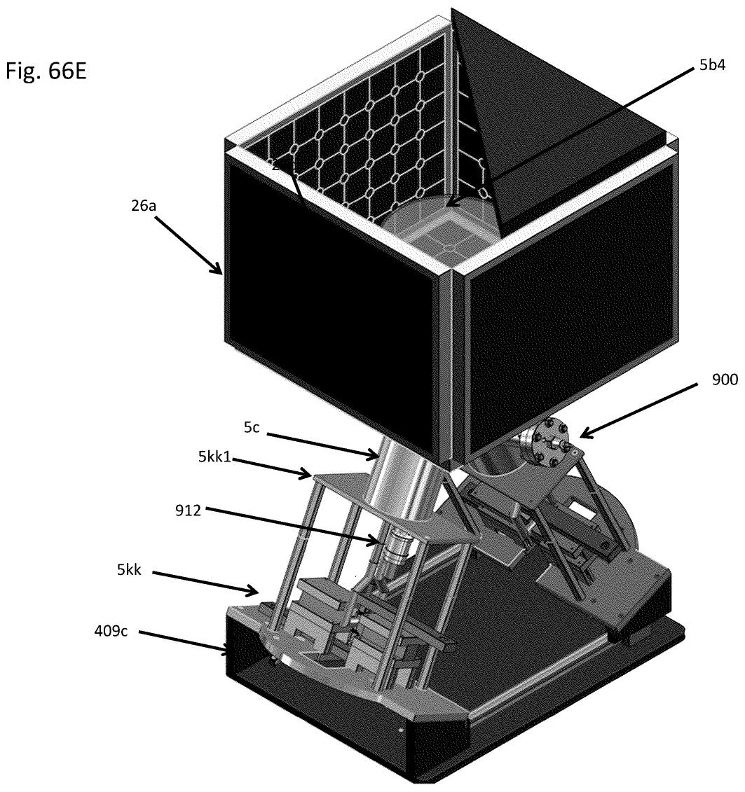

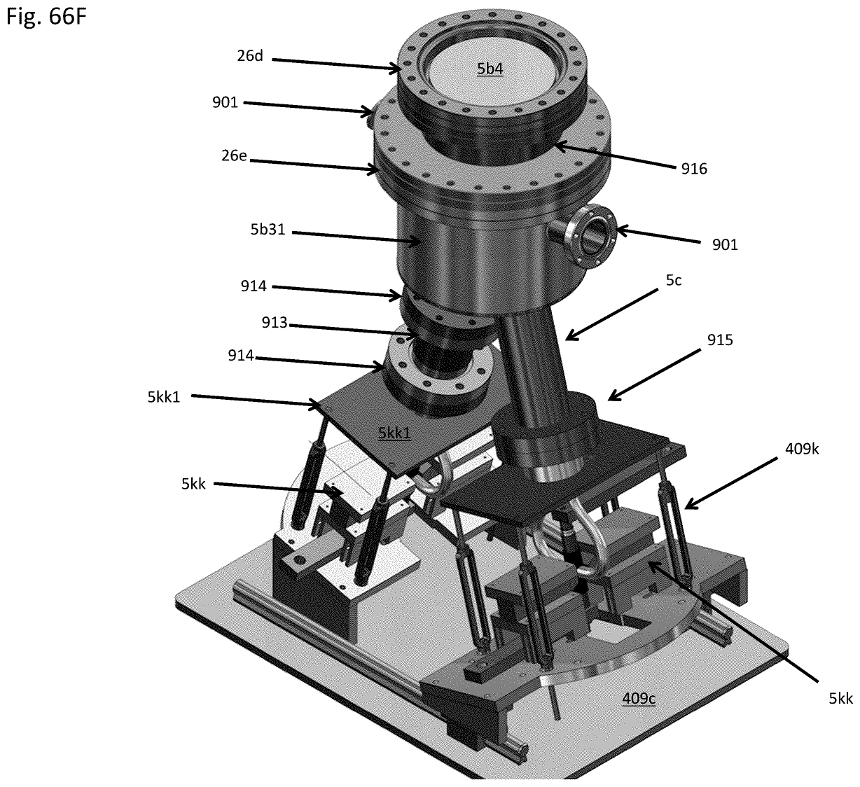

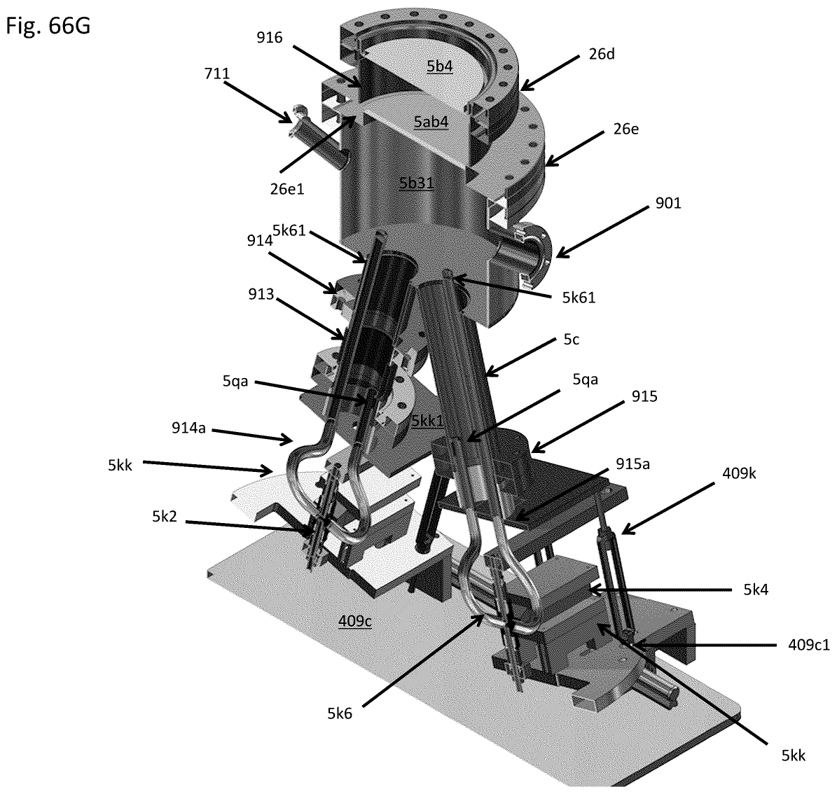

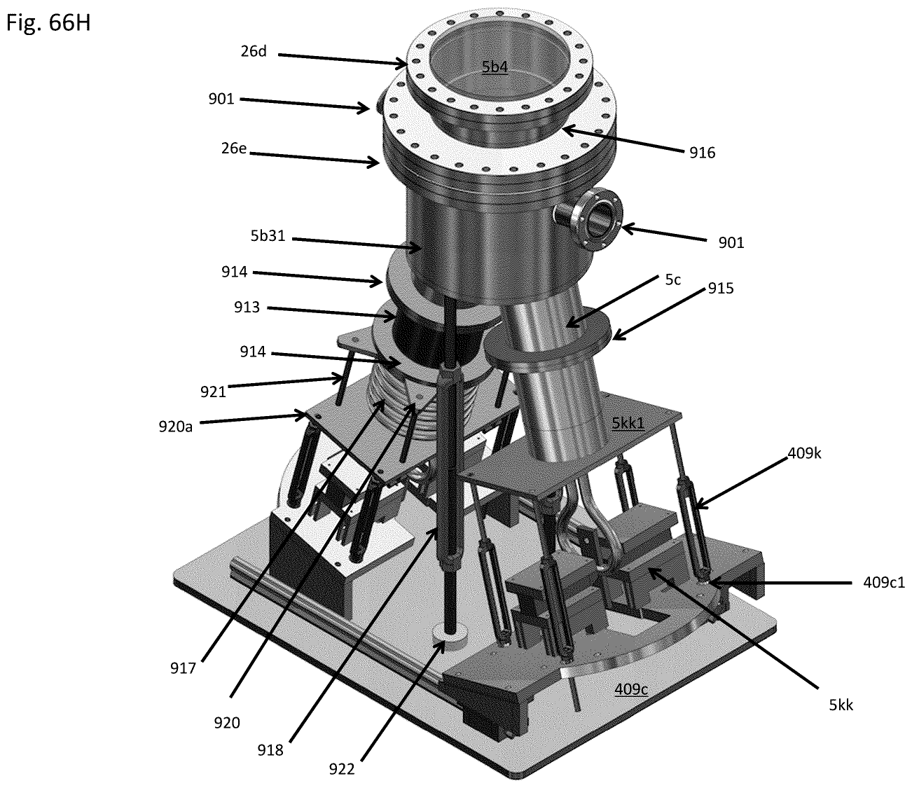

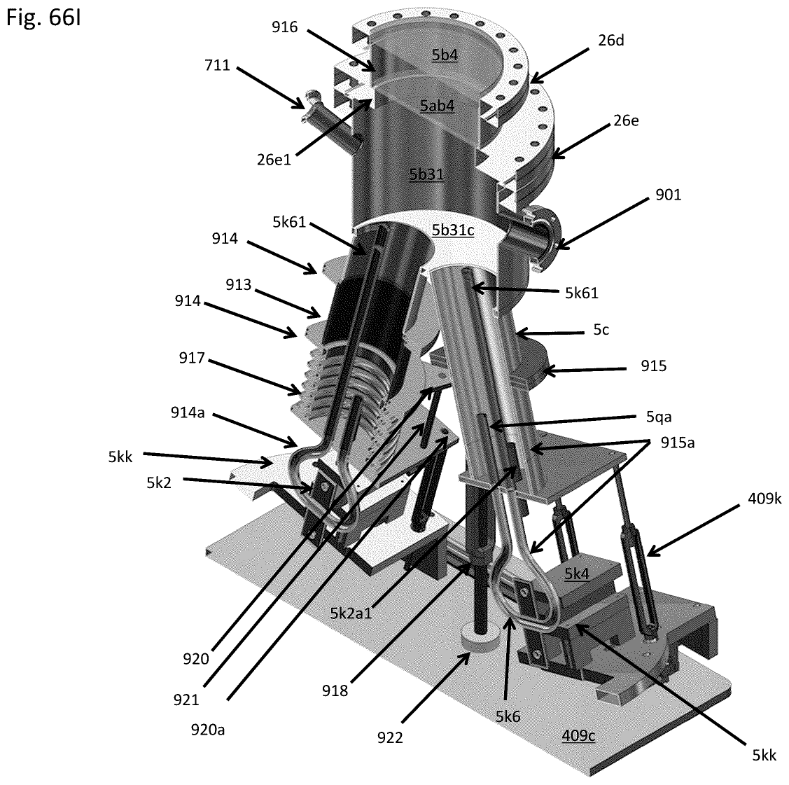

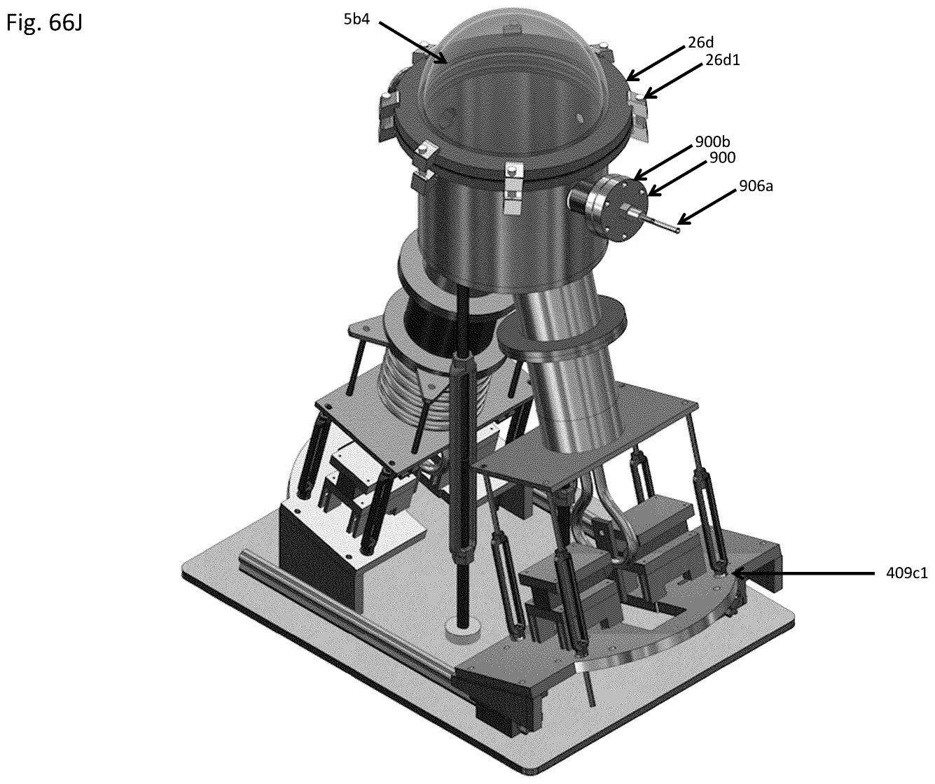

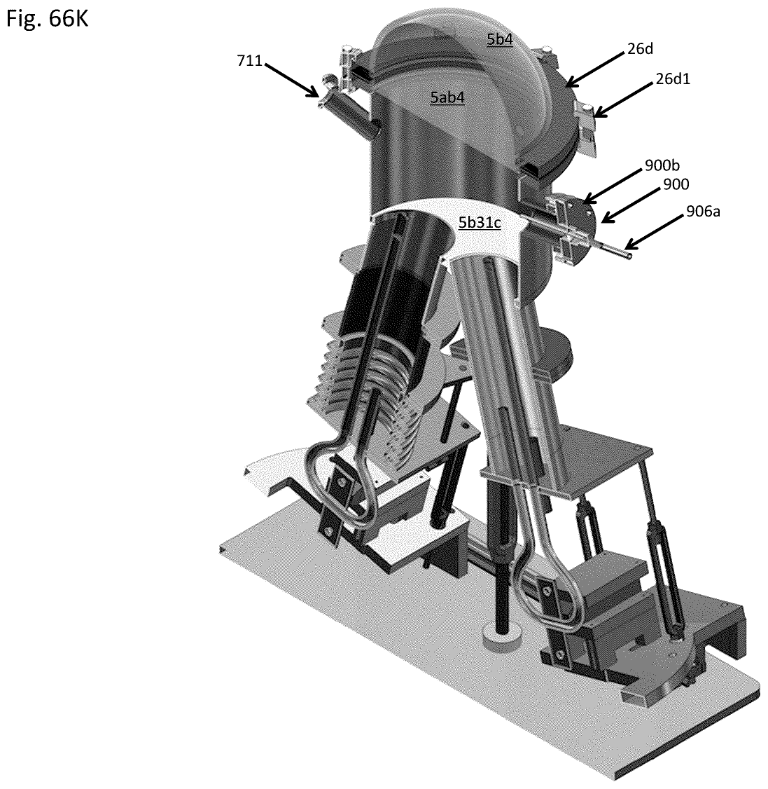

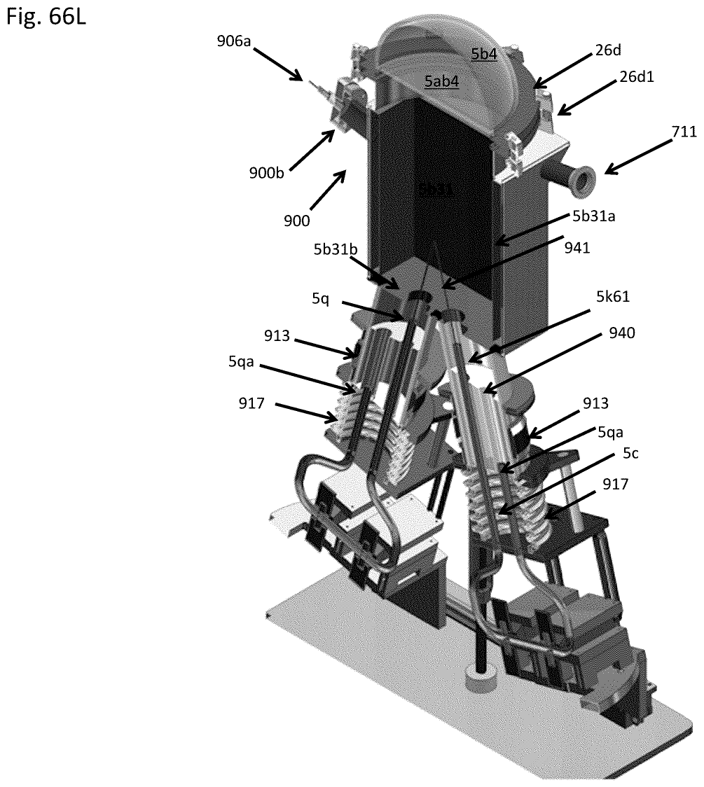

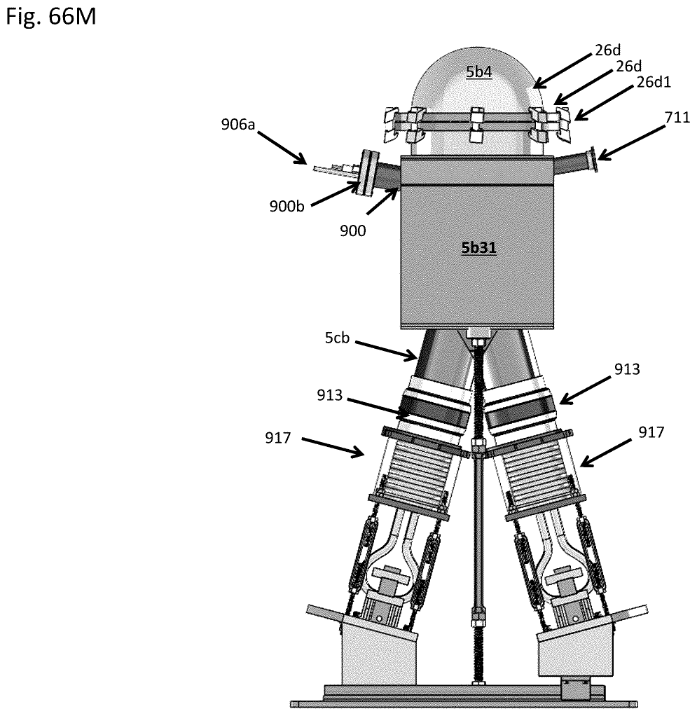

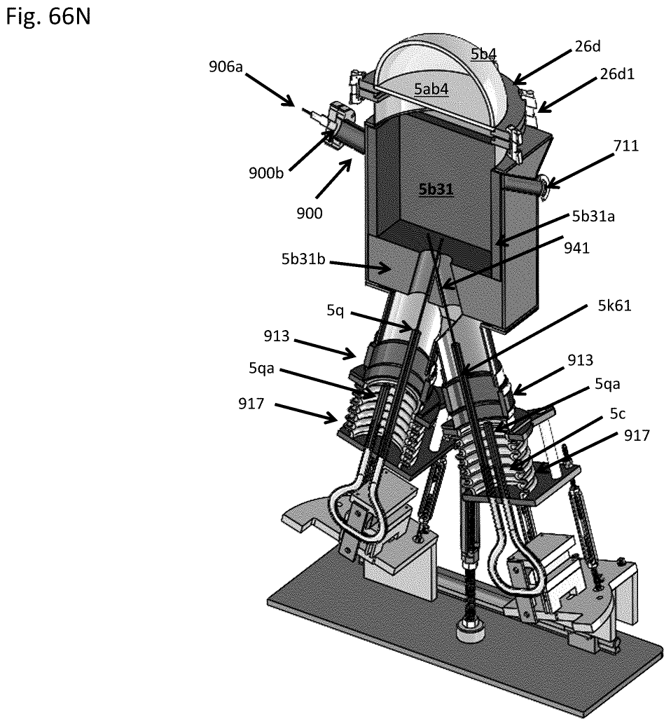

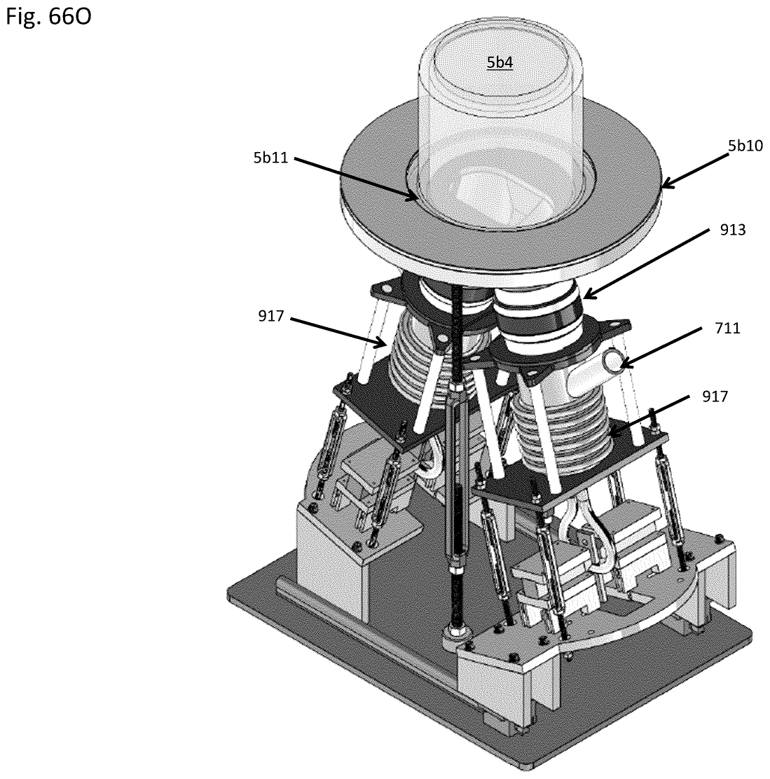

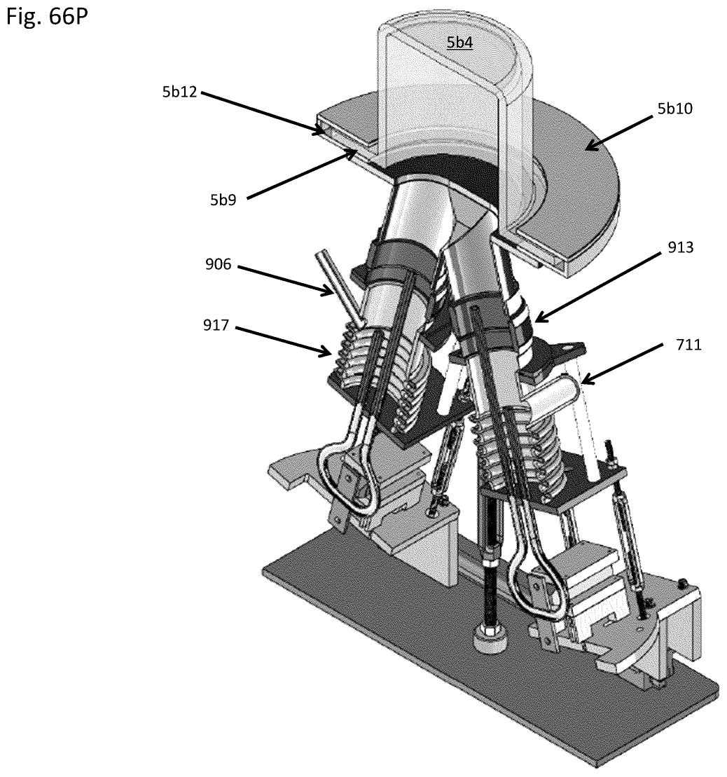

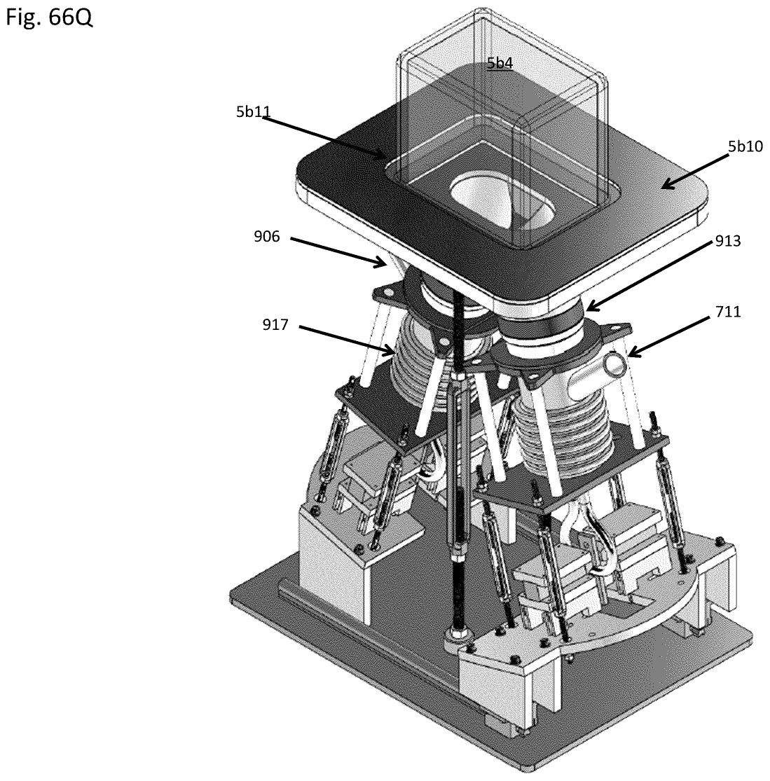

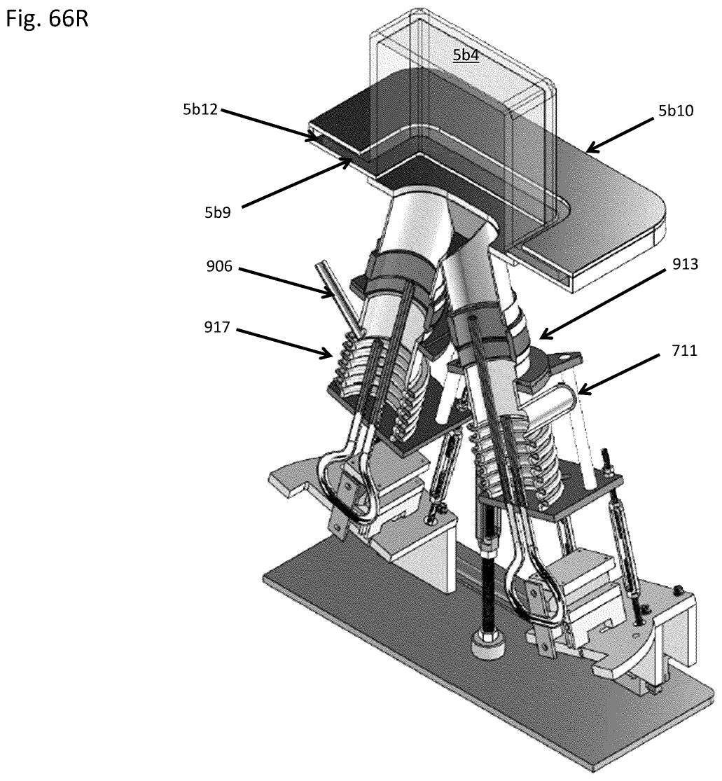

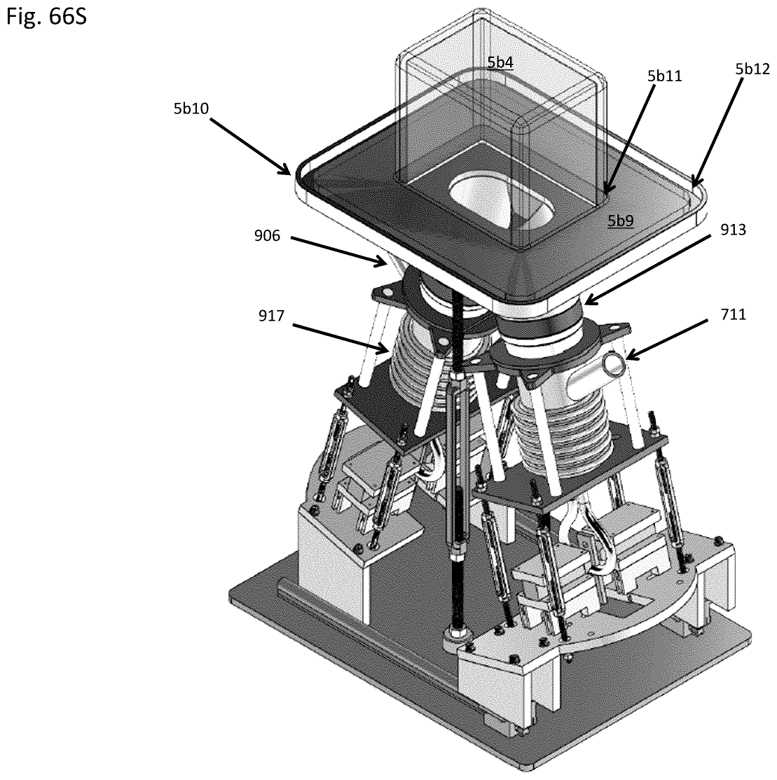

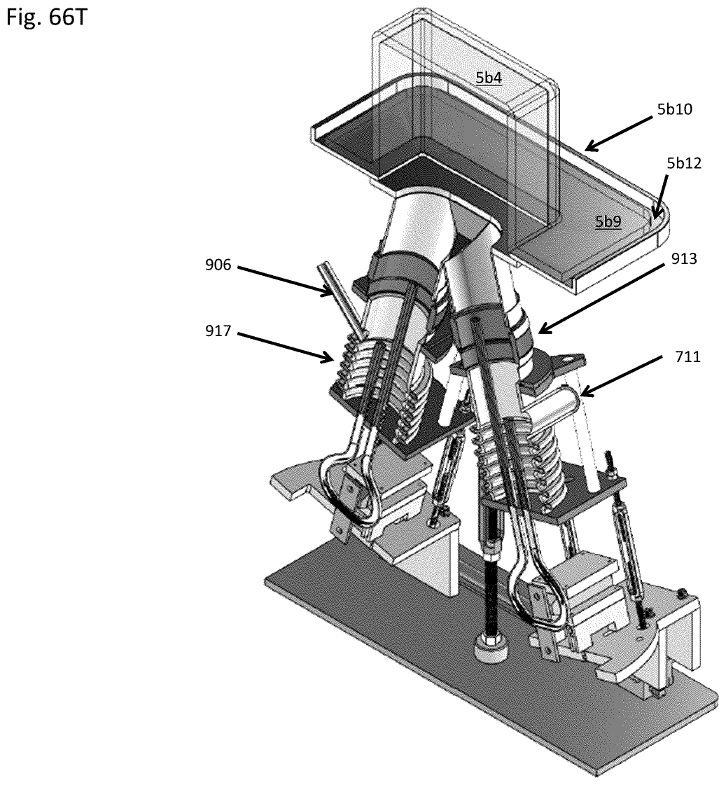

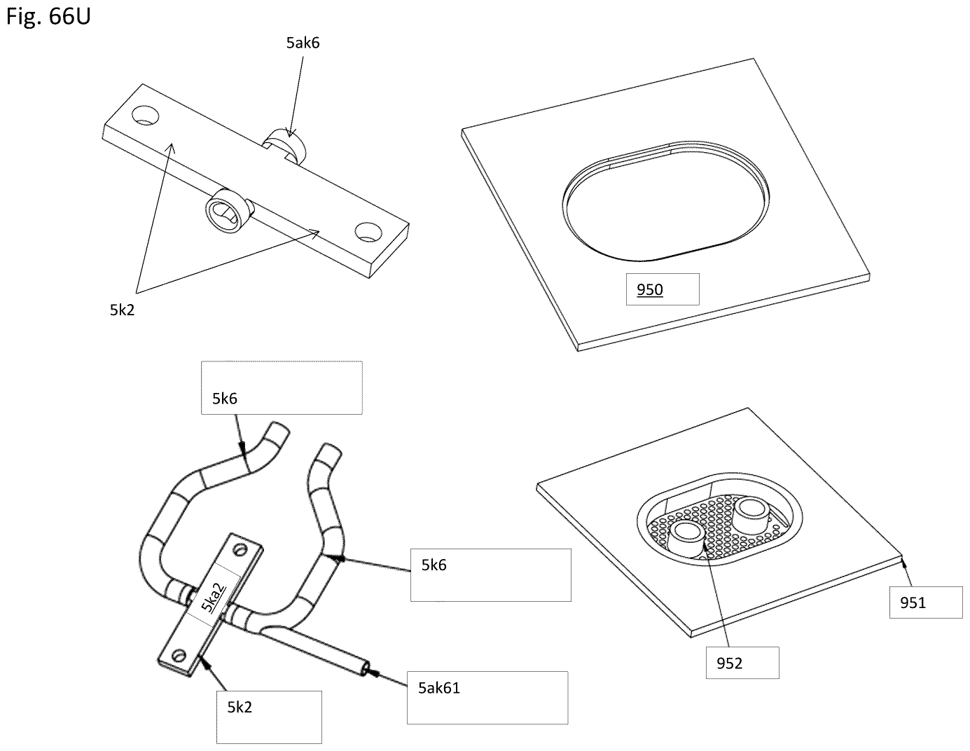

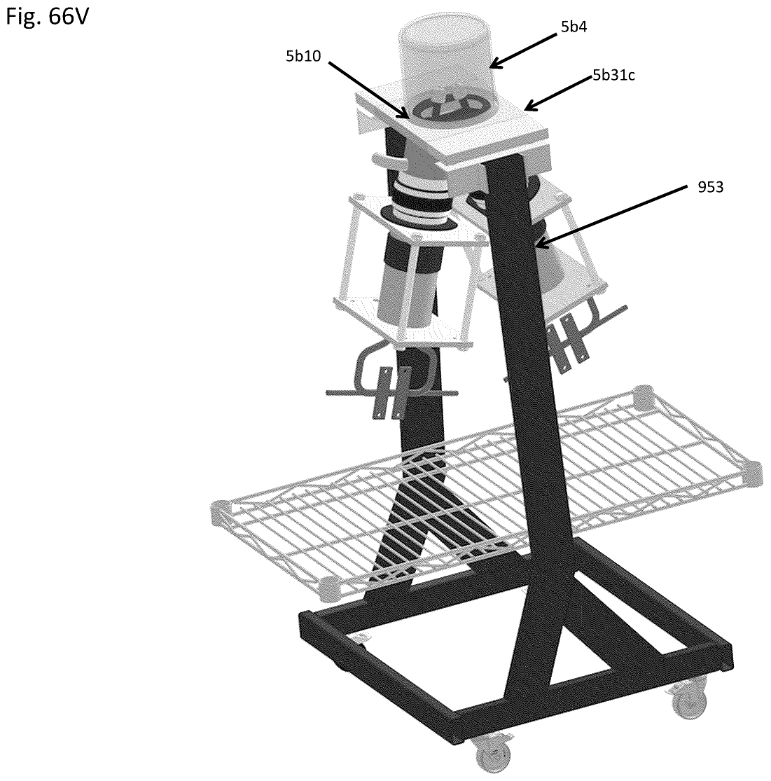

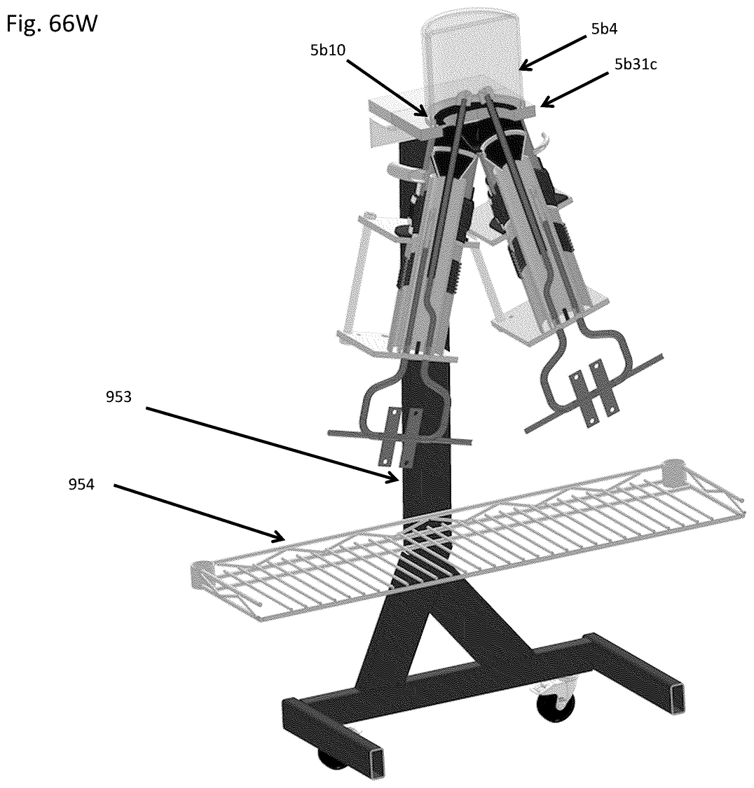

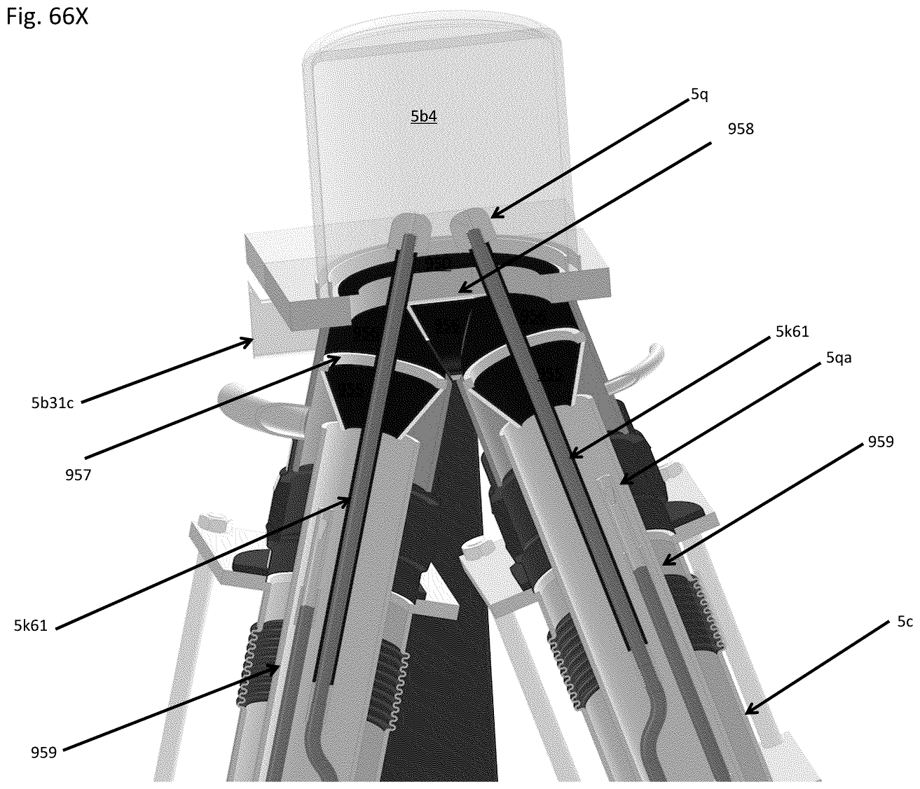

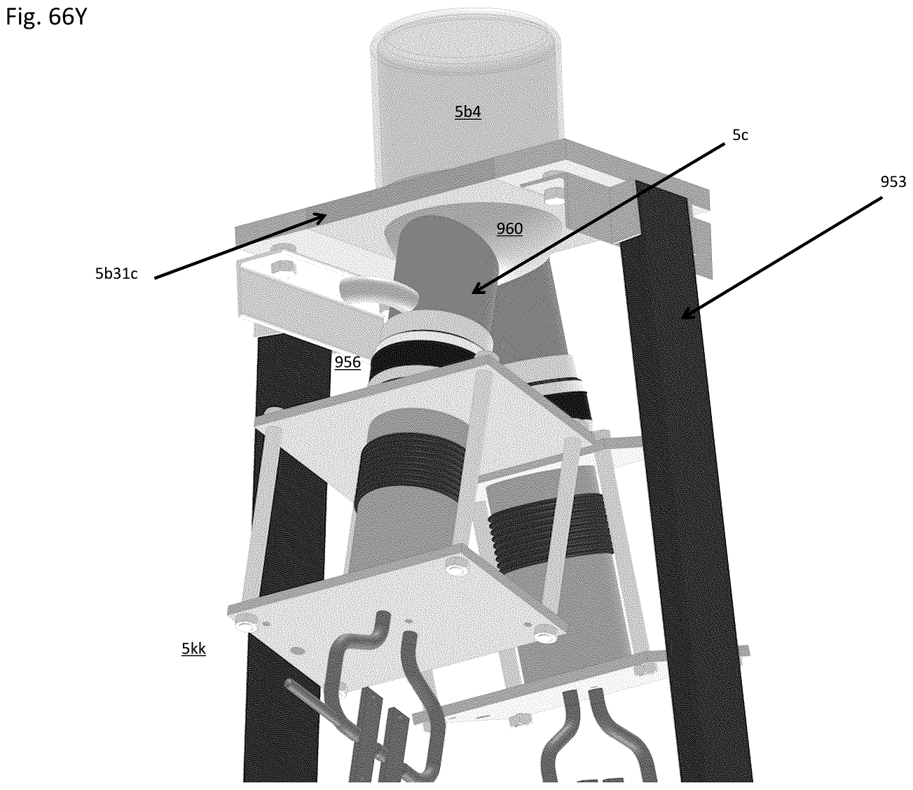

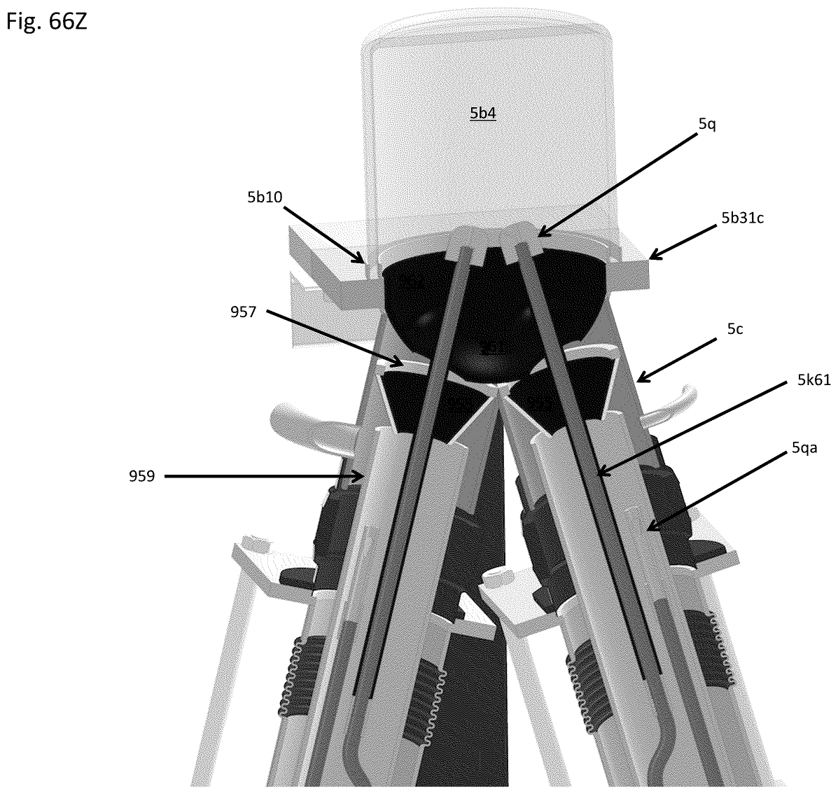

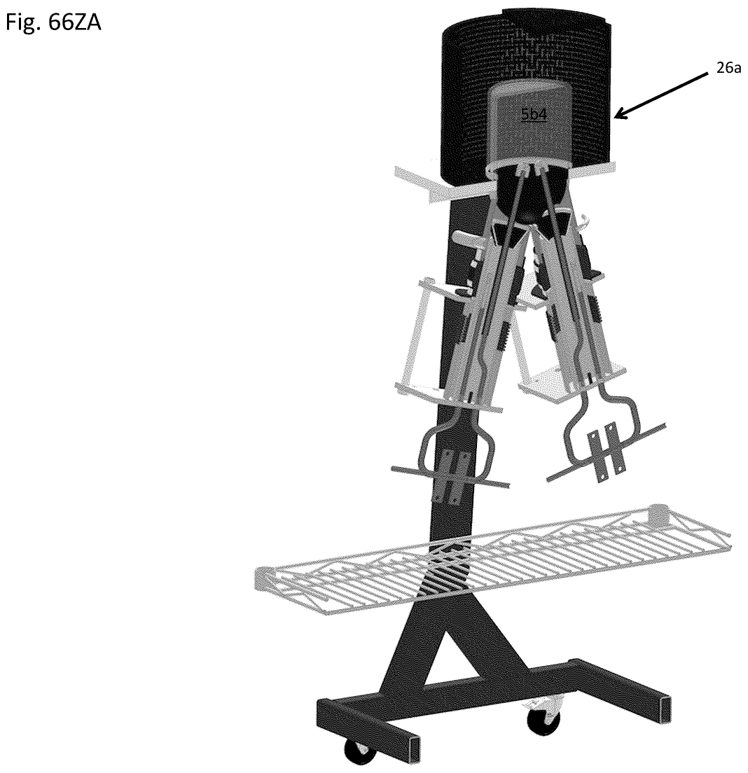

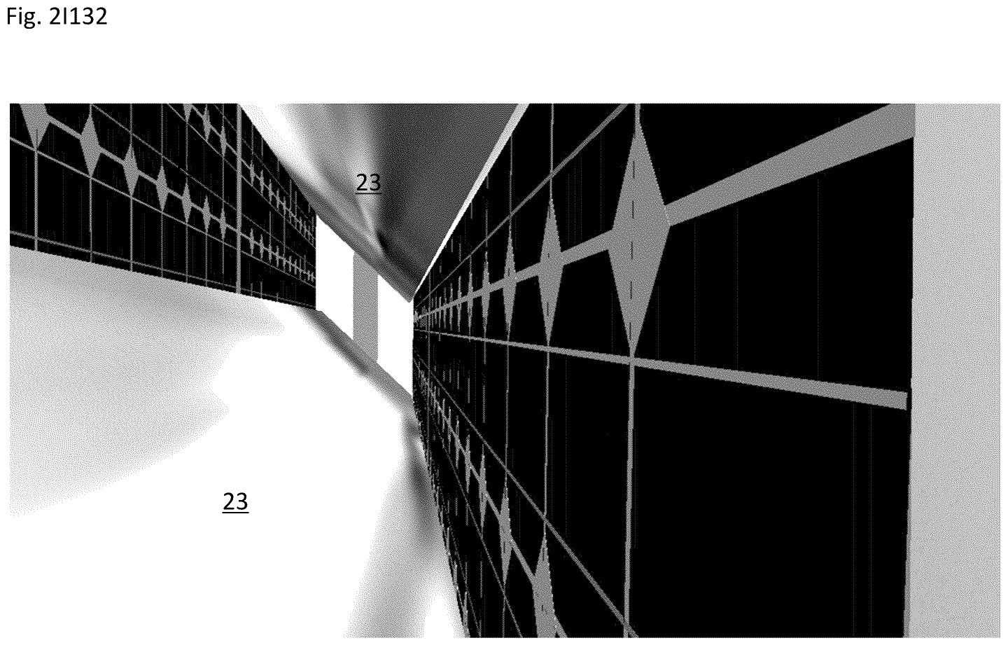

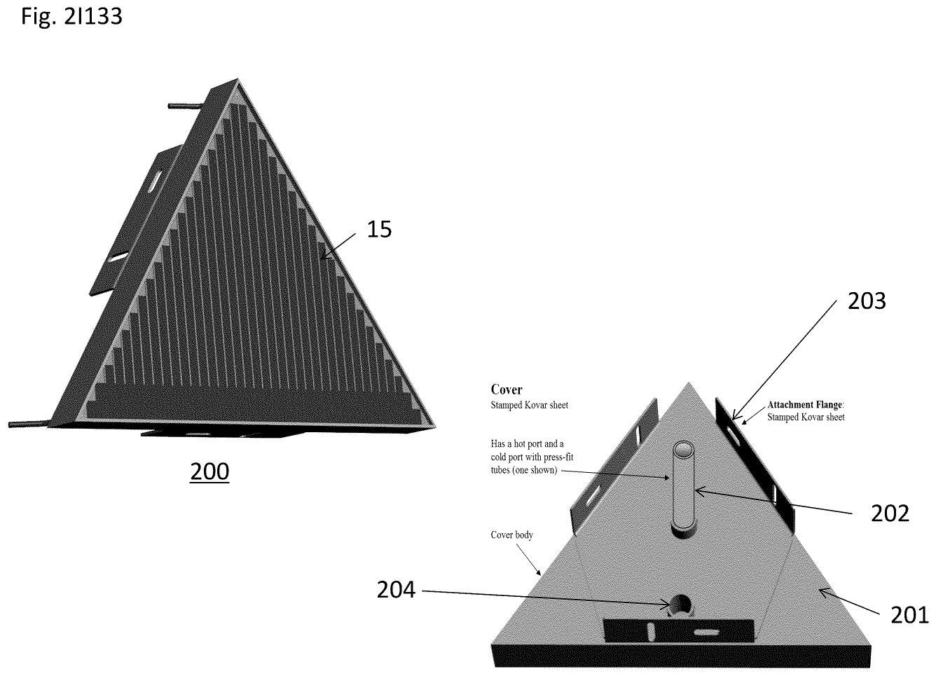

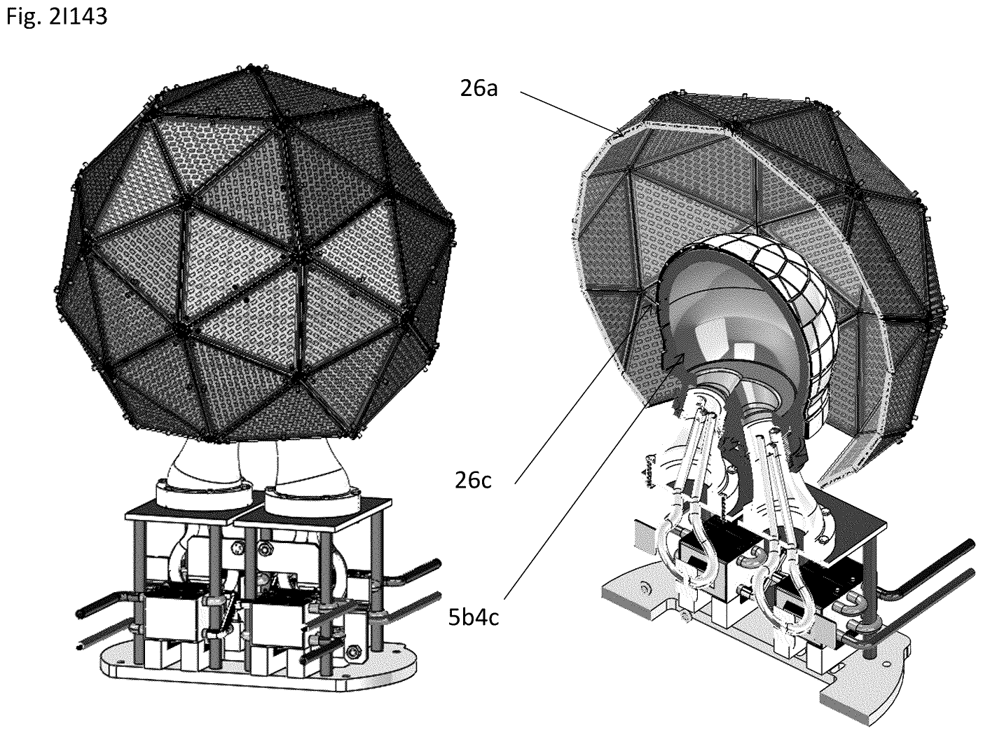

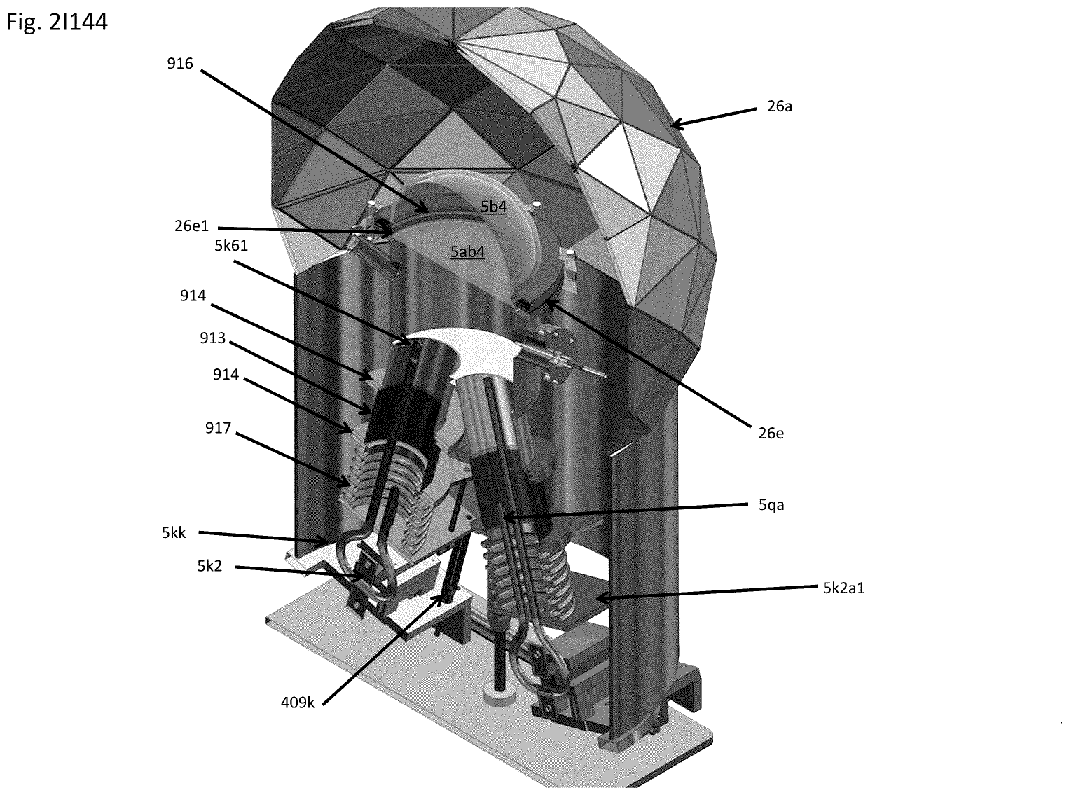

In an embodiment, such as one shown in FIGS. 66C-66N, the SunCell® comprises a two reservoirs 5c, each comprising an electromagnetic (EM) pump such as a DC, AC, or another EM pump of the disclosure and injector that also serves as the ignition electrode and a reservoir inlet riser for leveling the molten metal level in the reservoir. The molten metal may comprise tin, silver, silver-copper alloy, gallium, Galinstan, or another of the disclosure. The SunCell® may further comprise a reaction cell chamber 5b31, electrically isolating flanges between the reservoirs and the reaction cell chamber such as electrically isolating Conflat flanges, and a drip edge at the top of each reservoir to electrically isolate the reservoirs and EM pumps from each other wherein the ignition current flows with contact of intersecting molten metal streams of the two EM pump injectors. In an embodiment, at least one SunCell component such as each reservoir 5c, the reaction cell chamber 5b31, and the inside of the EM pump tube 5k6 are coated with a ceramic or comprise a ceramic liner such as such as one of BN, quartz, titania, alumina, yttria, hafnia, zirconia, silicon carbide, or mixtures such as TiO₂—Yr₂O₃—Al₂O₃, or another of the disclosure. In an embodiment, the SunCell® further comprises an external resistive heater such as heating coils such as Kanthal wire wrapped on the outer surface of at least one SunCell® component. In an embodiment, the outer surface of at least one component of the SunCell such as the reaction cell 5b3, reservoir 5c, and EM pump tube 5k6 is coated with a ceramic to electrically isolate the resistive heater coil such as Kanthal wire wrapped on the surface. In an embodiment, the SunCell® may further comprise at least one of a heat exchanger and thermal insulation that may be wrapped on the surface of at least one SunCell® component. At least one of the heat exchanger and heater may be encased in the thermal insulation.

In an embodiment, the resistive heater may comprise a support for the heating element such as a heating wire. The support may comprise carbon that is hermetically sealed. The sealant may comprise a ceramic such as SiC. The SiC may be formed by reaction of Si with carbon at high temperature in the vacuum furnace.

The SunCell® heater may be a resistive heater or an inductively coupled heater. An exemplary SunCell® heater comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal AF, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater may comprise SiC that may be capable of operating at a temperature of up to 1625° C.

The electromagnetic pumps may each comprise one of two main types of electromagnetic pumps for liquid metals: an AC or DC conduction pump in which an AC or DC magnetic field is established across a tube containing liquid metal, and an AC or DC current is fed to the liquid through electrodes connected to the tube walls, respectively; and induction pumps, in which a travelling field induces the required current, as in an induction motor wherein the current may be crossed with an applied AC electromagnetic field. The induction pump may comprise three main forms: annular linear, flat linear, and spiral. The pumps may comprise others know in the art such as mechanical and thermoelectric pumps. The mechanical pump may comprise a centrifugal pump with a motor driven impeller. The power to the electromagnetic pump may be constant or pulsed to cause a corresponding constant or pulsed injection of the molten metal, respectively. The pulsed injection may be driven by a program or function generator. The pulsed injection may maintain pulsed plasma in the reaction cell chamber. The EM pump may comprise a multistage pump.

In an embodiment, the EM pump tube 5k6 comprises a flow chopper to cause intermittent or pulsed molten metal injection. The chopper may comprise a valve such as an electronically controlled valve that further comprises a controller. The valve may comprise a solenoid valve. Alternatively, the chopper may comprise a rotating disc with at least one passage that rotates periodically to intersect the flow of molten metal to allow the molten metal to flow through the passage wherein the flow in blocked by sections of the rotating disc that do not comprise a passage.

The molten metal pump may comprise a moving magnet pump (MMP). An exemplary commercial AC EM pump is the CMI Novacast CA15 wherein the heating and cooling systems may be modified to support pumping molten metal.

In an embodiment, the EM pump may comprise an AC, inductive type wherein the Lorentz force on the molten metal is produced by a time-varying electric current through the molten metal and a crossed synchronized time-varying magnetic field. The time-varying electric current through the molten metal may be created by Faraday induction of a first time-varying magnetic field produced by an EM pump transformer winding circuit. The source of the first time-varying magnetic field may comprise a primary transformer winding, and the molten metal may serve as a secondary transformer winding such as a single turn shorted winding comprising an EM pump tube section of a current loop and a EM pump current loop return section.

In an embodiment wherein the molten metal injector comprising at least one EM pump comprising a current source and magnets to cause a Lorentz pumping force, the EM pump magnets 5k4 may comprise permanent or electromagnets such as DC or AC electromagnets. In the case that the magnets are permanent magnets or DC electromagnets, the EM pump current source comprises a DC power source. In the case that the magnets 5k4 comprise AC electromagnets, the EM pump current source for the EM bus bars 5k2 comprises an AC power source that provides current that is in phase with AC EM pump electromagnet field applied to the EM pump tube 5k6 to produce a Lorentz pumping force. In an embodiment wherein the magnet such as an electromagnet is immersed in a coolant that is corrosive such as a water bath, the magnet such as an electromagnet may be hermetically sealed in a sealant such as a thermoplastic, a coating, or a housing that may be non-magnetic such as a stainless-steel housing.

In another embodiment, the ignition system comprises an induction system wherein the source of electricity applied to the conductive molten metal to cause ignition of the hydrino reaction provides an induction current, voltage, and power. The ignition system may comprise an electrode-less system wherein the ignition current is applied by induction by an induction ignition transformer assembly. The induction current may flow through the intersecting molten metal streams from the plurality of injectors maintained by the pumps such as the EM pumps. In an embodiment, the reservoirs 5c may further comprise a ceramic cross connecting channel such as a channel between the bases of the reservoirs 5c. The induction ignition transformer assembly may comprise an induction ignition transformer winding and an induction ignition transformer yoke that may extend through the induction current loop formed by the reservoirs 5c, the intersecting molten metal streams from the plurality of molten metal injectors, and the cross-connecting channel. The induction ignition transformer assembly may be similar to that of the EM pump transformer winding circuit.

In an embodiment, the heater to melt the molten metal comprises a resistive heater such as one comprising wire such as Kanthal or other of the disclosure. The resistive heater may comprise a refractory resistive filament or wire that may be wrapped around the components to be heated. Exemplary resistive heater elements and components may comprise high temperature conductors such as carbon, Nichrome, 300 series stainless steels, Incoloy 800 and Inconel 600, 601, 718, 625, Haynes 230, 188, 214, Nickel, Hastelloy C, titanium, tantalum, molybdenum, TZM, rhenium, niobium, and tungsten. The filament or wire may be potted in a potting compound to protect it from oxidation. The heating element as filament, wire, or mesh may be operated in vacuum to protect it from oxidation. An exemplary heater comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Another exemplary filament is Kanthal APM that forms a non-scaling oxide coating that is resistant to oxidizing and carburizing environments and can be operated to 1475° C. The heat loss rate at 1375 K and an emissivity of 1 is 200 kW/m² or 0.2 W/cm². Commercially available resistive heaters that operate to 1475 K have a power of 4.6 W/cm². The heating may be increased using insulation external to the heating element.

An exemplary heater 415 comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal AF, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater 415 may comprise SiC that may be capable of operating at a temperature of up to 1625° C. The heater may comprise insulation to increase at least one of its efficiency and effectiveness. The insulation may comprise a ceramic such as one known by those skilled in the art such as an insulation comprising alumina-silicate. The insulation may be at least one of removable or reversible. The insulation may be removed following startup to more effectively transfer heat to a desired receiver such as ambient surroundings or a heat exchanger. The insulation may be mechanically removed. The insulation may comprise a vacuum-capable chamber and a pump, wherein the insulation is applied by pulling a vacuum, and the insulation is reversed by adding a heat transfer gas such as a noble gas such as helium. A vacuum chamber with a heat transfer gas such as helium that can be added or pumped off may serve as adjustable insulation.

The ignition current may be time varying such as about 60 Hz AC, but may have other characteristics and waveforms such as a DC or AC waveform having a frequency in at least one range of 1 Hz to 1 MHz, 10 Hz to 10 kHz, 10 Hz to 1 kHz, and 10 Hz to 100 Hz, a peak current in at least one range of about 1 A to 100 MA, 10 A to 10 MA, 100 A to 1 MA, 100 A to 100 kA, and 1 kA to 100 kA, and a peak voltage in at least one range of about 1 V to 1 MV, 2 V to 100 kV, 3 V to 10 kV, 3 V to 1 kV, 2 V to 100 V, and 3 V to 30 V wherein the waveform may comprise a sinusoid, a square wave, a triangle, or other desired waveform that may comprise a duty cycle such as one in at least one range of 1% to 99%, 5% to 75%, and 10% to 50%. To minimize the skin effect at high frequency, the windings of the ignition system may comprise at least one of braided, multiple-stranded, and Litz wire. In an embodiment, the ignition power waveform such as a periodic square wave of ignition current, as well as the frequency and duty cycle are selected to optimize at least one of the output power and power gain given by the ratio of the power output and the ignition power. An exemplary frequency square wave waveform is in the range of 1 to 500 Hz. In another exemplary embodiment, the ignition power comprises a repeated pattern of different currents over time such as square waves that alternative between a high current such as 1500A and a low current such as 500A wherein the square wave widths of high and low currents may be the same or different.

### Power System and Configuration

At least a portion of the injector EM pump tube 5k61 and the nozzle 5q may comprise carbon wherein an EM pump tube section such as one in contact with the molten metal such as tin may comprise a metal such as stainless steel, W, or Ta to conduct ignition electrical current. The carbon may comprise a hard form such as glassy carbon or comprise a hard coating such as pyrolytic-coated or CalCoat-coated carbon. In an exemplary embodiment, the carbon portion of the EM pump tube or nozzle may be connected to the metal section of EM pump tube using a coupler by gluing the parts together using a glue such as Aremco Products Graphitic Bond 551RN. The carbon may be coated with a coating such as a pyrolytic carbon coating. In another embodiment, at least a portion of the injector EM pump tube 5k61 and the nozzle 5q may comprise and oxide coat such as tungsten oxide or Ta oxide on W and Ta components, respectively. In an embodiment, the injector EM pump tube 5k61 comprises a carbon-to-metal nozzle coupler to connect the carbon nozzle to a metal section of the EM pump tube by means such as a potting compound or glue. The couple may a carbide that is favorable to forming a bond with the nozzle and avoids forming a carbide that is related to corrosion of the coupler. An exemplary material of the latter case is at least one of W, Ta, and Ni. At least one nozzle such as the positive nozzle may be submerged.

In an embodiment, at least a portion of the injector EM pump tube 5k61 and the nozzle 5q such as ones comprising W may be covered or sheathed with a material such as quartz, BN, alumina, carbon, or another ceramic such as one of the disclosure to reduce or prevent at least one of conduction on the outer surface and recombination of hydrino plasma ions and electrons. In an embodiment, at least a portion of the reaction cell chamber walls may comprise a conductive surface to facilitate hydrino plasma ion-electron recombination. Exemplary surfaces are a liquid wall or floor comprising the molten metal and at least one refractory metal plate such as at least one W plate that may be clean metal. The preferential ion-electron recombination in the reaction cell chamber may prevent the hydrino reaction plasma from concentrating in the reservoir such as the positive reservoir.

In an embodiment, the separation distance between the injector electrodes is minimized to minimize the ignition voltage. The nozzles may be recessed in the reservoirs to minimize the exposure to plasma that would cause them to be thermally damaged. The extent of submersion may be determined by a balance between thermal protect and avoiding an excessive ignition voltage due to the increased electrode separation with distance wherein at least one of a large separation distance and high ignition voltage may cause an undesired outcome of the plasma being localized in at least one reservoir such as the positive reservoir. In an embodiment an inert gas such as argon may be added to the reaction mixture at sufficient pressure such as one in the range of about 0.1 torr to 5 atm to prevent the plasma from localizing in at least one reservoir.

In an embodiment, the area of the nozzle may be increased to increase the radiative heat loss to prevent thermal damage. The nozzle emissivity may be maximized by means such as surface oxidation or roughening to maximize the radiation. In an exemplary embodiment, the nozzle may comprise a large heavy surface roughened or oxidized W disc or cylinder such as one having a mass in the range of about 10 g to 2 kg with a nozzle cone in the center. In another embodiment, the electrode may comprise at least a partial liquid or hybrid solid-liquid electrode. The nozzle may comprise a pool for molten metal wherein the molten metal may serve to cool the nozzle. In an alternative embodiment, the injector electrode may comprise a large ejection hole in the center of the nozzle and further comprise a plurality of smaller holes or pinholes around the perimeter of the nozzle and the injection EM pump tube. The nozzle outlet hole may comprise other geometries other than round such as polygonal, fan, star pattern and other known in the art to produce a desired geometry of ejected stream such as a circular cross-sectional stream or a stream that is spread or distributed in at least one of space and time. The high ignition current may create a magnetic pinch effect forcing the pinhole flow parallel to the injector EM pump tube and nozzle flow to maintain a molten metal on the nozzle to serve to protect the nozzle from plasma and thermal damage.

In an embodiment, at least one nozzle may comprise a polarity of outlets such as ones that connect to a central channel that connects to the EM pump tube to inject a plurality of molten metal streams. The nozzle may comprise a larger central outlet and a plurality of other outlets such as circumferential ones to the central outlet that may be positioned on a flat-topped nozzle. The plurality of streams may inject molten metal into the hydrino reaction plasma to at least one of decrease the ignition voltage and increase the effectiveness of the injected molten metal to clean the PV window or PV window cavity.

In another embodiment, the nozzles may comprise W of sufficient thermal mass such as mass in the range of about 10 g to 1 kg such that they do not melt when the nozzles are recessed in the reservoirs by a distance such as one in the range of 0.5 mm to 10 cm from the top of the baseplate liner 5b31b. In another embodiment, the top of the reservoir such as the positive reservoir may comprise a metal screen or grid such as a refractory one such as a W grid that shields the nozzle from the plasma electric field while allowing for return molten metal and injection metal flows.

In an embodiment, at least one seal between components of the SunCell may comprise a wet seal. The wet seal may comprise a seal formed by a molten solid that is confined by the same or another solid confinement material. The solid confinement material may flow as a liquid into a void between two components to be sealed together, fill the void, and solidify to confine the molten solid which forms a seal between two components (e.g. a seal comprising molten tin confined by solid tin in a gap between two components that are sealed by the molten tin). The wet seal may comprise at least one of a heater, a chiller, temperature sensors, and a controller to maintain the molten (liquid) and solid phases of the wet seal.

In an embodiment, hydrogen may be supplied to the cell through a hydrogen permeable membrane such as a structurally reinforced Pd—Ag or niobium membrane. The hydrogen permeation rate through the hydrogen permeable membrane may be increased by maintaining plasma on the outer surface of the permeable membrane. The SunCell® may comprise a semipermeable membrane that may comprise an electrode of a plasma cell such as a cathode of a plasma cell (e.g., a glow discharge cell). The SunCell® such as one shown in FIG. 66C may further comprise an outer sealed plasma chamber comprising an outer wall surrounding a portion of the wall of cell 5b31 wherein a portion of the metal wall of the cell 5b31 comprises an electrode of the plasma cell. The sealed plasma chamber may comprise a chamber around the cell 5b31 such as a housing wherein the wall of cell 5b31 may comprise a plasma cell electrode and the housing or an independent electrode in the chamber may comprise the counter electrode. The SunCell® may further comprise a plasma power source, and plasma control system, a gas source such as a hydrogen gas supply tank, a hydrogen supply monitor and regular, and a vacuum pump.

The system may operate via the production of two plasmas. An initial reaction mixture such as a non-stoichiometric H₂/O₂ mixture (e.g., an H₂/O₂ having less than 20% or less than 10% or less than 5% or less than 3% O₂ by mole percentage of the mixture) may pass through a plasma cell such as a glow discharge to create a reaction mixture capable of undergoing the catalytic reactions with sufficient exothermicity to produce a plasma as described herein. For example, a non-stoichiometric H₂/O₂ mixture may pass through a glow discharge to produce an effluence of atomic hydrogen and nascent H₂O (e.g., a mixture having water at a concentration and with an internal energy sufficient to prevent formation of hydrogen bonds). The glow discharge effluence may be directed into the reaction chamber where a current is supplied between two electrodes (e.g., with a molten metal passed therebetween). Upon interaction of the effluence with the biased molten metal (e.g., gallium or tin), the catalytic reaction between the nascent water and the atomic hydrogen is induced, for example, upon the formation of arc current. The power system may comprise:
a) a plasma cell (e.g., glow discharge cell);
b) a set of electrodes in electrical contact with one another via a molten metal flowing therebetween such that an electrical bias may be applied molten metal;
c) a molten metal injection system which flows the molten metal between the electrodes;
   wherein the effluence of the plasma cell is oriented towards the biased molten metal (e.g., the positive electrode or anode).

The SunCell may comprise a transparent window to serve as a light source of wavelengths transparent to the window. The SunCell may comprise a blackbody radiator 5b4c that may serve as a blackbody light source. In an embodiment, the SunCell® comprises a light source (e.g., the plasma from the reaction) wherein the hydrino plasma light emitted through the window is utilized in a desired lighting application such as room, street, commercial, or industrial lighting or for heating or processing such as chemical treatment or lithography.

In an embodiment, the source of electrical power or ignition power source comprises a non-direct current (DC) source such as a time dependent current source such as a pulsed or alternating current (AC) source. The peak current may be in at least one range such as 10 A to 100 MA, 100 A to 10 MA, 100 A to 1 MA, 100 A to 100 kA, 100 A to 10 kA, and 100 A 10 to 1 kA. The peak voltage may be in at least one range of 0.5 V to 1 kV, 1 V to 100 V, and 1 V to 10 V. In an embodiment, the EM pump power source and AC ignition system may be selected to avoid inference that would result in at least one of ineffective EM pumping and distortion of the desired ignition waveform.

In an embodiment, the source of electrical power to supply the ignition current or ignition power source may comprise at least one of a DC, AC, and DC and AC power supply such as one that is powered by at least one of AC, DC, and DC and AC electricity such as a switching power supply, a variable frequency drive (VFD), an AC to AC converter, a DC to DC converter, and AC to DC converter, a DC to AC converter, a rectifier, a full wave rectifier, an inverter, a photovoltaic array generator, magnetohydrodynamic generator, and a conventional power generator such as a Rankine or Brayton-cycle-powered generator, a thermionic generator, and a thermoelectric generator. The ignition power source may comprise at least one circuit element such as a transition, IGBT, inductor, transformer, capacitor, rectifier, bridge such as an H-bridge, resistor, operation amplifier, or another circuit element or power conditioning device known in the art to produce the desired ignition current. In an exemplary embodiment, the ignition power source may comprise a full wave rectified high frequency source such as one that supplies positive square wave pulses at about 50% duty cycle or greater. The frequency may be in the range of about 60 Hz to 100 kHz. An exemplary supply provides about 30-40 V and 3000-5000 A at a frequency in the range of about 10 kHz to 40 kHz. In an embodiment, the electrical power to supply the ignition current may comprise a capacitor bank charged to an initial offset voltage such as one in the range of 1 V to 100 V that may be in series with an AC transformer or power supply wherein the resulting voltage may comprise DC voltage with AC modulation. The DC component may decay at a rate dependent on its normal discharge time constant, or the discharge time may be increased or eliminated wherein the ignition power source further comprises a DC power supply that recharges the capacitor bank. The DV voltage component may assist to initiate the plasma wherein the plasma may thereafter be maintained with a lower voltage. The ignition power supply such as a capacitor bank may comprise a fast switch such as one controlled by a servomotor or solenoid to connect and disconnect ignition power to electrodes.

The hydrino reaction rate may increase with current; however sustained high current and power may thermally damage the SunCell. The SunCell ignition power source may comprise a charging power supply, a capacitor bank such as one comprised of a plurality of supercapacitors, a voltage sensor, a controller, and an ignition switch. To avoid the thermal damage while achieving high hydrino reaction kinetics, high current may be applied intermittently. This intermittent application of ignition current may be achieved by continuously charging a capacitor bank with a power supply such as a DC power supply. Activation of the ignition switch may discharge the and then discharging the capacitor bank by activating the ignition switch to discharge from a first voltage set point to a second lower voltage set point controlled by the controller in response to the voltage sensor. For example, the first and second voltage setpoints may be chosen such that wherein the peak ignition current during capacitor discharge is greater than the charging current provided by the DC power supply.

In an embodiment, at least one of the hydrino plasma and ignition current may comprise an arc current. An arc current may have the characteristic that the higher the current, the lower the voltage. In an embodiment, at least one of the reaction cell chamber walls and the electrodes are selected to form and support at least one of a hydrino plasma current and an ignition current that comprises an arc current, one with a very low voltage at very high current. The current density may be in at least one range of about 1 A/cm² to 100 MA/cm², 10 A/cm² to 10 MA/cm², 100 A/cm² to 10 MA/cm², and 1 kA/cm² to 1 MA/cm².

In an embodiment, the SunCell® comprises a vacuum system comprising an inlet to a vacuum line, a vacuum line, a trap, and a vacuum pump. The vacuum pump may comprise one with a high pumping speed such as a root pump, scroll, or multi-lobe pump. The vacuum system may be capable of at least one of ultrahigh vacuum and maintaining a reaction cell chamber operating pressure in at least one low range such as about 0.01 Torr to 500 Torr, 0.1 Torr to 50 Torr, 1 Torr to 10 Torr, and 1 Torr to 5 Torr. The pressure may be maintained low in the case of at least one of (i) H₂ addition with trace HOH catalyst supplied as trace water or as O₂ that reacts with H₂ to form HOH and (ii) H₂O addition. In the case that noble gas such as argon is also supplied to the reaction mixture, the pressure may be maintained in at least one high operating pressure range such as about 100 Torr to 100 atm, 500 Torr to 10 atm, and 1 atm to 10 atm wherein the argon may be in excess compared to other reaction cell chamber gases. The argon pressure may increase the lifetime of at least one of HOH catalyst and atomic H and may prevent the plasma formed at the electrodes from rapidly dispersing so that the plasma intensity is increased.

In an embodiment, the vacuum pump may comprise at least one of a (i) positive displacement, momentum transfer, and entrapment pump, (ii) mechanical pump such as a scroll, rotary vane, dry screw, diaphragm, molecular drag, turbo, or root pump, (iii) a cryopump, and (iv) a hydrogen recombiner that reacts with the flowing hydrogen from at least one of the reaction cell chamber 5b31, PV window cavity 5b5, and the reservoirs 5c to form water. The vacuum pump may comprise a plurality of pumps that may be connected in at least one of series and parallel. The recombiner may comprise at least one of a supported catalyst such as a noble or transition metal such Pt, Pd, Ir, or Ni on a high surface area support such as alumina or silica, Raney nickel, a hot catalytic surface such as a heated W, noble metal, or Ni filament, and an oxidant such as oxygen or CuO. The supported catalyst may be heated for activation. In an alternative embodiment, the H₂/O₂ recombiner comprises a plasma source such as a glow discharge, microwave, radio frequency (RF), inductively or capacitively-coupled RF plasma or another plasma cell known in the art. The oxygen may be mixed with the hydrogen as a vacuum pump ballast gas. The water may be pumped away or removed by at least one of a vacuum pump such as a mechanical one, a cryopump, and an a chemical absorbent such as a hydroscopic one such as a desiccant such as silica gel, activated charcoal, calcium sulfate, calcium chloride, and molecular sieves (typically, zeolites), and others known in the art.

In an embodiment, the SunCell® may comprise a (i) gas recirculation system with a gas inlet and an outlet, (ii) a gas separation system such as one capable of separating at least two gases of a mixture of at least two of a noble gas such as argon, O₂, H₂, H₂O, air, and hydrino gas, (iii) at least one noble gas, O₂, H₂, and H₂O partial pressure sensors, (iv) flow controllers, (v) at least one injector such as a microinjector or mass flow controller such as one that injects water or water vapor, (vi) at least one valve, (vii) a pump, (viii) an exhaust gas pressure and flow controller, and (ix) a computer to maintain at least one of the noble gas, argon, O₂, H₂, H₂O, and hydrino gas pressures. The recirculation system may comprise a semipermeable membrane to allow at least one gas such as molecular hydrino gas to be removed from the recirculated gases. In an embodiment, at least one gas such as the noble gas may be selectively recirculated while at least one gas of the reaction mixture may flow out of the outlet and may be exhausted through an exhaust.

In an embodiment, the pressure sensor may comprise at least one of (i) a thermal conductivity type such as a Pirani gauge such as an MKS Series 925 MicroPirani™ Vacuum Pressure Transducer, (ii) a capacitance type such as an MKS 600 Series absolute analog Baratron® capacitance manometer, and (iii) a piezoresistive gauge such as an MKS Series 902B Piezo transducer. The Pirani type gauge may be calibrated for the SunCell gas such as hydrogen. In an embodiment, the gauge may comprise a plurality of different sensors in the same or separate gauges used in combination. An exemplary embodiment of a combination piezoresistive and capacitance gauge comprises the DCP Quantum DuoSENS Capacitive Piezo Vacuum Sensor 0.01 to 1000 Torr, that is gas independent. To be compatible with temperature limitations of the gauge, the evacuated gases may be cooled by means such a water bath, forced air, heat sinks such as copper or aluminum blocks with optional coolant fins such as air fins, and a heat exchanger such as one that uses a heat exchanger and circulating coolant used to cool the EM pump magnets.

In an embodiment, the SunCell comprises a means to record plasma spectral emission such as a spectrometer and at least one mass flow controller. At least one component of the hydrino reaction mixture such as at least one of oxygen, hydrogen, water vapor, air, and an inert gas is controlled by monitoring at least one characteristic spectral emission with the spectrometer wherein the intensity or relative intensity to at least one other characteristic plasma emission is used to control the flow of the component by the mass flow controller.

In an embodiment, the SunCell® may be operated prominently closed with addition of at least one of the reactants H₂, O₂, and H₂O wherein the reaction cell chamber atmosphere comprises the reactants as well as optionally a noble gas such as argon. The total gas may be maintained in a desired pressure range such as in the range of about 0.1 Torr to 100 atm. In an exemplary embodiment, the pressure is maintained in the range of about 1 to 10 Torr by a control system such as one comprising a processor and one or more pressure sensors, gas flow controllers, valves, and gas sources. The atmosphere may be at least one of continuously and periodically or intermittently exhausted or recirculated by the recirculation system. The exhausting may remove at least one of hydrino gas and excess oxygen. The addition of reactant O₂ with H₂ may be such that O₂ is a minor species and essentially forms HOH catalyst as it is injected into the reaction cell chamber with excess H₂. A torch may inject the H₂ and O₂ mixture that immediately reacts to form HOH catalyst and excess H₂ reactant.

In an embodiment, the gas pressure in the reaction cell chamber may be at least partially controlled by controlling at least one of the pumping rate and the recirculation rate. At least one of these rates may be controlled by a valve controlled by a pressure sensor and a controller. Exemplary valves to control gas flow are solenoid valves that are opened and closed in response to an upper and a lower target pressure and variable flow restriction vales such as butterfly and throttle valves that are controlled by a pressure sensor and a controller to maintain a desired gas pressure range.

Removal of molecular hydrino product may be further increased by increasing the vacuum pumping rate. The SunCell such as one shown in FIGS. 66O-66T may comprise a plurality of vacuum ports such as 711 connected to one or more vacuum pumps. In an embodiment, at least one of the EM pumping rate and capacity may be increased to serve as a dripping metal vacuum pump. The molecular hydrino absorbed on the returning molten metal surface and in the molten metal may be pumped through a molecular hydrino permeable section of the EM pump tube to exhaust the hydrino externally to the SunCell.

In an embodiment, the SunCell® comprises a means to vent or remove molecular hydrino gas from the reaction cell chamber 5b31 or PV window cavity 5b4. In an embodiment, at least one of the walls such as those of the PV window cavity, reservoirs, and EM pump tube have a high permeation rate for molecular hydrino such as H₂(1/4). In an embodiment, at least one of the length and diameter of at least one wall such as that of the reservoirs and EM pump tubes may be increased to increase the permeation rate. At least one of the wall thickness may be minimized and the wall operating temperature maximized. In an embodiment, the thickness of at least one of the walls may be in the range of 0.05 mm to 5 mm thick. In an exemplary embodiment, the reaction cell chamber material may comprise one or more of stainless steel such as 347 SS such as 4130 alloy SS or Cr—Mo SS, nickel, Ti, niobium, vanadium, iron, W, Re, Ta, Mo, niobium, and Nb(94.33 wt %)—Mo(4.86 wt %)—Zr(0.81 wt %). Crystalline material such as SiC may be more permeable to hydrinos than amorphous materials such as Sialon or quartz such that crystalline material are exemplary liners.

In an exemplary embodiment, the permeation of molecular hydrino may be through at least one wall or baseplate of the SunCell such as at least one of the PV widow cavity, EM pump tube, and reservoir walls and the baseplate 5b31c. In an embodiment, at least one of the width and length of the EM pump tube may be increased to increase the molecular hydrino permeation rate wherein the EM pumps may be positioned to the side of the reservoirs to accommodate the increased pump tube length while optimizing the dimensions of the SunCell.

In an embodiment, at least one of (i) the vacuum pressure may be maintained and (ii) the molecular hydrino gas may be removed by a Sprengel pump wherein molten metal such as tin is injected into the reaction cell chamber such as the PV window cavity and flows back to the reservoirs as drops. The flow may be through beads such as quartz beads. The Sprengel pump, may comprise at least one Sprengel pump tube that runs from the top to bottom of the reservoir and is vacuum sealed to the reservoir walls at the bottom of the reservoir where the electrical break 913 (FIGS. 66O-66T) connects. The drops of molten metal may flow into the Sprengel pump tubes and trap gas from the interior of the SunCell such as from the PV window cavity and cause it to be transported and compressed along each tube. The drops may exit the tube at the bottom to release the gas. The compressed gas may be released in the vacuum tight chamber comprising the bellows 917 that may comprise a pool of molten metal and the inlet of the EM pump. The compressed molecular hydrino gas may be pump out of the bellows chamber or allowed to permeate through the walls of the bellows.

In an embodiment, the Sprengel pump tubes may extend into the EM pump. Molten metal may return through at least one of the Sprengel pump tubes and the reservoir. The molten metal in the reservoir may flow into an inlet tube to the EM pump wherein the inlet may comprise an inlet riser to regulate the molten metal level in the reservoir. The flow from the Sprengel pump tubes and the EM pump tube inlet and join at a union before the EM pump. In an embodiment, at least one of the walls may comprise a gas permeable membrane. In an embodiment, the gas permeable membrane may comprise a frit comprises of pores having a pore size less than one that the molten metal such as tin can flow through such as a diameter less than 10 microns. At least a portion of the EM pump tube and the Sprengel pump tubes wall may comprise the gas permeable membrane.

In an embodiment, a means to remove hydrino gas from the PV window cavity by permeation may comprise a gas selective membrane comprising (i) a frit with a pore size below that which is penetrated by a molten metal such as gallium that serves as at least a portion of a wall of a component of the SunCell such as a portion the PV window cavity wall, the reservoir wall, or the EM pump tube wall, (ii) a chamber with an open top to serve as a reservoir for a molten metal wherein the frit serve as at least one wall, and (iii) the molten metal to fill the reservoir to serve as a vacuum tight seal to atmospheric pressure and a path for hydrino gas to diffuse from inside of the SunCell through the frit to the outside such as atmosphere. The reservoir may be thin such that the molten metal in the reservoir may be thin such as in the range of about 0.1 mm to 10 mm thick to support diffusion of hydrino gas from the inside of the SunCell.

In an embodiment, the Sprengel-type gas pump may comprise the tubes attached to and penetrating the reservoir baseplate 5kk1 wherein the tubes may enter a vacuum-tight chamber. The tubes may enter at the top of the chamber that may serve a as reservoir chamber such that the drops of returning molten metal and gas pushed by the drops flow into the reservoir chamber. The gas may fill the top and the molten metal may fill the bottom of the reservoir chamber. The base of the reservoir chamber may comprise an inlet to an EM pump that may inject the molten metal into the reaction cell chamber or PV window cavity to maintain a hydrino reaction plasma. The gas containing portion of the reservoir chamber may comprise a penetration to a vacuum pump to evacuate the gas.

At least one wall of the reservoir chamber may comprise a permeable membrane such as one comprising at least one of the frit and a thin molten metal seal. In an embodiment, the EM pump may comprise a plurality of stages wherein the inlet to the reservoir chamber and the inlet from the reservoir may feed molten metal to different pump stages. In an exemplary embodiment, the reservoir chamber feeds a first stage, and the reservoir feeds a second stage wherein the reservoir may comprise and inlet riser to control the molten metal level of the reservoir. The EM pump and the reservoir chamber may be positioned juxtaposed to the reservoir to achieve suitable packaging.

In an embodiment, the SunCell may comprise an electrostatic precipitation system (ESP) system. The ESP system may comprise two separated electrical breaks in the vacuum line 711 close to the reaction cell chamber 5b31 to electrically isolate a positive vacuum line section that is positively polarized. The positive section may comprise positive lead on the vacuum line, and a component of the SunCell such as the reaction cell chamber 5b31 may comprise a negative lead. The leads may be connected to a high voltage power supply such that the positive section is positively biased and the SunCell component is negatively bias or at ground. The voltage applied to the positive section may be in at least one range of about 10 V to 10 MV, 50 V to 1 MV, and 100 V to 100 kV with a corresponding positive section diameter in at least one range about 0.1 mm to 1 m, 1 mm to 10 cm, and 1 mm to 5 cm. The tube may be flattened such that the cross-sectional area for vacuum pumping remains similar to that of connected sections of vacuum line such as those of the electrical breaks 945. The corresponding electric field may be in the range of about 1000 V/m to 10⁸ V/m wherein the gas pressure in the tube may be in the range of about 0.1 milliTorr to 10 atm. The plasma in the reaction cell chamber may charge oxide particles such as gallium or tin oxide particles negatively, and such particles that flow through the vacuum line may be electrostatically attracted to the positively changed walls of the isolated positively polarized vacuum line section. The vacuum line to the positive section may at least one of comprise an electrical insulator or be lined with an electrical insulator to prevent the charged particles from losing charge before entering the positive vacuum line section. ESP accumulated particles may fall back into the reaction cell chamber by gravity or be forced back by means such as a gas jet such as a hydrogen or argon gas jet.

In an embodiment, the reaction cell chamber reaction cell mixture is controlled by controlling the reaction cell chamber pressure by at least one means of controlling the injection rate of the reactants and controlling the rate that excess reactants of the reaction mixture and products are exhausted from the reaction cell chamber 5b31. In an embodiment, the SunCell® comprises a pressure sensor, a vacuum pump, a vacuum line, a valve controller, and a valve such as a pressure-activated valve such as a solenoid valve or a throttle valve that opens and closes to the vacuum line from the reaction cell chamber to the vacuum pump in response to the controller that processes the pressure measured by the sensor. The valve may control the pressure of the reaction cell chamber gas. The valve may remain closed until the cell pressure reaches a first high setpoint, then the value may be activated to be open until the pressure is dropped by the vacuum pump to a second low setpoint which may cause the activation of the valve to close. In an embodiment, the controller may control at least one reaction parameter such as the reaction cell chamber pressure, reactant injection rate, voltage, current, and molten metal injection rate to maintain a non-pulsing or about steady or continuous plasma.

In an embodiment, the SunCell® comprises a source of hydrogen such as hydrogen gas and a source of oxygen such as oxygen gas. The source of at least one of hydrogen and oxygen sources comprises at least one or more gas tanks, flow regulators, pressure gauges, valves, and gas lines to the reaction cell chamber. In an embodiment, the HOH catalyst is generated from combustion of hydrogen and oxygen. The hydrogen and oxygen gases may be flowed into the reaction cell chamber. The inlet flow of reactants such as at least one of hydrogen and oxygen may be continuous or intermittent. The flow rates and an exhaust or vacuum flow rate may be controlled to achieve a desired pressure. The inlet flow may be intermittent wherein the flow may be stopped at the maximum pressure of a desired range and commenced at a minimum of the desire range. At least one of the H₂ pressure and flow rate and O₂ pressure and flow rate may be controlled to maintain at least one of the HOH and H₂ concentrations or partial pressures in a desired range to control and optimize the power from the hydrino reaction. In an embodiment, at least one of the hydrogen inventory and flow many be significantly greater than the oxygen inventory and flow. The ratio of at least one of the partial pressure of H₂ to O₂ and the flow rate of H₂ to O₂ may be in at least one range of about 1.1 to 10,000, 1.5 to 1000, 1.5 to 500, 1.5 to 100, 2 to 50 and 2 to 10. In an embodiment, the total pressure may be maintained in a range that supports a high concentration of nascent HOH and atomic H such as in at least one pressure range of about 1 mTorr to 500 Torr, 10 mTorr to 100 Torr, 100 mTorr to 50 Torr, and 1 Torr to 100 Torr. In an embodiment, at least one of the reservoir and reaction cell chamber may be maintained at an operating temperature that is greater than the decomposition temperature of at least one of gallium oxyhydroxide and gallium hydroxide. The operating temperature may be in at least one range of about 200° C. to 2000° C., 200° C. to 1000° C., and 200° C. to 700° C. The water inventory may be controlled in the gaseous state in the case that gallium oxyhydroxide and gallium hydroxide formation is suppressed.

In an embodiment, the SunCell® comprises a gas mixer to mix at least two gases such as hydrogen and oxygen that are flowed into the reaction cell chamber. In an embodiment, the micro-injector for water comprises the mixer that mixes hydrogen and oxygen wherein the mixture forms HOH as it enters the reaction cell chamber. The mixer may further comprise at least one mass flow controller, such as one for each gas or a gas mixture such as a premixed gas. The premixed gas may comprise each gas in its desired molar ratio such as a mixture comprising hydrogen and oxygen. The H₂ molar percent of a H₂—O₂ mixture may be in significant excess such as in a molar ratio range of about 1.5 to 1000 times the molar percent of O₂. The mass flow controller may control the hydrogen and oxygen flow and subsequent combustion to form HOH catalyst such that the resulting gas flow into the reaction cell chamber comprises hydrogen in excess and HOH catalyst. In an exemplary embodiment, the H₂ molar percentage is in the range of about 1.5 to 1000 times the molar percent of HOH. The mixer may comprise a hydrogen-oxygen torch. The torch may comprise a design known in the art such as a commercial hydrogen-oxygen torch.

### Formation of Nascent Water and Atomic Hydrogen

In an embodiment, the reaction cell chamber further comprises a dissociator chamber that houses a hydrogen dissociator such as Pt, Pd, Ir, Re, or other dissociator metal on a support such as carbon, or ceramic beads such as Al₂O₃, silica, or zeolite beads, Raney Ni, or Ni, niobium, titanium, or other dissociator metal of the disclosure in a form to provide a high surface area such as powder, mat, weave, or cloth. In an embodiment the SunCell® comprises a recombiner to catalytically react supplied H₂ and O₂ to HOH and H that flow into the reaction cell chamber 5b31. The recombiner may further comprise a controller comprising at least one of a temperature sensor, a heater, and a cooling system such a as heat exchanger that senses the recombiner temperature and controls at least one of the cooling system such as a water jet and the heater to maintain the recombiner catalyst in a desire operating temperature range such as one in the range of about 60° C. to 600° C. The upper temperature is limited by that at which the recombiner catalyst sinters and loses effective catalyst surface area.

In another embodiment, the recombiner comprise as hot filament such as a noble metal-black coated Pt filament such as Pt-black-Pt filament. The filament may be maintained at a sufficiently elevated temperature to maintain the desired rate of recombination by resistive heating maintained by a power supply, temperature sensor, and controller.

In an embodiment, the H₂/O₂ recombiner comprises a plasma source such as a glow discharge, microwave, radio frequency (RF), inductively or capacitively-coupled RF plasma. The discharge cell to sever as the recombiner may be high vacuum capable. An exemplary discharge cell 900 shown in FIGS. 66C-66N comprises a stainless-steel vessel or glow discharge plasma chamber 901 with a Conflat flange 902 on the top with a mating top plate 903 sealed with a copper, silver-plated copper, or tantalum gasket or O-ring. The flanges may be coated with a coating such as Flameproof paint, alumina, CrC, TiN, CrN, TiAlN, Ta, or another of the disclosure that prevents alloy formation with the molten metal. The gasket or O-ring such as Ta ones may be alloy-formation resistant. In an embodiment, the flanges may be replaced by flat metal plates (no bolt holes) such as annuluses around the perimeter of each joined component. The plates may be welded together on the outer edges to form a seam. The seam may be cut or ground off to separate the two plates. The top plate may have a high voltage feedthrough 904 to an inner tungsten rod electrode 905. The cell body may be grounded to serve as the counter electrode. The top flange may further comprise at least one gas inlet 906 for hydrino reaction mixture gases such as at least one of H₂, O₂, air, H₂O, and a noble gas (e.g., Ar), or mixtures thereof (e.g., H₂/O₂, H₂/air, H₂/H₂O, H₂/noble gas, O₂/noble gas, H₂/O₂/H₂O, H₂/O₂/noble gas, H₂/H₂O/noble gas, O₂/H₂O/noble gas, H₂/O₂/H₂O/noble gas, H₂/O₂/air, H₂/air/H₂O, H₂/air/noble gas, H₂/O₂/air/H₂O, H₂/O₂/air/noble gas, H₂/O₂/air/H₂O/noble gas). To increase the desired yield of HOH catalyst production while adding argon to the hydrino reaction mixture, hydrogen gas and oxygen gas may be flowed through the discharge cell, and argon may be flowed through a separate gas inlet into the reaction cell chamber 5b31. The bottom plate 907 of the stainless-steel vessel may comprise a gas outlet to the reaction cell chamber. The glow discharge cell further comprises a power source such as a DC power source with a voltage in the range of about 10 V to 5 kV and a current in the range of about 0.01 A to 100 A. The glow discharge breakdown and maintenance voltages for a desired gas pressure, electrode separation, and discharge current may be selected according to Paschen's law. The glow discharge cell may further comprise a means such as a spark plug ignition system to cause gas breakdown to start the discharge plasma wherein the glow discharge plasma power operates at a lower maintenance voltage which sustains the glow discharge. The breakdown voltage may be in the range of about 50 V to 5 kV, and the maintenance voltage may be in the range of about 10 V to 1 kV. The glow discharge cell may be electrically isolated from the other SunCell® components such as the reaction cell chamber 5b31 and the reservoir 5c to prevent shorting of the ignition power. Pressure waves may cause glow discharge instabilities that create variations in the reactants flowing into the reaction cell chamber 5b31 and may damage the glow discharge power supply. To prevent back pressure waves due to the hydrino reaction from propagating into the glow discharge plasma chamber, the reaction cell chamber 5b31 may comprise a baffle such as one threaded into a BN sleeve on the electrode bus bar where the gas line from the glow discharge cell enters the reaction cell chamber. The glow discharge power supply may comprise at least one surge protector element such as a capacitor. The length of the discharge cell and the reaction cell chamber height may be minimized to reduce the distance from the glow discharge plasma to the positive surface of the gallium, to increase the concentration of atomic hydrogen and HOH catalyst by reducing the distance for possible recombination.

The glow discharge cell may be replaced by other sources of atomic hydrogen such as one that works by thermally dissociating hydrogen in an electron bombardment heated fine tungsten capillary (thermal hydrogen cracker) wherein by bouncing along the hot walls, the molecular hydrogen is cracked to atomic hydrogen. The atomic hydrogen source may be one know in the art such as the exemplary commercial atomic hydrogen source of H-flux Atomic Hydrogen Source by Tec Tra (https://tectra.de/sample-preparation/atomic-hydrogen-source/#:˜:text=H %2Dflux %20Atomic %20Hydrogen %20Source,is %20cracked %20to %20at omic %20hydrogen).

In an embodiment, the area of the connection between the source of at least one of atomic H and HOH catalyst such as a plasma cell and reaction cell chamber 5b31 may be minimized to avoid atomic H wall recombination and HOH dimerization. The plasma cell such as the glow discharge cell may connect directly to an electrical isolator such as a ceramic one such as one from Solid Seal Technologies, Inc. that connects directly to the reaction cell chamber. The electrical isolator may be connected to the discharge cell and the flange by welds, flange joints, or other fasteners known in the art. The inner diameter of the electrical isolator may be large such as about the diameter of the discharge cell chamber such as in the range of about 0.05 cm to 15 cm. In another embodiment wherein the SunCell® and the body of the discharge cell are maintained at the same voltage such as at ground level, the discharge cell may be directly connected to the reaction cell chamber. The connection may comprise a weld, flange joint, or other fastener known in the art. The inner diameter of the connection may be large such as about the diameter of the discharge cell chamber such as in the range of about 0.05 cm to 15 cm.

In an embodiment, the SunCell® comprises as a driven plasma cell such as a discharge cell such as a glow discharge, microwave discharge, or inductively or capacitively coupled discharge cell wherein the hydrino reaction mixture comprises the hydrino reaction mixture of the disclosure such as hydrogen in excess of oxygen relative to a stoichiometric mixture of H₂ (66.6%) to O₂ (33.3%) mole percent. The driven plasma cell may comprise a vessel capable of vacuum, a reaction mixture supply, a vacuum pump, a pressure gauge, a flow meter, a plasma generator, a plasma power supply, and a controller. Plasma sources to maintain the hydrino reaction are given in Mills Prior Applications which are incorporated by reference. The plasma source may maintain a plasma in a hydrino reaction mixture comprising a mixture of hydrogen and oxygen having a deficit of oxygen compared to a stoichiometric mixture of H₂ (66.6%) to O₂ (33.3%) mole percent. The oxygen deficit of the hydrogen-oxygen mixture may be in the range of about 5% to 99% from that of a stoichiometric mixture. The mixture may comprise mole percentages of about 99.66% to 68.33% H₂ and about 0.333% to 31.66% O₂. These mixtures may produce a reaction mixture upon passage through the plasma cell such as the glow discharge sufficient to induce the catalytic reaction as described herein upon interaction with a biased molten metal in the reaction cell chamber.

In an embodiment, the ceramic liner, coating, or cladding of at least one SunCell® component such as the reservoir, reaction cell chamber, ignition feedthrough, and EM pump tube may comprise at least one of a metal oxide, alumina, zirconia, titania, zirconia, yttria stabilized zirconia, hafnia, magnesia, Mullite, or mixtures such as ZrO₂—TiO₂—Y₂O₃, TiO₂-Yr₂O₃—Al₂O₃, BN, BN—B₂O₃, quartz, fused silica, SiO₂, silicon carbide, zirconium carbide, zirconium diboride, silicon nitride (Si₃N4), a glass ceramic such as Li₂O×Al₂O₃×nSiO₂ system (LAS system), the MgO×Al₂O₃×nSiO₂ system (MAS system), the ZnO×Al₂O₃×nSiO₂ system (ZAS system). At least one SunCell® component such as the reservoir, reaction cell chamber, EM pump tube, liner, cladding, or coating may comprise a refractory material such as at least one of graphite (sublimation point=3642° C.), a refractory metal such as tungsten (M.P.=3422° C.) or tantalum (M.P.=3020° C.), niobium, niobium alloy, vanadium, a ceramic, a ultra-high-temperature ceramic, and a ceramic matrix composite such as at least one of borides, carbides, nitrides, and oxides such as those of early transition metals such as hafnium boride (HfB₂), zirconium diboride (ZrB₂), hafnium nitride (HfN), zirconium nitride (ZrN), titanium carbide (TiC), titanium nitride (TiN), thorium dioxide (ThO₂), niobium boride (NbB₂), and tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000° C.), Ta₄HfC₅TaX₄HfCX₅ (4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.), and a turbine blade material such as one or more from the group of a superalloy, nickel-based superalloy comprising chromium, cobalt, and rhenium, one comprising ceramic matrix composites, U-500, Rene 77, Rene N5, Rene N6, PWA 1484, CMSX-4, CMSX-10, Inconel, IN-738, GTD-111, EPM-102, and PWA 1497. The ceramic such as MgO and ZrO may be resistant to reaction with H₂. The SunCell component coating may be applied by at least one method of the group of molecular vapor deposition, chemical vapor deposition, physical vapor deposition, diffusion coating, MOCVD, sputtering, high velocity spray application, electrostatic spray application, electrodeposition using plasma or electrolysis, electroplating, and other deposition methods known in the art.

In an embodiment, the SunCell may comprises dual molten metal injectors 5k61 each in a reservoir 5c (FIGS. 66F-66L) wherein each serves as an ignition a current carrying electrode that may further comprise at least one of an electrical break 913 that may comprise a thermally insulating liner, electrical break flanges 914, reservoir flanges 915, EM pump tube assembly 5kk, EM pump tube 5k6, EM bus bars 5k2, EM pump magnets 5k4, and an inlet riser 5qa. The SunCell may further comprise a vacuum line 711, a discharge cell 900 and body 901, a gas inlet such as one that passes through an electrical feedthrough 906a (FIGS. 66J-66L), reaction cell chamber 5b31, top flanges 26e that may comprise a solid plate or inner PV window flange, a PV chamber 916, an inner PV window 5ab4, a seat for the inner PV window 26e1, and an outer PV window 5b4. In an exemplary embodiment, the positive lead of the glow discharge power supply connects to a gas line extension of a feedthrough-gas inlet 906a, and the negative lead is attached to the discharge cell flange 906b or chamber 901 or the reaction cell chamber 5b31 wherein the negative connection may be indirect by connecting to a gas line such as argon gas line 906 (FIG. 66C) that is in electrical contact with the discharge cell flange 906b. The discharge cell body 901 may be mounted on the reaction cell chamber 5b31 directly as shown in FIG. 66G, or by a connection such as an elbow that permits the discharge cell body to be oriented in another desired direction such as vertically. In an embodiment, the discharge cell 900 may be mounted on the top of the reaction cell chamber 5b31 in a desired orientation such as vertically.

### Thermophotovoltaic Converter

A test of single junction Group III/V semiconductor PV conversion of 1207° C. blackbody emission with infrared light recycling was reported by Z. Omair, et al., “Ultraefficient thermophotovoltaic power conversion by band-edge spectral filtering”, PNAS, Vol, 116, No. 3, (2019), pp. 15356-15361 which is incorporated by reference in its entirety. Omair et al., achieved 30% conversion efficiency and projected an efficiency of 50% with mirror, PV, blackbody emissivity, view factor, series resistance, and other improvements. The thermophotovoltaic (TPV) conversion efficiency for 3000K SunCell emission by a single junction concentrator silicon PV cell operating at 120° C. was calculated to be 84% with a practical expectation of 50%. In an embodiment, the SunCell® comprises a thermophotovoltaic (TPV) converter comprising at least one photovoltaic cell and at least one blackbody radiator or emitter. The blackbody radiator for thermophotovoltaic conversion with light recycling comprises one or more of (i) at least one of the outer walls of a SunCell component and (ii) the hydrino plasma in the reaction cell chamber that emits light through the PV window to the PV converter. The SunCell component having an outer wall that serves as a blackbody radiator may comprise at least one of the reaction cell chamber and reservoir comprising a refractory material that is resistant to alloy formation with the molten metal such as a wall comprising Mo, Ta, W, Nb, Ti, Cr, Zr alloys and internally coated such as VHT Flameproof paint or similar ceramic paint or ceramic coated steel or stainless steel or refractory metal. Alternatively, the wall may comprise at least one of carbon, quartz, fused silica, and a ceramic such as alumina, hafnia, zirconia, silicon carbide, boron nitride (BN), and another of the disclosure. In an embodiment, the blackbody radiator may comprise a filter to block emission of infrared light to the TPV cell. The TPV cell may comprise at least one of a filter such as an infrared filter on the front surface and a mirror on the back surface such as an infrared mirror. The photons that enter the PV cell having energy below the cell's band gap may be reflected back to the SunCell such as to at least one of the SunCell component wall and the reaction cell chamber through the PV window to recycle the corresponding low-energy photons.

Due to reflections and multiple reflections of plasma and recycled light by the molten metal inside of the reaction cell chamber, the percentage the direct plasma emission, stray plasma and SunCell component emission such as wall, molten metal, and positive electrode emission, and recycled light that may exit the chamber or be transmitted through a PV window may be 100%. In an embodiment, at least one of the reaction cell chamber and the reservoirs may be thermally insulated such that the power transferred from the SunCell through the PV window to a load such as a PV converter, oven absorber, or boiler absorber is dominated by radiation. The percent of hydrino reaction power radiated is function of the molten metal emissivity which is typically in the range of about 0 to 0.3 and the reaction cell chamber wall temperature which may be in the range of 500° C. to 3500° C. The percentage of radiation transmitted may increase with deceased molten metal emissivity and increased reaction cell chamber wall temperature. In an exemplary embodiment comprising an upper transparent half dome PV window connected to a lower reaction cell chamber, the transmission through the PV window was calculated to be about 100% with a plasma blackbody temperature of 3000K, a molten metal emissivity of 0.3, and a reaction cell chamber wall temperature of 1700° C.

In an embodiment, the SunCell may comprise dual reservoirs and injector electrodes that inject molten metal such that the injected molten metal streams intersect to form a plasma. In an embodiment, at least one reaction cell chamber wall may be transparent to at least one of visible and infrared light. The reactions cell chamber walls may comprise a PV window. The SunCell may comprise a reaction cell chamber with a polygonal shape such as a square, rectangle, pentagon, hexagon, etc. The surface of the reaction cell chamber may be clad with PV cells such a thermophotovoltaic (TPV) cells wherein a gap may exist between the reaction cell chamber walls and the PV cells. In an embodiment, at least one window or filter comprises a means such as surface texture or a quarter wave plate to reduce reflection. In another embodiment, the SunCell may further comprise a PV window comprising a chamber connected to the reaction cell chamber by a joint such as a flanged joint. The TPV cells may surround the PV window to receive plasma emission and convert it into electricity. The TPV cell may reflect light such as infrared light that is not converted into electricity back to the plasma to be recycled.

In an embodiment, the molten metal may comprise tin. The reaction cell chamber temperature may be maintained above a temperature at which the reaction of tin with water vapor to form tin oxide is thermodynamically unfavorable wherein water is supplied to the hydrino reaction as part of the hydrino reaction mixture such as one comprising at least two of hydrogen, oxygen, and water vapor. In an exemplary embodiment wherein the hydrino reaction mixture comprises water vapor, the reaction cell chamber is maintained above 875K. Addition of molecular or atomic hydrogen as part of the hydrino reaction mixture decreases the temperature at which the reaction of tin with water vapor to form tin oxide is thermodynamically unfavorable.

In an embodiment, the SunCell comprises a water injector such as sources of hydrogen and a source of oxygen and a recombiner such as a plasma cell, recombiner catalyst such as a noble metal on a support such as alumina, or another recombiner of the disclosure. The source of hydrogen and oxygen may be corresponding gases supplied by gas lines, mass flow controllers, valves, flow and pressure sensors, a computer, and other systems of the disclosure. Alternatively, water may be supplied as a water vapor gas. The water vapor gas may be controllably flowed into at least one of the reaction cell chamber and molten metal by a mass flow controller from a water tank maintained at a desired pressure for the mass flow controller operation. The water vapor pressure may be controlled by controlling the temperature of a water vapor source such as a closed water tank. In an exemplary embodiment, the water vapor mass flow controller such as at least one of MKS model #1150, 1152m, and 1640 (https://www.mksinst.com/c/vapor-mass-flow-controllers; https://ccrprocessproducts.com/product/1640a-mass-flow-controller-mks/) comprises one that senses the difference in inlet and outlet pressure and uses that data to control the water vapor flow rate.

In an exemplary embodiment shown in FIGS. 66C-D, the SunCell for thermophotovoltaic (TPV) conversion with light recycling comprises an inverted Y geometry wherein the inverted “V” portion of the inverted Y geometry comprises the two injection reservoirs 5c that connect to a reaction cell chamber 5b31, and the straight portion of the inverted Y geometry comprises a blackbody radiator or a PV window 5b4. The inverted V portion may further comprise at least one of a glow discharge cell 900 connected to the reaction cell chamber 5b31 with a gas inlet for reactant gases such as H₂ and O₂ gas and a vacuum line 711 connected to a vacuum pump to evacuate the reaction cell chamber. The glow discharge cell may comprise a flange at the top to provide access to at least the discharge electrode for replacement. At least one of the glow discharge cell 900 and vacuum line 711 may be tilted upward to avoid filling with molten metal and may be lined with a liner such as one of the disclosure that avoids formation of an alloy with the molten metal. The glow discharge cell liner may be electrically conductive or comprise a partial liner with a portion of the non-lined cell wall serving as an electrode.

The straight portion PV window may comprise a rectangular cavity with an opening to the reaction cell chamber. Alternatively, the PV window may comprise a flat plate that covers the reaction cell chamber. The plate may comprise a window in a housing that may be sealed with a gasket such as one by Rayotek. In an embodiment, the PV window or PV window cavity is vacuum sealed to the baseplate 5b31c or housing by at least one or more of adhesive, thermal fusing, gasket, brazing, and compression sealing. The sealing may comprise a sealing method and means known in the art (https://rayoteksightwindows.com/services/sealing.html). In an exemplary embodiment, the PV window cavity may be mounted in a sight glass fitting such as one by Rayotek that comprises a flange that can be welded to a mating flange on the baseplate 5b31c. The weld seam can be cut to separate the parts. In an exemplary embodiment, the PV window cavity flange may be sealed in between two bolted metal flanges with graphite gaskets such as Graphoil, Braided flexible graphite Packing with encapsulated E-Glass (https://www.sealsales.com/braidedpacking/flexiblegraphitepacking.html), or Garlock Style 1333-G Graphite Packing between each metal flange and the PV window cavity flange. The gasket may comprise a C-seal. In an exemplary embodiment, a Conflat flange may comprise at least one C-seal such as one to apply pressure to the top of the PV window cavity flange wherein a carbon gasket serves as the seal between the bottom of the PV window cavity flange and the and the bottom Conflat flange. In an embodiment, the gasket may comprise bladder (e.g. a malleable metal tube filled with a liquid with a high boiling point or a gas). The gasket may comprise vermiculite such as a Thermiculite gasket such as one by Flexitallic or a vermiculite spiral wound gasket (e.g. SW600-V835 Sunwell Seals or Thermiculite 845 Flexpro Kammprofile). In an embodiment, the flange bolts comprise springs and optionally bushings between the flange and nuts for the bolts wherein the springs may be extended farther from a hotter zone at the flange by the bushings.

In an embodiment, the PV window cavity comprises a section between the baseplate and a transparent portion of the PV window cavity to allow for rapid diffusion of molecular hydrino product from the PV window cavity. The corresponding lower portion of the PV window cavity comprising the diffusion section of the cavity may comprise a metal or other material that is highly permeable to molecular hydrino such as a metal such as CrMo steel. The lower cavity may be connected to the baseplate by a weld, flange, or other union such as one of the disclosure. The diffusion and transparent cavity portions may be connected by a flange or other union such as one of the disclosure. The lower cavity may be at least partially filled to a liner such as a carbon one. The thickness of the liner may be selected to at least partially maintain the hydrino reaction plasma in the transparent portion of the PV window cavity. The carbon liner may comprise CalCarb. The wall temperature of the permeable portion may be maintained at one that is favorable for rapid molecular hydrino diffusion such as a temperature in the range of about 100° C. to 3000° C.

The window may be metalized and brazed or welded to the housing. The window may be glued to the housing by a glue such as one of the disclosure. Alternatively, the window may comprise a flat plate that is glued to a flange on top of the reaction cell chamber. The glue may comprise a commercial high temperature metal to metal or window to metal sealant such as a high temperature vacuum epoxy such as (i) Torr Seal TS10 and 353ND vacuum epoxy (ThorLabs), (ii) FO-EPXY-UHV (Accu-Glass Products, Inc.), (iii) TorrSeal (Kurt J. Lesker), (iv) EP30-2, EP29LPSP, and EP21TCHT-1 (Masterbond), and (v) KB 1039 CRLP, KB 1040 CTE-LO, KB 10473 FLAO, and KB 1372-LO (Kohesi Bond). In an embodiment, at least one flat panel PV denser receiver array is positioned flat and parallel to a rectangular PV window face or the flat plate window to receive the light emission from inside of the PV window chamber or the reaction cell chamber. A gap may separate each dense receiver array from the corresponding PV window face or plate. In an embodiment shown in FIGS. 66C and 66D, the SunCell may comprise a PV window chamber. Other geometries such a rectangular, cubic, cylindrical, and conical are within the scope of the disclosure. At least one wall of the PV window chamber may be flat to facilitate at least one of light transmission out of the PV window chamber and the light recycling of the hydrino reaction plasma light between the PV panels of the PV converter 26a (FIG. 66E) and the hydrino reaction plasma in the PV window chamber. The facilitation of at least one of light transmission out of the PV window chamber and the light recycling may be achieved by minimizing reflection of the light by the at least one transparent window wall. At least one window wall surface may comprise a coating or texture to further minimize light reflection during PV conversion into electricity.

The V portion of the inverted Y geometry may comprise a refractory metal such as Mo, Ta, W, Nb, Ti, Cr, and internally coated steel, stainless steel, or a refractory metal. The coating may comprise a high-temperature ceramic paint such as VHT Flameproof paint or similar ceramic paint or a ceramic coating such as Mullite. The PV window or cavity may comprise quartz, sapphire, MgF₂, aluminum oxynitride, or other PV window of the disclosure. In an embodiment, the PV window may comprise a heater to preheat it to prevent the molten metal from solidifying. In an exemplary embodiment, the PV window or cavity such as a quartz, sapphire, aluminum oxynitride, MgF₂, or a Schott Nextrema PV window may be preheated with heater such as resistive heater, hydrogen-oxygen flame heater, or a plasma recombination reaction heater. In an embodiment, the quartz PV cavity may be formed by at least one of molding, welding, and slip casting. In an exemplary embodiment, the quartz PV cavity may be formed from a quartz tube with a molded base draw through a mold or a welded plate base.

In an embodiment, the dual injectors may be aligned to cause the corresponding injected molten metal streams to intersect. Considering that the bases of the reservoirs, the reservoirs, and the intersecting metal streams form a triangle with the apex at the point of streams intersection, apex angle may be increased by increasing the base length to avoid mutual Lorentzian deflection of the intersecting streams (e.g. the stream trajectories are made more linear with less arc shape).

The V and straight portion may be joined by a seal such as a gasketed seal 26d (FIG. 66C). The gasket may comprise carbon, and the seal 26d may comprise bolted flanges. Alternatively, the seal and union 26d between the inverted V and straight portions may comprise a glue (FIG. 66D). In an embodiment, the high temperature windows such as those by Rayotek (https://rayoteksightwindows.com/products/high-temp-sight-glass-windows.html) may be connected to form a plasma chamber or cavity wherein the windows comprise the PV window for plasma emission to the PV converter with light recycling. The connection may be achieved by welding the edges of the windows to form a polygonal cavity that may be further welded to the reaction cell chamber at a bottom opening of the cavity.

In embodiments of a means to electrically isolate the ignition electrodes of a SunCell comprising dual injectors: (i) at least one reservoir may comprise an isolation joint such as such as flanged joint comprising an insulating gasket and isolated bolts such as ceramic bolts or bolts comprising insulating bushings and (ii) at least one of the reaction cell chamber and at least one reservoir comprises an electrical insulating wall section (an isolator, or electrical break) such as a ceramic one such as a ceramic of the disclosure such as alumina, SiC, BN, or quartz that electrically isolates the two reservoirs from each other wherein (a) the reservoir isolator may comprise a ceramic tube with a flange on each end that mates two reservoir sections or mates to a reservoir section and the reaction cell chamber such as a flanged electrical isolator or electrical break such as the exemplary CF Flanged Vacuum Ceramic Break, https://www.lesker.com/newweb/feedthroughs/ceramicbreaks_vacuum.cfm?pgid=cf further comprising at least one of gaskets to mate to matching flanges of the reservoir and a liner such as a ceramic liner such as one of the disclosure that may at least one of protect the gaskets and the electrical break from alloy formation with the molten metal and thermal shock, respectively, (b) the reservoir isolator may comprise a ceramic tube with a weldable metal ring on each end such as a Kovar or Invar ring to mate the two reservoir sections or a reservoir section and the reaction cell chamber by welding such as an exemplary Weldable Vacuum Ceramic Break, https://www.lesker.com/newweb/feedthroughs/ceramicbreaks_vacuum.cfm?pgid=weld, and (c) the reservoir isolator may comprise a ceramic tube with a wet seal on each end that mates to two reservoir sections or mates to a reservoir section and the reaction cell chamber. In an embodiment, the electrical break comprises a ceramic cylinder such as an alumina cylinder that is plated first with Mo—Mn alloy and then Ni that is brazed to Kovar that is plated with Ni. The braze may have a high melting point such a greater than 600° C. Exemplary brazes are Cu(72)—Ag(28) alloy, copper, ABA, gold ABA, PdNiAu alloy (AMS 4785 M.P.=1135° C.) or Paloro or a similar braze such as one at the link:https://www.morganbrazealloys.com/en-gb/products/brazing-alloys/precious-brazing-filler-metals/.

In an embodiment, both reservoirs of the dual injector SunCell shown in FIGS. 66C-66L comprise an electrical break that at least one of (i) isolates the ignition voltage of one reservoir from that of the other until the molten metal streams injected from each reservoir intersect and at least partially isolates the EM pump power supply of one reservoir from that of the other and (ii) may also at least partially isolate the ignition power supply from the EM pump power supplies. In another embodiment, at least two power supplies of the ignition power supply, the EM pump power supply of a first reservoir, and the EM pump power supply of the second reservoir has a capability of operating about autonomously of at least one other power supply. Each power supply may be one known in the art or one modified with voltage and current fluctuation suppressant reactance to negate fast voltage and current ignition transients to allow about independent power supply operation. Exemplary suppressant reactance comprises at least one capacitor bank in parallel or at least one inductor in series with the EM pump power supply.

In an embodiment, the reservoir comprising an electrical break may be sufficiently long to remove the electrical break sufficiently far from the reaction cell chamber that it does not overheat. In an embodiment, the electrical break may comprise at least one inner liner comprising a thermal insulator such that the break can be maintained below its failure temperature while the molten metal temperature inside of the liner may be higher. The electrical break may be coated with at least one coating such as CrC, alumina, TiN, CrN, TiAlN, WC, or another of the disclosure to avoid at least one of oxidation such as on the outside and alloy formation such as on the inside. The metal to ceramic union braze of the electrical break may be covered with potting material such as Resbond 940SS or another of the disclosure. In an exemplary embodiment, the molten metal comprises silver and the liner comprises at least one refractory material such as carbon, BN, quartz, alumina, moldable or castable ceramic, ceramic beads such as alumina beads that may further comprise a binder such as Resbond, a refractory metal, and other liners of the disclosure. The liner may fill the reservoir except for channels for the EM pump inlet and outlet. The height of the electrical break and liner may be minimized to allow for thermal conduction through the channels to maintain molten metal across the break and liner. In an embodiment, the electrical break may be externally cooled. The EM pump tube brace may comprise the electrical break liner of the disclosure.

In embodiment comprising an electrical isolator to electrically isolate the ignition electrodes of a SunCell comprising dual injectors, at least one reservoir may comprise an electrical break comprising a ceramic reservoir wall section that may further comprise a ceramic-metal union on each end to mate to the reservoir wall at each end. In an embodiment, the reservoir molten metal level is a desired level below the top of the ceramic portion of the isolator on the reaction cell chamber side. In an exemplary embodiment, the reservoir molten metal level is a desired level below the top of the ceramic-metal union of the electrical break on the reaction cell chamber side. The height of the inlet riser inlet may be adjusted to match to the desired level to control the maximum molten metal level at the desired level. The electric break may comprise an internal thermal insulation puck with a hole for molten to flow to at least one of a molten metal reservoir or a lower portion of the molten metal reservoir, an inlet riser to the EM pump tube, and an ignition bus bar on the EM pump side of the puck. An injection EM pump and electrode may penetrate through the insulation puck to the reaction cell chamber side to inject molten metal to a counter electrode.

In an embodiment, each reservoir may comprise a drain plug to allow for the gravity-facilitated removal of molten metal from the bottom of the reservoirs during serving and maintenance. In an embodiment, the inlet riser may comprise a strainer such as a metal screen such as a W or Ta screen to protect the EM pump and nozzle form being blocked by debris flowing into the inlet riser.

The reservoir on the EM pump side of the electrical break may be increased in length to increase the reservoir molten metal inventory. The length of the reservoir may be increased on the reaction cell chamber side of the break to move the electrical break further from the plasma to lower its operating temperature. In another embodiment, the electrical break may be capable of high temperature such as one between 450° C. and 1500° C. wherein the braze of the break is selected to have a melting point above the operating temperature. An exemplary high temperature electrical break comprises at least one of Kovar and niobium and a compatible high-temperature braze such as Paloro-3V, a similar braze such as one at the link: https://www.morganbrazealloys.com/en-gb/products/brazing-alloys/precious-brazing-filler-metals/, or another of the disclosure.

The electrical break may comprise a ceramic (e.g. 97% alumina), a weld adapter flange circumferential about the ceramic insulator such as one comprising Cu/Ni (e.g. 70%-30%) or Fe/Ni (e.g. 50%-50%), and a Conflat flange (e.g. 304 stainless-steel) brazed or welded circumferentially to the weld adapter flange. The electrical break may further comprise a bellows or S-flange (diaphragm) between the CF flange and the weld adapter flange.

The maximum molten metal inventory of the two reservoirs 5c is such that maximum molten level in the electrical break side comprising the initial filled volume and the volume of the molten metal above the lowest height of the inlet riser of the reservoir opposite the electrical break reservoir does not exceed the height of the ceramic of the electrical break.

In an exemplary embodiment having a reservoir electrical break, an unoxidized inner-most W liner may be used with a middle carbon liner, and outer W liner or cladding in the reaction cell chamber. The liner may cover at least one of the reaction cell chamber 5b31 walls, the floor of the reaction cell chamber, and the reservoirs 5c. The reaction cell. chamber floor liner 5b31b may comprise conduits or groves to channel the molten metal away from the corresponding injected molten metal stream when flowing from the injector 5k61 back to the reservoir 5c. In an exemplary embodiment, each reservoir injector 5k61 is located away for the center of the reaction cell chamber in its reservoir and the grooves of the floor liner 5b31b direct molten metal return flow to the sides of the reservoir, and alternatively, the center-facing side of the reservoir. In another embodiment, the injectors 5k61 extend above the top of the reservoirs and reaction cell chamber floor liner 5b31b such that the returning molten metal streams cannot interfere with the injected streams.

In an embodiment, the PV window comprises a means such as a mirror such as a dichroic mirror or filter to reflect light of wavelengths that have significantly higher energy than the band gap to the PV cells of the PV converter 26a. In an embodiment, the reflected light has energy in at least one range of about 10%-1000% higher, 10%-500% higher, and 10%-100% higher. In another embodiment, at least one of the reaction cell chamber and the PV window may comprise a means to down convert the energy of the light such as a phosphor.

The joint and PV window may be contained in a vacuum-tight housing comprising a window chamber such as a vacuum chamber that further houses the PV converter. The housing may be fastened to the top of the reaction cell chamber by a faster or joint. The fastener or joint may comprise a weld. The housing may have penetrations for a vacuum line to a vacuum pump and for the electrical lines and cooling lines of the PV converter. About equal pressure may be maintained on both sides of the window (vent) by controlling the vacuum pumps of the window chamber and the reaction cell chamber. In an embodiment, an overpressure may be maintained in the window chamber relative to the reaction cell chamber to cause the widow to be held against the top of the reaction cell chamber on a window seat or flange. Alternatively, the window and the reaction cell chamber vacuum lines may be joined and then connected to a single vacuum pump. In another embodiment, the window seal may be leaky to allow the pressure to equilibrate on both sides of the window. The vacuum-tight housing may comprise a vacuum sealable opening such as a flanged port, gate valve, or door. In a further embodiment, the window and the reaction cell chambers may comprise a tube such as a gas line that connects the two chambers such that the gas pressure may dynamically equalize between the two connected chambers.

In an embodiment shown in FIGS. 66F-66L and 2I144, the SunCell comprises dual molten metal injectors 5k61 each in a reservoir 5c wherein each serves as an ignition a current carrying electrode. In an embodiment, at least one of the dual molten metal injectors 5k61 may comprise a plurality of at least one of injectors 5k61 or nozzles 5q per corresponding reservoir 5c. At least one dual molten metal injector 5k61 in a reservoir 5c may further comprise an electrical break 913 that may comprise a thermally insulating liner and electrical break flanges 914. The SunCell may further comprise reservoir flanges 915. The dual molten metal injector 5k61 each in a reservoir 5c may further comprise an EM pump tube assembly 5kk, EM pump tube 5k6, EM bus bars 5k2, EM pump magnets 5k4, and an inlet riser 5qa. The SunCell may further comprise a vacuum line 711 connected to a vacuum pump, that may comprise a screen or filter to remove at least one of molten metal such as tin, gallium, or silver, and the corresponding oxides. To clean the vacuum line screen of adhered material such as at least one of metal oxide and metal, the vacuum line 711 may comprises a gas jet back flush such as at least one gas nozzle on the pump side of a vacuum screen to apply a pulsed gas jet such as argon gas jet through the screen to blow the adhered material back towards the reaction cell chamber 5b31.

In an embodiment, the electrical break 913 comprises a commercial one such as one made by Kurt Lesker such as the exemplary CF Flanged Vacuum Ceramic Break, Product No. CFT08V2376, https://www.lesker.com/newweb/feedthroughs/ceramicbreaks_vacuum.cfm?pgid=cf_or made by MPF Products Inc. such as Product No. A0625-2-W,https://mpfpi.com/shop/uhv-isolators/1Okv-uhv-breaks/a0625-2-w/. In an alternative embodiment, the electrical break 913 comprises two tubes such as sections of reservoir tubes 5c joined by an electrically insulating adhesive that forms a layer that electrically isolates the two joined tubes. The thickness of the adhesive layer may be in the range of about 15 micrometers to 2 cm. The resistance of the layer may be in the range of about 1 kilo-ohm to 1 giga-ohm. The tubes may comprise flanges that are joined by the adhesive. The adhesive and corresponding seal between the two tubes may be vacuum seal capable. The adhesive may be capable of operating at high temperature and may be capable of thermal cycling. In an embodiment, the electrical break may comprise a potting compound layer between two metal tubes such as stainless steel (SS) tubes that have sufficient thickness to form a bond sufficient for operation of the SunCell while minimizing the contact area of the union to maximize the resistance. To increase the shear strength of the corresponding vacuum capable union between the tubes, the union may at least one of comprise a thicker tubing that are butt-end joined and may comprise other mating structures such as flanges, concentric tubes (e.g. tube-in-tube), and a protrusions or tongue on at least one side of the break (e.g. tongue and grove). In an exemplary embodiment, two tubes having the same inner diameter (ID) and outer diameter (OD) are milled on the ends, one on the ID and the other the OD, such that the ends fit concentrically with a gap sufficient that electrical isolation between the tubes is achieved with the adhesive such as Resbond 940HT for 400 series steel (e.g. greater than 17 microns for an applied 50V ignition voltage). The adhesive or potting compound may comprise one with a nearly matched coefficient of thermal expansion (CTE) as that of the tubes. Alternatively, the metal of the reservoir section comprising the electrical break is selected to nearly match the CTE of the adhesive or potting compound. In an exemplary embodiment, 400 series stainless steel such as SS 440 and cold rolled steel (CRS) each have a CTE that is about a match to the CTE of Resbond 940HE. Other exemplary steels and metals are steel, stainless steel ferric 410, cast iron gray, hard alloy K₂O, molybdenum, niobium, tantalum, vanadium, and tungsten. The metal may be thin (e.g. having a thickness in the range of about 0.1 mm to 10 mm) to provide flexibility to accommodate thermal expansion. In an embodiment, the electrical break may comprise at least one of thermal expansion joints and a compressible material to accommodate any thermal expansion mismatch between the adhesive and the metal.

The potting compound layer may comprise a plurality of potting compounds or adhesives such as ones made by Cotronics Corporation or Aremco, or others of the disclosure. In an embodiment, the potting compounds or adhesives may be selected to provide at least one layer that serves as a non-conductive current barrier and at least one other that serves to optimize the match the CTE of the break with that of the tubes. In an exemplary embodiment, Cotronics Resbond 940SS or 954 and 940HE that have coefficients of thermal expansion (CTE's) that nearly match the CTE of SS are used in combination since 940SS and 954 are conductive, whereas 940HE is not. In another embodiment, the ends of the tubes are coated with 940SS that is cured to create an electrically insulating oxide outer coat on the surface, then the oxide-coated surfaces are joined with 940SS or another adhesive or potting compound such as 940HE. In an embodiment, the electrical break may comprise an electrically insulating tin return flow shield, liner, or a deflector to prevent tin shorting across the electrical break. In an exemplary embodiment, the deflector comprises a shelf with an edge attached to the inside of the tube above the break such as a welded-in ring drip edge inside of the tube positioned above the break. In an embodiment, the reservoir 5c comprises a section that comprises an electrical break 913. At least a portion of the electrical break section of the reservoir may be at least partially filled with ceramic beads such as zirconia beads or other beads of the disclosure that act to at least one of thermally insulate the electrical break and prevent electrical shorting across the electrical break such as commercial electrical break or an electrical break comprising a ceramic potting compound.

The SunCell may further comprise a discharge cell 901, reaction cell chamber 5b31, top flanges 26e that may comprise a solid plate or inner PV window flanges, a PV window chamber 916, an inner PV window 5ab4, a seat for the inner PV window 26e1, and an outer PV window 5b4. The inner PV window 5ab4 may be semi-sealed (e.g., tight to molten metal, but not necessarily tight to vacuum) wherein a vacuum seal is provided by the PV window flange 26d, the inner PV window flange 26e, the vacuum-tight housing or chamber 916 that houses the semi-sealed window 5ab4 that is joined to a support 26e1 on top of the reaction cell chamber 5b31. In an exemplary embodiment, the window 5ab4 may comprise a Rayotek window comprising a gasket seal to its housing that is not vacuum tight. Alternatively, the exemplary window 5ab4 may comprise flat plate or cavity window clamped, glued, or fixed by a gasketed joint or union to a support on the top of the reaction cell chamber 5b31 such as to an inner PV window flange support 26eL. Exemplary clamps are C-clamps between the support 26e1 and the window 5ab4. The inner PV window 5ab4 may be connected to the inner PV window flange support 26e1 at a counter sunk fixture. At least one of the electrical break flanges 914, the reservoir flanges 915, the inner PV window flanges 26e, and the PV window flanges 26d may provide access to the interior of at least one of the reservoirs 5c, reaction cell chamber 5b31, and inner PV window 5ab4.

In an embodiment shown in FIGS. 66J-66L and 2I144, the outer PV window 5b4 may comprise a PV window flange 26d that is sealed with a gasket and fasteners 26d1. In an exemplary embodiment, the PV window comprises fused silica, quartz, sapphire, or aluminum oxynitride in the form of a half dome with a precision milled or lapped flange of the same material as the window wherein the window may be sealed with a Graphoil, vermiculite, or ceramic fiber gasket, a metal ring on top of the flange, and clamps 26d1. The PV window dome 5b4 may further be sealed with a vacuum adhesive. The adhesive may comprise a commercial high temperature metal to metal or window to metal sealant such as a high temperature vacuum epoxy such as (i) Torr Seal TS10 and 353ND vacuum epoxy (ThorLabs), (ii) FO-EPXY-UHV (Accu-Glass Products, Inc.), (iii) TorrSeal (Kurt J. Lesker), (iv) EP30-2, EP29LPSP, and EP21TCHT-1 (Masterbond), and (v) KB 1039 CRLP, KB 1040 CTE-LO, KB 10473 FLAO, and KB 1372-LO (Kohesi Bond).

In an embodiment having tin as the molten metal, the SunCell comprises a means to prevent at least one of the PV windows 5b4 and 5ab4 (FIG. 66F-66L) from being opacified by at least one of tin metal and tin oxide. In an embodiment, the PV window comprises a means such as a window temperature controller to maintain the PV window temperature above the melting point of at least one of tin (MP 232° C.) and tin oxide such as SnO (MP 1080° C.) and SnO₂ (MP 1630° C.). The window temperature controller may comprise at least one of a heater or chiller, a temperature sensor, and a controller to maintain a desired PV window temperature such as one in at least one range of 200° C. to 2500° C., 232° C. to 2000° C., 232° C. to 1800° C., and 232° C. to 1650° C. The heater or chiller may comprise a stream of heated or cooled air applied to the window. In the latter case, the PV window may be heated by the hydrino plasma. In another embodiment, the PV window may be cleaned of tin oxide by hydrogen reduction. The reducing hydrogen reactant may comprise hydrogen gas flowed into the reaction cell chamber wherein the hydrogen pressure is controlled using the hydrogen source, flow controller, pressure and flow gauges, lines, and computer to achieve the reduction. At least one of the hydrogen pressure and PV window temperature may be controlled to provide conditions that are thermodynamically favorable for the reduction of tin oxide by hydrogen. The hydrogen pressure may be in the range of 1 milliTorr to 10 atm. The PV window temperature may be in at least one range of 100° C. to 2500° C., 232° C. to 2000° C., 232° C. to 1800° C., and 232° C. to 1650° C. The hydrogen reaction may occur intermittently at a different hydrogen pressure than on desired to optimize the hydrino reaction rate. The PV window may be cleaned by the hydrino reaction plasma. The PV window may be cleaned by injection of molten tin onto the window surface. The injection may be by the injector EM pumps or independent EM pumps. The EM pump or pumps that clears the window may comprise a raster injector having a raster mechanism that scans the injection over the window surface. The raster mechanism may comprise an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or rotate the direction of the injected molten metal stream. In another embodiment, the window may comprise at least one of a coating that resists tin oxide adherence such as a carbon coating, a spinning window, a mechanical scraper, and a gas jet such as ones of the disclosure.

In an exemplary embodiment, the PV window such as at least one of 5ab4 and 5b4 is cleaned by injecting molten metal onto the inner surface from at least one nozzle with a plurality of ejection apertures or orifices such as one to inject tin to an opposing stream and another to inject tin onto the PV window to clean it of debris such as metal oxide and metal. The molten metal injected onto the window may further provide additional cooling, and, in some embodiments, may prevent or decrease window overheating or structural deformations of the window associated with overheating (e.g., warping, cracking, decreases in transparency). In an embodiment, the window maintains a steady state temperature due to radiative heat loss at its operating blackbody temperature that balances the optical power and thermal power that is absorbs to heat it.

In an embodiment, the injected molten metal stream velocity may be high such that the intersection of the streams causes molten metal to splatter onto the PV window to at least one of clean and cool it.

In an embodiment, the SunCell® such as one comprising dual molten metal injectors comprises an injector alignment mechanism or aligner such as an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or rotate at least one of the nozzle 5q, the injector 5k61, reservoir 5c, break reservoir EM pump assembly 914a (FIG. 66G), and the EM pump assembly 5kk. The aligner may cause the corresponding molten metal stream injected from the aligned nozzle to change to a desired direction to achieve alignment with the opposing stream injected by the opposing injector resulting in intersection of the molten metal streams. The aligner may comprise a sensor such as an ignition current or voltage sensor and a controller such as a computer to automatically align the aligned injector to maintain the stream intersection. The aligner may comprise a mechanical linkage such as a gear system to rotate the nozzle 5q to achieve alignment wherein the nozzle may comprise a non-symmetrical aperture. The aligner may comprise at least one mechanical push-pull rod connected to the injector 5k61 or nozzle 5q that mechanically moves the injector 5k61 or nozzle 5q. The rod may penetrate the reservoir 5c through a conduit to a drive mechanism wherein at least one of the conduit and drive is hermetically sealed. The drive mechanism may comprise at least one of a threaded rod collar and a means to rotate the rod, and a pneumatic, hydraulic, and piezoelectric actuator or other actuator of the disclosure to push or pull the rod.

In an embodiment, the nozzle aligner may comprise at least one sensor such as a PV cell such as one of the PV converter 26a that senses the light emitted from the PV window or PV window cavity, a processor such as a computer to process the light intensity recorded by the sensor, and a controller to control the movement of at least one actuator of the aligner to cause molten metal injected by at least one nozzle to be directed to locations on the inside of the PV window or PV window cavity. The directed flow may be in response to a diminution of the light transmitted due the window becoming coated by metal or metal oxide. The resulting increased flow at the location may enhance the removal of the window coating.

In another embodiment of SunCell comprising dual molten metal injectors, the EM pump assembly 5kk may be mounted to a slide table 409c (FIGS. 66B-66L and 2I144) with supports 409k to mount and align the corresponding slanted EM pump assemblies 5kk and reservoirs 5c. The SunCell supports 409k, may comprise turnbuckles that are adjustable to any height and may lock with locknuts. The supports 409k may be electrically isolated from the slide table 409c by electrical isolators such as ceramic or Teflon washers 409c1. The washers may be at the base of the supports 409k. The SunCell may comprise an electrical break 913 (FIGS. 66G-66L and 2I144) that electrically isolates the break EM pump assembly 914a from the reaction cell chamber 5b31, reservoir section above the break, the opposing reservoir 5c, and the reservoir EM pump assembly 915a. At least one of the reaction cell chamber 5b31, reservoir section above the break, the opposing reservoir 5c, and the reservoir EM pump assembly 915a may be at least one of further supported and rigidly attached to the slide table 409c independently of the support of the break EM pump assembly 914a. An exemplary rigid support on each side of the reaction cell chamber is reaction cell chamber support 918 shown in FIGS. 66H-66L and 2I144. In an embodiment, the support 918 may comprise a pressure controller such as a deformable bushing or spring 922 at the base 409c end to maintain a desired support pressure as the SunCell components contract and expand. The reservoir comprising the electrical break 913 may further comprise a flexible reservoir section such as a welded-in or flange-connected bellows 917 (e.g. such as https://www.mcmaster.com/bellows/expansion-joints-with-butt-weld-ends/https://www.mcmaster.com/bellows/expansion-joints-with-butt-weld-ends/or https://www.mcmaster.com/bellows/high-temperature-all-metal-expansion-joints-with-flanged-ends/or a braided hose (e.g. https://www.mcmaster.com/bellows/extreme-temperature-air-and-steam-hose-with-male-threaded-fittings/}. The flexible section may comprise a material such as tantalum or be coated with a coating such as a Flameproof paint, chrome, chromium carbide, alumina, tantalum, TiN, CrN, TiAlN, or another coating of the disclosure that protects the flexible section such as a bellows from alloy formation with the molten metal. The flexible section may comprise a liner such as a thermal insulator such as one comprising BN, Macor, quartz, alumina, zirconia, or another of the disclosure to protect the flexible section from overheating. The liner may be sectional, segmented, or loose fitting to permit flexibility. The flexible section 917 may be connected above or below the electrical break 913. The aligner may comprise at least one tilt system to selectively tilt the cylindrical axis of the bellows by compression of one side and extension of the opposite side of the flexible section. The tilt system may comprise a means to extend or contract the length of the supports 409k of the break EM pump assembly 914a to cause the corresponding injector EM pump tube 5k61 and nozzle 5q to change its direction. In an embodiment, the tilt system comprises a plurality of length-adjustable supports 409k to permit the alignment to occur in a plurality of azimuthal as well as vertical directions. The tilt system of the aligner may comprise an actuator such as a mechanical, screw jack, stepper motor, linear motor, thermal, electric, pneumatic, hydraulic, magnetic, solenoidal, piezoelectric actuator, shape memory polymer, photopolymer or other actuator known in the art to adjust the length of the supports 409k. In an exemplary embodiment, the aligner comprises (i) a bellows such as one butt-end-welded to the break 913 or a break flange 914 on one end and butt-end-welded to the reservoir 5c on the other end, (ii) four turnbuckle supports 409k electrically isolated from the slide table 409c by ceramic washers at their bases, and (iii) a mechanical means to rotate each turnbuckle to cause the nozzle position adjustment by adjusting the length of the turnbuckles wherein the reaction cell chamber 5b31 and reservoir 5c without the electrical break are rigidly supported to allow independent motion of the break EM pump assembly 914a. An exemplary rigid support is reaction cell chamber support 918 shown in FIGS. 66H-66L and 2I144. The mechanical means to rotate each turnbuckle may comprise a fixed gear on each turnbuckle, each with a mating gear and a motor such as a servomotor to rotate the mating gear to cause a length change of the turnbuckle. The rotation may be controlled by a computer that receives ignition current and voltage data from corresponding sensors. Alternatively, the aligner comprises a tilt system comprising at least one actuator such as one of the disclosure to change the length of one or more of the supports 409k to cause the alignment.

In another embodiment, the aligner comprises a flexible section such as a bellows 917 in the reservoir 5c between the reaction cell chamber 5b31 and the reservoir EM pump assembly 915a and a tilt system to selectively tilt the cylindrical axis of the bellows by compression of one side an extension of the opposite side of the bellows wherein at least the reaction cell chamber 5b31, the reservoir section 5c above the bellows, the opposing reservoir 5c, and the break EM pump assembly 914a may be at least one of further supported and rigidly attached to the slide table 409c to permit independent motion of the reservoir EM pump assembly 915a below the bellows. An exemplary rigid support is reaction cell chamber support 918 shown in FIGS. 66H-66L and 2I144. The tilt system may comprise at least one support 409k capable of adjustable length to tilt the bellows to cause the alignment. An exemplary tilt system is an actuator such as one of the disclosure to cause the length adjustment to achieve the alignment.

In alternative embodiment, the aligner comprises the flexible section such as a bellows 917 and a contraction tilt system wherein the tilt of the bellows by the tilt system is achieved by contraction of one side of the bellows rather than compression and lengthening of the opposite side of the bellows. An exemplary contraction tilt system shown in FIGS. 66H-66L and 2I144 comprises a flexible section such as a bellows 917 and a contraction or clamping device that may span the bellows 917 along its cylindrical axis and fastened to the bellows at opposite ends. An exemplary contraction tilt system comprises a frame 920 at the electrical break end of the bellows and a moveable frame 920a at the opposite end, and a plurality of contraction elements such as screws or bolts 921 that span the frames wherein the contraction or shortening of a bolt 921 causes the bellows to contract or shorten on the side of the shortened bolt and lengthen on the opposite side with the lengthening of the corresponding bolts 921. In an embodiment, at least one movable frame 920a may comprise a means for the bolts 920 to tilt as their length between the frames 920a is adjusted. The tilt means may comprise slotted holes for the bolts 920. In an embodiment, the turnbuckle supports 409k (FIG. 66I) are replaced with rigid supports that may be fastened to at least the base of the reaction cell chamber such as welded metal leg supports such as tri or quad supports. The bellows contraction elements may comprise a threaded bolt fixed at each top corner hole of bellows bracket 921 and a bushing, washer, and nut on threaded bolt portion at each corresponding lower bracket corner hole to adjust the EM pump molten metal injection direction. In another embodiment, the contraction element may each comprise a clamp such as C-clamp that may be fastened across the bellows wherein the fastener may comprise a weld. To increase the ease of contraction by the elements, the bellows may comprise a source of leverage such as metal extensions fastened perpendicular to the bellows wall such as welded-on angle or channel iron levers to which the contraction elements such as the C-clamps attach.

The contraction element may comprise an actuator such as one of the disclosure. The actuator may be attached on the outside of the bellows wherein the inside may serve as a section of the corresponding reservoir 5c.

In an embodiment, the aligner comprises a flexible section of the injector EM pump tube 5k61 such as a bellows and a system to tilt the injector EM pump tube 5k61. The tilt system may comprise a linkage such as a mechanical linkage and a system to move the linkage such as a mechanical, screw jack, stepper motor, linear motor, thermal, electric, pneumatic, hydraulic, magnetic, solenoidal, piezoelectric actuator, shape memory polymer, photopolymer or other actuator known in the art to move the linkage.

In an embodiment, at least one of the reservoir, electrical break, and bellows may comprise a magnetic material such as one having a high Curie temperature such as steel (Curie Temperature 770° C.). The magnetic material such as steel may serve as a magnetic circuit to trap ignition current flux and flux caused by reservoir eddy or image currents wherein the flux trapping acts to prevent a magnetic pinch effect instability in the molten metal stream. In an embodiment, at least one of the reservoir, electrical break, and bellows may comprise a magnetic material cladding, collar, or cover such as one comprising magnetic steel. In another embodiment, at least one of the reservoir, electrical break, and bellows may comprise an electrical insulator or a material having low or no electrical conductivity which may prevent the formation of eddy or image currents and the corresponding magnetic flux that may interfere with molten metal injection by the EM pumps.

In an embodiment shown in FIG. 66L, the nozzle 5q comprises an opening that is about centered on the end of the injector section of the EM pump tube 5k61 such that the corresponding molten metal stream is ejected parallel to the injector section of the EM pump tube 5k61. In an embodiment, each injector tube may comprise a plurality (e.g., two, three, four) of nozzles 5q, and/or each reservoir 5c may comprise be in fluid communication with a plurality of injector tubes 5k61. The height of the injector section of the EM pump tube 5k61 in the reservoir 5c may be adjusted such that the nozzle is within the reservoir to protect it from damage by exposure to more intense plasma in the reaction cell chamber 5b31. In an embodiment, the nozzle may be submerged in the molten metal pool of the reservoir. The reservoirs and the corresponding injector sections of the EM pump tubes 5k61 of two such injectors and nozzles of a dual injector SunCell may be angled relative to each other such that the ejected molten metal streams follow trajectories 941 that intersect in the reaction cell chamber 5b31. The reservoirs 5c may form an inverted V connected to the reaction cell chamber 5b31 and the PV window 5ab4 and 5b4. The angle between the reservoirs comprising the legs of the inverted V may be in the range of about 1° to 179°. The region where the reservoirs 5c connect to the reaction cell chamber 5b31 may comprise a heat spreader to prevent this area from overheating. The heat spreader may be a thickening of the walls of at least one of the reservoirs and the floor of the reaction cell chamber. The heat spreader may comprise a metal collar around the exterior top portions of the reservoirs. Exemplary heat spreaders comprise stainless steel or copper.

In an embodiment to further prevent overheating of the upper section of the reservoirs and the base of reaction cell chamber where the reservoirs attach to the base, the reaction cell chamber 5b31 may serve as a receptable for an insert. The insert may comprise the reaction cell chamber floor liner 5b31b and sections of the reservoirs 5c in connection with the reaction cell chamber 5b31. The insert may comprise a refractory material such as at least one comprising ceramic, carbon, quartz, a refractory metal such as tungsten, and another refractory material of the disclosure or known in the art. The insert may comprise a composite of materials. The insert may comprise a plurality of parts that may be fastened together. The fastener may comprise glue, braze, weld, bolts, screws, clamps, or another fastener of the disclosure or known in the art. In the case of glued carbon parts, an exemplary glue comprises Aremco Products Graphitic Bond 551RN. The reservoirs may comprise metal tubes of any desired cross section geometry (e.g. circular, square, or rectangular), fastened to the base of the reaction cell chamber. The corresponding fasteners may comprise welds. The metal may comprise stainless steel or another of the disclosure.

In an alternative embodiment, the reservoirs are fastened or fused to each other (e.g. as shown in FIGS. 66M and 66N), the fasteners such as welds may be above the electrical break 913 of each reservoir to maintain electrical isolation of the molten metal injector electrodes. In this fused reservoir embodiment shown in FIGS. 66M and 66N, the reservoirs are only partially connected directedly to the metal reaction cell chamber base, and the base in the center region where the reservoirs are attached to each other is removed. The connection from the base to the joined section of the reservoirs may comprise bridging metal sections such as such as flat trapezoidal and triangular sections that are joined together and joined to the reservoirs in the center regions as shown in FIGS. 66N-66M. The joints may comprise welds. In an embodiment, a thick insert liner fills the base cavity, the cavity formed by the corresponding connections to the joined reservoirs. The insert liner may comprise at least one of the base liner 5b31b and the reservoir liner. In an exemplary embodiment, the insert comprises a thick carbon or carbon-like block liner such as a Calcarb liner that inserts into the reaction cell chamber at the base to form the reaction cell chamber base liner 5b31b. The block liner may comprise two tubes machined into the block having the diameter of the reservoirs angled to the vertical to align with the reservoir tubes of about the same cross-sectional dimensions. The angle may be in the range of about 5° to 85° to the vertical. The thickness of the block may be in the range of about 1 mm to 100 mm and fit at least one of the base of the reaction cell chamber, the base cavity, and the reservoirs. In another embodiment, the machined tubes may have a minimum diameter to support the operation of the reservoirs such that it reduces the plasma volume in the reservoirs to reduce their heat load. The liner tube diameter may be in the range of 1% to 100% of the diameter of the reservoirs.

In an embodiment, components such as the upper reservoir 5cb, the electrical break 913, and the bellows 917 (FIGS. 66F-66N) may be connected by flanges 914 that may be gasketed and bolted, or welded. Alternatively, the components may be welded directly together. In an exemplary embodiment, a component union may comprise a reducer such as one to weld the electrical break 913 to the upper reservoir 5cb.

The electrical break may be coated internally to protect it from alloy formation with the molten metal. The coating may comprise an electrical insulator. Exemplary coatings are VHT paint, Mullite, alumina, and others of the disclosure. The electrical break may further comprise a liner such as an electrically insulating liner such as a BN, quartz, or another liner of the disclosure.

In an embodiment, the nozzles 5q are oriented in the direction of the injector EM pump tube further comprising an extended height reaction cell chamber 5b31 to permit the molten metal streams to intersect within the reaction cell chamber 5b31 that may further comprise at least a portion of any cavity formed by the PV window 5b4. In an embodiment, at least one of the reaction cell chamber and the PV window may comprise a geometry comprising the vertical portion of an inverted Y. This section may comprise any desired geometrical horizontal cross section such as a circle or a square. The reaction cell chamber may comprise a liner 5b31a such as one comprising at least one of carbon and W. In an embodiment, at least a portion one or more side walls of the reaction cell chamber 5b31 may comprise a PV window. In an exemplary embodiment shown in FIGS. 66C-66D and 66L, the PV window may comprise a transparent rectangular or cubic chamber such as one comprising quartz or sapphire that is connected to the reaction cell chamber 5b31 by a union such as one comprising a lapped quartz or sapphire flange mated to a matching metal flange. In a further exemplary embodiment, the corresponding PV chamber formed by the PV window(s) may comprise the reaction cell chamber 5b31 shown in FIG. 66L wherein the union is at the base where the reservoirs connect to the reaction cell chamber. The union may be sealed with a gasket such as a graphite gasket and clamps or by glue or adhesive. In an alternative embodiment, the rectangular or cubic chamber may comprise a frame with quartz or sapphire window panels that are sealed with gaskets or glued or adhered to the frame such as a metal frame. In either embodiment, the glue or adhesive may comprise one of the disclosure. The adhesive may comprise a composite such as a plurality of layers to allow adhesion to the frame and adhesion to the window by corresponding layers of different adhesives. In an embodiment, the base or frame may comprise an anchor such as a metal screen welded or soldered to the base or frame wherein the adhesive is applied to the anchor and to the window such as a quartz or sapphire window.

In an embodiment, the anchor comprises a thin metal annulus comprising a cylinder with a collar or flange at each end of the cylinder. The anulus may be welded vacuum tightly to the base or frame, and the opposite collar of the annulus may be glued to the PV window. The annulus may comprise at least one expansion means such as at least one circumferential pleat in the cylinder or anulus wall. The glue union may comprise multiple layers such as one on the base or frame side and one on the window side of the corresponding glue union. In an embodiment, the thermal coefficient of expansion of the flange, the glue, and the window are about matched for the operating temperature range. In an exemplary embodiment, a sapphire window is glued to a selected stainless-steel (SS) flange having a matched similar coefficient of expansion. In an embodiment, the SS may comprise Kovar or Invar. The glue or adhesive may comprise one of the disclosure. The glue union may be replaced with a suitable braze such as one that is capable of high temperature operation such as one of the disclosure. The operating temperature may be in the range of about 300° C. to 2000° C.

In an embodiment, the EM pump pressure may be increased to cause molten metal to be injected on the surface of at least one of a top 5ab4 and 5b4 and side windows of the PV window chamber to clean the windows of material such as metal oxide such as tin oxide or gallium oxide.

In an embodiment, at least one set of flanges such as 914 and 915 shown in FIGS. 66H-66L and 2I144 as well as other flanges such as 26d, 26e, and 902 may be replaced by flat metal plates (no bolt holes) such as annuluses around the perimeter of each joined component. The plates may be welded together on the outer edges to form a seam. The seam may be cut or ground off to separate the two plates.

In an embodiment, the injector EM pump tube 5k61 such as a one that is at least one of refractory and resistant to alloy formation with the molten metal such as a W or Ta one may comprise a tube fastener to fasten the tube to a collar on the EM pump baseplate 5kk1. The fastener may comprise a weld. The fastener may comprise a compression fitting. Alternatively, the fastener may comprise an adhesive or potting compound such as one of the disclosure such as a ceramic such as Cotronics Resbond 940SS that may have a similar thermal expansion coefficient as stainless steel, Cotronics Resbond 940 HT, or Sauereisen Electrotemp Cement. Exemplary high temperature glues or adhesives of the disclosure are Cotronics Resbond 907GF, 940HT, 940LE, 940HE, 940SS, 903 HP, 908, or 904 zirconia adhesive, a zirconium oxide coating such as Aremco Ultra-Temp 516 comprising ZrO₂—ZrSiO₄, and Durabond as such as RK454. In another embodiment, the fastener comprises EM pump tube and collar annuli such as washers on each wherein the annuli may be welded on the edges to fasten the tube. Alternatively, the EM pump tube may comprise an annulus to secure the tube to the collar welded to the baseplate using a cover such as a carbon plate that pushes the annulus against the baseplate. The plate may be glued to the baseplate or held in place by at least one fastener. The components such as the collar, annulus, and fasteners may be coated with a tin alloy resistant coating such as one of the disclosure such as CrC, alumina, or Ta.

At least one of the EM pump tubes 5k6, reservoirs 5c, and reaction cell chamber 5b31 may be coated with a coating that protects the underlying metal from alloy formation with the molten metal. Exemplary coating are oxides, carbides, diborides, nitrides, a ceramic one such as Flameproof paint, and another of the disclosure. At least one of the EM pump tubes 5k6, reservoirs 5c, and reaction cell chamber 5b31 such as at least one of the walls and base may be lined with a liner. An exemplary liner is carbon or a ceramic such as alumina such as 96+% alumina or FG995 Alumina circumferential to a tungsten liner. The carbon may be coated with an electrical insulator such as Flameproof paint, ZrO₂, or Resbond 907GF. The reservoir 5c and reaction cell chamber 5b31 may have a polygonal cross section such as a square or rectangular cross section. The liner such as one comprising at least one of carbon and tungsten may comprise plates of the liner material that may be beveled together at plate intersections.

In embodiments of the disclosure, the coatings of SunCell components such as the reaction cell chamber, the inlet riser, the reservoirs, and EM pump tube may comprise one manufactured by ZYP coatings such as yttrium oxide, hafnium-titanium oxide, zirconium oxide, YAG, 3Y₂O₃-5Al₂O₃, and aluminum oxide. At least one ZYP coating may substitute for Flameproof paint.

At least one of the reaction cell chamber 5b31 and the PV window chamber 916 may further comprise at least one structural support to support the weight of at least one of the reaction cell chamber 5b31 and the PV window chamber 916 such as at least one column or turnbuckle 409k that may be attached to table 409c. In an alternate embodiment, the SunCell may be supported by brackets attached to the baseplate 5b31c wherein the brackets are connected to a support structure or frame. The reservoirs may be suspended or supported by flexible support rods to the reservoir plates 5kk1. To hold the magnets 5k4 in place, the EM pump assembly 5kk may comprise brackets between the EM pump magnets 5k4 or a magnet bracket from the reservoir baseplate 5kk1.

In an embodiment, the PV window comprises at least one blower or compressor and at least one jet to cool the PV by high velocity gas flow over the window surface. The gas such as helium or hydrogen may be selected such that it is inert, transparent to the emitted radiation, and has a high heat transfer capability.

In an embodiment, the PV window may be positioned in the center of a sphere with light recycling capable PV covering the inside of the sphere. Alternatively, the PV window may be positioned in the center of an annulus comprising a plane mirror at the bottom of a hemisphere comprising light recycling capable PV covering the inside of the hemisphere. The mirror may comprise a polished metal, ceramic such as Accuflect (Accuratus), or other reflector known in the art capable of reflecting substantially all wavelengths emitted by the SunCell such as light in the wavelength range of about 200 nm-5000 nm.

In an embodiment such as one shown in FIGS. 66L, the reaction cell chamber walls may be operated at high temperature to serve as a blackbody radiator to the PV cells of the PV converter 26a. The PV cells of the PV converter 26a may each comprise an infrared backing or bottom layer mirror to perform light recycling to the blackbody radiator walls. The reaction cell chamber walls may comprise a refractory material such as niobium that enables operation at the high temperature such as in the range of about 1000° C. to 3500° C. The walls may be coated with a coating of the disclosure such as alumina or CrC to suppress at least one of oxidation and alloy formation with the molten metal.

In an embodiment, the molten metal such as gallium or tin is flowed through a heat exchanger such as a tube in shell type that comprises a thermophotovoltaic converter. The molten metal such as gallium or tin may be pumped through the tubes that radiate to TPV cells mounted inside of the shell.

In an embodiment, the intense blackbody radiation emitted by the hydrino plasma through the PV window may be directly used as at least one of a radiative heater, a light source, and a directed energy weapon. The directed energy such as intense light emission may destroy or melt incoming projectiles such as missiles and bullets.

In an embodiment, the molten metal may comprise any known metal or alloy such as tin, gallium, Galinstan, silver, copper, Ag—Cu alloy such as 71.9% Ag/28.1% Sn, and Ag—Sn alloy such as 50% Ag/50% Sn melt. The SunCell may comprise a PV window to allow at least one of plasma and blackbody light to be emitted from the reaction cell chamber to a PV converter. In an embodiment, the reaction cell chamber comprises gas to cause the blackbody temperature to be more uniform. The gas may comprise a noble gas such as argon. The gas pressure may be high to better distribute the temperature.

The molten metal may comprise a metal such as tin that resists wetting of a PV window preventing opacification of the window. The PV window may comprise a transparent material that may be at least one of resistant to high temperature and resistant to tin wetting. The window may comprise at least one of quartz, zerodur (lithium aluminosilicate glass-ceramic), ULE (titania-silica binary glass with zero coefficient of thermal expansion (CTE)), sapphire, aluminum oxynitride, MgF₂, glass, Pyrex, and other such windows known in the art. The window may be capable of operating at high temperature such as in the range of about 200° C. to 1800° C. and may serve as a blackbody radiator in addition to transmitting plasma emission from inside of the reaction cell chamber. Suitable exemplary high temperature-capable windows are those of Rayotek's High Pressure, High Temperature Sight Glass Windows (HTHP) (https://rayoteksightwindows.com/products/high-temp-sight-glass-windows.html).

In an embodiment, the PV window is at least one of cleaned and cooled with at least one of a gas blanket, gas jet, high-pressure jet, or gas knife from a source such as a gas nozzle or injector, a gas source, and a flow and pressure controller such as a pressure sensor, a valve, and a computer which may operate during plasma generation. The gas may comprise at least one of a noble gas such as argon and steam. In an embodiment, a window cleaner comprises a water jet that may be pulsed wherein the excess water may be pumped off as steam. In an embodiment, the gas jet may comprise steam. The window may comprise a local vacuum port connected to a vacuum pump to remove steam before it flows into the reaction cell chamber. The window may further comprise a baffle such as a gate valve to close of the window from the reaction cell chamber to permit the steam to be selectively pumped off by the local vacuum port and vacuum pump. In an embodiment, the window may comprise a molten metal pump such as an electromagnetic pump to inject the molten metal such as gallium, tin, silver, copper, or alloys thereof onto the inner surface of window to clean it.

In an embodiment, the molten metal comprises tin. In an embodiment, the PV window comprises a conducting transparent coating such as indium tin oxide. A bias may be applied to the window by a voltage source to repel adhering particles such as tin and SnO particles. In an embodiment, the window is plasma cleaned by a source of plasma such as a glow discharge source. In an embodiment, at least one of the window or a housing for the window may further comprise an electrode of the glow discharge. In an embodiment, the PV window is in proximity to the glow discharge cell 900 (FIG. 16.19A) that provides HOH and atomic H to the reaction cell chamber 5b31. The discharge cell may be at least one of position or angled such that atomic hydrogen formed in the discharge cell from supplied molecular hydrogen flows over the surface of the PV window. The atomic hydrogen may react with tin or tin oxide to form volatile SnH₄ to clean the PV window. In an embodiment, the outlet of the discharge cell may comprise a baffle or deflector to cause the flow of atomic hydrogen from the outlet of the discharge cell to be incident on the PV window. The baffle or divertor may comprise a material that a low hydrogen recombination coefficient or low capacity for recombination such as glass, quartz, or a ceramic such as alumina or BN.

In an embodiment, the power generation system (called SunCell) comprises at least one plasma cell comprising (i) a discharge plasma generation cell 900 that generates a water/hydrogen mixture to be directed towards the molten metal cell through the discharge plasma generation cell and (ii) a discharge plasma ignition cell that creates a discharge plasma in the reaction cell chamber 5b31 wherein at least one of the plasma cells causes the ignition of a hydrino plasma in the reaction cell chamber 5b31 wherein the hydrino plasma comprises a plasma that is at least partially powered and sustained by the hydrino reaction. In these embodiments, the discharge plasma generation cell such as a glow discharge cell induces the formation of a first plasma from a gas (e.g., a gas comprising a mixture oxygen and hydrogen); wherein effluence of the discharge plasma generation cell is directed towards any part of the molten metal circuit (e.g., the molten metal, the anode, the cathode, an electrode submerged in a molten metal reservoir, either of two molten metal reservoirs, either of two injector molten metal electrodes). In these embodiments, the discharge plasma ignition cell such as a glow discharge cell induces a discharge in the reaction cell chamber such as a gas discharge to cause ignition of the hydrino reaction in the reaction cell chamber. The electrodes of the discharge plasma ignition may comprise the ignition electrodes. The electrodes of the discharge cell may comprise at least one of the anode, the cathode, an electrode submerged in a molten metal reservoir, either of two molten metal reservoirs, either of two injector molten metal electrodes, the reservoir, the reaction cell chamber, and an independent discharge plasma ignition electrode that penetrates the reaction cell chamber through an electrical isolating connector such as a feedthrough. The discharge plasma ignition electrode may be a metal such as Ta, W, or a coated metal such as a carbide or nitride coated stainless steel electrode that resists alloy formation with the molten metal.

In an embodiment, the light to electricity converter comprises the photovoltaic converter of the disclosure comprising photovoltaic (PV) cells that are responsive to a substantial wavelength region of the light emitted from the cell such as that corresponding to at least 10% of the optical power output. In an embodiment, the PV cells are concentrator cells that can accept high intensity light, greater than that of sunlight such as in the intensity range of at least one of about 1.5 suns to 75,000 suns, 10 suns to 10,000 suns, and 100 suns to 2000 suns. The concentrator PV cells may comprise c-Si that may be operated in the range of about 1 to 1000 Suns. The silicon PV cells may be operated at a temperature that performs at least one function of improving the bandgap to better match the blackbody spectrum and improving the heat rejection and thereby reducing the complexity of the cooling system. In an exemplary embodiment, concentrator silicon PV cells are operated at 100 to 500 Suns at about 130° C. to provide a bandgap of about 0.84 V to match the spectrum of a 3000° C. blackbody radiator. The PV cells may comprise a single junction or a plurality of junctions such as triple junctions. The concentrator PV cells may comprise single junction Si or single junction Group III/V semiconductors or a plurality of layers such as those of Group II/V semiconductors such as at least one of the group of InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge. The plurality of junctions such as triple or double junctions may be connected in series. In another embodiment, the junctions may be connected in parallel. The junctions may be mechanically stacked. The junctions may be wafer bonded. In an embodiment, tunnel diodes between junctions may be replaced by wafer bonds. The wafer bond may be electrically isolating and transparent for the wavelength region that is converted by subsequent or deeper junctions. Each junction may be connected to an independent electrical connection or bus bar. The independent bus bars may be connected in series or parallel. The electrical contact for each electrically independent junction may comprise grid wires. The wire shadow area may be minimized due to the distribution of current over multiple parallel circuits or interconnects for the independent junctions or groups of junctions. The current may be removed laterally. The wafer bond layer may comprise a transparent conductive layer. An exemplary transparent conductor is a transparent conductive oxide (TCO) such as indium tin oxide (ITO), fluorine doped tin oxide (FTO), and doped zinc oxide and conductive polymers, graphene, and carbon nanotubes and others known to those skilled in the art. Benzocyclobutene (BCB) may comprise an intermediate bonding layer. The bonding may be between a transparent material such a glass such as borosilicate glass and a PV semiconductor material. An exemplary two-junction cell is one comprising a top layer of GaInP wafer bonded to a bottom layer of GaAs (GaInP//GaAs). An exemplary four-junction cell comprises GaInP/GaAs/GaInAsP/GaInAs on InP substrate wherein each junction may be individually separated by a tunnel diode (/) or an isolating transparent wafer bond layer (//) such as a cell given by GaInP//GaAs//GaInAsP//GaInAs on InP. The PV cell may comprise InGaP//GaAs//InGaAsNSb//Conductive Layer//Conductive Layer//GaSb//InGaAsSb. The substrate may be GaAs or Ge. The PV cell may comprise Si—Ge—Sn and alloys. All combinations of diode and wafer bonds are within the scope of the disclosure. An exemplary four-junction cell having 44.7% conversion efficacy at 297-times concentration of the AM1.5d spectrum is made by SOITEC, France. The PV cell may comprise a single junction. An exemplary single junction PV cell may comprise a monocrystalline silicon cell such as one of those given in Sater et al. (B. L. Sater, N. D. Sater, “High voltage silicon VMJ solar cells for up to 1000 suns intensities”, Photovoltaic Specialists Conference, 2002. Conference Record of the Twenty-Ninth IEEE, 19-24 May 2002, pp. 1019-1022.) which is herein incorporated by reference in its entirety. Alternatively, the single junction cell may comprise GaAs or GaAs doped with other elements such as those from Groups III and V. In an exemplary embodiment, the PV cells comprise triple junction concentrator PV cells or GaAs PV cells operated at about 1000 suns. In another exemplary embodiment, the PV cells comprise c-Si operated at 250 suns. In an exemplary embodiment, the PV may comprise GaAs that may be selectively responsive for wavelengths less than 900 nm and InGaAs on at least one of InP, GaAs, and Ge that may be selectively responsive to wavelengths in the region between 900 nm and 1800 nm. The two types of PV cells comprising GaAs and InGaAs on InP may be used in combination to increase the efficiency. Two such single junction types cells may be used to have the effect of a double junction cell. The combination may be implemented by using at least one of dichroic mirrors, dichroic filters, and an architecture of the cells alone or in combination with mirrors to achieve multiple bounces or reflections of the light as given in the disclosure. In an embodiment, each PV cell comprises a polychromat layer that separates and sorts incoming light, redirecting it to strike particular layers in a multi-junction cell. In an exemplary embodiment, the cell comprises an indium gallium phosphide layer for visible light and gallium arsenide layer for infrared light where the corresponding light is directed. The PV cell may comprise a GaAs_{1-x-y}NₓBi_{y} alloy.

The PV cells may comprise silicon. The silicon PV cells may comprise concentrator cells that may operate in the intensity range of about 5 to 2000 Suns. The silicon PV cells may comprise crystalline silicon and at least one surface may further comprise amorphous silicon that may have a different bandgap than the crystalline Si layer. The amorphous silicon may have a wider bandgap than the crystalline silicon. The amorphous silicon layer may perform at least one function of causing the cells to be electro-transparent and preventing electron-hole pair recombination at the surfaces. The silicon cell may comprise a multijunction cell. The layers may comprise individual cells. At least one cell such as a top cell such as one comprising at least one of Ga, As, InP, Al, and In may be ion sliced and mechanically stacked on the Si cell such as a Si bottom cell. At least one of layers of multi-junction cells and cells connected in series may comprise bypass diodes to minimize current and power loss due to current mismatches between layers of cells. The cell surface may be textured to facilitate light penetration into the cell. The cell may comprise an antireflection coating to enhance light penetration into the cell. The antireflection coating may further reflect wavelengths below the bandgap energy. The coating may comprise a plurality of layers such as about two to 20 layers. The increased number of layer may enhance the selectivity to band pass a desired wavelength range such as light above the bandgap energy and reflect another range such as wavelengths below the bandgap energy. Light reflected from the cell surface may be bounced to at least one other cell that may absorb the light. The PV converter may comprise a closed structure such as a geodesic dome to provide for multiple bounces of reflected light to increase the cross section for PV absorption and conversion. The geodesic dome may comprise a plurality of receiver units 200 (FIG. 2I133) such as triangular units covered with PV cells 15. The dome may serve as an integrating sphere. The unconverted light may be recycled. Light recycling may occur through reflections between member receiver units such as those of a geodesic dome. The surface may comprise a filter that may reflect wavelengths below the bandgap energy of the cell. The cell may comprise a bottom mirror such as a silver or gold bottom layer to reflector un-absorbed light back through the cell. Further unabsorbed light and light reflected by the cell surface filter may be absorbed by a blackbody radiator and re-emitted to the PV cell wherein the blackbody radiation comprises at least one of a component of the SunCell such as at least one wall of the reaction cell chamber and the reservoir. In an embodiment, the PV substrate may comprise a material that is transparent to the light transmitted from the bottom cell to a reflector on the back of the substrate. An exemplary triple junction cell with a transparent substrate is InGaAsP (1.3 eV), InGaAsP (0.96 eV), InGaAs (0.73 eV), InP substrate, and copper or gold IR reflector. In an embodiment, the PV cell may comprise a concentrator silicon cell. The multijunction III-V cell may be selected for higher voltage, or the Si cell may be selected for lower cost. The bus bar shadowing may be reduced by using transparent conductors such as transparent conducting oxides (TCOs).

The PV cell may comprise perovskite cells. An exemplary perovskite cell comprises the layers from the top to bottom of Au, Ni, Al, Ti, GaN, CH₃NH₃SnI₃, monolayer h-BN, CH₃NH₃PbI₃₋ₓBrₓ, HTM/GA, bottom contact (Au).

The cell may comprise a multi p-n junction cell such as a cell comprising an AlN top layer and GaN bottom layer to converter EUV and UV, respectively. In an embodiment, the photovoltaic cell may comprise a GaN p-layer cell with heavy p-doping near the surface to avoid excessive attenuation of short wavelength light such as UV and EUV. The n-type bottom layer may comprise AlGaN or AlN. In an embodiment, the PV cell comprises GaN and AlₓGa₁₋ₓN that is heavily p-doped in the top layer of the p-n junction wherein the p-doped layer comprises a two-dimensional-hole gas. In an embodiment, the PV cell may comprise at least one of GaN, AlGaN, and AlN with a semiconductor junction. In an embodiment, the PV cell may comprise n-type AlGaN or AlN with a metal junction. In an embodiment, the PV cell responds to high-energy light above the band gap of the PV material with multiple electron-hole pairs. The light intensity may be sufficient to saturate recombination mechanisms to improve the efficiency.

The converter may comprise a plurality of at least one of (i) GaN, (ii) AlGaN or AlN p-n junction, and (iii) shallow ultra-thin p-n heterojunction photovoltaics cells each comprising a p-type two-dimensional hole gas in GaN on an n-type AlGaN or AlN base region. Each may comprise a lead to a metal film layer such as an Al thin film layer, an n-type layer, a depletion layer, a p-type layer and a lead to a metal film layer such as an Al thin film layer with no passivation layer due to the short wavelength light and vacuum operation. In an embodiment of the photovoltaic cell comprising an AlGaN or AlN n-type layer, a metal of the appropriate work function may replace the p-layer to comprise a Schottky rectification barrier to comprise a Schottky barrier metal/semiconductor photovoltaic cell.

In another embodiment, the converter may comprise at least one of photovoltaic (PV) cells, photoelectric (PE) cells, and a hybrid of PV cells and PE cells. The PE cell may comprise a solid-state cell such as a GaN PE cell. The PE cells may each comprise a photocathode, a gap layer, and an anode. An exemplary PE cell comprises GaN (cathode) cessiated/AlN (separator or gap)/Al, Yb, or Eu (anode) that may be cessiated. The PV cells may each comprise at least one of the GaN, AlGaN, and AlN PV cells of the disclosure. The PE cell may be the top layer and the PV cell may be the bottom layer of the hybrid. The PE cell may convert the shortest wavelength light. In an embodiment, at least one of the cathode and anode layer of the PE cell and the p-layer and the n-layer of a PV cell may be turned upside down. The architecture may be changed to improve current collection. In an embodiment, the light emission from the ignition of the fuel is polarized and the converter is optimized to use light polarization selective materials to optimize the penetration of the light into the active layers of the cell.

In an embodiment, the light emission from the hydrino plasma in the reaction cell chamber through the PV window to the PV converter may comprise predominantly ultraviolet light and extreme ultraviolet such as light in the wavelength region of about 10 nm to 300 nm. The PV cell may be response to at least a portion of the wavelength region of about 10 nm to 300 nm. The PV cells may comprise concentrator UV cells. The cells may be responsive to blackbody radiation. The blackbody radiation may be that corresponding to at least one temperature range of about 1000K to 6000K. The incident light intensity may be in at least one range of about 2 to 100,000 suns and 10 to 10,000 suns. The cell may be operated in a temperature range known in the art such as at least one temperature range of about less than 300° C. and less than 150° C. The PV cell may comprise a group III nitride such as at least one of InGaN, GaN, and AlGaN. In an embodiment, the PV cell may comprise a plurality of junctions. The junctions may be layered in series. In another embodiment, the junctions are independent or electrically parallel. The independent junctions may be mechanically stacked or wafer bonded. An exemplary multi-junction PV cell comprises at least two junctions comprising n-p doped semiconductor such as a plurality from the group of InGaN, GaN, and AlGaN. The n dopant of GaN may comprise oxygen, and the p dopant may comprise Mg. An exemplary triple junction cell may comprise InGaN//GaN//AlGaN wherein // may refer to an isolating transparent wafer bond layer or mechanical stacking. The PV may be run at high light intensity equivalent to that of concentrator photovoltaic (CPV). The substrate may be at least one of sapphire, Si, SiC, and GaN wherein the latter two provide the best lattice matching for CPV applications. Layers may be deposited using metalorganic vapor phase epitaxy (MOVPE) methods known in the art. The cells may be cooled by cold plates such as those used in CPV or diode lasers such as commercial GaN diode lasers. The grid contacts may be mounted on the front and back surfaces of the cells as in the case of CPV cells. In an embodiment, the surface of the PV cell such as one comprising at least one of GaN, AlN, and GaAlN may be terminated. The termination layer may comprise at least one of H and F. The termination may decrease the carrier recombination effects of defects. The surface may be terminated with a window such as AlN.

In an embodiment, at least one of the PV window and a protective window of the photovoltaic (PV) and photoelectric (PE) converter may be substantially transparent to the light to which it is responsive. The window may be at least 10% transparent to the responsive light. The window may be transparent to UV light. The window may comprise a coating such as a UV transparent coating on the PV or PE cells. The coating may be applied by deposition such as vapor deposition. The coating may comprise the material of UV windows of the disclosure such as a sapphire or MgF₂ window. Other suitable windows comprise LiF and CaF₂. Any window such as a MgF₂ window may be made thin to limit the EUV attenuation. In an embodiment, the PV or PE material such as one that is hard, glass-like such as GaN serves as a cleanable surface. The PV material such as GaN may serve as the window. In an embodiment, the surface electrodes of the PV or PE cells may comprise the window. The electrodes and window may comprise aluminum. The window may comprise at least one of aluminum, carbon, graphite, zirconia, graphene, MgF₂, an alkaline earth fluoride, an alkaline earth halide, Al₂O₃, and sapphire. The window may be very thin such as about 1 Å to 100 Å thick such that it is transparent to the UV and EUV emission from the cell. Exemplary thin transparent thin films are Al, Yb, and Eu thin films. The film may be applied by MOCVD, vapor deposition, sputtering and other methods known in the art.

In an embodiment, the cell may covert the incident light to electricity by at least one mechanism such as at least one mechanism from the group of the photovoltaic effect, the photoelectric effect, the thermionic effect, and the thermoelectric effect. The converter may comprise bilayer cells each having a photoelectric layer on top of a photovoltaic layer. The higher energy light such as extreme ultraviolet light may be selectively absorbed and converted by the top layer. A layer of a plurality of layers may comprise a UV window such as the MgF₂ window. The UV window may protect ultraviolet UV) PV from damage by ionizing radiation such as damage by soft X-ray radiation. In an embodiment, low-pressure cell gas may be added to selectively attenuate radiation that would damage the UV PV. Alternatively, this radiation may be at least partially converted to electricity and at least partially blocked from the UV PV by the photoelectronic converter top layer. In another embodiment, the UV PV material such as GaN may also convert at least a portion of the extreme ultraviolet emission from the cell into electricity using at least one of the photovoltaic effect and the photoelectric effect.

The photovoltaic converter may comprise PV cells that convert ultraviolet light into electricity. Exemplary ultraviolet PV cells comprise at least one of p-type semiconducting polymer PEDOT-PSS: poly(3,4-ethylenedioxythiophene) doped by poly(4-styrenesulfonate) film deposited on a Nb-doped titanium oxide (SrTiO3:Nb) (PEDOT-PSS/SrTiO3:Nb heterostructure), GaN, GaN doped with a transition metal such as manganese, SiC, diamond, Si, and TiO₂. Other exemplary PV photovoltaic cells comprise n-ZnO/p-GaN heterojunction cells.

To convert the high intensity light into electricity, the generator may comprise an optical distribution system and photovoltaic converter 26a such as that shown in FIG. 21132. The optical distribution system may comprise a plurality of semitransparent mirrors arranged in a louvered stack along the axis of propagation of light emitted from the cell wherein at each mirror member 23 of the stack, light is at least partially reflected onto a PV cell 15 such as one aligned parallel with the direction of light propagation to receive transversely reflected light. The light to electricity panels 15 may comprise at least one of PE, PV, and thermionic cells. The window to the converter may be transparent to the cell emitted light such as short wavelength light or blackbody radiation such as that corresponding to a temperature of about 1000K to 4000K wherein the power converter may comprise a thermophotovoltaic (TPV) power converter. The PV window or the window to the PV converter may comprise at least one of sapphire, aluminum oxynitride, LiF, MgF₂, and CaF₂, other alkaline earth halides such as fluorides such as BaF₂, CdF₂, quartz, fused quartz, UV glass, borosilicate, and Infrasil (ThorLabs). The semitransparent mirrors 23 may be transparent to short wavelength light. The material may be the same as that of the PV converter window with a partial coverage of reflective material such as mirror such as UV mirror. The semitransparent mirror 23 may comprise a checkered pattern of reflective material such as UV mirror such as at least one of MgF₂-coated Al and thin fluoride films such as MgF₂ or LiF films or SiC films on aluminum.

In an embodiment, the TPV conversion efficiency may be increased by using a selective emitter, such as ytterbium on the surface of the blackbody emitter 5b4c. Ytterbium is an exemplary member of a class of rare earth metals, which instead of emitting a normal blackbody spectrum emit spectra that resemble line radiation spectra. This allows the relatively narrow emitted energy spectrum to match very closely to the bandgap of the TPV cell.

In an embodiment, the PV converter 26a (see, e.g., FIGS. 2I143-2I144) may comprise a plurality of triangular receiver units (TRU), each comprising a plurality of photovoltaic cells such as front concentrator photovoltaic cells, a mounting plate, and a cooler on the back of the mounting plate. The cooler may comprise at least one of a multichannel plate, a surface supporting a coolant phase change, and a heat pipe. The triangular receiver units may be connected together to form at least a partial geodesic dome. The TRUs may further comprise interconnections of at least one of electrical connections, bus bars, and coolant channels. In an embodiment, the receiver units and the pattern of connections may comprise a geometry that reduces the complexity of the cooling system. The number of the PV converter components such as the number of triangular receiver units of a geodesic spherical PV converter may be reduced. The PV converter may comprise a plurality of sections. The sections may join together to form a partial enclosure about the blackbody radiator 5b4c or PV window 5b4. At least one of the PV converter and the blackbody radiator 5b4c may be multi-faceted wherein the surfaces of the blackbody radiator and the receiver units may be geometrically matched. The PV window may also have a similar geometrical match with the PV converter 26a such as in the case of a partial dome PV window 5b4 (FIG. 2I144) and a partial geodesic dome PV converter 26a. For example, the PV window may be spherical or hemispherical and the PV converter may comprise multiple PV panels in a geodesic dome configuration and, optionally, the center of PV window sphere and the center of the geodesic dome are the same or nearly the same (e.g., within 1 cm). The PV converter enclosure may comprise at least one of triangular, square, rectangular, cylindrical, or other geometrical units. The blackbody radiator 5b4c or PV window 5b4 may comprise at least one of a square, a partial sphere, or other desirable geometry to irradiate the units of the PV converter. In an exemplary embodiment, the converter enclosure may comprise five square units about the blackbody radiator 5b4c or PV window 5b4 that may be spherical, rectangular, or a square. The converter enclosure may further comprise receiver units to receive light from the base of the blackbody radiator or PV window. The geometry of the base units may be one that optimizes the light collection. The enclosure may comprise a combination of squares and triangles. The enclosure may comprise a top square, connected to an upper section comprising four alternating square and triangle pairs, connected to six squares as the midsection, connected to at least a partial lower section comprising four alternating square and triangle pairs connected to a partial or absent bottom square.

A schematic drawing of a triangular element of the geodesic dense receiver array of the photovoltaic converter is shown in FIG. 2I133. The PV converter 26a in a geodesic dome (see, e.g., FIGS. 2I143-2I144) may comprise a dense receiver array comprised of triangular elements 200 each comprised of a plurality of concentrator photovoltaic cells 15 capable of converting the light from the blackbody radiator 5b4c or PV window 5b4 into electricity. The PV cells 15 may comprise at least one of GaAs P/N cells on a GaAs N wafer, InAlGaAs on InP, and InAlGaAs on GaAs. The cells may each comprise at least one junction. The triangular element 200 may comprise a cover body 201, such as one comprising stamped Kovar sheet, a hot port 202 and a cold port 204 such as ones comprising press fit tubes, and attachment flanges 203 such as ones comprising stamped Kovar sheet for connecting contiguous triangular elements 200.

In an embodiment comprising a thermal power source, the heat exchanger of the PV converter 26a comprises a plurality of heat exchanger elements 200 such as triangular elements 200 shown in FIG. 2I133 each comprise a comprising a hot coolant outlet 202 and a colder coolant inlet 204 and a means to absorb the light. The light may be from the blackbody radiator 5b4c such as the reaction cell chamber wall or the hydrino plasma through the PV window 5b4. The heat exchanger elements 200 may each transfer power not converted into electricity as heat into the coolant that is flowed through the element. At least one of the coolant inlet and outlet may attach to a common water manifold. The heat exchanger system may further comprise a coolant pump, a coolant tank, and a load heat exchanger such as a radiator and air fan that provides hot air to a load with air flow through the radiator.

The cooler or heat exchanger of each receiver unit may comprise at least one of a coolant housing comprising at least one coolant inlet and one coolant outlet, at least one coolant distribution structure such as a flow diverter baffle such as a plate with passages, and a plurality of coolant fins mounted onto the PV cell mounting plate. The fins may be comprised of a highly thermally conductive material such as silver, copper, or aluminum. The height, spacing, and distribution of the fins may be selected to achieve a uniform temperature over the PV cell area. The cooler may be mounted to a least one of mounting plate and the PV cells by thermal epoxy. The PV cells may be protected on the front side (illuminated side) by a clover glass or window. In an embodiment, the enclosure comprising receiver units may comprise a pressure vessel. The pressure of the pressure vessel may be adjusted to at least partially balance the internal pressure of the molten metal vapor pressure inside of the reaction cell chamber 5b31.

In an embodiment, the PV converter 26a comprises a dense receiver array comprising an ensemble of linear elements, each comprised of a plurality of PV cells. The elements may be oriented along the vertical or z-axis of the SunCell PV window cavity. The elements may be arranged to optimize at least one of absorption of incident light radiated from the hydrino reaction plasma maintained in the PV window cavity and the reflection of at least one of light below the bandgap of the PV cells and light not converted into electricity. The latter reflected light may recycled light that is transmitted through the PV window cavity and incident the hydrino reaction plasma where it is at least partial absorbed to contribute to the power radiated by the hydrino reaction plasma maintained inside of the PV window cavity. The width of the linear elements may be selected to optimize at least one of the absorbed and recycled light. The linear elements may form an ensemble comprising an enclosure circumferentially to the PV window cavity. In an exemplary embodiment, the ensemble comprises a cylinder circumferential to a cylindrical PV window cavity wherein the PV window cavity comprises a flat or dome top. The PV converter may comprise a flat PV ensemble and a geodesic dome PV ensemble, respectively. The latter may comprise triangular PV elements comprised of PV cells. The PV cells of each linear element may be connected in at least one of series and parallel to provide a desired voltage and current per element. The linear elements may be connected in at least one of series and parallel to provide a desired total ensemble voltage and current.

In an embodiment, the power of the SunCell may be sensed optically by a light power meter or a spectrometer capable of recording the plasma blackbody radiation and temperature. The recorded power such as that transmitted through the PV window 5b4 may be used by a controller to control the hydrino reaction conditions such as those of the disclosure to maintain a desired power output.

In an embodiment (FIGS. 2I143-2I144), the radius of the PV converter may be increased relative to the radius of the blackbody radiator 5b4c or PV window 5b4 to decrease the light intensity based on the inverse radius-squared dependency of the light power flux. Alternatively, the light intensity may be decreased by an optical distribution system comprising a series of semitransparent mirrors 23 along the blackbody radiator ray path (FIG. 21132) that partially reflects the incident light to PV cells 15 and further transmits a portion of the light to the next member of the series. The optical distribution system may comprise mirrors to reduce the light intensity along a radial path, a zigzag path, or other paths that are convenient for stacking a series of PV cells and mirrors to achieve the desired light intensity distribution and conversion. In an embodiment, the blackbody radiator 5b4c or PV window 5b4 may have a geometry that is mated to the light distribution and PV conversion system comprising series of mirrors, lenses, or filters in combination with the corresponding PV cells. In an exemplary embodiment, the blackbody radiator or PV window may be square and to match a rectilinear light distribution and PV conversion system geometry.

The parameters of the cooling system may be selected to optimize the cost, performance, and power output of the generator. Exemplary parameters are the identity of the coolant, a phase change of the coolant, the coolant pressure, the PV temperature, the coolant temperature and temperature range, the coolant flow rate, the radius of the PV converter and coolant system relative to that of the blackbody radiator, and light recycling and wavelength band selective filters or reflectors on the front or back of the PV to reduce the amount of PV incident light that cannot be converted to electricity by the PV or to recycle that which failed to convert upon passing through the PV cells. Exemplary coolant systems are ones that perform at least one of i.) form steam at the PV cells, transport steam, and condense the steam to release heat at the exchange interface with ambient, ii.) form stream at the PV cells, condense it back to liquid, and reject heat from a single phase at the heat exchanger with ambient such as a radiator, and iii.) remove heat from the PV cells with microchannel plates and reject the heat at the heat exchanger with ambient. The coolant may remain in a single phase during cooling the PV cells.

The PV cell may be mounted to cold plates. The heat may be removed from the cold plates by coolant conduits or coolant pipes to a cooling manifold. The manifold may comprise a plurality of toroidal pipes circumferential around the PV converter that may be spaced along the vertical or z-axis of the PV converter and comprise the coolant conduits or coolant pipes coming off of it. In an embodiment, the heated coolant may be used to provide thermal power to a load. The cooling system may comprise at least one additional heat exchanger to cool the coolant and provide heat to the thermal load. The cooled coolant may be recirculated to the cold plate by a pump.

At least one of the reaction cell chamber, reservoirs, and EM pumps may be cooled by a coolant such as water. The coolant may be passively circulated through a heat exchanger or actively circulated by a pump to remove heat according to the disclosure. The passive circulation may comprise a steam formation and condensation heat transfer cycle. At least one of the PV cells and the PV window may be cooled by a circulating coolant. In an embodiment, the PV converter 26a comprises a dense receiver array of PV cells, a PV window, a housing that houses the PV converter, a coolant that is circulated through the housing by at least one pump, a heat exchanger, at least one temperature sensor, at least one flow sensor, and a heat exchanger to remove heat from at least one of the PC cells and the PV window. The coolant may have a low light absorption coefficient in the spectral region of the light emitted to or from the PV window wherein the light may be recycled. The coolant may comprise water. The coolant may comprise a molten salt selected for the operating temperature of at least one of the PV window and the PV cells and having a low absorption coefficient for the emitted or recycled light. The optical path length between the PV window and the PV cells may be minimized to reduce the absorption of the emitted or recycled light. A coolant flow rate may be maintained by the pump to cool the PV window to maintain a stable window temperature. In an alternative embodiment, the PV window is operated at a temperature at which the blackbody radiation to the PV cells provides sufficient cooling to maintain the operating temperature. In an embodiment, the PV window chamber is sufficiently large such that the light absorption by the PV window is a significant contributor to the heating of the PV window compared to plasma heating wherein the distance of the window walls from the plasma reduces the plasma heating.

In an embodiment, the light below the PV band gap may be recycled by being reflected from the PV cells, absorbed by the blackbody radiator 5b4c, and re-emitted as the blackbody radiation at the blackbody radiator's operating temperature such as in the range of about 1000 K to 4000 K. The blackbody radiator may comprise an external SunCell wall or a PV window and the hydrino reaction plasma. In an embodiment, the reflected radiation that is below the band gap may be transparent to the PV window such that it is absorbed by the reaction cell chamber 5b31 gases and plasma. The absorbed reflected power may heat the blackbody radiator to assist to maintain its temperature and thereby achieve recycling of the reflected below band gap light. In an embodiment comprising a blackbody radiator such as an external SunCell wall a high emissivity may be applied to the surface. The coating may comprise carbon, carbide, boride, oxide, nitride, or other refractory material of the disclosure. Exemplary coatings are graphite, ZrB₂, zirconium carbide, and ZrC composites such as ZrC—ZrB₂ and ZrC—ZrB₂—SiC. The coating may comprise a powder layer.

To facilitate a match of the radiative power density transferred from the SunCell to an acceptable operating power density of the thermophotovoltaic (TPV) cells, the power produced by the SunCell may also be spread over a larger surface area of the at least one of the reaction cell chamber and the reservoir by increasing the geometric area of at least one of the reaction cell chamber and reservoir. In an embodiment, a desired power density radiated by at least one of the reaction cell chamber and the reservoir walls is matched to the power produced by the SunCell by increasing at least one dimension of SunCell to increase the corresponding wall surface area. The TPV cells are selected to have high efficiency at the corresponding concentration of light emitted from the walls and made incident on the TPV cells. In an embodiment comprising a PV window wherein the concentration exceeds at least one of the capacity of the TPV cells or the cooling system of the TPV cells, the light concentration may be reduced to an appropriate level by placement of the TPV cells of the PV converter 26a at a larger distance from the PV window 5b4 such as shown in FIG. 66E. In an exemplary embodiment, the PV converter 26a may comprise a six-sided cubic or rectangular cavity that surrounds the PV window 5b4. A bottom panel of the PV converter may attach to the PV window flange 26d. The connection may comprise a thermal insulator between the PV panel and the flange connection. In an embodiment, the PV window comprising the straight geometry section of the inverted Y geometry SunCell may be increased in size to spread the light over a larger area. An exemplary PV geometry is a cylindrical or rectangular jug with a body having a larger cross section than the cross section of the joint with the flange of the invert V geometry section. In another embodiment, the thermal load on the PV window may be decreased by increasing its surface area by making it larger wherein the larger area increases the heat loss to maintain a desired window operating temperature.

In an embodiment, the TPV converter is housed in a chamber capable of at least one of vacuum, atmospheric, and above atmospheric pressure. The TPV converter may be maintained under a vacuum or an inert atmosphere such as a noble gas atmosphere such as an agon atmosphere. The chamber may comprise electrical feedthroughs for electrical connections for the ignition, the EM pump, and the plasma discharge cell 900 currents as well as others for sensors such as temperature, gas flow, gas pressure, optical power, and optical spectrum sensors.

In an embodiment, the PV window of the SunCell may comprise a plurality of windows such as spatially separated panes such as the one shown in FIGS. 66I and 66L and 2I144 comprising an inner window or pane 5ab4 and an outer window or pane 5b4. The separated panes may form a cavity. The PV window may comprise a vacuum pump. The cavity may be differentially pumped by the vacuum pump to maintain at least a partial vacuum in the cavity. The differential pumping may mitigate any air leak. The outer pane may be at least partially vacuum capable. The inner pane may at least partially seal the molten metal and plasma from the cavity. In another embodiment, the SunCell may comprise a tank of inert gas such as argon, at least one valve, a flow controller, a pressure sensor, and a controller to maintain a desired pressure of gas in the cavity such as one above atmospheric pressure. In an embodiment, the oven may comprise a vacuum capable or tight vessel or cavity wherein the vacuum capable or tight oven may be connected to or comprise the chamber 916 (FIGS. 66G, 66I, and 66L). The chamber 916 may be maintained under vacuum by the differential vacuum pump or may be maintained at a desired pressure of a desired atmosphere such as an inert gas atmosphere.

In an embodiment, the optical power produced in the reaction cell chamber may be transmitted through the PV window to a photovoltaic converter of the disclosure and converted to electricity. The electricity may be used for any application of electricity known in the art such as exemplary applications or loads of the group of resistive heating, air conditioning, electric ovens, high temperature electric furnaces, electric arc furnaces, electric steam boilers, heat pumps, lighting, motive power trains, electric motors, appliances, power tools, computers, audio-video systems, and data centers. The SunCell may be made to any desired scale to meet any desired load demands, or the SunCell may be ganged to any desired scale. The PV converter may be designed to output a desire current and voltage range. The SunCell may comprise corresponding power conditioning systems for the applications such as at least one inverter, transformer, and DC-DC converter, and DC to DC voltage converter and regulator.

In an embodiment, the output power of the SunCell may be controlled to a desire level by controlling the parameters that determine the hydrino reaction rate such as those of the disclosure. The output power may be sensed by at least one of (i) the SunCell optical power sensed by an optical sensor such as a photodiode, (ii) the electrical power output of the PV converter 26a, and (iii) the thermal power sensed by a thermal sensor such as an optical pyrometer or a thermocouple. The output power is determined by the hydrino reaction rate which may be sensed by the intensity and the frequency of the sound produced by the hydrino reaction which may in the range of about 1 Hz to 30,000 Hz. The controlling parameters that determine the hydrino reaction rate such as those of the disclosure (e.g. H₂, O₂, H₂O flow rates, EM pumping rate, ignition current, operating temperature) may be altered based on at least one of the plasma sound and frequency to achieve a desire hydrino reaction rate.

### Wet Seal

In an embodiment, the seal between the PV window and the top of the reaction cell chamber comprises a molten metal wet seal. These wet seals typically are structures designed to join two solid materials and components of the system through use of a molten metal confined in the region of the seal by a confinement means. In an embodiment, the wet seal may comprise a circumferential annular channel such as a square or rectangular one containing the molten metal and an annular circumferential lip on the PV window that sits in the molten metal of the channel. In an embodiment the width of the channel is extended, and the outer wall may be absent wherein the molten metal solidifies on the periphery to form the barrier for the corresponding inner wet seal. An exemplary embodiment comprises a plate such as a quartz, fused silica, or sapphire disc with a perimeter window lip comprising an annulus of the same material fabricated or machined in or glued to the underside using an adhesive such as Resbond 905 or 989 and a wide flat flange such as a SS flange welded to the top of the reaction cell chamber having a raised ring to dam up molten metal interior to the window lip with the molten metal being solidified at the perimeter of the wide flange to form a vacuum tight seal. The perimeter region of the wide flange may be cooled to facilitate the molten metal solidification. The width of the flange may be sufficient to allow cooling and metal solidification at the perimeter such as on having a width in the range of about 1 mm to 25 cm.

The solidified component of the wet seal may comprise the sealing molten metal. Alternatively, the wet seal may comprise a plurality of materials with at least one in a molten phase and at least one other in a solid phase. The wet seal may comprise the sealing molten metal, and at least one of a different solid metal than that of the sealing molten metal and a solidified molten salt such as an alkali, alkaline earth, or transition metal hydroxide, halide, carbonate, oxide, and other salts and mixtures such as eutectic mixtures. In an embodiment, the solidified phase may have a higher melting point that the liquid sealing phase.

In an embodiment, the wet seal comprises a PV window or PV window chamber comprising a flange in a housing (FIGS. 66O-66T). The wet seal may further comprise a packing at its outer edge capable of being wetted by the molten metal. The wet seal may be maintained by molten metal contained in the housing and in contact with the PV window or PV window chamber. The housing may comprise two metal flanges that are welded around the perimeter or comprise two Conflat flanges sealed with a gasket such as a copper gasket. The housing may comprise a lower inner wall to hold the liquid metal before it is solidified and an upper wall to maintain the dammed up molten metal against the outer wall of the PV window or cavity. The wet seal may comprise a means to cool the molten metal at the outer edge of the housing such as a cooling loop. In another embodiment wherein the molten metal comprises a high melting point such as one above 100° C. such as silver, the wet seal comprises a localized heater to selectively melt the metal in the region of the contact between the metal and the PV window or PV window chamber. At least one of solidified molten metal at the outer portion of the housing and flange and the wetting forces of the packing may be prevent the molten metal from flowing due to external forces such as atmospheric pressure and gravity. The packing may comprise a wicking structure such as a heat pipe wick such as a powdered metal, grooved metal, or metal screen wick. The packing may comprise a microtextured material such as CalCarb.

In an embodiment (FIGS. 66O-66T), the wet seal comprises a molten metal phase such as one comprising gallium, tin, silver, silver-copper (71.9/28.1) alloy (MP=779° C.), or another metal in contact with the outer wall of the PV window chamber 5b4 and a solidified phase of the molten metal at the outer perimeter of the wet seal. The molten metal and solidified metal may be contained in a circumferential housing 5b10 around the PV window chamber that further houses a circumferential flange, lip, or collar 5b9 of the PV window chamber. The flange may comprise the same material as the PV window chamber and be fused to it. The housing 5b10 may comprise a lower plate welded to the perimeter of the baseplate 5b31c (FIGS. 66I and 66K) wherein the baseplate 5b31 may comprise a thickness capable of supporting the weight of the PV window chamber caused by vacuum inside of the PV window chamber. The thickness may be in a range of about 1 mm to 6 cm. The housing may comprise and upper plate having a radius greater than that of the PV window chamber 5b4 to form a gap 5b11 between the outer wall of the PV window chamber and the PV window housing 5b10. The cross section of the housing may comprise a channel ring. The housing 5b10 may comprise thin metal such as sheet metal having a thickness in the range of about 0.1 mm to 5 mm to limit the radial heat transfer. The housing may be stamped from sheet metal and may comprise a plurality of sections that may be welded together to house the PV window chamber flange.

In an embodiment, the PV window cavity flange may be bonded to the PV window cavity by a high temperature capable adhesive such as a quartz-to-quartz adhesive such as Aremco Ceramabond 618-N, Ceramabond™ 503, Ceramabond™ 571, Ceramabond™ 835M, or Ceramabond™ 865. In an exemplary embodiment, a cylindrical PV window cavity insets into an annular flange that is adhered to the outer wall of the PV window cavity using Ceramabond 618-N. A high vacuum seal may be maintained at the base of the PV window cavity, and the flange may maintain a thin layer of wet seal molten metal to support the wet sealing. The wet seal may further comprise a housing or retention ring at the outer edge of the flange that is welded to the baseplate 5b31c to hold the wet seal molten metal in the region under the flange and optionally vertically along the height of the flange edge.

In an embodiment that permits the PV window chamber to be reversibly removed to access the injector nozzles and other SunCell components inside of the PV window chamber, the SunCell may comprise an inner and an outer PV window chamber baseplate 5b31c. The outer PV window chamber baseplate may have attached or support the wet seal housing and PV window chamber and may be further attached to the inner PV window chamber baseplate. In an embodiment, the outer PV window chamber baseplate may comprise an annulus having an inner radius equal to or greater than the radius or semimajor axis of the of the opening to the cavity formed by the connection of the fused reservoirs with the baseplate as shown in FIGS. 66M-66N. In the former case, the outer PV window chamber may comprise a cutout for the cavity opening. The PV window chamber baseplate may comprise a sealed union capable of vacuum between the outer and inner PV window baseplates to form one baseplate having inner and outer sections. Alternatively, the outer PV window chamber baseplate may be mounted on inner PV window chamber baseplate or vice versa. The baseplates may be fastened together by a vacuum tight seal. The seal may comprise a flanged seal, one of the disclosure, or another seal known in the art. The seal may comprise at least one of welds, braze, an adhesive such as one of the disclosure such as Resbond 940SS, a gasket and fasteners such as bolts, and another union of the disclosure or known in the art. In an exemplary embodiment, (i) both the inner and outer PV window chamber baseplates have the same outer radius and matching oval cutouts for the opening of the cavity formed by the union of fused reservoirs to the inner PV window chamber baseplate (FIGS. 66M and 66M), (ii) the wet seal housing and a right cylindrical PV window chamber are attached to the outer PV window chamber baseplate, and (iii) the outer PV window chamber baseplate is mounted on top of the inner PV window chamber baseplate by Cotronics Resbond 940SS adhesive. The adhesive may be applied and positioned around the cutout to the cavity opening to limit the effects of thermal expansion on the union. In an embodiment, a weld seal is reversible by mechanical abrasion or cutting, and an adhesive seal is reversible by the ability to break the union by shattering it with a tool that produces shock such as a hammer and chisel tool. In an alternative embodiment, the geometry of the baseplates, wet seal housing, and PV window chamber are polygonal such as square and cubic, respectively.

In an embodiment, the wet seal comprises a barrier ring such as a short wall such as one of height in the range of about 0.1 mm to 2 cm on the baseplate 5b31c around the central elliptical inlet of the fused reservoirs to serve as a barrier, in the event that leaked wet seal gallium flows on the baseplate inside of the PV window cavity. In an alternative embodiment, the barrier ring may be positioned at the inner wall of the PV window cavity.

The SunCell may further comprise a startup heater to melt the wet seal metal at the position of the outer wall of the PV window chamber. The startup heater may be retractable. The heater may comprise at least one of a resistive band heater or torch or burner such as an oxy-acetylene or H₂/O₂ one around the circumference of the PV window chamber. The heater may comprise (i) a source of at least one of fuel such as H₂ or acetylene and oxygen such as corresponding gas tanks wherein the H₂ and O₂ may be generated from the electrolysis of H₂O, (ii) at least one temperature sensor, and (iii) a controller to control the temperature of the molten metal at the outer PV widow cavity wall. The burner may be powered intermittently to apply intermittent heating, and the heating power may be adjusted as the thermal heating contribution from the hydrino reaction increases such that the desired wet seal molten metal temperature is maintained. In an embodiment to startup the SunCell, a burner heater may heat at least one of the molten metal such as tin in the reservoirs, the reservoirs 5c, the PV window chamber 5b4, and the wet seal metal in contact with the PV window chamber to a molten state. The burner may comprise a hydrogen manifold to supply hydrogen to a least one nozzle such as a plurality of nozzles wherein atmospheric air supplies the oxygen for the corresponding combustion flames. Alternatively, the burner may comprise two manifolds, (e.g. one for H₂ or acetylene and another for oxygen), and a plurality of nozzles wherein the gas from the separate manifolds are mixed in the nozzles before combustion. In an embodiment, each burner nozzle of the plurality of nozzles may comprise at least one of a connection to the hydrogen or acetylene gas manifold, a connection to the oxygen gas manifold, an independent hydrogen or acetylene gas line, an independent oxygen gas line, and an independent torch head with separate gas flow controllers for the hydrogen or acetylene gas and the oxygen gas. Air may substitute for the oxygen manifold and line. In an embodiment, the burner may comprise at least one nozzle, a means to move the at least one nozzle such as a mechanical means, and a heater controller to cause a desired temporal and spatial heating by the corresponding nozzle flame(s).

In another embodiment (FIGS. 66S-66T) that permits the PV window chamber to be reversibly removed to access the injector nozzles and other SunCell components inside of the PV window chamber 5b4, the wet seal housing 5b10 comprises an angle ring welded to the PV window chamber baseplate 5b31c wherein the PV window chamber 5b4 comprises a flange 5b9 having a smaller OD than the ID of the angle ring. The corresponding gap 5b12 between the flange and the angle ring may serve as a housing for two layers of the wet seal, a top molten layer and a bottom solid layer wherein a vacuum-capable seal is maintained between the wall of the housing and the PV window chamber flange. The molten layer may comprise a molten metal such as tin, aluminum, or silver, and the lower layer may comprise the corresponding solidified metal. The housing 5b10 may comprise stainless steel or another refractory metal. In the case that the wet seal metal such as aluminum (MP=660° C.) forms an alloy with the housing metal such as stainless steel, the metal may be coated with a coating such as silicate, Alumina, Mullite, TiN, CrN, TiAlN, CrC, Ta, or another of the disclosure or known in the art that prevent the alloying.

A wet seal system typically comprises (i) a gallium reservoir circumferential to the PV window cavity flange that supplies gallium to the gap between the bottom of the PV window flange 5b9 and a portion of the baseplate 5b31c wherein the wet seal is maintained on the vacuum side surface comprising an outer reservoir wall and the outer portion of the baseplate 5b31c, (ii) a PV window cavity flange 5b9 and a portion of baseplate 5b31c on which the PV window cavity flange is mounted, (iii) a continuous separator in the gap between the outer reservoir wall and the vertical edge of the PV window flange and the gap between the bottom of the PV window flange and the baseplate, (iv) a source of magnetic field perpendicular to the gap between the PV window flange and the baseplate such as a permanent magnet, (v) a current supply and electrodes on opposite sides of the separator connected to the gallium to supply current to the corresponding gallium wet seal circuit wherein the current in the presence of the crossed magnetic field produces a radial MHD force in the gap between the PV window flange and the baseplate, and (vi) an MHD-atmospheric pressure force balance processor. In The MHD-atmospheric pressure force balance processor may analyze and process information from sensors measuring the wet seal position such as at least one optical sensor and one conductivity sensor, an MHD current sensor and controller, an evacuation rate sensor such as a pressure gauge and controller such as at least one of a vacuum value such as a needle valve and its controller and a vacuum pump and its controller. The MHD-atmospheric pressure force balance processor may receive sensor input and reiteratively adjust the MHD current and vacuum rate to achieve and maintain a stable wet seal as the PV window cavity is evacuated. As an alternative to reiteratively adjusting the MHD current and vacuum rate to match the MHD force with the atmospheric force during evacuation, the MHD-atmospheric pressure force balance processor may set the current supply controller to provide a current corresponding to an excess MHD force relative to the maximum atmospheric force when the PV window cavity is fully evacuated. In an exemplary embodiment, the current source may comprise a power supply or a battery such as one with a variable resistor to adjust the current. As the vacuum increases, the outer atmospheric pressure may cause more gallium to flow into the gap between PV window flange and the baseplate to cause an increase in the width of the wet seal and an increase in MHD current flow with a concomitant increase in the opposing MHD force until a steady state wet seal is established. Temporary reversible mechanical pressure may be applied across the wet seal gap during sealing by a pressing means such as a press. In an exemplary embodiment, downward pressure may be applied to the PV window cavity and flange by a press in addition to that due to atmospheric pressure. The increasing pressure during cavity evacuation may create an increase in a frictional force to oppose the inward flow of the wet seal molten metal caused by an imbalance in forces such as that due to atmospheric, opposed to the wetting force and MHD force wherein the frictional force may be proportional to the normal force of the flange on the baseplate times the coefficient of friction. The pressing means may be removed once the wet seal is established.

An alternative embodiment, the wet seal system typically comprises (i) a molten metal reservoir such as a liquid gallium reservoir circumferential to the PV window cavity flange that supplies gallium to the wet seal gap between the bottom of the PV window flange 5b9 and a portion of the baseplate 5b31c wherein the wet seal is maintained on the vacuum side surface comprising an outer reservoir wall and the outer portion of the baseplate 5b31c, (ii) a PV window cavity flange 5b9 and a portion of baseplate 5b31c on which the PV window cavity flange is mounted, (iii) a source of magnetic field perpendicular to the gap between the PV window flange and the baseplate such as a permanent magnet wherein the magnetic field direction is +z over ½ the length of the seal and −z over the other half, (iv) a current supply and electrodes on opposite sides of seal connected to the gallium to supply current to the corresponding gallium wet seal circuit wherein the current in the presence of the crossed magnetic field produces a radial MHD force in the gap between the PV window flange and the baseplate, and (v) an MHD-atmospheric pressure force balance processor and controller. In an embodiment wherein the wet seal gap is very thin such as in the range of about 1 nm to 5 mm, the wet seal may comprise a thin layer or film of wet seal molten metal that replaces the molten metal reservoir. The permanent magnet may comprise a plurality of magnets, each having the field perpendicular to the major face that are aligned along a ferromagnetic bar having a desired geometry such as a square or circle to form a magnet of the desired geometry. In an exemplary embodiment, the flat magnets are mounted on a matching-width flat iron bar with the magnetic field oriented in the +z direction along ½ the length of a closed square path and the magnetic field oriented in the −z direction along the other ½ the length of a closed square path wherein the magnets align along the side faces even in the case of each 900 angle bend wherein the iron plate eliminates the fringe field of the juxtaposed magnets and causes the side faces to attract.

The leads to the electrodes may travel in the +z direction through penetrations in the baseplate 5b31c and each may connect to a bus bar oriented along the axis perpendicular to the wet seal to spread the MHD current evenly along the width of the wet seal to avoid radial currents in the molten metal that could cause Lorentz force instabilities in the wet seal molten metal as well and to avoid arcing of the connection between the electrodes and the molten metal such as gallium. The bus bar may be recessed in the baseplate 5b31c to minimize the wet seal gap.

In an embodiment, the electrode lead and electrode may comprise a liquid current lead and electrode electrically connected to the wet seal liquid metal such as gallium or tin. The liquid metal (e.g., gallium or tin) may fill a nonconducting tube with a lead wire inside of a standing pool of the liquid metal (e.g., gallium or tin) that is in continuity with the wet seal metal and may run inside the tube for a portion of the height of the pool to make electrical contact with the pool. The tube may be sealed to the baseplate such as 5b31c at one end and at the exit of the lead wire at the other end wherein an external portion of the lead wire is connected to a current supply to supply current to the wet seal to produce a Lorentz force in combination with a cross applied magnetic field. The liquid lead may run vertically. Exemplary tubes comprise quartz, ceramic, or a metal such as stainless steel with an internal coating of a non-conductor such as mullite, alumina, or another suitable coating of the disclosure.

In an embodiment, the wet seal may be stably established by the steps of (i) solidifying the wet seal molten metal, (ii) applying vacuum while applying down pressure, (iii) applying an MHD force in excess to the atmospheric force by applying MHD current, and (iv) allowing the molten metal to melt to establish a vacuum tight wet seal. The electrodes, bus bar, and wet seal molten metal may be electrically isolated from the baseplate by electrical insulation such as an electrically insulating coating such as Mullite, alumina, zirconia, other ceramic, VHT paint, or another of the disclosure.

In an embodiment, the MHD force of the wet seal may comprise a gradient force. The gradient MHD force may increase in the direction of the vacuum side of the wet seal. The gradient may be achieved by at least one of a gradient in the MHD magnetic field and the MHD current. The permanent magnet or electromagnet may be designed to provide the gradient in magnetic field. A gradient in resistance may provide the gradient in current. The gap between the sealed surfaces of the wet seal may be variable to provide the gradient in resistance and thereby the gradient in current. In an exemplary embodiment, the gap may increase in the direction of the vacuum side of the wet seal.

In an embodiment, the wet seal housing surface that is in contact with the molten metal such as gallium, tin, or silver is coated with an oxide such as silicate, Mullite, alumina-silicate, alumina, or VHT paint to increase the wetting or surface adhesion interaction of the wet seal molten metal and the housing surface. In an embodiment, the housing surface may comprise additionally a coating of the oxide of the molten metal such as gallium oxide that may improve the wet seal molten metal wetting. In an embodiment, the height or length of the wet seal molten metal in contact with the housing may exceed that which form a vacuum-capable seal such as a height or length in the range of about 0.1 mm to 10 cm.

The flange may have suitable thickness to maintain the two layers due to heat losses from the top to the bottom layers. The wet seal may comprise a layer of thermal insulation such as CalCarb within at least one of the two layers to support the different physical phases or states of the two layers. The thermal insulation may have thickness in the rage of about 1 mm to 10 cm. In an embodiment, the wet seal housing comprises a closed-bottom shallow right cylinder such as a metal one having an outer radius equal to or greater than the outer radius of the PV window chamber baseplate 5b31c such as greater that the outer radius of the PV window chamber and a height about equal to or greater than the height of the PV window flange such as in the range of about 1 mm to 20 cm. In an embodiment to increase the height of the wet seal, the PV window chamber flange may comprise a downward vertical extension on the outer diameter seated in a corresponding floor indentation or well of the wet seal housing. The housing may further comprise a cutout for the opening of the cavity formed by the union of fused reservoirs to the inner PV window chamber baseplate (FIGS. 66M and 66M) wherein the housing may be sealed to the PV window chamber baseplate 5b31c by means such as a weld, braze, adhesive, flange, or another seal of the disclosure or known in the art. In an embodiment, the weld may comprise a seam weld or laser weld. The wet seal may further comprise a heater such as one comprising a plurality of oxyacetylene or oxyhydrogen torches that may be supplied by two separate gas manifolds, one for each gas, positioned around the perimeter wherein the torch flames are directed at the seal metal between the housing wall and the PV window chamber flange to maintain the molten top layer. The wet seal may comprise a layer of molten metal such as silver on top of the flange to transfer heat from the outer wall of the PV window chamber to the upper molten layer of the wet seal to support maintaining the top molten wet seal layer. The PV window chamber may be removed by melting both layers of the wet seal, removing the heater, and lifting the PV window chamber off.

In another embodiment, the wet seal may comprise at least one of a chiller and heater to maintain two metal phases, the upper molten and lower solidified layers. The wet seal metal may comprise one with a low melting point such as gallium or tin. The wet seal may be thermally insulated with at least one of a thermal reflector (e.g. a heat shield having a low emissivity) such as aluminum or silver foil and an insulator for thermal conduction such as CalCarb. In an embodiment, the solid wet seal metal layer and corresponding portion of the wet seal housing may be selectively thermally insulated with the molten layer exposed to heat from the SunCell to maintain the molten state. In an embodiment, the flange thickness may be minimized in at least one section radially from the wall of the PV window chamber to limit radial heat transfer to the solidified layer. The thinned section of the flange may have a thickness in a range of about 0.5 mm to 5 cm. The solidified layer may further comprise thermal insulation such as CalCarb to reduce heat transfer from the flange. In an exemplary embodiment, the wet seal comprises (i) gallium with CalCarb separating the upper molten and lower solid metal layer, (ii) a resistive heater in the upper layer to maintain the molten phase, (iii) a chilled water loop in thermal contact with the solidified metal layer through a chilled surface such as a cold plate, (iv) a chiller to cool the circulated water and a pump to circulate the chilled water, (v) reflective and conductive thermal insulation encasing the wet seal, (vi) at least one air flow system such as one comprising one or more of an air fan or blower and baffles to maintain the ambient air temperature relatively low compared to the temperature of the air at the SunCell reservoirs wherein the air flow system may further remove heated air to reduce air heating of the PV converter 26a, and (vii) a wet seal cooling system such as one comprising (a) circulating water temperature and flow rate sensors, (b) temperature sensors for at least one of the molten and solidified wet seal metal, (c) heater, chiller, and pump power sensors and controllers, and (d) a wet seal system controller to maintain the two phases of the wet seal to maintain a vacuum seal of the PV window chamber. In an embodiment, the EM pump magnets comprise an EM pump cooling system to cool the magnets. The cooling system may comprise at least one cold plate or loop in contact with each magnet, a chiller, a temperature sensor, a coolant, a coolant circulation pump, a circulation flow rate sensor, a coolant temperature sensor, and a controller to control the chiller power, coolant temperature, and coolant flow rate to maintain a desired operating temperature range for the magnets. The magnet operating temperature range may be about 0° C. to 500° C. In an embodiment, the cooling system may at least partially serve as the wet seal cooling system. The coolant may first flow to the wet seal in a case such as one wherein the wet seal has a lower heat load.

In an embodiment, at least one of the PV window chamber baseplate 5b31c and the outer PV window chamber baseplate may have a sufficient radius to move the PV window chamber seal sufficiently far from the PV window chamber such that its temperature is at or below the maximum operating temperature of low-temperature vacuum seals such as ones comprising flanges and gaskets such as ones comprising elastomers such as Teflon and Viton that operate at a temperature up to 250° C. and 204° C., respectively. The low-temperature seal may further comprise a means of cooling such as a heat sink, heat pipe, heat exchanger, heat fins that may further comprise a forced air system such as fans, water cooling or other coolant system, or another cooling system of the disclosure or known in the art.

In another embodiment, the PV window chamber seal comprises at least one of an adhesive and a gasket that seals the PV window cavity flange to the baseplate which may comprise a matching flange. The seal may further comprise a flange that seats on top of the PV window chamber flange. The gasket may comprise Teflon, Viton, graphite, and other gaskets known in the art. In an embodiment, the CTE's of the adhesive fasten a fused silica window flange to a Kovar or Invar counter flange that is cooled to avoid a maximum temperature above 200° C. In an embodiment, the PV window chamber is polygonal such as cubic to limit the length of seal wherein a square seal can comprise 4 sides with expansion joints at the corners.

In an embodiment, a graphite gasketed flange seal for the PV window cavity comprising a top and bottom seal flange bolted together with top and bottom graphite gaskets between each flange surface of the PV window cavity and the corresponding seal flange, further comprises a gallium angle ring around the perimeter of the gasketed flange such as a graphite-gasketed flange seal welded to the bottom flange of the seal to form a cavity around the graphite gasketed flange seal. The cavity may be filled with wet seal molten metal such as gallium to form a wet seal. Alternatively, the graphite gasketed flange seal may further comprise an inter-flange wall welded to the top surface of the bottom seal flange inside of the seal flange bolts. The top seal flange may comprise a wet seal molten metal fill hole to serve as means to vertically fill the cavity formed between the PV window cavity flange and the inter-flange wall to form a wet seal. The PV window cavity flange should comprise a sufficient thickness such a one in the range of about 1 mm to 100 mm to permit an inter-flange wall height sufficient to form the wet seal. In an embodiment, the gasket may comprise a deformable material such as carbon or graphite or BN. The graphite, carbon, or BN gasket may be at least partially compressed by atmospheric pressure such that at least one of the flange bolt tension may be reduced and the flange bolts may be eliminated.

In an embodiment, the seal may comprise the PV window cavity flange 5b9 as the top flange and the baseplate 5b31c as the bottom flange of a gasketed flange seal such as a graphite gasketed flange seal for the PV window cavity. The graphite or carbon gasket may be compressed by atmospheric pressure by pulling a vacuum on the PV window cavity. The seal may optionally further comprise the wet seal housing such as a gallium angle ring around the perimeter of the gasketed flange welded to the bottom flange 5b31c of the seal to form a molten-metal-filled cavity around the graphite gasketed flange seal. A wet seal may be maintained along at least one of the vertical perimeter edge of the PV window cavity flange and between the bottom of the PV window cavity and the baseplate 5b31c. In the latter case, the graphite gasket has an outer diameter less that the outer diameter of the PV window cavity flange to form a cavity between the bottom of the PV window cavity and the baseplate 5b31c for wet seal molten metals such as tin or gallium. In an exemplary embodiment, the partial gasket thickness is the range of about 0.1 mm to 10 mm to minimize the gap between the baseplate 5b31c and the PV window cavity flange 5b9 while preventing penetration of the wet seal metal into the PV window cavity. In an embodiment, the seal may comprise at least one of a groove and a recessed or indented portion of the PV window cavity and baseplate to accommodate a portion of the height of the gasket to reduce the gap between the PV window cavity flange and the baseplate. In an embodiment, the baseplate 5b31c comprises a recessed section that comprises a matching flange to the PV window cavity flange and further comprises an inner well of molten metal to cover the inside surface of the gasket to prevent its degradation by gases in the PV window cavity.

In an embodiment, the base of the PV window cavity 5b4 comprises a gasket interface that permits the mounting of the base on the gasket and further permits the gasket to slide under the base as the gasket expands and contracts during thermal cycling. The gasket interface may comprise smooth surfaces and edges to avoid cutting the gasket such as a carbon gasket. The gasket interface may comprise the open-ended base walls of the PV cavity comprising wall edges wherein the inner and outer wall edges may be smoothed. The edges may comprise a chamfer or a radius of curvature that allows gasket mobility without significant gasket damage that would cause wet seal failure. In an exemplary embodiment, (i) the gasket may comprise carbon and have a width equal to or greater than the thickness of the PV window cavity wall at the base and (ii) the base may comprise the straight walls of PV window cavity wherein the base may be lapped to being flat to within a low tolerance such as within the range 0.001 mm to 2 mm, and the edges of the base wall may be smooth, curved, or chamfered. In an alternative embodiment, the gasket interface may comprise at least one of a thickening of the walls of the PV window cavity and a flange wherein each comprises a smooth gasket mounting surface with the gasket. In an alternative embodiment, the PV window cavity 5b4 comprises a flange having the smooth edges wherein the lower flange surface serves as the gasket interface.

In another embodiment, the wet seal such as a gallium or tin wet seal may be maintained along the base of the outer wall of the PV window cavity 5b4 wherein the housing or retention ring may comprise the same material as that of the PV window cavity such as quartz or fused silica. The retention ring may seal to baseplate 5b31c to prevent wet seal molten metal flow. The seal may comprise at least one of precision machined surface and coating such as one that does not wet with the molten metal such as BN. The retention ring may comprise a flange that may facing away from the PV window cavity. The retention ring may comprise a compression source such as clamps to apply a pressure on the seal such as one comprising a gasket to increase the sealing.

In an embodiment, the base of the PV window cavity 5b4 comprises a gasket interface that permits the mounting of the base on the gasket and further permits the gasket to slide under the base as the gasket expands and contracts during thermal cycling. The gasket interface may comprise smooth surfaces and edges to avoid cutting the gasket such as a carbon gasket. The gasket interface may comprise the open-ended base walls of the PV cavity comprising wall edges wherein the inner and outer wall edges may be smoothed. The edges may comprise a chamfer or a radius of curvature that allows gasket mobility without significant gasket damage that would cause wet seal failure. In an exemplary embodiment, (i) the gasket may comprise carbon and have a width equal to or greater than the thickness of the PV window cavity wall at the base and (ii) the base may comprise the straight walls of PV window cavity wherein the base may be lapped to being flat to within a low tolerance such as within the range 0.001 mm to 2 mm, and the edges of the base wall may be smoothed, curved, or chamfered. In an alternative embodiment, the gasket interface may comprise at least one of a thickening of the walls of the PV window cavity and a flange wherein each comprises a smooth gasket mounting surface with the gasket.

In an embodiment, at least the base of the PV window cavity may be cooled, and the outer base-wall of the cavity may be dip-coated with wet seal metal to form a thin layer of a controlled thickness to serve as the wet seal molten metal when melted.

Shear forces may develop on the PV window cavity or its flange when the baseplate 5b31c to which the wet seal housing 5b10 is fastened contracts more than solidified wet seal metal such as tin. The wet seal housing 5b10 may comprise an annular wall, a wet seal retention wall, attached perpendicularly to the baseplate 5b31c with gap 5b12 between wall and the PV window outer wall or flange 5b9. In an embodiment to allow the top of the wet seal retention wall to at least one of deform or bend from the vertical when excessive shear forces develop on the PV window cavity or its flange, the retention wall comprises at least one unwelded overlapping section such as one at the corner of a square or rectangular retention wall that may further comprise a low gauge or soft metal. The overlapping sections must be tight to prevent wet seal metal leakage. In an alternatively embodiment, the retention wall comprises a fan-like bellows that allows the top of the retention wall to bend from the vertical when excessive shear forces developed on the PV window cavity or its flange.

In an embodiment, the gasket comprises the MHD current circuit or loop of the wet seal metal in the solidified state. The metal may comprise a foil that may comprise a thickness in the range of about 0.1 to 10 mm. The current loop may be in continuity with the metal of the liquid electrodes that may optionally also be in the solidified state. In an embodiment, pressure may be at least initially applied to the solid metal gasket by means such as clamps, or a top flange. A vacuum may be applied to the PV window cavity with the MHD magnetic field and MHD current applied as the solidified wet seal metal is melted wherein a high vacuum transitions to a high vacuum as the wet seal metal melts. At least one of the MHD current and magnetic field may be adjusted to maintain the wet seal integrity as the MHD force of the seal opposes the atmospheric pressure force.

In an alternative embodiment, the wet seal may have no gasket wherein the precision and matching flatness of the PC window cavity flange and baseplate are such that any gap between the two is within at least one range of about less than 1 mm, less than 100 microns, and less than 10 microns. In an exemplary embodiment, at least a circumferential portion of the gap between the PV window cavity flange and the baseplate is less than a height above which the liquid metal such as gallium can penetrate such as less than 10 microns wherein a gasket is optional.

In an exemplary embodiment, the SunCell may comprise a retractable startup oven to heat the molten metal and the SunCell components in contact with the molten metal during operation to a temperature greater than that of the melting point of the molten metal. In an exemplary embodiment comprising molten tin, the SunCell is heated by the over to about 300° C. or greater, then the oven may be at least partially retracted as at least one of the wet seal burner and vacuum pump are turned on. Next, the hydrino reaction may be immediately started to maintain the molten tin, PV window chamber, reservoirs, and EM pumps at a temperature above about 232° C. (tin melting point). In an embodiment, the wet seal comprises a plurality of metal layers, each in the molten or liquid state, such as one comprising a top solid layer, a middle liquid layer, and a second bottom solid layer. At least one solid layer may be maintained by cooling. The cooling may be achieved with a cold plate and a chiller. The liquid layer may be maintained by a heating. The heating may be achieved with a heater. The top solid layer may protect the liquid layer from oxidation (e.g. air oxidation). The liquid layer may maintain a vacuum seal of the PV window chamber 5b4.

In the case that the operating temperature of the PV window and the molten metal in contact with the PV window chamber is higher than the melting point of the metal, the wet seal may comprise a means to cool the metal on the perimeter of the housing to form the solid phase. The means to cool may comprise at least one of a chiller, heat sink, heat exchanger, cold plate, heat spreader, heat pipes, heat fins, and other means of cooling known in the art. The coolant of the means to cool such as a heat exchanger may comprise a refrigerant, water, ethylene glycol, a molten salt, a molten metal, or another coolant known in the art. The wet seal may further comprise a thermal insulator embedded in at least one of the molten and solidified phase to reduce the heat transferred from heated molten (liquid) metal phase to solidified (solid) molten metal phase. The thermal insulator may be embedded in a cross section of the conductive thermal path from the liquid to solid phases of the metal. The thermal insulator may comprise a ceramic such as quartz, BN, or alumina, or CalCarb, or another such as another of the disclosure.

In an exemplary embodiment, the wet seal comprises inner liquid and outer solid phases of silver or silver-copper (71.9/28.1) alloy, a wet seal metal housing, and a H₂/O₂ burner around the circumference of the PV window chamber, and a cooling means or loop around the perimeter of the wet seal housing further comprising a thermal insulator such as one of CalCarb, MgO, or Al₂O₃ that replaces 10-99% of the thermal circuit cross section of wet seal metal. The cooling loop may comprise heat fins and an air blower to move air over the fins. In an embodiment, a compressible insulation such as CalCarb may be incapsulated in a crush-proof material such as a ceramic or a metal capsule to prevent its compression. The thermal insulator may be embedded in at least one of the liquid and solid wet seal metal phases. In an embodiment to further limit heat transfer from the liquid to the solid phase, the wet seal comprises thermal insulation at the bottom such as in between the flange and the bottom portion of the housing, and the housing may at least one of comprise a metal that has a low thermal conductivity and be thin.

In an alternative embodiment, the wet seal is reversed in that the solid phase is in the inner position in contact with the outer wall of the PV window or PV window chamber, and the molten phase is at the perimeter of the wet seal. The housing may be tight against the PV window or PV window chamber. The housing at inner position may comprise a gasketed seal such as a compression seal such as one comprising graphite. The heater such as a burner may be positioned at the outer position, and the cooler may be positioned at the inner position to maintain the corresponding phases.

An exemplary SunCell comprising a PV window chamber sealed with a wet seal comprises a fused reservoir design such as one shown in FIGS. 66M-66T comprises (i) a CalCarb base 5b31b with a wet floor, (ii) a reservoir liner comprising an outer CalCarb liner with an inner wet wall liner, (iii) an electrical break comprising an non-conducting potting compound or adhesive joining two sections of each reservoir, (iii) a heavy-mass, recessed tungsten nozzles that may each comprise a plurality of outlets, and (iv) a fused silica right cylinder cavity having a flange on the base and a silver wet seal wherein the molten silver in contact with the base of the PV window chamber is maintained by a localized resistive heater by a burner such as one comprising a plurality of H₂/O₂ torch nozzles distributed along the perimeter of the PV window chamber. To prevent alloy formation with the molten metal, at least one of the baseplate 5b31c, reservoirs, electrical break, and bellows may be coated with a coating such as Mullite or Alumina, and the EM pump tubes may be coated with a coating comprising an electrical conductor such as CrN, CrC, TiN, TiAlN, Ta. Other similar coatings are within the scope of the disclosure. The coating be applied by diffusion coating, plasma deposition, electroplating, and other methods known in the art. In an exemplary embodiment, Ta is electroplated inside of the EM pump tube at the position of the bus bars 5k2. At least one of the CalCarb PV window chamber floor liner and reservoir liner may be coated with Calcoat, Calfoil, pyrocarbon, Calcoat paint, silicon carbide, or pyrolytic carbon.

Another exemplary SunCell comprising a PV window chamber sealed with a wet seal comprises a fused reservoir design such as one shown in FIGS. 66M-66N comprises (i) a CalCarb base insert, base liner, and reservoir liner that runs from the CalCarb base insert to the top of the alumina insulator of the electrical break 913 wherein the CalCarb reservoir liners are coated with Calcoat, Calfoil, pyrocarbon, Calcoat paint, silicon carbide, or pyrolytic carbon, (ii) at least the top portion of the reservoirs contain zirconium oxide beads, (iii) a wet floor comprising a liquid tin housing topped by a W screen, (iv) an about 1000° C. capable electrical break that is CrN coated without a liner (e.g. MPF A23703-1 (special) copper braze), (v) a heavy-mass, recessed tungsten nozzles that may comprise a plurality of outlets, and (vi) a fused silica cubic PV window chamber having a flange on the base and a gallium wet seal having an angle ring design shown in FIGS. 66S-66T wherein the molten gallium upper layer is maintained by a localized resistive heater and the lower solid layer is separated from the upper layer by a layer of CalCarb and is maintained in the solid state by a water-cooled cold plate positioned circumferentially in contact with the floor of the wet seal housing. At least one of the baseplate 5b31c, reservoirs, electrical break, and bellows may be coated with Mullite or Alumina, and the EM pump tubes may be coated with CrC. Other similar coatings are within the scope of the disclosure. The ignition EM pumps may comprise multi-stages that are connected in parallel.

In an embodiment, the SunCell comprising a PV window chamber 5b4 such as one sealed with a wet seal (FIGS. 66O-66T) may comprise at least one of the H₂—O₂ gas inlet line 906 and vacuum line 711 at an upward angle in a reservoir 5c such as the negative reservoir between the electrical break 913 and bellows 917 and the vacuum line at an upward angle in a reservoir 5c such as the positive reservoir between the electrical break 913 and bellows 917. In the case that the gas inlet or the vacuum line are subject to tilting due to being incorporated into or below the bellows 917, the gas line or vacuum line may further comprise an elbow to direct the line downward or a flexible bellows pipe connection to accommodate the line movement. The H₂—O₂ gas inlet line may further comprise the plasma cell of the disclosure such as a glow discharge cell 900. The reservoir may comprise a tube in the corresponding section where the gas inlet and vacuum lines are connected. The upward angle orientation of the lines may prevent molten metal such as molten tin flow into the vacuum and reactant gas lines. The tube section may be coated with an alloy resistant coating such as Mullite or Alumina and may be lined or unlined with a liner of the disclosure with a penetration for the corresponding line. In another embodiment the lines may comprise tubes inside of the PV window chamber 5b4 such as W tubes that enter through vacuum tight penetrations in the baseplate 5b31c. The open ends in the lines may comprise hats or baffles to limit molten metal flow into the vacuum and reactant gas lines.

In an embodiment, the wet may be orientated in any direction wherein during startup of the seal, the molten metal is melted while a vacuum pump pulls a vacuum on the corresponding PV window or PV window chamber to be sealed such that atmospheric pressure maintains the molten metal of the seal in place against gravity.

Current carrying conductors are drawn together when the corresponding currents flow in the same direction. In an embodiment, the PV window seal to the reaction cell chamber flange comprises a wet seal of a molten metal such as the molten metal injected by the EM pump injectors such as tin, gallium, copper, silver, or alloys thereof. The wet seal may further comprise a conductor such as at least one wire or bus bar positioned to form a current carrying circuit along the length of the wet seal such as in the center along the path of the seal, two electrical leads of the circuit, a means to electrically isolate the leads, and power supply to supply current such as DC current to the conductor through the electrically isolated leads, and a current controller that causes a controlled current to flow in the circuit. In an embodiment, the conductor is not insulated such that the current applied to the conductor also flows in the molten metal of the seal in contact with the conductor wherein the currents of the conductor and the molten metal are parallel. The parallel currents cause the molten metal to be drawn to the conductor to maintain a molten seal. In an embodiment, the current flow is sufficient to draw the molten metal to the current carrying circuit to maintain a suitable seal for the operating conditions in the reaction cell chamber. In an embodiment, the seal may comprise two electrically isolated leads that contact the molten metal at oppositive ends of the path of the seal such as a linear, rectangular, or circular path. The leads may be connected to the power supply to supply the current to the molten metal. In an embodiment, the current of at least one of the conductor and molten metal is high to cause at least one of pinch, magnetic pinch, electromagnetic pinch, and magnetostriction such as in at least one range of 1A to 50,000A, 10A to 10,000A, 100A to 5000A, and 100A to 1000A.

The wet seal may comprise a magnetohydrodynamic molten metal wet seal. In an embodiment, a source of magnetic field provides a Lorentz force acting on current carrying molten metal along the path of the seal to maintain the wet seal. The wet seal may comprise a molten metal electrical circuit comprising a molten metal current path or circuit in contact with the PV window chamber having electrically isolated electrical leads in contact with the molten metal at opposite ends of the path, a current supply to the leads and circuit, and further comprising a source of a magnetic field such as a permanent or electromagnet to provide a Lorentz force to maintain the wet seal. The circuit may comprise any desired geometry such as a linear, rectangular, or circular circuit. In an embodiment, the current may be in at least one range of 1A to 50,000A, 10A to 10,000A, 100A to 5000A, and 100A to 1000A. The wet seal may further comprise a support structure such as a bracket to suspend the source of magnetic field at least one of peripheral, under, or over the wet seal plane. In an embodiment, the source of magnetic field may produce an azimuthal field such as the field of a current carrying wire wherein the magnetic field creates a force on the current carrying molten metal to cause the molten metal to be drawn toward the source of magnetic field to maintain the wet seal. The source of the magnetic field may comprise a current carrying wire. In an embodiment, the magnetic field of a magnet is transverse to the current direction such that the cross product of the current and the magnetic flex (I X B) is towards the magnet by right hand rule. The magnetic field may be supplied by a plurality of magnets oriented with the field transverse to the current direction. Alternatively, the magnetic field may be supplied by a plurality of current loops oriented in a plane perpendicular to the plane of the seal such that the corresponding magnetic field is transverse to the direction of the current flowed through the molten metal.

In some embodiments, the wet seal comprises at least one molten metal pump system to produce and force to act against at least one of gravity and pressure external to at least one of the reaction cell chamber, the PV window, and the PV window chamber such one or more electromagnetic pumps. Each electromagnetic pump may comprise at least one of a (i) DC or AC conduction type comprising a DC or AC current source supplied to the molten metal through electrodes or leads and a source of constant or in-phase alternating vector-crossed magnetic field, (ii) an induction type comprising a source of alternating magnetic field through a shorted loop of molten metal that induces an alternating current in the metal and a source of in-phase alternating vector-crossed magnetic field, and (iii) an induction pump, in which a travelling field induces the required current, as in an induction motor wherein the current may be crossed with an applied AC electromagnetic field. The induction pump may comprise three main forms: annular linear, flat linear, and spiral. The EM pump type may comprise another of the disclosure or known in the art. The EM pump may be multistage. In an exemplary embodiment, the DC magnet and DC current source are replaced by an AC magnet and an AC current source wherein the magnetic field and current are in phase to be crossed to produce a radial force on the molten metal of the wet seal. Multistage DC as well as AC and traveling wave EM pumps are known in the art to development pressure significantly greater than atmospheric pressure. In an embodiment of the wet seal, the seal may comprise at least one electromagnetic pump to inject molten metal in the housing space on top of the flange and between outer edge of the housing and PV window or PV window chamber. The pressure of injected molten metal may be sufficient to oppose the external forces on the molten metal such as atmospheric pressure and gravity.

In an embodiment, the Lorentz force of the wet seal balances at least one external force on the wet seal and maintains the wet seal. The wet seal may comprise a barrier wall that dams up the molten metal forced against it by the Lorentz force to form a raised head. The PV window may be positioned in the raised metal head formed against at least one external force. The raised head may oppose at least one external source of pressure such as at least one of gas pressure such as atmospheric pressure and gravity. The wet seal may comprise a plurality of wet seals to increase the pressure differential capacity of the wet seal. The wet seal may be time dynamic wherein the Lorentz force is controlled in time in response to temporal changes in the external forces. The gap between the outer PV window and the inside of the outer channel wall may be minimized to distribute the force of atmospheric pressure and gravity within the wet-seal molten metal acted on by the Lorentz force. The molten metal surface tension may also contribute to maintaining the molten metal wet seal wherein the effect may be increased due to the atmospheric pressure compression of the PV window or PV window chamber onto the channel floor. The channel floor may comprise a gasket such as a graphite gasket to contribute the wet seal. In an embodiment, atmospheric pressure may push the molten metal in the gap between the inside surface of the PV window chamber and the inside channel wall to a higher level than the level in the gap between the outside of the PV window and the outer channel wall wherein the corresponding head pressure differential may contribute to the wet seal. The differential may be established stably following significant evacuation of the reaction cell chamber wherein the wet seal current may be substantially reduced or terminated while the seal is maintained. In an embodiment, the base of the channel may be flexible such that it can accommodate a tight seal with the PV window or cavity due to force of atmospheric pressure and possibly additional externally applied mechanical pressure by means such as clamps. The channel base may comprise a flexible metal such as thin metal sheet.

An embodiment of the magnetohydrodynamic (MHD) molten metal wet seal or MHD wet seal comprises a peripheral channel containing the molten metal and connected to the reaction cell chamber. The PV window may comprise a peripheral lip or cavity that sits in the wet seal channel. The PV window chamber may comprise the walls and top of the reaction cell chamber. An exemplary channel comprises an annulus channel welded around the perimeter of a circular reaction cell chamber base containing the open base of a PV window closed cavity. The channel may be electrically non-conductive. The channel may comprise electrical insulation such as a coating, liner, or cladding such as VHT paint or alumina, Mullite, zirconia, or other coating comprising an electrical insulator such as an oxide. The MHD molten metal wet seal may further comprise a source of current, a current controller, and leads connected to the molten metal in the channel to cause a controlled current to flow in the metal and may further comprise a source of magnetic field such as a permanent or electromagnet wherein the corresponding magnetic field interacts with the current to create a Lorentz force that is in at least one direction of radial (e.g. directed towards the pressurized side of the seal and away from the vacuum side of the seal) and upward (+z-direction) to maintain the wet seal by opposing at least one force such as gravity and atmospheric pressure. In an exemplary embodiment, the magnetic field is in the vertical direction, and the current is along the perimeter of the wet seal such that the Lorentz force is radial, and corresponding radial molten metal flow is stopped by the outer wall of the channel to form a raised head between the outer channel wall and the outer surface of the PV window chamber. The corresponding balanced forces of pressure, gravity, and Lorentz forces maintain the wet seal. Alternatively, the magnetic field is in the radial direction, and the current is along the perimeter of the wet seal such that the Lorentz force is upward, and the corresponding upward molten metal flow is stopped by the force balance. The corresponding balanced forces maintain the wet seal. In an embodiment, the channel may comprise a splash guard to prevent molten metal from splashing out of the channel due to vibration or agitation.

To permit high-temperature operation of the wet seal, the wet seal may comprise at least one of a channel and reaction cell chamber base comprising a refractory material such as one of the disclosure, a liner comprising a thermal insulating refractory material such as one of the disclosure, and a cooling system such as a heat exchanger. Alternatively, the wet seal may be distanced away for the hottest portions of the SunCell. In an embodiment, the inner channel wall that is interior to the reaction cell chamber comprises thermal insulation such as Calcarb, a ceramic such a BN or quartz, and may further comprise a liner such as a refractory metal such as W. In an embodiment, at least the inner channel wall that is interior to the reaction cell chamber of the channel comprises a refractory material such as a refractory metal such as niobium, tantalum, or tungsten. In an embodiment, the magnets of the MHD wet seal may be comprise a cooling system to cool them such as a heat exchanger and a chiller. The magnets may be positioned at a distance from the channel and may further comprise a magnetic circuit such as a yoke or concentrator such as one having a high Curie temperature such as one comprising iron or cobalt to apply the corresponding magnetic field to the channel.

In an embodiment, the electrical leads may be close together such as with a separation in the range of about 0.1 mm to 1 cm. the leads may be potted in a ceramic potting compound having a CTE that matches that of the metal of the flanges such as Resbond 940 SS in the case of stainless-steel flanges. The potting compound may further serve to seal the spacing between the potted electrical leads. Alternatively, the lead penetrations through the channel wall into the molten metal may comprise feedthroughs that may be welded into the channel wall. Exemplary feedthroughs may each comprise a W conductor and a high temperature ceramic to W braze to be capable of operating at high temperature such as in the range of about 250° C. to 2000° C. In an embodiment, rather than contacting the molten metal through penetrations, electrically insulated leads travel over the top edge of the channel such as the outer edge and travel in the negative z(vertical)-direction to contact the top surface of the molten metal of the wet seal on opposite sides of a separator comprising a means to isolate the positive and negative electrodes. An exemplary separator comprises an electrical insulating wall between the electrodes. The outer channel wall may comprise two protrusions that serve as conduits for the leads. The lead may be housed in a protrusion of the channel wall. In an alternative embodiment to the lead comprising electrical insulation, the electrical isolation of each lead may be achieved by the electrically insulating coating or liner of the channel or by a physical gap between the channel and the lead maintained by a lead support. The leads may comprise a conductor such as tungsten, tantalum, niobium, or stainless steel that is resistant to forming an alloy with the molten metal of the wet seal. In an embodiment, an electrode such as a grounded or negative electrode may comprise the inner housing wall having the electrical insulator partially and selectively removed to make contact with the wet seal molten metal and further comprising an electrical contact on the outside of the housing wall to make contact with the source of electrical current.

In a further exemplary embodiment, the electrically insulating lead spacer or lead electrical divider may comprise a metal wall separator that is coated with an electrically insulating coating such as a ceramic coating such VHT paint, Mullite, or alumina. In an embodiment, the channel may comprise a physical break or gap with an end plate at the open end of each side of the gap to seal the open ends of the channel. The end plates may be welded in. The PV window or PV window chamber may comprise two notches to accommodate the end plates. The notches and gap between the end plates may be sealed with an adhesive such as Resbond 898 or coating such as VHT paint or another adhesive or coating of the disclosure or known in the art. Alternatively, the separator may comprise an electrical break comprising an electrical insulator such as a ceramic or quartz plate, and metal pieces that are brazed to the on opposite sides of insulator and welded to the channel walls to isolate the two polarities of the circuit wherein the metal pieces may be coated with an electrically insulating coating. The braze may be replaced with solidified molten metal. The separator ceramic may be part of the window or be adhered to the window with a suitable adhesive such as Resbond 898.

Alternatively, the separator may comprise an MHD separator wherein the wet seal input current and output current carried by the leads run in opposite directions such that the corresponding current carrying molten metal segments of the wet seal repel into two separated conductor segments in close proximity, held apart by the Lorentz force. In an embodiment, the wet seal may comprise a magnet that increases the repulsive force on the segments. In an exemplary embodiment, the wet seal comprises (i) a circumferential current in the molten metal of the wet seal in the wet seal channel, (ii) a magnet parallel to the current path, above or below it, and (iii) a two leads that have a currents transverse to the wet seal current such that the Lorentz forces of the transverse input and output currents are repulsive to force these current segments apart to serve as an MHD separator. In the case that the electrically insulated leads travel over the top edge of the channel such as the outer edge and travel in the negative z(vertical)-direction to contact the top surface of the molten metal of the wet seal on opposite sides of the separator there is no Lorentz force on the leads since they run parallel to the magnetic field.

The MHD separator may comprise the same or an independent magnet from the wet seal magnet. The magnetic field of the MHD separator may be separately controllable from the magnetic field of the wet seal in order to control the MHD separator. The magnetic field control may be achieved by controlling at least one of the distance and angle of the magnetic field with respect to the input and output currents, and the current of an electromagnet. The surface tension of the molten metal of the wet seal may contribute to the metal segment separation. In an embodiment, the separator may comprise a material that at least partially physically separates the input and output conductor segments until the MHD separator is effective. The physical separator may comprise a material that the molten metal does not wet such as fused silica beads. The wet seal comprising an MHD separator may not require a separator wall and a corresponding separator notch in the PV window chamber. The physical separator may cause the lead shorting current resistance to be higher than the wet seal current to assist in the establishment of the effectiveness of the MHD separator during startup of the wet seal.

In an embodiment, the electrical insulating separator comprises the radial wall welded to both sides and the bottom of the channel and further comprising a separator notch or gap for the PV window chamber rather than the PV window chamber comprising a notch. The separator wall may comprise a tight fit against the PV window chamber on both sides of the notch. The notch may be sealed with an adhesive such as Resbond 940SS or Resbond 898 or a gasket such as a carbon gasket. The tight fit may cause the electrical resistance for a short circuit between the leads to be relatively high compared to the wet seal circuit resistance, such that the opposing radial input and output currents flow sufficiently to cause the opposing current segments to separate by the corresponding Lorentz force.

In an alternative embodiment, the leads may be electrically insulated (e.g. potted in a ceramic such as Resbond 898) at the outer wall of the channel such that a radial current exists at the inner edge of the potting, and the Lorentz force of the corresponding opposing current segments propagates a liquid metal separation front radially inward to eliminate the any shorting current and replace it with the wet seal current. The leads may enter the channel through penetrations or vertically (along the −z axis), and each may further comprise a segment in the xy-plane with the end of this segment contacting the molten metal. The xy-plane segment may cause the repelling MHD separator Lorentz force. In an embodiment with no physical separator, a portion of segments of the leads in the xy-plane are free of molten in a gap between them such that a separation front in the molten metal may propagate radially inward when the wet seal current flows. The leads may comprise a material that maintains the gap such as ones that resist wetting such as stainless-steel or tungsten lead segments. The separator may comprise combinations of separators such as an MHD separator and at least a partial physical separator such as at least a segment of radial wall welded to at least the inner side and a portion of the bottom of the channel.

In an exemplary embodiment, the wet seal comprises (i) annulus magnet, (ii) a fused silica cylinder window chamber having one end open and the other closed and an OD less than the OD of the magnet, (ii) a circumferential annulus channel coated with VHT paint containing wet seal molten metal such as tin and the cylindrical window chamber, welded to a reaction cell chamber of diameter smaller than the ID of the magnet (iii) the magnet suspended below the channel by a support having its magnetic field lines in the z-direction with the plane of the channel in the xy-plane, (iv) electrically isolated W electrical leads to the wet seal metal potted in Resbond 940SS through penetrations in the channel, (v) radially VHT coated metal channel wall (separator) that current breaks the molten metal into two separate pools, each in contact with one lead, and (vi) a source of current to the leads to cause current flow in the molten metal to provide a radial Lorentz force with the crossed magnetic field. The cylinder comprises a notch to fit over the separator. The notch may be sealed to the separator with an adhesive such as Resbond 940SS or Resbond 989 or a compressed gasket such as a graphite gasket.

In an embodiment, the wet seal housing surface that is in contact with the molten metal such as gallium, tin, or silver is coated with an oxide such as silicate, Mullite, alumina-silicate, alumina, or VHT paint to increase the wetting or surface adhesion interaction of the wet seal molten metal and the housing surface. In an embodiment, the housing surface may comprise additionally a coating of the oxide of the molten metal such as gallium oxide that may improve the wet seal molten metal wetting. In an embodiment, the height or length of the wet seal molten metal in contact with the housing may exceed that which form a vacuum-capable seal such as a height or length in the range of about 0.1 mm to 10 cm. In an embodiment, atmospheric pressure on the surface having atmosphere applied to it may be counterbalanced or opposed by pressure on the opposite side of the wet seal produced by at least one of hydrostatic pressure and a pump pressure. The opposing hydrostatic pressure may be provided by a column of liquid such as a column of the wet seal molten metal that may be in contact with the wet seal. The opposing pump pressure may be provided by one or more of any kind of pump capable of applying the opposing pressure such as a gas pump, a liquid pump, or an electromagnetic pump. In an embodiment, the opposing force is provided by a current applied to the molten metal with a transverse component of magnetic field to produce a counterbalancing Lorentz force and pressure. In an exemplary embodiment, the pump comprises the Lorentz force producing components of the MHD wet seal of the disclosure.

At least one section of the PV window or PV window chamber may comprise a flat, concave, convex, a combination of at least one of flat, concave, convex, or other curvature that creates about equal pressure or minimum stress due to atmospheric pressure. In an exemplary embodiment, the PV window chamber such as a PV window chamber composed of fused silica comprises a right cylinder and optionally a flat, concave, or convex top plate. In another embodiment, the PV geometry is optimized to at least one of minimize reflection for at least one of plasma light and light recycled from the PV converter and optimize the light distribution over the PV cells of the PV array. In an exemplary embodiment, the PV window chamber comprises flat sides wherein the PV converter may comprise flat panels that are each parallel to a corresponding PV window chamber wall.

In a further embodiment, the MHD wet seal between the reaction cell chamber and the PV window or PV window chamber comprises a channel containing molten metal into which the PV window or PV window chamber is seated, a source of magnetic field including magnets such as permanent magnets, electromagnets, or combinations thereof, a current source to supply current to the molten metal in the channel, and electrical leads on opposite sides of the PV window or PV window chamber. The PV window or PV window chamber may electrically isolate the electrical leads from each other such that current flows through the molten metal, and the direction of the current and the magnetic field are such that a Lorentz force created by the current and the magnetic field is in a direction to oppose at least one of the forces of gravity and atmospheric pressure.

In an embodiment, the wet seal comprises a continuous closed channel housing the molten metal of the seal and the lower edge or flange of the PV window or the PV window chamber and further comprises the electrical leads to the wet seal current on opposite sides of the PV window or PV window chamber. The leads may be circumferentially displaced to cause overlap of the circumferential wet seal current in the same direction. The PV window or the PV window chamber may serve as the separator wherein the short circuit resistance between the leads is greater than the wet seal current circuit resistance. In an embodiment, the base of the channel may comprise a conductor on which the PV window or cavity rests. The conductor may be positioned in selective segments to facilitate current cross over from one side of the separator to the other. The leads may comprise an outer lead that contacts the wet seal molten metal outside of the PV window or chamber and an inner lead that contacts the wet seal molten metal inside of the PV window or chamber. The outer lead may comprise an insulated wire or bus bar that may travel along the −z-axis in a conduit that may be electrically insulated. The seal at the outer lead may comprise a wet seal. The inner lead may comprise an insulated wire or bus bar that may travel along the +z-axis in a conduit and penetrate the under the reaction cell chamber base plate. The conduit may be electrically insulated. The seal at the inner lead may comprise a wet seal or another such as a Swagelok. The distance of the seal from the reaction cell chamber may be sufficient for the seal to at a operate at a suitable temperature to achieve the seal such as a temperature about below the melting point of the molten metal or within the operating range of the Swagelok. In an embodiment, a lead may be potted in a penetration to contact the wet seal molten metal.

In another embodiment, the wet seal comprises a continuous closed channel housing the molten metal of the seal and the lower edge or flange of the PV window or the PV window chamber and further comprises the electrical leads to the wet seal at current positions about equidistance along the channel relative to each other (e.g. positioned 180° relative to each other on a closed circular channel). The current may flow in about equal opposing circulations between the two leads (e.g. ½ of the current between the leads flows clockwise and ½ of the current lows counterclockwise). In an embodiment, the wet seal comprises a magnet such as a permanent magnet or electromagnet to provide a crossed magnetic field to wet seal current. The magnetic field may be the opposite polarity for each ½ of the perimeter with opposite currents such that the Lorentz force is in the same direction relative to the channel (e.g. ½ of the channel may be magnetized with the magnetic field in the +z-direction, and ½ of the channel may be magnetized with the magnetic field in the −z-direction). In an exemplary embodiment, the magnetic field is provided by two semicircular magnets positioned under the channel to provide a +z-field for the clockwise wet seal current and a −z-field for the counterclockwise wet seal current. The resistance of each channel may be adjusted such that the currents flow about equally (e.g., the absolute value of one current is within 30% or within 5% of the other current) in both the clockwise and counterclockwise directions. The relative resistance of the two current paths may be adjusted by changing the relative cross-sectional area of the molten metal in each direction to balance the corresponding currents wherein the two current paths comprise a current divider. The length of each path may also be adjusted by positioning the electrodes different than 180° separation. In an embodiment, the MHD wet seal comprises sensors for at least one of current and magnetic field and a controller to control at least one of the current and magnetic field to produce an about uniform Lorentz force around the perimeter of the MHD wet seal. The magnetic field may be controlled by controlling the current of at least one electromagnet. The MHD wet seal may comprise a sensor of the wet seal molten metal level in the housing channel such as at least two conductivity sensors displaced at different heights relative to the wet seal molten metal surface wherein the parameters that control the Lorentz force may be controlled to maintain a desired molten metal level in response to pressure differential changes across the wet seal.

In an embodiment, the electrical leads may be connected by at least one bare wire along the channel in each of the two current paths to force good contact between the applied current and the molten metal in the channel (or increase contact of molten metal in the channel with the electrical bias and increase current flow through the molten metal). In an embodiment, the molten metal channel comprises an electrically insulated open conduit or channel in the bottom that may be recessed, a cross-channel that runs radially or perpendicularly to the molten metal channel direction at the position of each electrode. This cross-channel houses a cross-electrode that connects to an electrode at about the outer molten metal channel wall and runs radially inward to about the inner molten metal channel wall. Each cross-electrode may better distribute the channel current evenly across the cross section of the channel molten metal. The magnetic field may be correspondingly adjusted so that the Lorentz force is in the same direction around the channel perimeter. In an embodiment, for a given current divider, the magnetic field is adjusted to balance the Lorentz force around the perimeter of the channel. The sensors and controller may suppress eddy currents and instabilities that may prevent the development of a uniform circumferential Lorentz force.

In an embodiment, at least one electrode such as a grounded electrode comprises the housing wall wherein a bare metal surface of the inner housing wall makes selective contact with the wet seal molten metal. In another embodiment, at least one electrode or electrode lead may be housed in a housing or a conduit wherein at least one of the electrode, electrode lead, and housing may be electrically insulated to prevent electrical shorting. The conduit or housing may be outside of the wet seal channel so that separation between the PV window cavity wall or flange and the housing wall may be minimized. The lead may connect to the electrode through any suitable path such as vertically from the +z or −z direction wherein the housing floor may comprise a corresponding penetration in the latter case, or radially such as through the housing wall wherein the connection may comprise a housing wall or PV window cavity penetration.

The magnetic field may change direction at the position of each lead which gives rise to a transverse transition field component. The wet seal may comprise one lead at the inner channel wall and one lead at the outer channel wall positioned about 180° from each other along the channel loop such that the radial current direction and the transverse fringe magnetic field in the magnetic-field-direction-transition region causes a Lorentz force that is in the +z direction at the positions of both leads. In an embodiment, the wet seal comprises a plurality of leads and magnets positioned at a plurality to locations along the channel to create a plurality of segments of Lorentz force on the molten metal wherein at least one of the current direction and magnetic field direction of each zone and the region between zones is selected to cause a Lorentz force that is directed against at least one of external atmospheric pressure and gravity. The direction of the Lorentz forces may be in at least one direction of in the +z-direction and the outward radial direction.

In an embodiment, the wet seal comprises the circumferential channel that contains the molten metal of the wet seal and houses the open base of the PV window or PV window chamber and further comprises a primary transformer loop through which the channel passes. The closed molten metal loop in the channel serves as a shorted secondary of the primary transformer wherein an altering current in the primary causes a current in the channel metal. The wet seal further comprises an electromagnet that serves as a source of magnetic field that is perpendicular to and in phase with the induced alternating current in the channel to cause a Lorentz force to oppose at least one of atmospheric pressure and gravity. In an exemplary embodiment, the magnetic field is along the z-axis and the wet seal current is in the channel is in the xy-plane.

The molten metal level within the cavity formed between the outer wall of the channel and the outer wall of the PV window chamber may change in response to changes in the pressure differential across the wet seal. The wet seal may further comprise a sensor for at least one of the pressure-differential across the seal such as pressure gauges, and the position of the molten metal of the wet seal such as optical or conductivity sensors, a processor, and a controller controlled by the processor to maintain the wet seal metal at a desired position by adjusting at least one of the wet-seal current and the magnetic field strength. The latter may be controlled by controlling the current of an electromagnet or the separation distance of a permanent magnet. In an embodiment, the walls of the channel are sufficiently high to accommodate small fluctuations in pressure differential across the wet seal such as in the range of about 1 mTorr to 100 Torr. The walls height may be in the range of about 1 mm to 1 m.

The support for the source of magnetic field may stationarily or dynamically position the source of magnetic field at any desired angle and separation distance with respect to the applied wet seal current direction such that the Lorenz force due to the crossed magnetic field of the source and the current may be in a desired direction. The Lorentz force direction and strength may be controlled by a sensor, a controller, a computer, and at least one actuator to provide a counter force to at least one force on the wet seal such as at least one of gravity and external atmospheric pressure.

In an embodiment, the wet seal molten metal comprises one that is resistant to oxidation such as silver. In another embodiment, the SunCell comprises a vacuum tight housing for the PV window wherein at least one of vacuum, inert atmosphere, and a gas mixture comprising at least one component of the hydrino reaction mixture is maintained. The inert atmosphere may prevent the wet seal molten metal from oxidizing. In an embodiment, the molten metal is replaced by a highly conductive molten salt such as a eutectic mixture. In an embodiment, an oxidation-resistant material may be floated on the surface of the wet seal such as a non-miscible liquid such as another molten metal or molten salt to protect the wet seal molten metal from oxidation. In an embodiment, the wet seal comprises an alloy that resists oxidation. The alloy may comprise an alloy of tin that forms a more protective oxide coating than pure tin such as Sn-0.0042 to 0.14 wt. % P alloy. Test results are given by Xian in the article Ai-Ping Xian, “Oxidation Behavior of Molten Tin Doped with Phosphorus”, Journal of Electronic Materials, December 2007, Vol. 36(12):1669-1678 which is incorporated by reference. In another embodiment, oxidized wet seal molten metal is replaced during maintenance.

In an embodiment, the oxide of the wet seal molten metal having the highest melting point of the metal oxides may be added on top of the wet seal molten metal to enhance the natural protective oxide coat. In exemplary embodiments, SnO₂ or Ga₂O₃ may be added to the air-exposed, top surfaces of Sn or Ga serving as the wet seal molten metal, respectively.

In an embodiment, the wet seal may comprise an electrolysis system to maintain a negative potential on the wet seal molten metal to maintain the metal in a reduced state. The electrolysis system may comprise a cathode in a cathode compartment, an anode in anode compartment, a source or voltage and current applied to the electrodes, a salt bridge, an oxide sensor, and a voltage and current controller. The cathode compartment of the electrolysis system comprises the wet seal molten metal, and the anode may comprise a compartment inside or outside of the PV window cavity. In the former case, the anode compartment may comprise a consumable and replaced reductant. In the latter case, the anode compartment may comprise the plasma molten metal. The salt bridge may be under the PV window cavity. The salt bridge may comprise a solid electrolyte, molten salt, or ion conductor such as an oxide ion conductor such as yttria stabilized zirconia. Alternatively, the electrolyte may comprise a positive ion conductor such as β-alumina or a proton conductor such as Nafion.

In an embodiment, the wet seal molten metal may comprise a molten metal other than the molten metal in the reaction cell chamber such as gallium and tin, respectively, and may further comprise a shield inside of the PV window or PV window chamber to prevent the reaction cell chamber molten metal form mixing with the wet seal molten metal and vice versa. The shield may comprise a roof or housing over the channel that blocks metal exchange by allows for gas evacuation. The housing may be part of the PV window and may comprise the same material such as fused silica. A union between the PV window and the housing may comprise a fused union.

In an embodiment, the seal between non-weldable components of the SunCell such as one between ceramic and metal such as the electrical break seal and one between non-weldable metals such as one between a stainless-steel component such as a reservoir and a Ta, Nb, or W component such as the reaction cell chamber may comprise an MHD wet seal. In an exemplary embodiment, the electrical break may comprise a stainless-steel EM pump assembly connected by an MHD wet sell to a ceramic reservoir that further serves as an electrical break. The ceramic reservoir may comprise BN, alumina, hafnia, zirconia, yttria-stabilized zirconia, SiC, quartz, or another ceramic of the disclosure.

In an embodiment, the wet seal housing surface that is in contact with the molten metal such as gallium, tin, or silver is coated with an oxide such as silicate, Mullite, alumina-silicate, alumina, or VHT (alumina-silicate) paint, or glass-coated or lined metal such as a compound of glass and carbon steel to increase the wetting or surface adhesion interaction of the wet seal molten metal and the housing surface. In an embodiment, the housing surface may comprise additionally a coating of the oxide of the molten metal such as gallium oxide that may improve the wet seal molten metal wetting. In an embodiment, the height or length of the wet seal molten metal in contact with the housing may exceed that which form a vacuum-capable seal such as a height or length in the range of about 0.1 mm to 10 cm. In an embodiment, atmospheric pressure on the surface having atmosphere applied to it may be counterbalanced or opposed by pressure on the opposite side of the wet seal produced by at least one of hydrostatic pressure and a pump pressure. The opposing hydrostatic pressure may be provided by a column of liquid such as a column of the wet seal molten metal that may be in contact with the wet seal. The opposing pump pressure may be provided by one or more of any kind of pump capable of applying the opposing pressure such as a gas pump, a liquid pump, or an electromagnetic pump. In an embodiment, the opposing force is provided by a current applied to the molten metal with a transverse component of magnetic field to produce a counterbalancing Lorentz force and pressure. In an exemplary embodiment, the pump comprises the Lorentz force producing components of the MHD wet seal of the disclosure. In an embodiment, the gap between the housing and the outer wall of the PV window cavity or its flange is sufficiently small to minimize the force corresponding to atmospheric, partial atmospheric, or pressure differential across the seal for a give Lorentz force based on a given current and magnetic field strength. In an embodiment, the gap may be in the range of about 0.001 mm to 10 cm. In an exemplary embodiment, the Lorentz force of 200 N/m due to a current of 200 A and a magnetic flux of 1 T is matched to the force of atmospheric pressure of 200 N/m along the perimeter of the channel when the gap is about 2 mm. In an embodiment, the gap between the PV window flange and the baseplate 5b31c (floor of 5b10) is very small such as in the range of about 0.001 mm to 2 mm due to compression from the atmospheric pressure on the PV window cavity 5b4. In an embodiment, at least one of the we seal housing wall and floor through which the magnetic field of the wet seal magnet penetrates may comprise at least one of a magnetic and ferromagnetic metal such as at least one of SmCo, alnico, neodymium, iron, nickel, and cobalt to enhance the magnetic field at position of the wet seal molten metal current to correspondingly increase the wet seal Lorentz force.

In an embodiment, the wet seal is optimized to achieve at least one of (i) a minimum gap between the PV window cavity component such as the PV window cavity wall or flange and the wet seal housing and (ii) a maximum the wet seal molten metal wetting of the PV window cavity component and the wet seal housing by means such as silicate coating the corresponding surfaces. In an exemplary embodiment, the housing and PV window cavity wall or flange may be precision machined or fabricated to minimize the gap. In an embodiment, the gap may be very small at the PV window cavity base especially with the atmospheric pressure loading under evacuated conditions. The PV window cavity such as a fused silica one may comprise a flange such as a fused silica flange wherein the wet seal may be achieved between the flange and the housing floor. At least one of the PV window cavity base, PV window cavity flange, and housing floor may be at least one of lapped and machined to achieve a precision minimum gap to optimize the corresponding wet seal.

In an embodiment, the channel containing the wet seal molten metal between the housing and the PV window cavity wall or flange comprises a covering or cap that is electrically isolated or insulated from the wet seal molten metal. The cap may be immovable. The cap may at least partially contact the wet seal molten metal such as the top surface. The cap may decrease the contact area of the external atmosphere with the wet seal molten metal. The cap may at least partially block the external atmospheric pressure from contacting the wet seal molten metal. The cap may effectively decrease the area of atmospheric pressure contact to decrease the atmospheric force opposed by the Lorentz force. The cap may further at least one of reduce surface oxidation of the wet seal molten metal and reduce mechanical loss of molten metal from the channel (e.g. confine the metal).

In another embodiment, the wet seal comprises liquid metal and a rotating mechanism that spins the seal comprising liquid metal such that the centrifugal force pushes radially on the molten metal and maintains the seal. The rotating mechanism may comprise a rotating window plate such as one by Visiport (http://www.visiport.com/). The rotating mechanism may comprise a mechanical rotating drive and a vacuum tight bearing such as one sealed in a housing. The radial centrifugal force may be balanced by external atmospheric pressure or by a barrier structure such as a peripheral barrier.

In an alternative embodiment, the wet seal comprises a wick material or structure that holds the molten metal by capillary or wetting forces. An exemplary wick comprises one of a molten metal heat pipe. In an embodiment, the wet seal comprises an MHD seal of the disclosure and a wick providing a capillary force to supplement the Lorentz force to maintain the wet seal. Three types of exemplary homogeneous wicks are screen, arterial, and annular such as wrapped screen, sintered metal, and axial grooves. Exemplary types of composite wick structures are composite screen, screen covered grooves, and composite slab. In an embodiment, the wet seal is at the interface of the molten metal and the PV window. The wick may be positioned on the outer surface of the PV window and in contact with the pool of molten metal in the channel.

In an embodiment, the wet seal may comprise a magnetic liquid such as a ferromagnetic liquid wherein the wet seal is maintained by the magnetic field of an external magnetic in the region of the seal.

In an embodiment, the PV window seal to the reaction cell chamber may comprise a high-melting-point braze such as copper braze between a sapphire PV window and stainless steel or Kovar flange. The braze such as one known in the art may have a melting point in the range of 200° C. to 2000° C.

In an embodiment, the PV window may comprise a chamber such as a cubic, rectanguloid, semispherical, or cylindrical cavity sealed to the reaction cell chamber flange at its base. The reaction cell chamber may be tapered in the direction of the PV window such as a fused silica, quartz, or sapphire one to direct plasma flow to the PV window such as one comprising a cavity.

In an embodiment, the reaction cell chamber base may be lined with a refractory reflector such as a refractory metal plate that is polished such as a polished W or Ta plate. In an embodiment, the metal plate may comprise a plurality of parallel stacked metal plates with a gap between they to serve as heat shields that reflect power through the PV window. Alternatively, the base plate may comprise reservoirs to form pools of the molten metal such as tin to maintain a low emissivity surface to reflect the plasma light through the PV window. The pools may be formed by damming up the return path to the reservoir or may be machined in the reaction cell chamber base plate such as a carbon base plate. The pools may be terraced to form a reflective surface with curvature such as a parabolic surface to increase the optical power transfer from the cell. Each base plate may further comprise at least one return molten metal spill over site, overflow site, or elevated return channel of a recessed reservoir. The pools and return feature may be machined in the carbon base plate to selectively cause the molten metal return flow from the molten metal injector to the reservoir in at least one desired region such as one that avoids the return flow interfering with the molten metal injection. In an embodiment, each reaction cell chamber base plate may comprise at least one return channel conduit which may return molten metal to the corresponding reservoir without the metal flowing over the edge of the reservoir connection to the baseplate and reaction cell chamber. In an embodiment, the injector EM pump tube 5k61 and nozzle 5q may be covered with an electrically insulating injection conduit for the trajectory of the injected stream that further prevents contact with return flow of molten metal. The injection conduit may prevent the injected stream from being deflected or interrupted by the return molten metal flow to the corresponding reservoir.

In an embodiment, baseplate liner 5b31b (FIGS. 66L and 66N) may comprise at least one of carbon, Calcarb, or similar carbon based refractory thermal insulator, or a ceramic thermal insulator and a refractory metal plate. The metal plate may comprise wells for the molten metal such as tin to serve as reflective tin pools. In an embodiment, the wall liner 5b31a (FIGS. 66L and 66N) may comprise at least one of a refractory material such as a refractory metal such as W or Ta and a refractory thermal insulator such as carbon. The wall liner 5b31a may further comprise the molten metal than may be flowed over or injected onto the surface by an injector such as at least one molten metal pump such as an EM pump. In an alternative embodiment, at least one of the baseplate liner 5b31b and the wall liner 5b31a may comprise surface texture such as a plurality of grooves to cause a resistance to molten metal flow such that at least one of the molten metal viscosity and the surface tension maintain a layer on the liner that serves as a reflective surface. Exemplary groove patterns are zigzag and herring bone to oppose molten metal return flow. The grooves may comprise a plurality of closely-spaced linear channels extending from the outer edge of the floor to at least one main reservoir return channel or to the reservoir directly. The spacing may be sufficient to maintain about a continuous molten metal coverage on the reaction cell chamber cavity base or floor. (reaction cell chamber cavity used herein also refers to the PV window chamber that may replace the reaction cell chamber cavity in embodiments). Alternatively, the base comprises a top plate comprising a refractory material such as a W plate that is wetted by tin to form a liquid reflective base. In an embodiment, any oxide coating on W may be removed such that the molten metal such as tin wets the metal surface to form a liquid mirror. In another embodiment, the plates of at least one of the base and walls of the reaction cell chamber may comprise a reflective surface such as a carbide coating or a coating that is wetted by the molten metal such as carbide coatings of Ni, Fe, Cr, Si, W, and Ta or another coating of the disclosure. The molten metal such as tin may wet the carbide to form a liquid mirror. In an embodiment, the reaction cell chamber base plate may comprise a highly textured surface to promote molten metal wetting to maintain a reflective molten metal coating. In an embodiment, Calcarb may serve as the baseplate liner having a highly textured surface to form a reflective thin molten metal film such as one comprising tin. In an embodiment, the liner such as the baseplate such as CalCarb may be surface functionalized to facilitate the molten metal wetting the surface. The functionalization may comprise adding at least one carbon terminated bond type such as oxygen, halogen, or hydrogen terminated carbon functionalization. The functionalization may be achieved by exposure of the Calcarb or similar material to the corresponding gas at elevated temperature such as above 100° C. The molten metal wetting such as tin wetting may also be achieved by vapor deposition, high velocity spray application, electrostatic spray application, electrodeposition using plasma or electrolysis, and other deposition methods known in the art.

In an embodiment, the reflective molten metal pool may comprise an inlet riser wherein the height of the molten metal inlet of the inlet riser determines the depth of the molten metal pool. The inlet riser may be connected to a drain conduit with an outlet in the reservoir that may outlet below the top of the nozzle.

In an embodiment, the reaction cell chamber comprises a molten metal spreader or distributor to maintain a reflective molten metal layer or film on the reaction cell chamber base plate or liner. The distributor may be positioned along at least one wall of the reaction cell chamber. In an embodiment, the distributor may comprise a comb, a blade off set from the baseplate, or a dripper. The distributor may comprise a collection channel for injected molten metal such as tin to be returned to the reservoirs. The comb, blade, or dripper may receive molten metal that flows from the channel and distribute it such that it flows from the distributor as a film. The dripper may further comprise perforations to drip and distribute tin over the surface of the base plate to maintain the reflective liquid tin coating. The baseplate may comprise a slope to facilitate the flow of tin from the distributor to the reservoirs.

In another embodiment, the reaction cell chamber or PV window chamber comprises at least one of a wet floor and one or more of a wet wall, each comprising a pump such as an EM pump to pump molten metal from the reservoir or metal collected from returning molten metal and pump it through a distributor such as a linear shower or slot spreader to maintain a molten metal flowing film on at least one of the reaction cell chamber 5b31 floor, baseplate 5b31c, and reaction cell chamber walls. The injection EM pump used to inject molten metal for the reaction may be used to supply molten metal to the distributor (e.g., shower nozzle), wherein the molten metal output from the injection EM pump is split into an injector pump tube and a wet wall EM pump tube. The EM pump tube from the injection EM pump to the inlet of the shower may comprise an access port to provide access to the inside of the EM pump tube. The connection may comprise a reversible one such as a Swagelok connection. Tube diameter may be adjusted according to a desire flow divider ratio. The shower EM pump tube may further comprise a flow control valve, a flow sensor, a floor coverage sensor, and at least one of a valve and EM pump rate controller to control the molten tin flow rate to the shower. The pitch and texture of the baseplate or floor such as that of the baseplate liner 5b31b may be adjusted with the liquid floor molten metal flow rate to maintain a desired molten metal coverage and flow rate. In an exemplary embodiment, the wet floor comprises two EM pumps that each pump molten metal from a corresponding reservoir to individual distributors on opposite sides of the PV window chamber at the baseplate 5b31c wherein each distributor comprises a tube such as a refractory tube such as one comprising W, Ta, Mo, or Nb that has a series of holes along its length and is positioned on the baseplate to create a molten metal shower on the surface baseplate 5b31c. In an embodiment comprising CalCarb as a liner for at least one of the floor and walls and further comprising at least one of a liquid floor and one or more liquid walls, the Calcarb may comprise a wear-resistant coating such as at least one of pyrocarbon, Calcoat CVD, Calcoat paint, silicon carbide, or Aremco Products Graphitic Bond 551RN coating or liner such as Calfoil, or may be covered by another liner such as a W or carbon liner. In the case of a carbon liner for the floor, the carbon such as a carbon plate may comprise channels to direct the return molten.

In an embodiment, the SunCell comprises at least one of a wet floor and wet wall comprising molten metal such as tin is held by surface tension/wicking against pump pressure. In an embodiment, at least one of the wet floor such as the PV window chamber floor and wet wall such as at least a portion of the reservoir wall such as the upper section towards the PV window chamber comprises a porous membrane such as a mesh, screen, or grating suspended over and covering a molten metal cavity. The wet floor and wall further comprise a source of molten metal flow into the cavity to fill it and push molten metal up through the membrane to create the at least one of wet floor and wet wall. In an embodiment, the molten metal cavity of the wet floor may be positioned on the insultation such as CalCarb insulation comprising the floor liner 5b3b. The wet floor may be on the base of the PV window chamber 5b4. In an embodiment, the wet wall may serve as a liner such as a reservoir liner. The wet wall may comprise an inner liner positioned internally to an outer liner such as one comprising thermal insultation such as CalCarb insulation. In an exemplary embodiment, the reservoir wet wall may comprise an outer cylindrical molten metal cavity and an inner cylindrical membrane covering the cylindrical molten metal cavity.

The cavity flow may be intermittent or continuous to maintain a desired molten metal coverage of the wet floor and wet wall. The source of molten metal flow to the wet floor and wet wall may comprise an electromagnetic (EM) pump such as an independent pump in fluid communication with the molten metal in the molten metal reservoir or comprise the injection EM pump that may output through the access port to distribute molten metal to the at least one of wet floor and wet wall. The molten metal flow may be through a line connected between the EM pump outlet and the cavity. Any excess molten metal flow through the membrane may flow into the reservoir. The molten metal level of the wet floor may be also maintained by molten metal injected into the reaction cell chamber or the PV window chamber by the EM pumps that also serve as electrodes for the ignition current. The SunCell may further comprise at least wet floor and wall sensor such as an optical or conductivity sensor and a controller to maintain the desired coverage by controlling the molten metal pressure and flow rate to the molten metal cavity. The controller may control the wet floor EM pump and ignition return flow maintenance of molten metal level of the wet floor cavity. The molten metal line from the EM pump access port to the molten metal cavity may comprise a valve that may be controlled by the controller to control the molten metal pressure and flow rate to the molten metal cavity. The membrane may comprise at least one of wires that may be woven, bars, screen, mesh, mat, grating, sintered metal powder, wick such as one used in molten metal heat pipes, and another porous material known in the art. The membrane may be a refractory material such as a refractory metal such as one of the disclosure such as W, Mo, Ta, of Nb, or quartz, a ceramic, or carbon. In an embodiment, the mesh size of the membrane may be in a range of about 10 to 1000 mesh. The mesh size may be uniform or vary over the area of the floor or wall to provide a desired molten metal film coverage. The effect of gravity on the head pressure variation of the molten metal in the molten metal cavity with vertical height along a wet wall may be negated by at least one of the vertical location of molten metal line input to the cavity and a variation of the mesh size with height. Another embodiment to cancel the effect of gravity is a wet wall comprising multiple vertically stacked cavities that may each be supplied molten metal at a different pressure and flow rate than those of others, and each may comprise a membrane that may have a different mesh size than that of other cavities.

In an exemplary embodiment, a finer mesh may require more pump pressure (EM pump current) but may maintain a higher film integrity due to the higher surface tension and wicking into the underlying liquid metal pool in the molten metal cavity. A horizontal cavity-membrane orientation may serve as liquid floor and a vertical (suspended) orientation may serve as a liquid wall (e.g. reservoir wet wall liner).

In an embodiment, the EM pump line to supply the floor molten metal cavity may penetrate the PV window chamber base plate, and the EM pump line to supply the reservoir molten metal cavity may penetrate the reservoir wall. The penetrations may be welded in. The EM pump inside of at least one of the baseplate and reservoir wall may comprise a refractory material such as a refractory metal (e.g. W, Ta, Mo, Nb), a ceramic, quartz, carbon, or another of the disclosure.

In an embodiment, the reaction cell chamber or PV window cavity floor liner 5b31b may comprise quartz or fused silica that may have a low heat transfer coefficient such as in the range of about 0.3 to 3 W/m K. The quartz baseplate liner may be mirrored to increase its reflectivity to reflect hydrino plasma light from the base of the PV window cavity to the PV cavity window walls to be transmitted to the PV converter 26a. The floor liner may comprise a plurality of layers that may be joined by means such as clamping, gasketed compression, a seal of the disclosure, fusing, gluing, or another seal or sealing method known in the art. To at least one of avoid thermal shock and reduce plasma light absorption by the quartz or fused silica floor plate liner 5b31b, the liner may comprise (i) a thin mirrored quartz or fused silica plate liner on top of another liner such as a CalCarb liner, (ii) a thin mirrored quartz or fused silica plate liner on top of thicker quartz or fused silica plate liner, or (iii) a single thin mirrored quartz or fused silica plate liner to form a cavity under the liner wherein the low pressure may provide thermal insulation approaching that of vacuum as the pressure is lowered. The thin liner may have a thickness in the range of about 0.1 mm to 10 cm, and the thick liner may have a thickness in the range of about 1 mm to 25 cm. The mirror may comprise a reflective metal film such as a film comprising a refractory metal such as W, Ta, and Mo, a transition metal such as Ni, or precious metal such as Pt. Alternatively, the mirror may comprise a polished metal plate such as one comprising a refractory metal such as W, Ta, and Mo, a transition metal such as Ni, or precious metal such as Pt or a dielectric mirror such as one by Newport Thin Film Laboratory (https://newportlab.com/mirror-coatings/). The mirror may be hermetically sealed separately or as a union or bond between layers of a plurality of liners. The metal plate mirror may be tightly held or adhered to the back surface of the quartz plate along its edges. In an exemplary embodiment, the metal plate may be sealed by a gasketed flange such as one comprising a compression seal.

In an alternative embodiment, the mirrored floor plate liner 5b31b, or reflector plate, such as a mirrored transparent plate may comprise a quartz or sapphire plate comprising a molten metal reservoir under the plate to maintain a pool of the molten metal such as tin in contact with the back of the plate to form a mirror. The reservoir may comprise a refractory material such as carbon that may be coated with a hydrogen-reaction resistant coating such as VHT paint, SiC, or a pyrolytic coating. In an embodiment, the quartz plate is seated in the reservoir such that the molten metal contacts the back of the plate to form a mirror and may further form a wet seal for at least one of reaction cell chamber and the PV window cavity gases to prevent corrosion of the mirror.

In an embodiment, at least one liner such as the baseplate liner, reservoir liner, and reaction cell chamber liner may comprise at least one heat shield such as a metal heat shield. The metal heat shield may comprise a metal plate such as a refractory metal plate such as one comprising tungsten, tantalum, or molybdenum. A plurality of heat shields may be separated by vacuum. The heat shields may be separated and exposed to the gas pressure in the SunCell.

In an embodiment comprising a thermal insulating liner, the thermal insulator may have a high operating temperature and may further have a low heat transfer coefficient such as a carbon derivative such as Mersen Calcarb (https://www.graphite-eng.com/uploads/downloads/calcarb_brochure.pdf) having a much less thermal conductivity than that of carbon, and 3000° C. capable. In this case, the thickness of the liner may be reduced by significantly relative to that of a carbon liner to achieve the same desired thermal gradient across the insulation. In an embodiment, the refractory material may comprise a ceramic such as magnesite carbon, aluminum oxide, hafnium oxide, magnesium oxide, magnesite, silicon carbide, zirconium oxide, mullite, Macor, and corundum, alumina-chrome wherein the refractory material may be castable. The thermal insulation liner may be peripheral or below a reflective or radiation shield liner such as at least one W plate.

In an embodiment, at least one of the reaction cell chamber base and the reservoir liners may comprise Calcarb. The Calcarb reservoir liner may further comprise another liner such as an electrical insulating liner such as a BN liner that may comprise at least one of a section of the liner such as a section that lines the electrical break 913 and it may be an inner liner for a Calcarb outer liner. The Calcarb liner may comprise an electrically insulating coating such as diamondlike carbon in at least one section such as the section that spans the electrical break. To prevent mechanical deterioration, the Calcarb liner may comprise at reflection liner such as a refractory liner covering such as a W liner or a wear-resistant coating such as at least one of pyrocarbon, Calcoat CVD, Calcoat paint, or silicon carbide coating or liner such as Calfoil. In an exemplary embodiment, the reservoir liner may comprise a CalCarb outer liner and a W inner liner wherein the W liner may comprise W tube or W plates that may interlock to form a closed polygon such as a square or hexagon. Alternative liners for the top of the reservoirs that may be lined with CalCarb are carbon, BN, quartz, fused silica, or ceramic beads such as metal oxide, nitride, carbide, or boride beads such as alumina, zirconia, yttria-stabilized zirconia, yttria, hafnia, magnesia, or other ceramic beads known in the art such as ones that have a high melting point such as in the range of about 500° C. to 4000° C. The bead diameter may be in the range of about 0.1 mm to 5 cm. The beads may each be reflective or coated with a reflective coat such as a metal such as a refractory metal, a transition metal, or precious metal.

The reservoir liner such as a carbon, BN, quartz, or ceramic bead liner such as a zirconia bead liner may extend upward to cover and protect the floor liner 5b31b such as a CalCarb floor liner at the top of the reservoir. In an embodiment, the bead liner may comprise ceramic beads that fill the void in the baseplate 5b31c formed by the fused reservoir section of the reservoirs shown in FIGS. 66M and 66N. In an embodiment, the bead liner comprises at least a partial housing for ceramic beads such as quartz, zirconia, or yttria-stabilized zirconia beads. The housing 951 (FIG. 66U) such as a BN, graphite, or quartz cup may comprise a bead retention structure or support such as a screen, grating, or floor with perforations or slots on the bottom of the housing.

In an exemplary embodiment, the baseplate liner 5b31b shown in FIG. 66U as 950 comprises a quartz plate with a mirror backing to reflect plasma light. The bead housing may comprise a carbon or quartz dish with a flange that may sit on an opening in the quartz plate to suspend the housing in at least a portion of the indentation in the baseplate 5b31c comprising the penetration for the fused reservoirs. In an exemplary alternative embodiment, the baseplate liner 5b31b comprises a two-level plate liner, one to hold the beads and one to reflect plasma light from the base of the PV window cavity. An upper baseplate liner 5b31b may comprise a quartz plate with a mirror backing to reflect plasma light that comprises an opening to at least a portion of the indentation in the baseplate 5b31c. The upper baseplate liner 5b31b may be separated by spacers from a lower baseplate liner 5b31b comprising a plate with a bead housing that is suspended in the indentation. At least one of the lower plate and housing may comprise carbon that may be coated with a coating such as a SiC, VHT paint, Mullite, alumina, pyrolytic carbon, another ceramic coating, or another coating of the disclosure. In both embodiments, the bead housing may further comprise (i) a perforated floor to permit returning molten metal drainage to the reservoirs, and (ii) penetrations for the injector nozzles that may have washers to allow for nozzle position adjustment, and (iii) at least one of the liner 5b31b may be separated from the baseplate 5b31c and the upper baseplate liner 5b31b may be separated from a lower baseplate liner 5b31b by spacers such as quartz, BN, or ceramic spacers, to form an empty space for thermal insulation. In another exemplary embodiment, the bead housing may further comprise (i) a perforated floor to permit returning molten metal drainage to the reservoirs, and (ii) penetrations for injected molten metal from the injector nozzles below the penetrations, and (iii) collars 952 (FIG. 66U) around the penetrations to retain the beads in the bead housing.

In an embodiment, the reservoir comprises at least two housings or chambers such as (i) an outer housing 5c that is heretically sealed with other components of the SunCell such as the EM pump base plate 5kk1 and the PV window cavity baseplate 5b31 and (ii) an inner housing that houses the molten metal. The inner housing may be sealed to the EM pump base plate 5kk1 at its bottom and open at its top to receive return flow of molten metal injected into the PV window cavity 5b4. The opening at the top may comprise a flare to form a female funnel to receive molten metal such as from the bead housing. The outer house may comprise a male funnel at its top to direct the flow of returning molten metal into the female funnel of the inner housing. In another embodiment, the male funnel may be on each side of the indentation of the fused reservoir such as at the top. The two male funnels feeding return molten metal flow to the corresponding two reservoirs may be electrically isolated for each other. The male funnel may comprise at drip edge to cause the returning molten metal stream to break up to form beads that interrupt any short circuit current to the molten metal housed in the inner housing. The outer housing may comprise an electrical break 913 and an injector alignment adjustor 917 such as a bellows. The inner housing may be electrically isolated from the outer housing above its electrical break. The inner housing may contain the inlet riser 5qa and the injector 5k61 in connection with the EM pump 5kk. The opening of the inlet riser may be near the top of the inner housing or reservoir to increase the pressure of the injected molten metal by the EM pump by increasing the depth of the contained molten metal.

In an embodiment, at least one of PV window cavity base components such as the mirrored floor plate, the fused reservoir indentation liner, the funnel, and an inner reservoir collar may comprise a drip edge. In an embodiment, at least one of (i) one or more drip edges, (ii) the mirrored floor plate, (iii) the fused reservoir indentation liner, and (iv) the funnel may comprise a seal to prevent returning molten metal from flowing into the gap between the inner and outer housings. In an embodiment, the drip edge may comprise an overhang of one component with another to serve as the seal. In an exemplary embodiment, the seal may comprise a drip edge that serves as a cover or overhang of the floor baseplate with the fused reservoir indentation liner. In another exemplary embodiment, the seal may comprise a drip edge that serves as a cover or overhang of the inner reservoir collar with the funnel. Alternatively, the seal may comprise a joint such as a lip or tongue and groove joint. The seal may comprise a gasketed joint such as one with a carbon gasket. In an exemplary embodiment, the top of the inner housing comprises a drip edge collar that overhangs the funnel, and the funnel further comprises a carbon gasket with the drip edge collar.

In an embodiment, the SunCell® further comprises an adjustable or dynamic PV window cavity baseplate 5b31c leveling system to maintain about uniform molten metal return flow. The baseplate leveling system may comprise an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or tilt at least one angle of the baseplate relative to the horizontal plane to a desired angle. In an exemplary embodiment, the drive mechanism may comprise at least one of a threaded rod collar and a means to rotate the rod, and a pneumatic, hydraulic, and piezoelectric actuator or other actuator of the disclosure to push or pull the rod.

At least one of the inner housing, inlet riser 5qa, and injector portion of the EM pump tube 5k61, may be covered with an electrically insulating liner or jacket such as one comprising quartz, BN, alumina, zirconia, or another of the disclosure. The liners or jackets may prevent a short circuit current between the returning molten metal stream and at least one of the inlet riser 5qa, the injector 5k61, and the inner wall of the inner housing. In an exemplary embodiment, the liner or jacket comprises a quartz or BN tube.

In an embodiment, the space between the inner and outer reservoirs (or inner and outer housings in a reservoir) may be filled a heat transfer material or block such as an electrical insulator and thermal conductor such as solid aluminum nitride (AlN), BN, or silicon carbide to cause heat transfer between the inner and outer reservoirs permitting heat removal from the inner reservoir during SunCell operation or transfer of heat to the inner reservoir to melt the molten metal such as tin during startup. Alternatively, the heat transfer material or block may comprise an electrical and thermal conductor that may be electrically isolated from the walls of the reservoirs by an electrical insulator such as an insulator membrane or coating. In an embodiment, the heat transfer material or block may transfer heat to the inner reservoir to melt the molten metal such as tin during startup. The heat may be transferred from the heater comprising a plurality of burners positioned to heat at least a portion of the outer wall of the outer reservoir.

In an embodiment, the heat transfer block may comprise (i) an electrical isolator such as a closed layer of an electrical insulator such as one comprising AlN, BN, or SiC between the inner and outer reservoirs and (ii) a high heat transfer material such as copper filling the balance of the space between the reservoirs. In an exemplary embodiment comprising cylindrical inner and outer reservoirs, the heat transfer block comprises at least one of (i) a BN liner external to the inner reservoir, (ii) a BN liner internal to the outer reservoir, (iii) a circumferential BN cylinder in between the inner and outer reservoir, and (iv) a copper annular cylinder or cylinders filling the balance of the space between the inner and outer reservoirs. The cylinder in the annular space may comprise an expansion joint or slot. The height of the heat transfer block may be a portion of the height of the reservoirs. The heat transfer block may comprise a plurality of sections. The heat transfer block may be positioned to allow for adjustments of the nozzles to achieve alignment using the aligner such as the bellows 917. The heat transfer block may be positioned in a section of the reservoir 5c the below the bellows 917. The heat transfer block may have an electrical isolator on the bottom such as at least one insulating spacer such as one comprising BN to prevent electrical contact with the EM pump baseplate 5kk1.

In an alternative embodiment, heat may be transferred to the inner reservoir by a thermal conductor such as a metal rod such as a copper, silver, aluminum, W, Ta, or Mo rod or a heat pipe. The conductor may be connected to a plate external to the inner reservoir that is heated by the heater such as one comprising a plurality of burners.

In an embodiment, the heater may comprise one of the disclosure such as a Kanthal wire resistive heater or an inductively coupled heater. The heater may further comprise at least one of an infrared reflector and thermal insulation that may be retractable following startup.

The pump tube 5k6 may comprise heat transfer blocks such as copper ones to transfer heat to the EM pump tube from at least one of the heater and the another SunCell component such as the reservoir or EM pump baseplate 5kk1.

In an embodiment, the SunCell may comprise a drainage reservoir capable of vacuum that is in connection with the gap between the outer and inner reservoirs through the EM pump base plate 5kk1 to receive unwanted flow of molten metal into the gap. The drainage reservoir may further comprise a drainage outlet to allow the drainage or removal of the molten metal collected in the drainage reservoir. The drainage may occur before the molten metal level in the drainage reservoir exceeds one that would cause the inner and outer reservoirs (or inner and outer housings in a reservoir) to electrically short such as a level higher than that of the top of the electrical break 913.

In an embodiment, the inner housing liners or reservoir liners made be at least partially fused to prevent returning molten metal from flowing between them. In an exemplary embodiment, the fused portion of the liner such as quartz or BN liners may be at the top such as at the top center to match the fused reservoirs. In an exemplary embodiment, the retuning molten metal may flow in openings such as slots in the peripheral sections of the bead housing wherein the openings for the nozzles 5q may be located toward the center of the bead housing.

In an embodiment, the EM pump 5kk is located at a position at the level of the opening of the inlet riser 5qa or lower. In an embodiment, the EM pump is located below or besides the outer reservoir housing 5c.

In an embodiment, the bead housing and beads may be removed to expose at least a portion of the indentation in the baseplate 5b31c comprising the penetration for the fused reservoirs directly to the plasma light wherein the at least one of the indentation walls and baseplate 5b31c may comprise at least one of a wet wall and wet floor such as one of the disclosure. An exemplary wet wall comprises a membrane lining such as a Ta membrane lining on the indentation walls to form a housing for returning molten metal that permeates the membrane to maintain the well wall. In an embodiment, the baseplate may comprise a mirror such as a metal backed quartz plate with a center cutout or the opening at the indentation. The metal backing may be the molten metal. In an embodiment, the molten metal level in the inner reservoir may serve to reflect plasma light from this area of the base or wall of the indentation. In an embodiment, the indentation walls may comprise a parabolic or another favorable geometry to reflect the plasma light out through the PV window cavity.

In an embodiment, the injector section of the EM pump tube 5k61 may comprise an electrically insulating liner such as a tube comprising a ceramic such a BN, alumina, hafnia, or zirconia, or a quartz tube liner. The return molten metal may flow inside the funnel, over the drip edge, and enter the inner reservoir at position of the injector section of the EM pump tube 5k61 below the nozzle 5q.

In an embodiment, the nozzle 5q comprises a center injector channel and outlet and at least one coating channel and off-center outlet wherein the coating channel may connect to the center channel and provide molten metal flow to the surface of the nozzle to prevent at least one of ion-bombardment erosion and thermal damage. At least one of the coating outlet and channel may be smaller than the injector outlet and channel. In an embodiment, the top of the nozzle may comprise a flat or concave surface such as a right cylinder such that some of the molten metal such as a film pools on the surface to prevent plasma damage. The nozzle may be angled to the normal to allow a flow from the top surface. The steady state or static film may have a thickness in the range of about 1 micrometer to 5 mm.

In an embodiment, the fused reservoir may be constructed from two vertical metal tubes and one horizontal metal tube which may have a larger radius than the vertical tubes. Such configurations may allow the fused reservoir indentation reservoir liner to be constructed from, for example, quartz tubes. In an embodiment, walls of the fused reservoir indentation may comprise a liner such as a quartz liner. In an embodiment, the mirrored floor plate liner 5b31b, or reflector plate, such as a mirrored transparent plate may comprise a single quartz plate coated on the back side with a pure silica reflector coating such as a pure silica coating with an open porosity such as Heraeus Reflective Coating (HRC®) and as Heraeus Quartz Reflective Coating (QRC®)(https://www.heraeus.com/media/media/hca/doc_hca/products_and_solutions_8/servi ces/LM_HRC_EN.pdf, https://www.heraeus.com/en/hng/products_and_solutions/infrared_emitters_and_systems/qrc_infrared_emitters/qrc_emitters.html, and https://www.heraeus.com/media/media/hng/doc_hng/products_and_solutions_1/infrared_emi tters_and_systems/qrs_infrared_d.pdf which are herein incorporated by reference). In some embodiments, the reflective layer may comprise silica or quartz microbeads. At least one of the mirrored quartz floor plate, the quartz fused reservoir indentation liner, the quartz funnel, and the quartz injector sleeve on the injector EM pump tube may comprise a silica or quartz reflective coating such as HRC® or silicon microbead coating. The HRC® coating is essentially 100% reflective from 250 nm to 2500 μm and is stable to 1100° C.

In an embodiment, at least one of the nozzle and a reflective nozzle collar such as W one may reflect light incident along the axis of the nozzle and injector EM pump tube section.

An exemplary SunCell® embodiment, shown in FIGS. 66V-X comprises a wet seal retention wall such as an outer 5b10 and optionally an inner retention wall, a PV window cavity 5b4 mounted on a baseplate 5b31c with the baseplate 531c mounted on a stand 953 having a cable rack 954 for supporting ignition power and EM pump power cables. The baseplate may be lined with a reflective liner 950 that may overhang the fused reservoir indentation 958 to form a drip edge for returning molten metal. The fused reservoirs may be lined with reflective liners 956 that are supported on the drip edge 957 for the returning molten metal such as tin. The drip edge 957 may be welded into the wall of each reservoir 5c of the fused reservoirs. The returning molten metal may flow over the drip edge 957 and into a reflective funnel 955 that may be sealed to the bottom of the drip edge 957 with a gasket such as a graphite gasket. The injector section of the EM pump tube 5k61 may pass through the center of the funnel and connect to a nozzle 5q. The injector section of the EM pump tube 5k61 may be lined with an electrically insulating sleeve. The liners, funnels, and sleeves may comprise quartz that may be coated with a reflective coating on the back such as the one by Heraeus. In an embodiment, one or more of the liners may be fused to one piece that that may be further fused with the PV window cavity. In exemplary embodiments, the sleeve may comprise at least one of quartz, boron nitride, carbon, and a plurality of carbon sections separated by electrically insulating sections or washers of boron nitride or quartz and may comprise at least two portions, and upper and a lower one.

An alternative exemplary SunCell® embodiment, shown in FIGS. 66Y-66ZA comprises dual inner 959 and outer 5c reservoirs and DC EM pump injectors 5kk as liquid electrodes having reservoirs 5c that intersect and join a spherical or hemispherical reservoir dome 960 connected to a baseplate 5b31c and a PV window chamber 5b4 that is sealed to baseplate by a wet seal having an outer wet seal retention wall 5b10 and optionally an inner retention wall, a PV window cavity 5b4 mounted on a baseplate 5b31c with the baseplate 531c mounted on a stand 953. The baseplate 5b31c wall and reservoir dome 960 may be lined with reflective liners 961 and 962, respectively. The reservoir dome liner 961 may have an overhang into each of the fused reservoirs 5c. The fused reservoirs may be lined with reflective liners that are supported on the drip edge 957 for the returning molten metal such as tin. The drip edge 957 may be welded into the wall of each reservoir 5c of the fused reservoirs. The returning molten metal may flow over the drip edge 957 and into a reflective funnel 955 that may be sealed to the bottom of the drip edge 957 with a gasket such as a graphite gasket. The PV converter 26a surrounding the PV window 5b4 is shown in FIG. 66ZA.

In an embodiment, the drip edge 957 may be brazed to the wall of the reservoir 5c with a braze that melts at a melting point that is greater than the operating temperature of the drip edge and low enough to permit the drip edge to be removed by melting the braze. Exemplary brazes are bronze (M.P.=890° C.), brass (M.P.=900° C.), silver (M.P.=961° C.), and copper (M.P.=1083° C.).

In another embodiment, the SunCell further comprises a cover such as a reflective cover that covers the opening in the fused reservoir dome liner 961 to the reservoirs. In an embodiment, the cover may comprise a penetration or hole through which at least one of the corresponding injector tube 5k61 and its sleeve passes. In an embodiment, the injector sleeve such as a quartz one may comprise at least two portions, an upper and a lower one. The cover may rest on the lower sleeve wherein the hole in the cover may have a diameter greater than that of the injector tube 5k61 and less than that of the lower sleeve. The height of the lower sleeve may be such that there is a gap such as one in the range of 0.1 mm to 10 mm between the cover and the dome liner 961 that may allow for return molten metal flow. The cover may have an outer diameter that is larger than the diameter of the opening in the fused reservoir dome liner 961. The cover may comprise a flat plate or a curved, parabolic, spherical, or hemispherical cover dome with the apex facing upwards towards the nozzle 5q. The cover may be reflective or mirrored. In an exemplary embodiment, the cover comprises quartz and the reflectivity is due to a coating on the back side from incident plasma light such as the Heraeus coating. The cover may further comprise at least one short narrow extension, post, or leg on its outer edge. Each post may rest on the fused reservoir dome liner 961 to form a gap at the base of the cover to permit molten metal return flow to the reservoirs 5c. In another embodiment, a curved cover such as a reflective quartz one is inverted such that the apex faces downwards. The dome may at least partially fill with reflective molten metal. The curvature of the cover liner dome may be such that molten metal is permitted to flow at its base and into the funnel 955.

In an embodiment, the reflective components such as at least one of the liner components such as liner 950, 956, 961, and 962 and the funnel 955, may comprise at least one reflective coating from the group of Aremco Quartz Coat 850 https://news.thomasnet.com/fullstory/reflective-coating-handles-temperature-to-1-600-f-454985, CP4040-S2-HT, and LC4040-SG, Aremco Pyro-Duct™ 597-A (Adhesive) Pyro-Duct™ 597-C(Coating)Silver-Filled, Electrically & Thermally Conductive, One-Part Systems to 1700° F. (927° C.) (https://www.aremco.com/conductive-compounds/), Aremco 634-RN—SiC, and the reflective quartz material OM 100 (Heraeus, https://www.heraeus.com/media/media/hca/doc_hca/products_and_solutions_8/solids/OM10 0_EN.pdf). In an embodiment, the mirrored liner comprising a metal such as silver, gold, or aluminum that may form an alloy with the molten metal may be coated with a protective coat such as one of the disclosure such as BN.

In an embodiment, the injector tube sleeve may comprise a seal at the top such as a gasket seal such as a carbon gasket. The bottom of the sleeve may be supported with a retainer device that allows for tin inside of the sleeve to drain to the reservoir.

In an embodiment, an indentation to the reservoirs or of the fused reservoirs may comprise a spherical, hemispherical, or parabolic dome section that may be lined with a shape-matching reflective liner such as a quartz one. The indentation may comprise a circular or electrical opening at the PV window cavity baseplate 5b31c that may have an outer diameter less than the inner diameter of the PV window cavity and any inner retention ring of a wet seal. In the case that the PV window cavity baseplate extends inside of the PV window cavity, the portion inside the PV window cavity may be covered with a reflective liner such as a quartz one. The baseplate liner may comprise an overhang of the indentation opening. The reflective liners may comprise a reflective quartz coating such as one by Heraeus. An exemplary spherical dome indention is shown in FIG. 66C. Each reservoir may comprise a welded-in drip edge such as one located at or near the top of the reservoir.

In an embodiment, at least one of the outer and inner walls of the wet seal channel, retention rings, or housing comprise and/or are coated with a material that is at least one of (i) resistant to alloy formation with the wet seal molten metal such as tin, (ii) is not wetted by the wet seal molten metal wherein avoidance of wetting may prevent wet seal molten metal wicking and consequent oxidation, and (iii) a refractory material. In an embodiment, the material may comprise a refractory metal such as W, Ta, Mo, or Nb, or a ceramic such as quartz or alumina. The coating may comprise one of the disclosure such as BN. The BN coating may be applied to at least the areas that are in contact with the wet seal molten metal.

In an exemplary embodiment, (i) the wet seal may comprise inner and outer retention rings wherein the inner retention ring may comprise a refractory metal such as W, Ta, Mo, or Nb, or a ceramic such as quartz or alumina, at least one of the walls of the inner and outer retention rings and the outer base wall of a quartz PV window cavity may coated with BN, and at least one retention ring may be at least partially sunk into the baseplate 5b31c, (ii) the fused reservoir section (such as the void formed between the fused reservoirs proximal to baseplate 5b31c) may comprise fused tube reservoirs that are connected and open to a metal hemisphere such as a stainless steel one wherein the top of the hemisphere and the outer edge of the reservoirs are welded to the PV window cavity baseplate 5b31c such that the inner surface of the corresponding indentation portion of the fused reservoirs comprising a hemisphere matches the inner diameter of the PV window cavity, (iii) a corresponding hemispherical liner may be present such as a quartz one that matches the inner surface of the metal hemisphere including the openings to the reservoirs and a cylindrical liner such as a quartz one that covers the wall of the circular central opening in the baseplate 5b31c wherein the liners may each further comprise a gasket such as a Cotronics ceramic gasket connected between each other and to the bottom edge of the PV window cavity to decrease return molten metal flow behind the liners (e.g., between the hemispherical liner and the hemisphere, between the cylindrical liner and the wall of the circular central opening), (iv) the top of the reservoirs may open to the indentation section of the fused reservoirs and comprise a drip edge at the opening, (v) a funnel may be connected to the bottom of the drip edge with a gasket such as a graphite one, and (vi) the funnel outlet may deliver returning molten metal such as tin to the inner reservoir. The liners may comprise a reflective coating such as the one by Heraeus. The fused reservoir dome liner may comprise a hemispherical section with having a spherical outer radius about equal to the spherical inner radius of the fused reservoir dome. The baseplate wall liner may have an outer radius about equal to the inner radius of the circular opening of the baseplate 5b31c. The liner thickness may be in the range of about 0.1 mm to 1 cm. In an embodiment, the fused reservoir dome liner may comprise smaller openings to the reservoirs than the ones from the fused reservoir dome to the reservoirs such that light the enters the reservoirs is predominantly directed to the funnel liner 955. The funnel liner may comprise a geometry such as a spherical, hemispherical, or parabolic shape to optimize the reflection of any incident light back towards the PC window cavity. Alternatively, the top of the reservoirs may be lined with a liner that may seat on the drip edge 957.

The wet seal may comprise at least one of a wet matrix or packing and a barrier gasket. The wet packing may comprise a wet seal molten metal and a solid matrix such as porous, particulate, or fibrous matrix that is wetted or impregnated with the wet seal molten metal. The barrier gasket such as a carbon or BN gasket may support the weight of the PV window cavity and prevent flow of wet seal molten metal due to applied external atmospheric pressure when the PV window cavity is evacuated. The wet seal may comprise at least two of a source of wet seal molten metal, a solid matrix or packing mixed with the wet seal molten metal, and a barrier gasket. In an embodiment, the matrix or packing may comprise a matrix impregnated or wetted by the wet seal molten metal such as gallium, tin, or silver. The matrix or packing may comprise an inert material such as an inorganic material such as ceramic, quartz, glass, metal oxide, or metal comprising particles, powder, fibers, mat, foam, porous solid, zeolites, crystals, or a crystal. In an embodiment, the matrix may comprise powdered, particulate, solid crystal, sintered powder, and other solid forms of one or more of silicate, aluminate, aluminosilicate, zirconate, hafnate, another metal oxide, and a metal. An exemplary packing is one or more of sand or alumina particles mixed with gallium, tin, or silver to for a viscous sludge-like wetted mixture or suspension. The ratio of the matrix or packing material to the molten metal may control the viscosity of the mixture or suspension.

In another embodiment, the matrix that is mixed with the wet seal molten metal may comprise a composition of matter such an inorganic one that is one or more of flexible and compressible such as aluminate silicate insulation such as Fiberfrax Fibermat and other similar ceramic fiber insulation products by ThermaXX (https://www.thermaxxjackets.com/products/insulation-materials/ceramic/#:˜:text=Fiberfrax %20Fibermat %20is %20a %20lightweight,needling %20o f %20long %20ceramic %20fibers). In an alternative embodiment, the wet matrix or packing may comprise a material that is impregnated with wet seal molten metal due to at least one wicking, capillary action, and molten metal surface tension. An exemplary material capable of this behavior is a sintered metal such as a sintered metal wick used in heat pipes.

In an embodiment, a portion of the wet seal molten metal that impregnates the matrix or packing may be separated from the wet matrix or packing mixture to form at liquid wet seal at least along the outside wall of the PV window cavity. The separation may be due to the force of atmospheric pressure applied during the evacuation of the PV window cavity. The liquid may be blocked from flow under the PV window cavity bottom edge or optionally under the flange on the bottom of the PV window cavity by a barrier gasket such as a carbon gasket. In an embodiment, the outside wall of the PV window cavity in contact with the liquid metal may be prewetted by the wet seal molten metal. The wet matrix or packing may be retained by the wet seal retention ring or housing circumferential to the PV window cavity dome. The wet seal may further comprise a second retention ring inside of the PV window cavity that may be close to the inside wall of the cavity. In an embodiment, the wet matrix or packing may comprise a thin layer of liquid molten metal on top of the wet seal impregnated matrix or packing between the outer retention wall and the outer wall of the PV window cavity to support a protective oxide coat. The layer thickness may be in the range if 0.001 mm to 1 cm. The height of the wet seal molten metal separated from the wet matrix or packing may be in the range of 0.1 mm to 10 cm.

In an embodiment, the wet seal molten metal such as tin may be replaced with a molten salt such as a eutectic mixture such as a mixture comprising a plurality of at least one of alkali and alkaline earth halides such as mixtures given by crct, http://www.crct.polymtl.ca/fact/documentation/FTsalt/FTsalt_Figs.htm, https://www.crct.polymtl.ca/fact/documentation/FS_All_PDs.htm, and Wenjin D., Alexander B., Thomas B., “Molten Chloride Salts for Next Generation CSP Plants: Selection of Promising Chloride Salts & Study on Corrosion of Alloys in Molten Chloride Salts”, ATP Conference Proceedings 2126, 200014 (2019); https://doi.org/10.1063/1.5117729 which are herein incorporated by reference in their entirety. In an exemplary embodiment, the wet salt comprises an outer retention ring such as a stainless steel one, an optional inner retention ring such as a Ta one, a gasket on the baseplate such as a carbon one on which the PV window cavity seats, and a eutectic salt mixture of two alkali iodides such as CsI (34 mol %)—LiI (66 mol %) MP=209° C., KI (37 mol %)—LiI (63 mol %) MP=279° C., or CsI (52 mol %)—NaI (48 mol %) MP=420° C. or mixtures comprising a plurality of alkali chlorides, alkaline earth chlorides, or both alkali and alkaline earth chlorides such as KCl (17.8 mol %)/MgCl₂ (68.2 mol %)/NaCl (14.0 mol %) MP=380° C. and KCl (70 mol %)/MgCl₂ (30 mol %) MP=415° C.

The surfaces of at least one wet seal component in contact with the molten salt such as those of the retention rings, base plate between the retention rings, and the outer wall of the base of the PV window cavity may be coated with a salt corrosion resistant coating such as aluminide (Hitemco), BN, disilicide, TiN, CrN, or Ta.

In an alternative embodiment shown in FIGS. 66F-66L wherein each reservoir 5c attaches independently and directly to the baseplate 5b31c of the reaction cell chamber 5b31 or the PV window cavity 5b4, the liners such as reflective quartz liners may comprise (i) a baseplate liner 5b31b with an overhang around the perimeter of the entrance to each reservoir 5c, (ii) a welded-in drip edge at each reservoir entrance, and (iii) a funnel that is sealed to the bottom side of the drip edge by a gasket such as a carbon gasket.

In an embodiment, to prevent or reduce warping (e.g., warping that may occur during plasma generation), the baseplate 5b31c may comprise a refractory metal with a low thermal expansion coefficient such as Nb, Ta, Mo, or W. The refractory baseplate 5b31c may be laser welded to the fused reservoir. In another embodiment, the baseplate 5b31c may be cooled.

In an embodiment, the EM pump may comprise a material that is resistant to forming an alloy with the molten metal. The EM pump tube 5k6 and bus bar assembly 5ka2 (FIG. 66 U) may comprise at least one of W and Ta. At least one of the Ta or W pump tubes 5k6 may be welded to a Ta, W, or stainless steel EM bus bar assembly and welded to a stainless-steel EM pump baseplate 5kk1 or a stainless EM pump tube section welded to the EM pump baseplate 5kk1 by a laser weld such as one using at least one of a shim such as a Kovar shim and a filler wire such as 347 stainless steel wire. The Ta or W EM pump tube may comprise an access port 5ak61 (FIG. 66 U) that is capped. The cap may comprise a Lokring fitting (https://www.lokring.com/) cap, sealed to the end of EM pump tube access port.

In an embodiment SunCell components exposed to the molten metal may be coated with a coating to prevent molten metal alloy formation. In an embodiment, the EM pump tube such as a stainless steel one may be coated with an electrical conductor such as at least one of W, Ta, TiN, CrN, TiAlN, CrC, chrome, TriCom 801 (USC technologies), silver, or a precious metal such as at least one of ruthenium, rhodium, pallidum, rhenium, iridium, platinum, platinum/aluminum, and gold applied by coating methods such as plasma or chemical vapor deposition, thermal diffusion coating and electroplating. In an embodiment, a Ta diffusion coating is applied to the EM pump tube such as a stainless steel one by decomposition of tantalum carbonyl such as Ta(CO)₆ or the reduction reaction of a tantalum chloride such as TaCl₄ with H₂ (e.g. Ultramet). In an embodiment shown in FIG. 66U, the pump tube section 5ak6 at the position of the EM bus bars 5k2 comprising the EM bus bar assembly 5ka2 may be welded to the pump tube by a method that prevents oxidation of the interior of the pump tube of the EM bus bar assembly. The EM bus bar assembly may be welded to the pump tube by at means such as laser welding, external welding, cooling, heat sinking, and inert atmosphere welding. In an embodiment, at least one of any of the surfaces of the EM pump tube or EM bus bar assembly may be masked or blocked to prevent oxidation of the uncoated tube metal or a pre-applied electrically conductive coating such as W, Ta, TiN, CrN, TiAlN, CrC, chrome, TriCom 801. In an embodiment, the masking or blocking material may comprise graphite such as graphite valve packing or graphite cord gasket that is packed into the region to be blocked or masked.

In an embodiment, at least one of the inner reservoir, EM pump baseplate 5kk1, and portions of the EM pump tube not coated with a conductive coating may also be coated with a coating to prevent molten metal alloy formation. An exemplary coating is an aluminide/alumina coating such as that of Hitemco (https://www.hitemco.com/) that may be applied by a method of the disclosure such as thermal diffusion. The coating may be applied with the EM pump tube 5k6 attached to the EM pump baseplate 5kk1. During the application of the non-conductive coating to components of a SunCell comprising Ta or W pump tubes, the EM pump tube may be blocked off, or the pump tube at the position of the EM bus bars 5k2 comprising the EM bus bar assembly may be masked if an electrically conductive coating such as W, Ta, TiN, CrN, TiAlN, CrC, chrome, TriCom 801 (USC technologies), silver, or a precious metal such as at least one of ruthenium, rhodium, pallidum, rhenium, iridium, platinum, platinum/aluminum, and gold is pre-applied to this section. In an embodiment, the masking or blocking material may comprise graphite such as graphite valve packing or graphite cord gasket that is packed into the region to be blocked or masked. The PV window cavity baseplate 5b31c, the indentation in the baseplate comprising the penetration for the fused reservoirs, and reservoir drip edge may be separately coated by a coating such as BN, aluminide/alumina (e.g. Hitemco), alumina, zirconia, SiC, mullite, or other ceramic by a means of the disclosure such as thermal spray, HVOF, plasma spray, or thermal diffusion, and attached to the outer reservoirs. The inner reservoir liner may be added. It may extend under the drip edge. Following the application of the coatings, the outer reservoir may be attached to the EM pump baseplate 5kk1 wherein coating this component is optional.

In an embodiment, at least one component coating such as the interior or exterior coating of at least one of the EM pumps, the baseplates 5kk1 and 5b31c, and the reservoirs may comprise a conductive metal nitride that may serve to prevent alloy formation on the internal surfaces and as well as oxidation of external surface of a SunCell component exposed to molten metal and air, respectively. The nitride may be applied by a thermal spray method. Alternatively, it may be formed by nitriding with nitrogen and hydrogen. An exemplary nitride material and component are a Ta nitride coated EM pump tube and EM bus bar assembly.

In an embodiment, an EM pump tube and EM bus bar assembly such as Ta or W ones that are susceptible to oxidation may be coated with a protective external coat such as at least one of a silicide (e.g. one formed by a pack cementation diffusion coating process such as one of Hitemco that uses silicon powder such as R512E fused disilicide coating), aluminide/alumina (e.g. one formed by a thermal diffusion coating process such as that of Hitemco), chrome, ruthenium, rhodium, rhenium, iridium, platinum, or platinum/aluminum, TiN, CrN, TiAlN, NiCrAlY, CoCrAlY, CrC, mullite, alumina, zirconia, SiC, VHT, ZrO₂ paint, or another ceramic of the disclosure or known in the art. In another embodiment, the oxidation-resistant coating may comprise mullite or yttrium stabilized zirconium where the component may be precoated with a high temperature bond coat such as NiCrAlY (service temperature about 1050° C.).

In another embodiment, the oxidation-resistant coating may comprise an inert metal. At least one of the external surfaces of the EM bus bars 5k2 and the EM pump tubes 5k6 may be electroplated with chrome, TriCom 801 (USC technologies), silver, or a precious metal such as at least one of ruthenium, rhodium, pallidum, silver, rhenium, iridium, platinum, platinum/aluminum, and gold. In exemplary embodiment, the EM pump tube may be plated with at least one metal of similar TCE such as at least one of chrome, ruthenium, rhodium, rhenium, iridium, platinum, platinum/aluminum.

In an embodiment, at least one SunCell component such as at least one of the EM pump tube, EM bus bar assembly, EM pump bus bars, inner or outer reservoir, bellows, EM pump base plate, and PV window base plate may comprise at least one of Ti₆Al₄V (Titanium 64) and niobium such as C103 alloy that are resistant to oxidation. Ti₆Al₄V and niobium component may be coated with a molten metal alloy mitigating coating such as one of the disclosure.

In an exemplary embodiment, the alloy and oxidation mitigation coatings and processes comprises the steps of (i) laser welding Ta pump tubes 5k6 connected to a Ta EM bus bar assembly to a stainless steel EM pump baseplate 5kk1 wherein the interior of the EM pump tube may be packed with carbon during laser welding, (ii) (a) applying a tantalum silicide coating (e.g. pack cementation diffusion coating process such as that of Hitemco), (b) applying a rhenium coating (e.g. Ultramet), (c) applying a TiN, CrN, or TiAlN coating (e.g. plasma coating such as that of Surface Solutions) on the external Ta surface of the EM pump tubes and EM bus bar assembly, or (d) not applying a coating wherein the Ta pump tubes 5k6 connected to a Ta EM bus bar assembly is operated at a temperature below that for which the Ta oxidation rate in air becomes such as below 300-400° C., and (iii) (a) applying a thermal diffusion aluminide/alumina coating such as that of Hitemco (https://www.hitemco.com/) or (b) applying a boron nitride (BN) coating to the inner reservoir, the EM baseplate 5kk1, the inner fused reservoir indentation, the funnel drip edge, and the PV window cavity baseplate while masking the interior and external of the tantalum silicide, rhenium, TiN, CrN, or TiAlN coated or uncoated Ta EM pump tubes and EM bus bar assembly. The BN coating may comprise one by ZYP that may be applied mechanically by brush or spray painting or by dip coating (http://www.zypcoatings.com/wp-content/uploads/BN-Hardcoat-CM_zyp.pdf). In an alternative embodiment, the Ta bus bar assembly is uncoated or coated with silicide, and the exterior of the Ta EM pump tubes, the inner reservoir, the EM baseplate 5kk1, the inner fused reservoir indentation, the funnel drip edge, and the PV window cavity baseplate are coated with a thermal diffusion aluminide/alumina coating such as that of Hitemco while masking the interior and external of the Ta bus bar assembly. In an embodiment, the EM pump tubes comprise one metal such as W or Ta, and the EM bus bar assembly comprise a second different metal such as SS wherein the interior of the EM bus bar assembly may be coated with a conductive coating such as TiN.

In an exemplary embodiment, the SunCell® comprises tungsten (W) EM pump tubes and bus bar assemblies that may be laser welded together using a 347 welding rod with Kovar shimming, and the EM pump tube may be laser welded to a SS EM pump baseplate. The W EM pump may be coated with an electrically conductive oxidation resistant coating such as chrome, Ni, WC, WSi₂, or a precious metal such as Pt or Pd. Oxide may be cleaned from the inside of the EM bus bar assembly using a flexible tool that accesses the interior through the EM pump inlet or outlet. Alternatively, the W EM pump may further comprise an access port sealed that may be sealed at the access end by a cap such as a Lokring cap.

In an embodiment, any oxide on the inside of the W EM pump bus bar assembly 5ak6 that is not coated may be removed chemically by means such as treatment with strong base or H₂ reduction such as reaction with H₂ at elevated temperature such as in the temperature range of 550° C. to 800° C. wherein the hydrogen pressure maybe in the range of 1 Torr to 10,000 Torr.

In an another exemplary embodiment, the alloy and oxidation mitigation coatings and processes comprises the steps of (i) TIG welding a stainless steel (SS) EM bus bar assembly to SS pump tubes wherein the interior of the EM bus bar assembly may be packed with carbon during welding, (ii) (a) applying a Ta diffusion coating (e.g. Ultramet), or (b) applying a W CVD coating (e.g. Ultramet) to the interior of the SS EM pump tubes and SS EM bus bar assembly, (iii) applying a thermal diffusion aluminide/alumina coating such as that of Hitemco (https://www.hitemco.com/), or (b) applying a boron nitride (BN) coating to the inner reservoir, the EM baseplate 5kk1, the inner fused reservoir indentation, the funnel drip edge, the PV window cavity baseplate while masking the interior of the SS EM pump tubes and SS EM bus bar assembly and the exterior of the SS EM bus bar assembly.

In an another exemplary embodiment, the alloy and oxidation mitigation coatings and processes comprises the steps of (i) applying a TiN, CrN, or TiAlN coating (e.g. Surface Solutions) to the interior and optionally the exterior of a stainless steel EM bus bar assembly, (ii) TIG welding the Ta, TiN, CrN, or TiAlN coated stainless steel (SS) EM bus bar assembly to SS pump tubes wherein the interior of the EM bus bar assembly may be packed with carbon during welding, and (iii) (a) applying a thermal diffusion aluminide/alumina coating such as that of (e.g. Hitemco) or (b) applying a boron nitride (BN) coating to the inner reservoir, the EM baseplate 5kk1, the inner fused reservoir indentation, the funnel drip edge, the PV window cavity baseplate and EM pump tubes except for the interior and exterior of the EM bus bar assembly which are masked.

In an embodiment, the EM pump tube is cooled to prevent alloy formation. The cooling system may comprise a gaseous or liquid coolant, a coolant circular, and a heat exchanger. The EM pump magnet cooling system may further serve to cool the EM pump tube. In an exemplary embodiment, the EM pump magnet cooling system may comprise water-cooled cold plates which house the magnets wherein the cooling water is chilled by a chiller and circulated by a water pump.

In an alternative embodiment, the EM pump comprises an EM pump housing that houses at least one of the EM pump tube 5k6 and the EM pump bus bars 5k2. In an exemplary embodiment, an EM pump tube comprised of a material that is susceptible to oxidation such as a tantalum EM pump tube and bus bars are housed in the housing that prevents oxidation of the tantalum. The housing may comprise a material that is not susceptible to oxidation, such as a stainless steel. The housing may be at least partially filled with a material such as one with a high heat transfer capacity such as at least one of a metal powder such as silver or copper powder and an electrical insulator such as BN to cause heat transfer from at least one of the EM pump tube and the bus bars to the housing to permit heat removal from the at least one the EM pump tube and the bus bars. The bus bars may be coated with an electrical insulator such as a BN coating between connection to prevent electrical shorting. The connection to the bus bars may be made through electrical feed throughs that may be welded to the housing and to the bus bars wherein a Ta to SS steel bus bar connection may comprise a laser weld according to the disclosure. The feedthrough leads may be electrically isolated from the conductive heat transfer material in the housing, or the material may comprise an electrical insulator such as BN or mica in contact with the leads. The feedthrough may comprise high-temperature capable (e.g. >500° C.) ones such as ones having stainless steel or W leads. In the latter case, a Ta to W weld connection may comprise a laser weld or the connection may comprise a mechanical fastener such as a threaded fixture.

In an embodiment, the EM pump magnets 5k4 may be located inside or outside of the housing. For the inside case, the housing may comprise penetrations for magnet coolant lines for cool blocks that cool the magnets. For the outside case, the housing walls may narrow in the region next to where the Lorentz force is developed wherein the housing may be electrically isolated from the EM bus bar assembly by electrical insulation or a gap. In an embodiment, the housing may comprise a plate and a reversible seal such as one comprising a flange and gasket.

The EM pump may fail by means such as at least one of alloy formation and oxidation of the inner pump tube wall. In an embodiment, the EM pump may be repaired by cutting off the sections that weld to the EM baseplate 5kk1 and welding a plate under the EM base plate 5kk1 that has a matching EM pump tube and bus bars 5k2 attached wherein the inlet and outlet of the new EM pump matched those of the repaired one. A minimum size plate with a matching EM pump tube and bus bars may also serve as a smaller component during coating of the EM pump tube and bus bars making it easier to fit the component inside of a coating reaction chamber.

In an embodiment, the bead retention structure or support such as one comprising a screen or perforations has an opening size slightly smaller than the bead diameter such as in the range of about 1% to 50% smaller. In an exemplary embodiment comprising 8-10 mm beads, the screen gap is about 6 mm. The screen may be attached to the reservoir wall or liner wall and further comprise a central opening of sufficient diameter to allow the injection part of the EM pump tube 5k61 to be moved for nozzle alignment. An inverted screen basket may be attached to the pump tube 5k61 above the bead retention screen to cover the opening without touching the bead retention screen. The depth of the beads may be selected to provide at least one of plasma light reflection, nozzle heat shielding, plasma confinement to the reaction cell chamber or PV window chamber, and to serve as a reservoir liner while reducing molten tin return flow resistance. In another embodiment, injection part of the EM pump tube 5k61 may be at least one of coated with an electrically insulating coating such as aluminide/alumina (e.g. Hitemco) or another of the disclosure, or covered with an electrically insulating cladding or liner such as one comprising quartz or BN.

In an embodiment, the support may be about V-shaped to support the beads that may at least partially fill the middle section of the reservoir union void to optionally provide at least one of thermal insulation and plasma light reflection wherein the support may taper outward such as towards the edge of a central ellipse in floor liner 5b31b such as a the CalCarb one to support a thin layer of beads. The tin layer may avoid a random walk of molten tin flowing over the beads returning to the reservoirs and shorting at least one ignition electrode.

In an embodiment, the support may comprise a tray for the beads that may cover at least a portion of the baseplate 5b31c or baseplate liner 5b31b such as a CalCarb one to optionally provide at least one of thermal insulation and plasma light reflection. The tray may have a plurality of depths such as a shallow depth over the area outside of the area of the reservoir union void. The void may comprise a central ellipse area in floor liner 5b31b such as a the CalCarb one. The tray may have a greater depth in this void area. The shallow depth of the tray may support a thinner layer of beads and the greater depth tray area may support a thicker layer of beads. The thinner layer may dynamically retain the molten metal to maintain a steady state reflective wet floor of the molten metal returning to the reservoirs following injection by pumps such as the ignition EM pumps. The thicker layer may provide a reflective surface while allowing the molten metal return through the beads and tray floor without electrical shorting of the ignition electrodes. The shorting avoidance may be achieved by providing an optimal bead thickness that reflects the light while being thin enough to avoid shorting by a random walk of the return molten metal flow. The tray may further comprise a plurality of penetrations or holes to allow the molten metal to flow through the tray floor to return to the reservoirs. The holes may have a smaller size than the size of the beads. The hole pattern may maximize the number of holes to allow for maximum molten metal flow through the tray floor. In an embodiment, the tray may comprise at least one of channels, penetrations, and conduits to return the molten metal to the reservoir. The tray may further comprise penetrations for at least one of the nozzles 5q and the injector sections of the EM pump tube 5k61. The penetrations for the nozzles or EM pump tube with may comprise enough travel room to allow the nozzles to be aligned while maintaining the bead support. The volume under the tray may be at least partially evacuated during operation due to the low-pressure hydrino reaction parameters such that the low pressure serves as thermal insulation. The tray of beads may prevent plasma from propagating below the tray such that heat transfer is avoided due to plasma heat transfer processes. In an embodiment, the thinner bead layer may have a depth in the range of about 0.1 mm to 5 cm, and the thicker bead layer may have a depth in the range of about 1 mm to 10 cm. In an embodiment, the injection part of the EM pump tube 5k61 in the region where at least one of the nozzles and EM pump tube penetrate the tray floor, may be at least one of coated with an electrically insulating coating such as aluminide/alumina (e.g. Hitemco) or another of the disclosure, or covered with an electrically insulating cladding, liner, or sleeve such as one comprising quartz or BN. In an exemplary embodiment, a quartz sleeve may be fastened in position by securing it tightly between the nozzle and an adjustable nut of a threaded section of the EM pump tube such as a coupler for a plurality of EM pump tube sections.

In an embodiment, the Lorentz force such as that from two molten metal currents in proximity such as those of the ignition current through the injected molten metal streams causes the molten metal to be at least one of dispersed and driven radially to at least one of clean the PV window or window cavity and cause the return molten metal flow to occur from the perimeter of the cavity.

In an embodiment, the injector nozzle tip may be positioned about even with the level of the ceramic beads at the top of the reservoir filled to the top with beads. In an embodiment, the beads around the nozzle tip may be glued together with an adhesive or potting compound such as Resbond 904 to stabilize the bead surface at the nozzle position. Alternatively, the nozzle tip be positioned at different recessed nozzle distances from the level of the top of the beads wherein the reservoir may further comprise a nozzle cavity in the beads to allow the nozzle injection to be unimpeded by the beads. In an exemplary embodiment, the bead liner may further comprise a center cavity such as a cylindrical one that may be formed in the beads to accommodate the ejection of molten metal into the reaction cell chamber or PV window chamber by the injection nozzle. The cavity may be supported by a tube such as a tube comprising a refractory material such as BN, carbon, a ceramic, or another of the disclosure or one comprising zirconia beads potted or adhered together with an adhesive or potting compound such as Resbond 904 or Resbond 940HT, or other high temperature Resbond compound having a low coefficient of thermal expansion. The volume radially to the center cavity may be filled with the beads such as zirconia beads. The injected molten metal that returns to the reservoir may flow between the beads and the housing perforations without wetting so that the beads prevent the returning molten metal from electrically shorting the injector nozzle. In an embodiment, the reservoir may be overfilled (e.g. above the level of the top of the reservoir and baseplate liner, reaction cell chamber baseplate liner, or PV window chamber baseplate liner 5b31b) with the ceramic beads such that return flow of molten metal into the reservoir may be immediately directed downward away from the corresponding injected molten metal stream.

In an embodiment, the ceramic beads such as zirconium or quartz beads comprise a low emissivity such as one in the range of about 0 to 0.6 to reflect plasma light and blackbody away from the reservoir and through the PV window or PV window chamber. In an embodiment, the beads may be polished to decrease the emissivity. The size of the beads may be selected to at least one of increase the reflectivity, improve the thermal insulation, reject plasma from the reservoir, protect the injection nozzle from at least one of heat and plasma, and break up the electrical connectivity of the injected molten metal returning to the reservoir. In an embodiment, the beads may comprise a plurality of sizes that may be mixed or separated in different zones within the reservoir including zones in at least one of the electrical break and bellows.

In an embodiment, another liner such as the baseplate liner 5b31b may comprise beads. The beads may be contained in a retention structure such as an open-top housing on the baseplate 5b31c or may be retained by an adhesive such as one of the disclosure. The bead baseplate liner may comprise a means such as a screen such as W screen to hold the beads in place or an adhesive such as a Resbond or Aremco adhesive of the disclosure or known in the art to fasten the beads in place. The position-fixed beads may further maintain a molten wet floor such as a molten tin wet floor.

In an embodiment, the refractory baseplate liner such as one comprising at least one of carbon, Calcarb, and tungsten may comprise a small diameter top section of each reservoir (e.g. a diameter in the range of about 1 mm to 6.5 cm) of at least one of cause exclusion of high power in this section due to the corresponding limited volume and restricted diffusion of reactants into the top section of each reservoir. Alternatively, the baseplate liner may comprise a larger diameter to the top section of each reservoir (e.g. a diameter in the range of about 2 cm to 10 cm) lined with a liner that has a lower emissivity such as BN. The liner may comprise texture on the inner surface such as a zigzag texture to reflect light upwards towards the PV window.

In an embodiment, the carbide base plate comprises a mean to avoid carbide formation with a stainless-steel reaction cell chamber or reservoirs. The means to avoid carbide formation may comprise non-carbide-reactive shims such as W, Ni, quartz, or BN shims ones. Alternately, the stainless-steel in contact with carbon may be coated with a protective coating such as an Alumina, CrC, Mullite, or other high temperature-capable protective coating of the disclosure or known in the art.

In an embodiment, the EM pump comprises an access port to provide access to the inside of the EM pump tube 5k6 at the position of the EM bus bars 5k2. The access port may comprise a tube section having connection to the EM pump tube in-line with the region of the EM bus bars. The tube section may be sealed at the end opposite the connection to the EM pump tube. An exemplary seal may comprise a weld or a Swagelok, threaded plug, or similar mechanical seal known in the art. The access port may serve to at least one of provide access to the interior of the EM pump tube such as at the region of the EM pump bus bars to remove any undesirable coating such as oxide one and to serve as a molten metal drain port. In the case of a welded access port the opposing end may be cut and rewelded following gaining the access. In an embodiment, the access port may comprise a flexible section such as a bellows or braided tube that is turned down to drain and up to add back tin. Superheated tin may be slowly added back to a room EM pump tube to allow air to be displaced and any oxide allowed to be floated upward away from the bus bar section. The tin may be allowed to solidify, and a cap may be welded on the outside of the access port to seal it. Alternatively, the access port may be sealed with a commercial seal such as a compression seal such as a Swagelok with a coefficient of thermal expansion that matches the metal of the access port such as SS. In an embodiment, the access port may comprise a tube welded to the EM pump tube and the bellows. In an alternative embodiment, the access port may comprise a Y or T Swagelok connected to the EM pump tube and to the bellows.

In an alternative embodiment to an access port comprising a bellows, the access port comprises an L-shaped tube with a swivel joint such as a Swagelok such that the EM pump tube can be reversibly drained of tin and refilled by rotating the L-shaped tube. The refill may be through an opening at the end of the L-shaped tube that may be capped (e.g. using a Swagelok or welded cap).

In an alternative embodiment, the interior of the EM pump tube is coated with an oxidation resistant coating such as a TiN or CrC coating that may also protect the tube for alloy formation with the molten metal.

In a thermophotovoltaic SunCell embodiment, the inner PV window 5ab4 is replaced with a refractory material such as W, niobium, tantalum, Mo, Ni, Ti, or Fe or alloys to serve as a blackbody radiator to emit light for PV conversion. The blackbody radiator may be sealed by mean such as braze, glue, gaskets and brackets, or a wet seal. In an embodiment, the SunCell may comprise an outer an outer PV window 5b4 capable or forming a vacuum-tight seal. In a thermophotovoltaic SunCell embodiment, the PV window cavity 5b4 (FIGS. 66O-66T) comprises an opaque refractory material to serve as a blackbody radiator. In an exemplary embodiment, a quartz, BN, alumina, graphite, or other ceramic blackbody radiator 5b4 is attached to the base 5b31c by a seal of the disclosure such as a wet seal. The quartz PV window cavity may be made opaque by mirroring the outer surface or by cladding the outer surface with a refractory metal or coating. The blackbody radiator may comprise a metal such as W, niobium, tantalum, Mo, Ni, Ti, or Fe or alloys. The blackbody radiation emitted from the blackbody emitter 5b4 may be incident the PV converter 26a wherein the light may be recycled to the blackbody emitter by mirrored PV cells of the PV converter to greatly increase ethe electrical conversion efficiency of the PV converter.

In an embodiment, the PV window cavity 5b4 may serve as a blackbody radiator such that, in addition to transmitting light generated from the plasma therethrough, the PV window is also heated by the plasma to a temperature that induces light emission from the window itself. The blackbody radiator 5b4 may emit blackbody radiation to the PV converter 26a that may be capable of light recycling such as shown by Omair et al. [Z. Omair, et. al., Ultraefficient thermophotovoltaic power conversion by band-edge spectral filtering”, PNAS, Jul. 30, 2019, (Vol. 116, No. 31, pp. 15356-15361 which is herein incorporate by reference]. The PV window cavity may be at least partially metallized with the molten metal. The PV window cavity may comprise a refractory material such as carbon, quartz, W, Ta, Mo, or Nb. The seal of the PV window cavity to the baseplate 5b31c may comprise the wet seal of the disclosure.

### Specialty

In an embodiment of the SunCell® operating at zero or near zero gravity, the molten metal injection system comprises a flow system comprising an electromagnetic pump in each reservoir, a tapering reaction cell chamber, a PV window chamber of smaller cross section area than that of the reaction cell chamber, and at least one conduit from the top of the PV window chamber to each EM pump such that injected molten flows through the rection cell chamber and PV window chamber to the pump to compete a flow circuit. In another embodiment, the EM pump assembly 5kk may be mounted on a rotating platform wherein the centrifugal force due to rotation at least one of replaces or supplements gravity for filling the pump inlet to the pumping section. The EM pump may be located external to the reservoir at a level about equal to the average molten metal level in the reservoir to at least one of take advantage of at least one of gravity and the centrifugal force to preload the EM pump. This pump location may also provide for more compact packaging.

In an embodiment, molecular hydrino such as H₂(1/4) trapped in a metal lattice such as a nickel lattice or in an inorganic lattice such as that of GaOOH may serve as at least one of a (i) molecular laser medium, (ii) photonic computer logic element, senor, or switch, and (iii) neutrino communications transceiver/receiver.

It was observed by Raman spectroscopy on magnetic samples that H₂(1/4) showed a series of SQUID-like fluxon transitions of a single rotational and spin-orbital spilt level and switched from discrete rotational transitions slit by spin-orbital and fluxon linkage transitions to a series of fluxon transitions of a single rotational and spin-orbital spilt level. These unique one/zero-type magneto-optical signals are enabling of computer logic gate or memory element applicants wherein the application of a magnetic field to magnetize the matrix comprising embedded molecular hydrino such as H₂(1/4) or a change in magnetic flux activates the computer logic gate or memory element such as optical ones. The fast speed magnetization switching such as that achieved with applied electric current or laser opto-magnetic interactions by ultrafast lasers [C. Wang, Y. Liu, “Ultrafast optical manipulation of magnetic order in ferromagnetic materials”, Nano Convergence, Vol. 7, No. 35, (2020), https://nanoconvergencejournal.springeropen.com/articles/10.1186/s40580-020-00246-3] is enabling of a fast processor wherein the fluxon series can encode the information that may be read by a light source as a detector signal. The light source may output light in the energy range of about the energies of H₂(1/p) ro-vibrational levels such as those given by Eqs. (29-30) such as one capable of outputting light in the range of X-ray to infrared (e.g. 10 keV to 0.05 eV). An exemplary light source comprises an infrared, visible, or UV laser. An exemplary detector comprises a photodiode, but may comprise other optical signal detectors known in the art.

In an embodiment, molecular hydrino or a composition of matter comprising molecular hydrino such as a gas, liquid, or solid comprising a mixture or chemically tapped or bound molecular hydrino may at least one of absorb and emit at least one photon to achieve an excitation or de-excitation of at least one of a virtual and real ro-vibrational state.

In an embodiment, H₂(1/p) such as H₂(1/4) may at least one of (i) absorb and emit a photon of ½ the energy of at least one of a rotational and vibrational level and (ii) absorb a plurality of photons such as two of energy equivalent to ½ or more of the energy of at least one of a resulting excited rotational and vibrational level and emit from that excited level. H₂(1/p) such as H₂(1/4) or a medium comprising H₂(1/p) such as H₂(1/4) may serve as a frequency doubling medium. In an exemplary embodiment, H₂(1/4) trapped in at least one of a KCl and KOH matrix such as a ball milled KOH—KCl (50/50 wt %) may be irradiated with a 325 nm laser and emit a spectrum comprising photons of ½ the energy of the ro-vibrational spectrum excited by high energy electron beam bombardment. The laser excited spectrum may comprise the ½-energy, virtual-level ro-vibrational spectrum of H₂(1/4) corresponding to the e-beam excitation emission spectrum of H₂(1/4) in a KCl matrix given by about 5.8 eV 4₂ (J+1)0.01509; J=0,1,2,3 . . . and comprising the matrix shifted=1 to =0 vibrational transition with 0.25 eV energy-spaced rotational transition peaks. Other exemplary embodiments of H₂(1/4) absorbing multiple photons during 785 nm laser irradiation of materials comprising hydrino such as GaOOH and Ni foils with subsequent emission of higher energy photons than those of the 785 nm laser are given in R. Mills, “Hydrino States of Hydrogen”, https://brilliantlightpower.com/pdf/Hydrino_States_of_Hydrogen_Paper.pdf which is herein incorporated by reference in its entirety. Exemplary rotational energies given in Tables 5-15 of the Appendix and Eq. (30), and exemplary vibrational energies are given by Eq. (29).

Several of the hydrino spectroscopic signatures were confirmed by experiments as described in the attached Appendix and Subappendix. It will be understood that these spectroscopic signatures may be found in the reaction products of the plasma forming reactions described herein.

### Neutrino Communication System

Other embodiments of a neutrino communication system are part of the disclosure of Mills prior filed PCT Application No.: PCT/IB2022/052016, entitled “INFRARED LIGHT RECYCLING THERMOPHOTOVOLTAIC HYDROGEN ELECTRICAL POWER GENERATOR” having an International Filing Date: Mar. 8, 2022 which is herein incorporated by reference in its entirety.

The hydrino molecule comprises two hydrogen isotope nuclei and two electrons in a single molecular orbital (MO). Uniquely the MO comprises a paired and unpaired electron (Mills GUT, Parameters and Magnetic Energies Due to the Spin Magnetic Moment of H₂(1/4) section). To conserve spin angular momentum during the formation of a bond between two hydrino atoms, the bond energy must be released as a neutrino such as an electron neutrino of spin ½:

$$H ( 1 / p ) + H ( 1 / p ) ⟶ {H}_{2} ( 1 / p ) {+}_{e} \qquad ( 38 )$$

Specifically, a neutrino comprises a photon having

$$\frac{ℏ}{2}$$

angular momentum in its electric and
magnetic fields (Mills GUT, Neutrinos section). During the reaction of Eq. (38), the angular momentum of the reactants is conserved in the products wherein each of the two reacting hydrino atoms are electron spin ½, and the product molecular hydrino and electron neutrino are also each spin ½. The neutrino emission reaction (Eq. (38)) or ro-vibrational transitions involving one or more of neutrinos, photons, and particle collisions such as ones of spin ½ such as electrons may be exploited for transmitting and receiving signals comprising information such as communication signals.

Using Raman spectroscopy with a high energy laser, a series of 1000 cm⁻¹ (0.1234 eV) equal-energy spaced Raman peaks were observed in the 8000 cm⁻¹ to 18,000 cm⁻¹ region wherein conversion of the Raman spectrum into the fluorescence or photoluminescence spectrum revealed a match as the ½-energy ro-vibrational spectrum of H₂(1/4) corresponding to the e-beam excitation emission spectrum of H₂(1/4) in a KCl matrix given by 5.8 eV-4²(J+1)0.01509 eV; J=0,1,2,3 . . . and comprising the matrix shifted v=1 to v=0 vibrational transition with 0.25 eV energy-spaced rotational transition peaks. Due to the unique electronic structure of H₂(1/4) comprising a paired and an unpaired electron in the H₂(1/4) molecular orbital (MO) requiring spin ½ conservation during vibrational transitions, the corresponding energy levels matched theoretical predictions of ro-vibration states of molecular hydrino with excitation and decay involving two-photons (Appendix FIGS. 22A-B, 23A-B, 24, and 25A-C), each of ½ the energy of the ro-vibrational state. These results support the potential of H₂(1/4) neutrino emission and absorption (Eq. (38)) serving as a means for communication (e.g. a neutrino telecommunication system wherein H₂(1/p) serves as a neutrino emitter corresponding to a signal transmitter and a neutrino absorber resulting in partial internal conversion to 2-photon emission to a photodetector corresponding to a receiver). The cross section of neutrinos, and especially low-energy neutrinos, toward any form of interaction such as nuclear reactions is essentially zero such that neutrino signals may be transmitted through any form of solid matter including through the Earth thereby eliminating the dependence on satellites and telecommunication towers.

In an embodiment, a neutrino communication system and method comprise a neutrino emitter and receiver comprising molecular hydrino. To conserve spin during the reverse of Eq. (38), at least one of a molecular hydrino vibrational or ro-vibrational transition may be caused by at least one of particle collision, and one photon or two-photon absorption and emission wherein at least a portion of the transitions may also result in the emission of neutrinos or be excited by the absorption of neutrinos. In an embodiment, at least one of excitation and decay of a H₂(1/p) vibrational or ro-vibrational transition by two-photon absorption and emission, respectively, may uniquely involve two photons, each of energy about equal to ½ the energy of the vibrational or ro-vibrational transition.

In an embodiment, a neutrino communication system may comprise
(i) a molecular hydrino or a source of molecular hydrino such as a SunCell. The molecular hydrino may be embedded in a lattice such as a crystalline lattice or a metallic lattice. The lattice may be reversibly magnetizable. Exemplary lattices are nickel, iron, cobalt, and gold metals, silicon, an alkali halide, an alkali hydroxide, mixtures of an alkali halide and alkali hydroxide, an oxyhydroxide such as FeOOH, and an oxide such as Fe₂O₃;
(ii) a controllable laser to apply photons to molecular hydrino that may be varied in time wherein the laser is of sufficient wavelength and power to at least one of excite and stimulate decay of at least one of a molecular hydrino vibrational or ro-vibrational state wherein the corresponding transition may involve two photons, each of energy about equal to ½ the energy of the vibrational or ro-vibrational transition;
(iii) a controllable particle beam such as an electron to apply particles to molecular hydrino that may be varied in time wherein the particles are of sufficient energy and power to at least one of excite and stimulate decay of at least one of a molecular hydrino vibrational or ro-vibrational state wherein the decay of each state may involve at least one of a photon and a neutrino;
(iv) at least one of a source of controllable magnetic field and electric field applied to molecular hydrino that may be varied in time;
(v) at photon detector;
(vi) a processor to at least one of modulate at least one of the magnetic field, electric field, laser, and particle beam to at least one of encode and receive a neutrino communication signals and to process the signals to send or receive communication signal information.

In an embodiment, at least one of a molecular hydrino vibrational state and a molecular hydrino ro-vibrational state may be at least one of exited and caused to undergo at least one of spontaneous and stimulated decay. At least one of the excitation and spontaneous and stimulated decay may be caused by at least one of the laser and the particle beam. The decay may cause the emission of the vibrational or ro-vibrational state energy as at least one of (i) one photon emission, (ii) two-photon emission, and (iii) at least one neutrino emission. The neutrino may serve as a communication signal. In an exemplary embodiment, an electron beam excites H₂(1/p) vibrational or ro-vibrational states that decay as neutrino emission or electron stimulated single photon emission, whereas a laser may excite a vibrational or ro-vibrational state by two photon absorption and stimulate two-photon emission of a vibrational or ro-vibrational state wherein the excitation may by any means such as neutrino, particle collision such as electron collision by an electron beam, or two-photon excitation. The signal may comprise a plurality of neutrinos due to the decay of a plurality of H₂(1/p) vibrational or ro-vibrational states. The absorption of a communication neutrino may excite the at least one of a molecular hydrino vibrational state and a ro-vibrational state wherein the decay may occur by at least one or two-photon emission. The photon emission may be detected by a photon detector and processed by a processor. In an exemplary embodiment, an electron beam incident molecular hydrino excites H₂(1/p) vibrational or ro-vibrational states with a time dependent intensity variation controlled by a processor that encodes signal information to serve as a neutrino signal transmitter, and molecular hydrino absorb the temporally varying neutrino signal to excite vibrational or ro-vibrational states that are stimulated to decay as two-photon emission with detection by a photon detector such as a photodiode to serve as a neutrino receiver. The temporal varying intensity is recorded and processed by a processor to receive the signal information as data and output the data to a video screen, memory element, speaker, or other output device known in the art.

In an embodiment, the neutrino communication system comprises one or more of at least one of (i) a controllable source of photons such as a laser that may be varied in time, (ii) a controllable source of energetic particles such as an electron beam that may be varied in time, (iii) (iii) molecular hydrino to serve as at least one of a source of emitted neutrino signal and an absorber of neutrino signal, and (iv) a means to convert the neutrino signal to a photon signal. The latter means may comprise a laser that stimulates two-photon emission from an excited molecular hydrino vibrational or ro-vibrational state wherein the state excitation is caused by the absorption of neutrinos. The source of photons, the source of energetic particles, and the source of neutrinos may each at least one of excite and stimulate decay of at least one of a molecular hydrino vibrational and ro-vibrational state. The decay of the molecular hydrino vibrational and ro-vibrational states may cause the emission of at least one of photons and neutrinos. At least one of laser and particle beam intensity modulation may modulate at least one molecular hydrino vibrational or ro-vibrational transition intensity comprising the emission or absorption of at least one of photons, collisional energy, and neutrinos by molecular hydrino. The transition may be at least partially mediated by a lattice comprising embedded molecular hydrino. The fast switching of photon sources such as lasers and particle beams such as electron beams and the fast absorption of a time varying neutrino signal is enabling of at least one of a fast transmitter and receiver wherein the corresponding temporal neutrino intensity variation may at least one of encode and process the signal information. In an embodiment, the signal at least partially comprises or is converted to photons that may be detected by a photon detector such as a photodiode.

In an embodiment, the neutrino communication system comprises at least one of a controllable source of magnetic field and electric field wherein modulation of the at least one field modulates the signal intensity from at least one transition comprising the emission or absorption of at least one of (i) a neutrino, (ii) particle collision energy, (iii) a single photon, and (iv) two photons by molecular hydrino. The transition may be at least partially mediated by a lattice comprising embedded molecular hydrino. In an exemplary embodiment, the application of a time varying magnetic field to at least one of change an applied magnetic flux and change the magnetization of a matrix comprising embedded molecular hydrino such as H₂(1/4), performs at least one function of encoding information in a transmitted signal, decoding information in a received signal, receiving information, and processing information wherein the signal between the transmitter and receiver may be carried by neutrinos. In an exemplary embodiment, the fast speed magnetization switching such as that achieved with applied electric current or laser opto-magnetic interactions by ultrafast lasers such a ones described by C. Wang, Y. Liu, “Ultrafast optical manipulation of magnetic order in ferromagnetic materials”, Nano Convergence, Vol. 7, No. 35, (2020), https://nanoconvergencejournal.springeropen.com/articles/10.1186/s40580-020-00246-3 (which is incorporated herein in its entirely by reference) is enabling of at least one of a fast transmitter and receiver wherein the temporal variation or modulation of the magnetic flux applied to molecular hydrino causes a corresponding temporal variation or modulation of the neutrino signal intensity. The temporal variation or modulation of the neutrino signal intensity maybe caused by a temporal variation or modulation of at least one of the cross section, transition probability, excitation or decay mode or mechanism (e.g. neutrino, one photon, two-photon, or collisional energy emission or absorption), polarization, directionality, energy, and lifetime of the molecular hydrino vibrational or ro-vibrational state. The modulation of the photons such as laser photons or energetic particles such as energetic electrons from an electron beam incident molecular hydrino may independently or in combination with the field modulation perform at least one function of encoding information in a transmitted signal, decoding information in a received signal, receiving information, and processing information wherein the signal between the transmitter and receiver may be carried by neutrinos. The transmitter modulator and receiver modulator such as the time varying source of H₂(1/p) vibrational or ro-vibrational state excitation or stimulated decay and corresponding temporal signal variation may comprise a heterodyne to remove or suppress noise in the signal. The current disclosure comprises modulation of signals and signal processing systems and methods as applied to the neutrino production and detection schemes provided herein. In an embodiment, the signal at least partially comprises or is converted to photons that may be detected by a photon detector such as a photodiode.

In an exemplary embodiment, an electron beam incident molecular hydrino excites H₂(1/p) vibrational or ro-vibrational states with a time dependent intensity variation controlled by a processor. Typically, a time dependent intensity variation is achieved by temporally varying an applied electric current or laser opto-magnetic interactions by ultrafast lasers to encode signal information on produced neutrinos, to serve as a neutrino signal transmitter. Molecular hydrino may absorb the temporally varying neutrino signal to excite vibrational or ro-vibrational states that are stimulated to decay by an applied laser as two-photon emission with detection by a photon detector such as a photodiode to serve as a neutrino receiver of the encoded neutrino signal. At least one frequency and amplitude modulation and demodulation of the neutrino signal may be achieved by an applied electric current or laser opto-magnetic interactions by ultrafast lasers to encode and unpackage transmitted and received data, respectively. The temporal varying intensity may be recorded and processed by a processor to receive the signal information as data and output the data to a video screen, memory element, speaker, or other output device known in the art.

The two-photon emission from the decay of a molecular hydrino vibrational or ro-vibrational state may comprise a photon which contributes to a line emission band and a photon that contributes to a continuum band. The fidelity of the reception or transmission of the neutrino signal may be improved by simultaneous detection and processing of the two types of photons. Different molecular hydrino states p of H₂(1/p) may serve as different energy band widths to carrying expanded information wherein the energy of the photons is further detected by the photon detector.

In an embodiment, at least one of the transmission and reception of the neutrino signal may be directional by at least one of aligning molecular hydrino in the lattice and by directional application of at least one of the electric field, magnetic field, photons, energetic particles, and neutrinos. The alignment of molecular hydrino in the lattice may be achieved by at least one of applying one or more of an alignment electric field and an alignment magnetic field, and by embedding the hydrino molecules in a lattice such as a crystalline lattice.

In an embodiment, a composition of matter such as a crystal comprising molecular hydrino such as KCl:H₂(1/4) or GaOOH:H₂(1/4) serves as a neutrino detector wherein a neutrino is absorbed by molecular hydrino to excite a H₂(1/p) vibrational or ro-vibrational state that decays with at least partial internal conversion to two photon emission that is subsequently detected by a photon detector to detect the neutrino. The signal and detection may involve a plurality of neutrinos, each detected in this manner.

In an embodiment, the H₂(1/p) vibrational or ro-vibrations energy is released as a combination of two or more of (i) two-photon emission, (ii) one photon emission, (iii) neutrino emission, and (iii) particle kinetic energy.

In an embodiment to achieve modulation of at least one of the signal corresponding to transmission and reception, the neutrino communication system further comprises a means to excite at least one of (i) electron paramagnetic resonance (EPR) transitions such as ones comprising at least one of spin flip, spin orbital coupling, and flux linkage transitions, and (ii) H₂(1/p) rotational transitions such as ones involving pure, concerted, and double rotation transitions that may further comprise spin orbital coupling and flux linkage transitions. The means to excite electron paramagnetic resonance (EPR) transitions may comprise a source of applied magnetic field such as a permanent or electromagnet and a source of electromagnetic radiation resonant with the desired EPR transitions such as a radio frequency or microwave transmitter. In an embodiment, at least one of the EPR transmitter and magnet such as those of an EPR spectrometer are temporally tunable. The EPR system may further comprise an EPR signal detector and processor such as ones known in the art such as those of an EPR spectrometer. The means to cause rotational transitions may comprise at least one of (i) a laser such as a visible or ultraviolet laser that causes Raman transitions, and (ii) an infrared light source to cause infrared radiation excited H₂(1/p) rotational transitions. The infrared system may further comprise an infrared signal detector and processor. Exemplary infrared systems comprise those of a Fourier transform infrared spectrometer system and other infrared spectrometer systems known in the art.

The modulation may be achieved by temporal shifting the energy or the amplitude of the of the transmitted or received communication signal. In an embodiment, at least one of the H₂(1/p) vibrational or ro-vibrational state (i) two-photon emission, (ii) one photon emission, (iii) neutrino emission, and (iii) particle kinetic energy and the H₂(1/p) vibrational or ro-vibrational state (i) two-photon absorption, (ii) one photon absorption, (iii) neutrino absorption, and (iii) particle kinetic energy corresponding to signal transmission and reception by a transmitter and receiver, respectively, is at least one of energy-shifted or amplitude-modulated by the at least one of the EPR and rotational transitions that may be modulated in at least one of energy and intensity (amplitude).

In an embodiment, the H₂(1/p) vibrational or ro-vibrational state (i) two-photon emission, (ii) one photon emission, (iii) neutrino emission, and (iii) particle kinetic energy may cause lasing to at least one of amplify the communication signal and cause it to be directional in a desired direction. In an embodiment, molecular hydrino may comprise at least one of a gas in a cavity and H₂(1/p) molecules embedded in a column of crystalline matrix wherein the cavity or column length may be sufficient to achieve lasing. In an embodiment, neutrino lasing occurs from excited H₂(1/p) vibrational or ro-vibrational states to produce an amplified directional communication signal that it transmitted from a transmitter to a receiver wherein the signal may be modulated by either the transmitter or receiver.

### Hydrino Catalyzed Fusion (HCF)

The equations given in this HCF section refer to those of Mills GUT.

Fusion reaction rates are extraordinarily small [47]. In fact, fusion is virtually impossible in the laboratory. A high relative kinetic energy corresponding to extraordinary temperatures of the participating nuclei must be sufficient to overcome their repulsive potential energy. The recent NIF experimental results confirm that so called “ignition” requires 250,000,000° C. and a deuterium-tritium density of ten times that of lead to achieve about 0.2% fusion power over that input to the NIF lasers. In this case, the lasers consumed 500 trillion watts of power, 33 times the peak power of the entire world. It is also remarkable that the NIF device cost $3.5B, and the fusion pellet cost $1M for a single shot that requires months to repeat. The product was less than one cents worth of radioactive thermal as an explosive shock wave.

Cold fusion regarding hydrogen loading, excess hydrogen absorbed in a metal lattice, to force nuclei together is not possible since the Coulombic energy barrier is 0.1 MeV [47]. Whereas the vibrational energies within crystals are much less, about 0.01 eV. Coulombic screening is also not plausible based on the known crystalline structure of metal hydrides. Given the relationship between temperature and energy, 11,600 K/eV, the disparity in temperature in both cases is 1.16×10⁷ versus 116 K, a factor of one hundred thousand.

Albeit, it is still high-energy physics involving colliders, muonic catalyzed fusion may propagate at a high rate at more conventional plasma temperatures. Rather than directly using high temperature and density conditions, fusion occurs by a muonic catalyzed mechanism involving forming muons in a high-energy accelerator that transiently replace electrons in atoms and molecules (time scale of the muon half-life of 2.2 s). In muon catalyzed fusion [48-49], the internuclear separation of muonic H₂ is reduced by a factor of 207 that of electron H₂ (the muon to electron mass ratio), and the fusion rate increases by about 80 orders of magnitude. A few hundred fusion events can occur per muon (vanishingly small compared to Avogadro's number of 6.022X×10²³). To be permissive of even this miniscule rate of fusion, the muonic molecules provide the same conditions as those at high energies. Correspondingly, the vibrational energies regarding the movement of the nuclei towards each other in an oscillating linear manner can be very large in the muonic hydrogen case, E_{vib} 207X 0.517 eV=107 eV wherein is the vibrational quantum number. During the close approach of the vibrational compression phase, the nuclei can assume an orientation that allows the mutual electric fields to induce multipoles in the quarks and gluons to trigger a transition to a fusion product. The highest vibrational energy states such as the state=9 with E_{vib} 107 eV=9X107 eV=963 eV are at the bond dissociation limit. Given the extraordinary confinement time in a bound state, these muonic molecules have sufficiently large kinetic energy to overcome the Coulombic barrier for fusion of the heavy hydrogen isotopes of tritium with deuterium at just detectable rates.

Fusion in the Sun occurs due to extreme gravitational compression and thermal temperatures that provide sufficient confinement time, enormous reactant densities, and incredible energies. But even here, the Sun considered as a fusion machine of 1.412×10³⁰ liter outputting 3.846×10²⁶ W corresponds to a feeble 272 W/liter. Fusion bombs (e.g. Tsar Bomba) require ignition by a fission bomb that produces power density on the order of

$$\frac{240 \times {10}^{15} J}{( {10}^{- 3} s ) ( 2.7 \times {10}^{7} liters )} = 8.8 \times {10}^{12} W / liter ,$$

3.2×10¹⁶ times the average power density of the Sun. Arc current detonation of hydrated silver shots and other conductive solid fuels comprising a source of hydrogen and a source of HOH catalyst yielded power densities comparable to those of nuclear weapons [50-54].

Next, consider the feasibility of hydrino catalyzed fusion (HCF) based on a similar mechanism to that of muonic catalyzed fusion. Once a deuterium or tritium hydrino atom is formed by a catalyst, further catalytic transitions

$$n = \frac{1}{2} ⟶ \frac{1}{3} , \frac{1}{3} ⟶ \frac{1}{4} , \frac{1}{4} ⟶ \frac{1}{5} ,$$

and so on may occur to a limited extent in competition with molecular hydrino formation that terminates this cascade. The hydrino atom radius can be reduced to 1/p that of the n=1 state atom. Analogous to muonic catalyzed fusion, the internuclear separation in the corresponding hydrino molecules is 1/p that of ordinary molecular hydrogen as given in the Nature of the Chemical Bond of Hydrogen-Type Molecules and Molecular Ions section (Eq. (11.204)). As the internuclear separation decreases due to high p states, fusion is more probable. As p becomes large, relativistic effects become appreciable for the energy transferred from a hydrino atom and accepted by the catalyst that provides the corresponding energy hole. As in the nonrelativistic case, the energy transferred is the potential energy of the hydrogen-type atom H(1/p) that transitions to a lower energy state, divided by p², the total number of multipole modes of the state according to Eq. (5.45). Due to similar relativistic effects in hydrino atoms of similar p states, hydrino atoms may serve as the catalyst by disproportionation reactions such as ones given by Eqs. (5.62-5.80). Disproportionation reactions may propagate or cascade to very low hydrino energy states of corresponding very high p values. The corresponding hydrino molecules have vastly shorter internuclear distances (Eq. (11.204)) such that finite rates of nuclear reactions may occur in the case of heavy hydrogen isotopes, deuterium and tritium.

In the case that the electron spin-nuclear interaction is negligible, using Eq. (1.292), the relativistic potential energy of a hydrino atom H(1/p) of a given state p is

$$V = \frac{{Ze}^{2}}{\begin{matrix}4 & {}_{0} r\end{matrix}} = \frac{{Z}^{2} {e}^{2}}{\begin{matrix}4 & {}_{0} {a}_{0} \sqrt{\begin{matrix}1 & {( Z )}^{2}\end{matrix}}\end{matrix}} = \frac{{( p )}^{2} {m}_{e 0} {c}^{2}}{\sqrt{\begin{matrix}1 & {( p )}^{2}\end{matrix}}} \qquad ( 5.112 )$$

wherein the radius given by Eq. (1.289) is

$$r = \frac{{a}_{0}}{p} \sqrt{\begin{matrix}1 & {( p )}^{2}\end{matrix}} \qquad ( 5.113 )$$

and Eqs. (28.8-28.9) were used. Thus, the energy hole according to Eqs. (5.112), (5.5), and (5.45) is

$$m \frac{{}^{2} {m}_{e 0} {c}^{2}}{\sqrt{\begin{matrix}1 & {( p )}^{2}\end{matrix}}} \qquad ( 5.114 )$$

which in the low-speed limit is m27.2 eV given by Eq. (5.5). Using Eq. (1.294) and Eqs. (5.6-5.9), the energy released from a hydrino state p during the transition involving an energy hole of quanta M is given by the difference in ionization energies between the initial and final energy states wherein the final p_{f} state is p_{f}=p+m:

$$E = {m}_{e 0} {c}^{2} ( \sqrt{\begin{matrix}1 & {( p )}^{2}\end{matrix}} \sqrt{\begin{matrix}1 & {( ( p + m ) )}^{2}\end{matrix}} ) \qquad ( 5.115 )$$

In the low speed-limit the energy released is given by Eq. (5.9). Note as given previously, p=137 is the highest value of p physically possible corresponding to a minimum radius of 0.022926 a₀=8.853×10¹⁵m=8.853fm compared to the radius of a proton of 1 fm.

The non-relativistic vibrational energies are given by Eq. (11.223) as E_{vib}=p²0.517 eV, and the relativistic atomic radii are given by Eq. (5.113). A sufficiently high p can provide vibrational energies and close approach of nuclei of corresponding molecules sufficient for fusion to ensue. Considering the p² dependency of the vibrational energies of H₂(1/p), and excitation of highest vibrational energy state at the bond dissociation limit (e.g.=9), the state p=15 can achieve comparable vibrational energies as muonic molecules; yet, the p=15 hydrino atomic radius (Eq. (5.113) and corresponding molecular hydrino internuclear distance are about 14 times greater than those of the muonic species. The p state that achieves comparable dimensions to those of muonic atoms and molecules is p=115 (Eq. (5.113)) which has a corresponding nonrelativistic vibrational energy of 6840 eV. Only the lowest energy vibrational state would likely be populated with the energy from bond formation p²4.478 eV (Eq. 11.252)) since the temperature required to excite 7 keV vibrational modes is on the order of 108 K, compared to an ordinary plasma temperature of about 1000 K. Considering that each muon catalyzes hundreds of fusion events, the cross section to populate the molecule hydrino vibration state is essential to match fusion rates comparable to muonic catalyzed fusion of tritium with deuterium since hydrino catalyzed fusion occurs as single events.

Consider the limit of the highest p value for a hydrino state H(1/p). Using Eq. (5.115), the energy for the cascade of two hydrogen atoms, each to the final state of H(1/137) results in an energy release of 1×10⁶ eV. In comparison, the fusion equation for deuterium and tritium is

$${}^{2} H + {}^{3} H ⟶ n ( 14.1 M eV ) + {}^{4} He ( 3.5 M eV ) \qquad ( 5.116 )$$

Nuclear fusion (i) requires accelerator-produced, radioactive tritium, (ii) it is a highly radioactive dangerous process, and (iii) it requires a steam cycle involving massive scale and a water-body coolant source such as a river as well as an electrical distribution grid. Production of chemical power as light and supersonic plasma flow enabling compact photovoltaic and magnetohydrodynamic conversion, respectively, that is devoid of any fuels or distribution infrastructure is much more practical and economically competitive as a commercial power technology.

Fusion has other utility such as production of (i) neutrons (D+T and D+D fusion), and (ii) ³He, tritium, and high energy protons (D+D fusion) which have industrial applications. In the case of extraordinarily high p states approaching p=137, bonding with inner shell electrons may result in fusion of heavier elements than hydrogen isotopes. Energetic fusion products may also initiate subsequent nuclear reactions.

Fusion requires a hydrino transition reaction cascade such as one propagated by disproportionation reactions to hydrino states of high p wherein the hydrino reaction mixture comprises a hydrogen isotope capable of reacting form hydrino, serving as a reactant in disproportionation reactions, and serving as a reactant in at least one fusion reaction. Exemplary hydrogen isotopes are deuterium, tritium, and combinations of deuterium and tritium. The reaction mixture may further comprise other nuclei capable of participating in a fusion reaction such as a lithium isotope such as ⁶Li and ³He wherein in at least one or more of these or fusion products of hydrino reactions may serve as a fusion reactant.

The hydrino transition reaction cascade is favored by (i) massive kinetics, (ii) hydrino and plasma confinement, and (iii) increasing duration of the hydrino reaction. One exemplary system to cause massive kinetics and hydrino and plasma confinement is detonation of hydrino reactant solid fuels under arc current conditions [50-54]. Specifically, detonation of hydrino reactant solid fuels was propagated by flowing a high current such as one in the range of 10,000A to 35,000A through a 5 mm diameter conductive vessel corresponding to current densities of 500 A/mm² to 1800 A/mm² wherein an arc current condition may be achieved. Applying 10,000A to 35,000A to cause detonation of (i) DSC pans containing a source of hydrogen and a source of HOH catalyst such as a hydrino reactant solid fuel, (ii) water in a DCS pan, and (iii) hydrated silver shots are further exemplary embodiments massive kinetics and plasma confinement [50-54]. Hydrino confinement is achieved by using as a component of the hydrino reactant mixture at least one of (i) a solid material to absorb hydrino atoms such as a metal surface or bulk such as one that also absorbs H atoms (e.g. Ni, Ti, Pd, Pt, Nb, or Ta) [54], (ii) a magnetic material such as FeOOH or Fe₂O₃, that favors magnetic bonding of hydrinos [54], and (iii) an oxide such as a metal oxide such as GaOOH or Ga₂O₃ that binds hydrinos [55]. The hydrino reaction mixture may be maintained at high temperature to increase the hydrino disproportion rate.

References given infra for the Hydrino Catalyzed Fusion (HCF) section are incorporated herein by reference in their entirety with other Mills Patents and Publications.
47. http://en.wikipedia.org/wiki/Nuclear_fusion.
48. L. I. Ponomarev, “Muon catalyzed fusion,” Contemporary Physics, Vol. 31, No. 4, (1990), pp. 219-245.
49. J. Zmeskal, P. Kammel, A. Scrinzi, W. H. Breunlich, M. Cargnelli, J. Marton, N. Nagele, J. Werner, W. Bertl, and C. Petitjean, “Muon-catalyzed dd fusion between 25 and 150 K: experiment,” Phys. Rev. A, Vol. 42, (1990), pp. 1165-1177.
50. R. Mills, Y. Lu, R. Frazer, “Power Determination and Hydrino Product Characterization of Ultra-low Field Ignition of Hydrated Silver Shots”, Chinese Journal of Physics, Vol. 56, (2018), pp. 1667-1717.
51. R. Mills J. Lotoski, “H₂O-based solid fuel power source based on the catalysis of H by HOH catalyst”, Int'l J. Hydrogen Energy, Vol. 40, (2015), 25-37.
52. https://brilliantlightpower.com/pdf/Spectroscopy_Nansteel_Report_040219.pdf.
53. https://www.brilliantlightpower.com/wp-content/uploads/pdf/Free-Air-TNT-Analysis.pdf.
54. R. Mills, “Hydrino States of Hydrogen”, https://brilliantlightpower.com/pdf/Hydrino_States_of_Hydrogen.pdf, submitted for publication.
55. Wilfred R. Hagen, Randell L. Mills, “Electron Paramagnetic Resonance Proof for the Existence of Molecular Hydrino”, Vol. 47, No. 56, (2022), pp. 23751-23761; https://www.sciencedirect.com/science/article/pii/S0360319922022406.

The invention claimed is:

1. A power generation system comprising:
a) at least one vessel comprising a baseplate capable of a maintaining a pressure below atmospheric comprising a reaction chamber;
b) two electrodes each in fluid communication with molten metal contained in a corresponding reservoir, wherein the molten metal is configured to flow between the electrodes to complete a circuit;
c) a power source connected to said two electrodes comprising a cathode and anode to apply an ignition current therebetween when said circuit is closed;
d) optionally, a plasma generation cell to induce the formation of a first plasma from a gas; wherein effluence of the plasma generation cell is directed towards the circuit
wherein when current is applied across the circuit, the effluence of the plasma generation cell undergoes a reaction to produce a second plasma and reaction products wherein energy from second plasma produces radiation;
e) a transparent window cavity to transmit radiation produced from the second plasma, wherein the transparent window cavity is in contact with the baseplate of the vessel;
f) a wet seal between the transparent window cavity and the baseplate comprising a wet seal molten metal, and
g) a power adapter configured to receive the radiation transmitted through the transparent window cavity and convert and/or transfer energy from the second plasma into mechanical, thermal, and/or electrical energy.

2. The power generation system of claim 1, wherein the molten metal is supplied to the electrodes to close the circuit by two molten metal injector systems that each form a molten metal stream in contact with one of the electrodes, wherein the molten metal streams intersect to close the circuit, and each molten metal injector system comprises:
a) at least a reservoir that contains some of the molten metal, a molten metal pump system configured to deliver the molten metal in the reservoir and through an injector tube to provide a molten metal stream, and the reservoir for receiving a returning molten metal stream following injection;
b) an inlet riser tube to control the molten metal level in the reservoir;
c) an electrical break in the wall of the reservoir to electrically isolate each of the corresponding electrodes from the electrode of opposite polarity, and
d) an alignment mechanism to change the orientation of the electrode injector such that the corresponded two streams of the two electrodes intersect to complete the circuit.

3-8. (canceled)

9. The power generation system claim 1, wherein the vessel comprises a spherical, hemispherical, or parabolic dome section to which the reservoirs are connected and further comprises a drip edge at the connection to each outer reservoir.

10. (canceled)

11. The power generation system claim 1, wherein the baseplate and vessel further comprises reflective liners of all the surfaces that are incident the plasma radiation and reflect the incident light through the window cavity to the power adapter wherein the liners further comprise penetrations for the injectors that are further covered by reflective penetration liners.

12-13. (canceled)

14. The power generation system of claim 1, wherein system further comprises an electromagnetic pump baseplate wherein the surfaces in contact with the molten metal are coated with a coating that prevents alloy formation with the molten metal.

15. The power generation system according to claim 1, wherein the vessel is connected to the window cavity and the wet seal further comprises:
a) a window flange at the base of the window cavity;
b) a baseplate flange on the baseplate;
c) a top flange on top of the window cavity flange having a mechanical connection to the baseplate flange to provide pressure on the window flange against the baseplate flange;
d) a gasket on a least one window cavity flange surface in contact with the top flange and the baseplate flange;
e) at least one of an inner circumferential housing or retention wall to the inside of the window cavity and an outer circumferential housing or retention wall to the outside of the window cavity flange, and
f) wet seal molten metal retained by the housing and retention wall and the gasket to maintain a lower pressure inside of the window cavity relative to outside to maintain a pressure differential.

16-24. (canceled)

25. The power generation system of claim 1, wherein the wet seal and window cavity further comprises a gasket interface comprising surfaces that permit relative moment between the gasket and the window cavity without destructive damage to the gasket.

26-27. (canceled)

28. The power generation system of claim 9, wherein the inner and outer reservoirs further comprise a thermal conductor and an electrical insulator which conduct heat positioned in the gap between the inner and outer reservoirs and permit heat conduction while maintaining the electrical isolation of the two electrodes.

29-31. (canceled)

32. The power generation system of claim 1, wherein said gas in the plasma generation cell comprises a mixture of hydrogen (H₂) and oxygen (O₂).

33-39. (canceled)

40. The power generation system of claim 1, wherein the vessel has a wet floor and/or a wet wall, and a baseplate or wall of the vessel has a layer of molten metal deposited thereon to reflect the second plasma light through the window cavity to the power adapter.

41-46. (canceled)

47. A power generation system comprising a magnetohydrodynamic wet seal for maintaining a vacuum on one side of a photovoltaic (PV) window comprising a cavity transparent to optical power; wherein the wet seal joins the PV window chamber and a baseplate and comprises a channel containing molten metal into which the PV window chamber is inserted;
wherein the molten metal is electrically connected to a power supply to create current in the molten metal in the channel to induce magnetorestriction of the molten metal in the housing to maintain the seal;
wherein light is generated on one side of the PV window, transmitted through the window, and collected in at least one photovoltaic cell to generate electrical power.

48. The power generation system of claim 47, wherein the molten metal is exposed to magnetic field such that the Lorentz force of the current and magnetic field on the molten metal in the channel is directed against external forces on the molten metal to maintain the wet seal.

49. A wet seal for maintaining a vacuum on one side of a photovoltaic (PV) window comprising a cavity transparent to optical power; wherein the wet seal joins a PV window chamber and a baseplate (e.g., a baseplate of the vessel having penetrations for the tops of one or more reservoirs) and comprises a channel containing molten metal into which the PV window chamber is inserted;
wherein the molten metal rotates such that the centrifugal force pushes radially on the molten metal to maintain the seal against external forces.

50. (canceled)

51. A wet seal for maintaining a vacuum on one side of a photovoltaic (PV) window comprising a cavity transparent to optical power;
wherein the seal comprises an electrically insulated channel dimensioned for the photovoltaic window chamber to be inserted therein and extending around the PV window chamber when the PV window chamber is inserted in the channel;
wherein the channel is filled with molten metal;
wherein the electrically insulated channel has at least one positive lead electrode and at least one negative lead electrode at different points of the channel;
at least one current is applied through the molten metal in the channel, and the molten metal is exposed to at least one magnetic field applied by at least one magnet to create at least one Lorentz force along a section of the channel wherein the electrodes and magnets are configured and oriented such that the Lorentz forces of the corresponding currents and magnetic fields are in the vector directions to oppose the atmospheric pressure force on the molten metal in the channel to produce a vacuum seal, the Lorentz forces of the currents and magnetic fields are sufficient to maintain a pressure difference.

52. The wet seal of claim 51, wherein the seal comprises two or more electrically insulated channels; wherein each channel has at least one positive lead electrode and negative lead electrode;
wherein when the PV window chamber comprising at least one edge is inserted into at least one channel, each channel is independently filled with molten metal such that the two or more channels together extend around the PV window, and
the current or currents in each channel is independently biased and together interact with independent Lorentz fields to maintain a pressure difference.

53. A method of maintaining a pressure difference between two sides of a first solid material comprising:
a) mating the first solid material and the second solid material with the molten metal disposed therebetween; wherein when mated, the molten metal has a magnetic field applied thereto;
b) applying a current through the molten metal;
c) reducing the pressure on the molten metal;
wherein the force created by the current and the magnetic field opposes the force created by the reduction of pressure to maintain the pressure difference.

54-55. (canceled)

56. The wet seal of claim 47, wherein the PV window forms a PV window cavity having a flange at its base, and the PV window flange is seated on a window cavity baseplate; wherein the magnetohydrodynamic wet seal between the PV window cavity flange and the window cavity baseplate further comprising comprises:
a) a molten metal reservoir circumferential to the PV window cavity flange that supplies molten metal to a gap between the bottom of the PV window flange and a portion of the baseplate;
b) a continuous separator in a gap between an outer wall of the molten metal reservoir wall and a vertical edge of the PV window flange and the gap between the bottom of the PV window flange and the baseplate;
c) a source of magnetic field such as a permanent magnet, wherein the magnetic field produced from the source of the magnetic field is perpendicular to the gap between the PV window flange and the baseplate;
d) a current supply and electrodes on opposite sides of the continuous separator connected to the molten metal to supply current to the corresponding tin or gallium wet seal circuit, wherein the current, in the presence of the crossed magnetic field, produces a radial MHD force in the gap between the PV window flange and the baseplate, and
e) an MHD-atmospheric pressure force balance processor operably connected to sensors of the wet seal position such as at least one optical sensor and one conductivity sensor, an MHD current sensor and controller, an evacuation rate sensor such as a pressure gauge and controller such as at least one of a vacuum value such as a needle valve and its controller and a vacuum pump and its controller wherein the MHD-atmospheric pressure force balance processor may receive sensor input and reiteratively adjust the MHD current and vacuum rate to achieve and maintain a stable wet seal as and when the PV window cavity is evacuated.

57. The wet seal of claim 56,
wherein the MHD-atmospheric pressure force balance processor sets the current supply controller to provide a current corresponding to an increased MHD force relative to the maximum atmospheric force, whereby as a vacuum inside the PV window cavity, the outer atmospheric pressure causes more molten metal to flow into the gap between PV window flange and the baseplate to cause an increase in the width of the wet seal and an increase in MHD current flow with a concomitant increase in the opposing MHD force until a steady state wet seal is established.
